(19) United States
(12) Patent Application Publication
(10) Pub. No.: US 2025/0377780 A1
(43) Pub. Date: Dec. 11, 2025

(54) Devices, Methods, and Graphical User Interfaces for Reconfiguring User Interfaces in Three-Dimensional Environments

(71) Applicant: Apple Inc., Cupertino, CA (US)

(72) Inventors: Jonathan Ravasz, Sunnyvale, CA (US); Matan Stauber, Philadelphia, PA (US); Danielle M. Price, Los Gatos, CA (US); William A. Sorrentino, III, Kentfield, CA (US); Stephen O. Lemay, Palo Alto, CA (US); Hugo D. Verweij, Portola Valley, CA (US); Hana Z. Wang, Novato, CA (US); Kirsty Keatch, Cupertino, CA (US)

(21) Appl. No.: 19/229,726

(22) Filed: Jun. 5, 2025

Related U.S. Application Data
(60) Provisional application No. 63/657,839, filed on Jun. 8, 2024.
(60) Provisional application No. 63/817,712, filed on Jun. 4, 2025.

(51) Int. Cl. G06F 3/0486; G06F 3/01

(52) U.S. Cl. CPC G06F 3/0486; G06F 3/017

(57) ABSTRACT

A computer system detects an input directed to a first object in a first placement location in a first user interface, wherein the user input includes first movement and meets drag criteria. In response, the computer system moves the first object relative to the first placement location based on the first movement. If the first object is approaching a second object in a second placement location in the first user interface, the computer system moves the second object in a first direction away from the first object. If the first object is within a threshold distance of the second object after the second object is moved away from the first object, the computer system ceases to move the second object away from the first object and initiates a process for creating a folder that includes the first object and the second object.

### RELATED APPLICATIONS

This application claims the benefit of and priority to U.S. Patent Application No. 63/817,712, filed on Jun. 4, 2025, and U.S. Patent Application No. 63/657,839, filed on Jun. 8, 2024, each of which is hereby incorporated by reference in its entirety.

### TECHNICAL FIELD

The present disclosure relates generally to computer systems that are in communication with one or more display generation components and, optionally, one or more input devices that provide computer-generated experiences, including, but not limited to, electronic devices that provide virtual reality and mixed reality experiences via a display generation component.

### BACKGROUND

The development of computer systems for augmented reality has increased significantly in recent years. Example augmented reality environments include at least some virtual elements that replace or augment the physical world. Input devices, such as cameras, controllers, joysticks, touch-sensitive surfaces, and touch-screen displays for computer systems and other electronic computing devices are used to interact with virtual/augmented reality environments. Example virtual elements include virtual objects, such as digital images, video, text, icons, and control elements such as buttons and other graphics.

### SUMMARY

Some methods and interfaces for interacting with environments that include at least some virtual elements (e.g., applications, augmented reality environments, mixed reality environments, and virtual reality environments) are cumbersome, inefficient, and limited. For example, systems that provide insufficient feedback for performing actions associated with virtual objects, systems that require a series of inputs to achieve a desired outcome in an augmented reality environment, and systems in which manipulation of virtual objects are complex, tedious, and error-prone, create a significant cognitive burden on a user, and detract from the experience with the virtual/augmented reality environment. In addition, these methods take longer than necessary, thereby wasting energy of the computer system. This latter consideration is particularly important in battery-operated devices.

Accordingly, there is a need for computer systems with improved methods and interfaces for providing computer-generated experiences to users that make interaction with the computer systems more efficient and intuitive for a user. Such methods and interfaces optionally complement or replace conventional methods for providing extended reality experiences to users. Such methods and interfaces reduce the number, extent, and/or nature of the inputs from a user by helping the user to understand the connection between provided inputs and device responses to the inputs, thereby creating a more efficient human-machine interface.

The above deficiencies and other problems associated with user interfaces for computer systems are reduced or eliminated by the disclosed systems. In some embodiments, the computer system is a desktop computer with an associated display. In some embodiments, the computer system is a portable device (e.g., a notebook computer, tablet computer, or handheld device). In some embodiments, the computer system is a personal electronic device (e.g., a wearable electronic device, such as a watch, or a head-mounted device). In some embodiments, the computer system has a touchpad. In some embodiments, the computer system has one or more cameras. In some embodiments, the computer system has a touch-sensitive display (also known as a “touch screen” or “touch-screen display”). In some embodiments, the computer system has one or more eye-tracking components. In some embodiments, the computer system has one or more hand-tracking components. In some embodiments, the computer system has one or more output devices in addition to the display generation component, the output devices including one or more tactile output generators and/or one or more audio output devices. In some embodiments, the computer system has a graphical user interface (GUI), one or more processors, memory and one or more modules, programs or sets of instructions stored in the memory for performing multiple functions. In some embodiments, the user interacts with the GUI through a stylus and/or finger contacts and gestures on the touch-sensitive surface, movement of the user's eyes and hand in space relative to the GUI (and/or computer system) or the user's body as captured by cameras and other movement sensors, and/or voice inputs as captured by one or more audio input devices. In some embodiments, the functions performed through the interactions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a transitory and/or non-transitory computer readable storage medium or other computer program product configured for execution by one or more processors.

There is a need for electronic devices with improved methods and interfaces for interacting with a three-dimensional environment. Such methods and interfaces may complement or replace conventional methods for interacting with a three-dimensional environment. Such methods and interfaces reduce the number, extent, and/or the nature of the inputs from a user and produce a more efficient human-machine interface. For battery-operated computing devices, such methods and interfaces conserve power and increase the time between battery charges.

In one aspect, a method is performed at a computer system that is in communication with one or more display generation components and one or more input devices. The method includes, displaying, via the one or more display generation components, at least a portion of a home menu user interface, in a first view of an environment, wherein: the home menu user interface includes a first plurality of user interface objects of a first object type and a second plurality of user interface objects of a second object type that is different from the first object type, and displaying the home menu user interface includes displaying a first portion of a respective plurality of user interface objects. The method further includes, while displaying the home menu user interface, including displaying the first portion of the respective plurality of user interface objects, detecting a first user input directed to a first user interface object included in the first portion of the respective plurality of user interface objects, wherein the first user input meets editing criteria. The method further includes, in response to detecting the first user input that is directed to the first user interface object and that meets the editing criteria: in accordance with a determination that the first user interface object corresponds to a first object type, performing a first operation of a first operation type with respect to the first user interface object; and in accordance with a determination that the first user interface object corresponds to a second object type different from the first object type, performing a second operation of a second operation type, different from the first operation type, with respect to the first user interface object.

In one aspect, a method is performed at a computer system that is in communication with one or more display generation components and one or more input devices. The method includes, displaying, via the one or more display generation components, a first user interface, in a first view of an environment, including displaying a first plurality of user interface objects in a first plurality of placement locations in the first user interface according to a first arrangement of the first plurality of user interface objects. The method further includes, while displaying the first user interface including the first plurality of user interface objects, detecting a first user input that is directed to a first user interface object of the first plurality of user interface objects, wherein the first user interface object was displayed at a first placement location in the first user interface when a start of the first user input was detected, and wherein the first user input includes first movement and meets drag criteria with respect to the first user interface object. The method further includes, in response to detecting the first user input that meets the drag criteria with respect to the first user interface object: moving the first user interface object relative to the first placement location in the first user interface based on the first movement of the first user input; in accordance with a determination that the first user interface object is approaching a second user interface object placed in a second placement location, different from the first placement location, in the first user interface, moving the second user interface object relative to the second placement location in a first direction away from the first user interface object; and in accordance with a determination that the first user interface object is within a first threshold distance of the second user interface object after the second user interface object is moved relative to the second placement location, away from the first user interface object, ceasing to move the second user interface object away from the first user interface object and initiating a process for creating a folder that includes the first user interface object and the second user interface object.

In one aspect, a method is performed at a computer system that is in communication with one or more display generation components, one or more audio output devices, and one or more input devices. The method includes, while displaying, via the one or more display generation components, a user interface in a reconfiguration mode, including displaying a first plurality of user interface objects, detecting, via the one or more input devices, a user input that corresponds to a request to move an object. The method includes, in response to detecting the user input that corresponds to the request to move the object, moving the object, and in accordance with a determination that the user input meets folder-creation criteria, generating, via the one or more audio output devices, an audio output indicative of an operation associated with creating a folder.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A is a block diagram illustrating an operating environment of a computer system for providing extended reality (XR) experiences in accordance with some embodiments.

FIGS. 1B-1P are examples of a computer system for providing XR experiences in the operating environment of FIG. 1A.

FIG. 2 is a block diagram illustrating a controller of a computer system that is configured to manage and coordinate an XR experience for the user in accordance with some embodiments.

FIG. 3A is a block diagram illustrating a display generation component of a computer system that is configured to provide a visual component of the XR experience to the user in accordance with some embodiments.

FIGS. 3B-3G illustrate the use of Application Programming Interfaces (APIs) to perform operations.

FIG. 4 is a block diagram illustrating a hand tracking unit of a computer system that is configured to capture gesture inputs of the user in accordance with some embodiments.

FIG. 5 is a block diagram illustrating an eye tracking unit of a computer system that is configured to capture gaze inputs of the user in accordance with some embodiments.

FIG. 6 is a flow diagram illustrating a glint-assisted gaze tracking pipeline in accordance with some embodiments.

FIG. 7 illustrates an example physical environment in which a user is interacting with a head mounted computer system, in accordance with some embodiments.

FIGS. 8A-8AL illustrate example user interfaces and interactions for reconfiguring a home user interface with multiple collections of user interface objects in a three-dimensional environment, in accordance with some embodiments.

FIGS. 9A-9AS illustrate example user interfaces and interactions for creating a folder of user interface objects in a three-dimensional environment, in accordance with some embodiments.

FIGS. 10A-10M is a flow diagram of methods of reconfiguring a home user interface with multiple collections of user interface objects in a three-dimensional environment, in accordance with various embodiments.

FIGS. 11A-11K is a flow diagram of methods of creating a folder of user interface objects in a three-dimensional environment, in accordance with various embodiments.

FIG. 12 is a flow diagram of methods of generating sounds associated with folder creation operations and other operations performed with respect to user interface objects in a three-dimensional environment, in accordance with various embodiments.

### DESCRIPTION OF EMBODIMENTS

The present disclosure relates to user interfaces for providing an extended reality (XR) experience to a user, in accordance with some embodiments.

The systems, methods, and GUIs described herein improve user interface interactions with virtual/augmented reality environments in multiple ways.

Some starting user interfaces (e.g., home user interfaces) for spatial computer systems are cluttered with different menus, sub-menus, windows, and/or a variety of user interface controls. Such starting user interfaces require navigating and selecting different options and user interface elements until locating a user interface or a control that provides a target functionality. Such techniques can become cumbersome, time consuming, and result in multiple additional inputs. Additionally, reconfiguring the starting user interface is limited, cumbersome, or inefficient, if at all possible. In some embodiments, an improved home user interface and a mechanism for reconfiguring the home user interface in a three-dimensional environment are provided. In some embodiments, instead of navigating through various user interfaces and/or menu options, the home user interface includes different collections of user interface objects (optionally, displayed in respective views of the home user interface), where the user interface objects are arranged into the different collections by object type. While a respective collection is displayed or in focus (optionally, in a reconfiguration mode) in the three-dimensional environment, the computer system detects an input that is directed to a user interface object in the respective collection and corresponds to a request to edit the respective collection of the home user interface (e.g., meets an editing criteria). In response to the same type of user input, the computer system performs different reconfiguration operations depending on a respective object type of the user interface object and/or, in some instances, the same reconfiguration operation irrespective of the object type. Displaying and arranging user interface objects into different collections by object type and using the same type of input to perform different reconfiguration operations depending on the object type, reduces the number of inputs and/or the amount of time needed to reconfigure the home user interface (e.g., the user can use the same type of input to perform reconfiguration operations of the home screen user even when collections of different types of user interface objects are visible) and/or to find a target functionally (e.g., the user does not have to navigate through various menus and/or controls to locate a target functionally).

In some embodiments, an improved mechanism for creating a folder of objects (e.g., application icons, contact icon, environment icons, controls, document icons, and/or other user interface objects) in an environment (e.g., a two-dimensional environment, a pseudo-three-dimensional environment, a three-dimensional virtual environment, a three-dimensional mixed-reality environment, and/or other environments in which objects are repositionable in an arrangement of placement locations in a user interface based on user inputs) is provided. In a home user interface, while a first icon is dragged toward a placement location occupied by a second icon, the computer system initially pushes the second icon away from the first icon. After the second icon is pushed away from the first icon and, in accordance with a determination that the first icon is within less than a threshold distance away from the second icon or the placement location of the second icon (and optionally remains so for at least a threshold amount of time), the computer system stops pushing the second icon away and initiates a folder creation process that optionally includes displaying a folder preview icon (e.g., an icon that envelopes the first icon the second icon). In some embodiments, in accordance with a determination that the folder creation process has not been cancelled (e.g., the first and second icons remain within less than the threshold distance away from each other before the expiration of a threshold amount of time), the computer system pulls the second icon toward the first icon and the original placement location of the second icon, and generates a folder preview icon that, optionally, initially includes at least the second icon and, then, pulls the first icon into the folder preview icon (e.g., before the first icon is released from the drag input, or in response to the first icon being released from the user's drag input). In some embodiments, after the folder preview icon is displayed and in accordance with a determination that the folder creation process has not been cancelled, the second icon appears to be sucked into the folder preview icon together with the first icon. After the folder preview icon is displayed and in accordance with a determination that the folder creation process has been cancelled (e.g., in accordance with a determination that the first icon is moved away from the second icon based on the user's drag input, before the expiration of the threshold amount of time or before the first icon is released from the user's drag input), the computer system ceases to display the folder preview icon, and forgoes creating a folder, thereby providing a user with an opportunity to cancel the folder creation process. Pushing an adjacent icon away from a dragged icon and then stop pushing and start pulling the adjacent icon toward the dragged icon after a folder creation process is initiated but before it is completed, provides continued visual assistance to a user in creating a folder and/or rearranging a home user interface, thereby reducing the number of inputs and/or the amount of time needed to create a folder or rearrange the home user interface in an environment (e.g., reducing errors and unintended inputs).

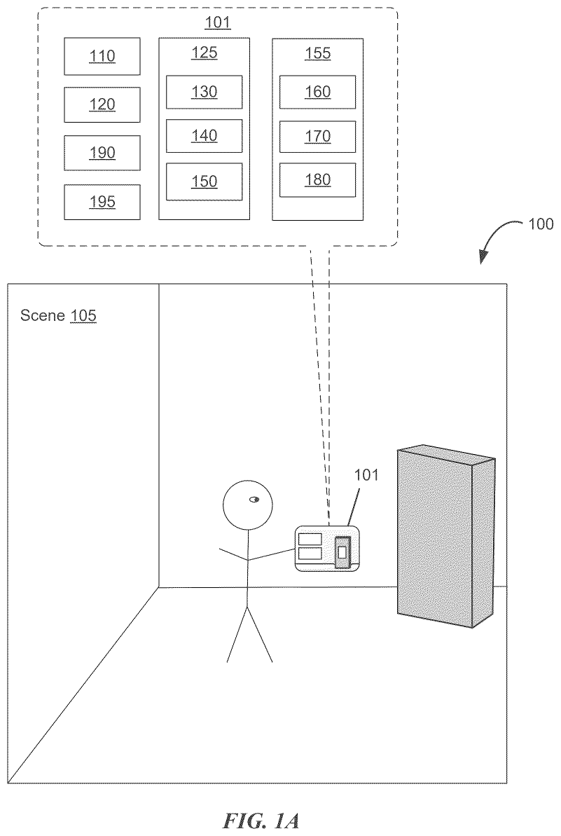

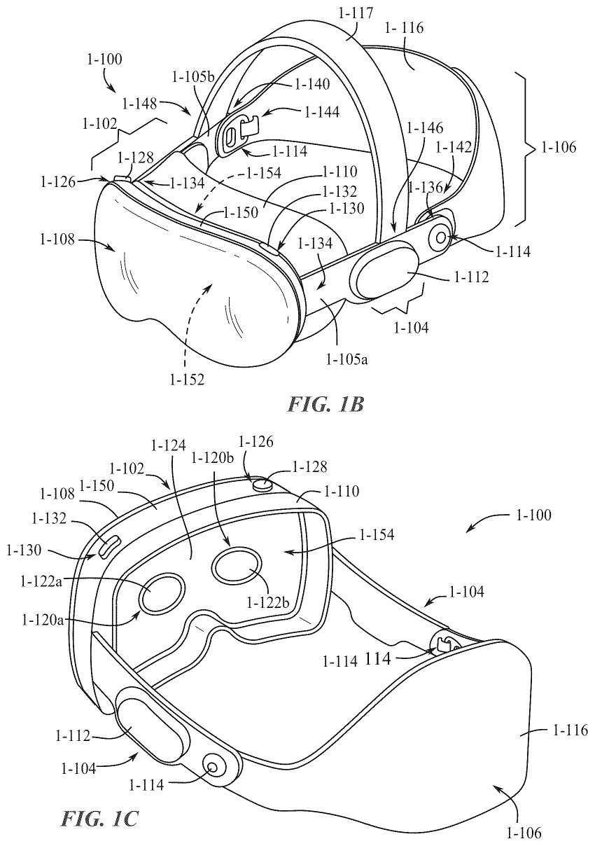

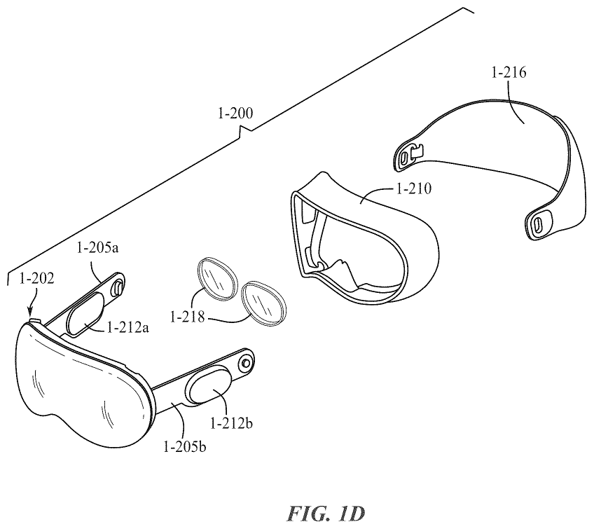

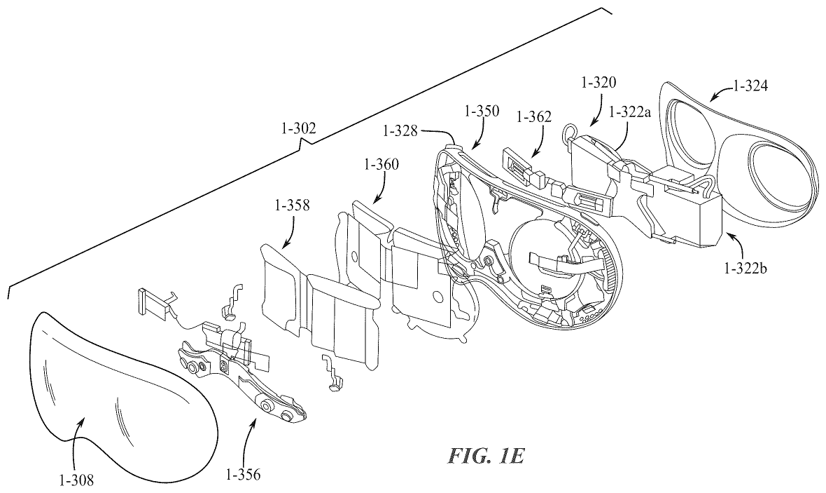

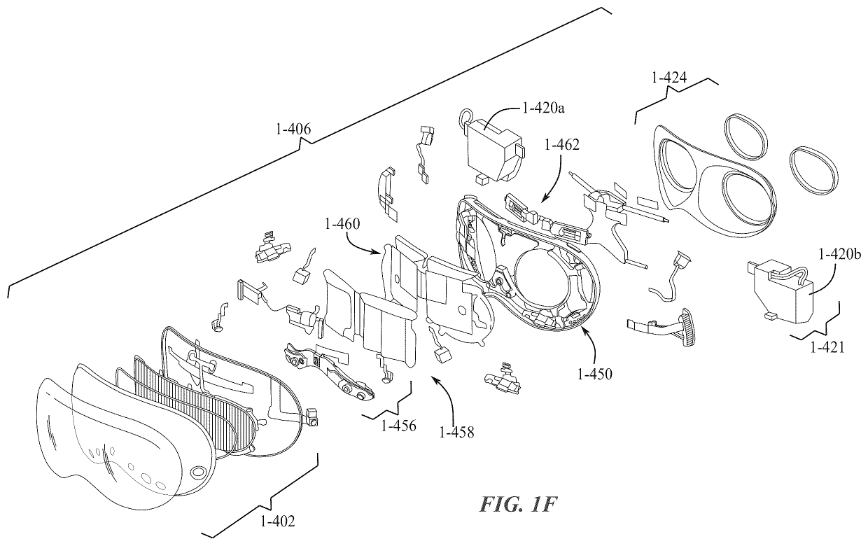

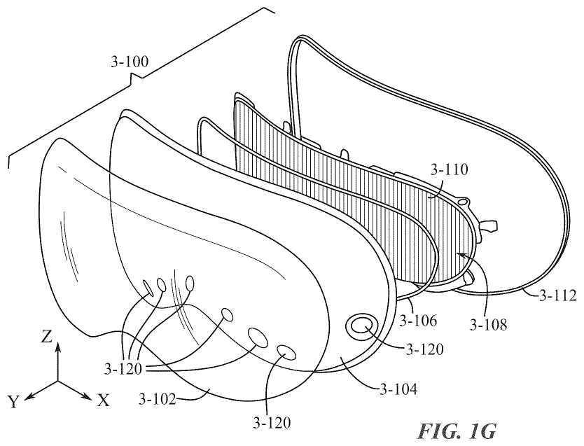

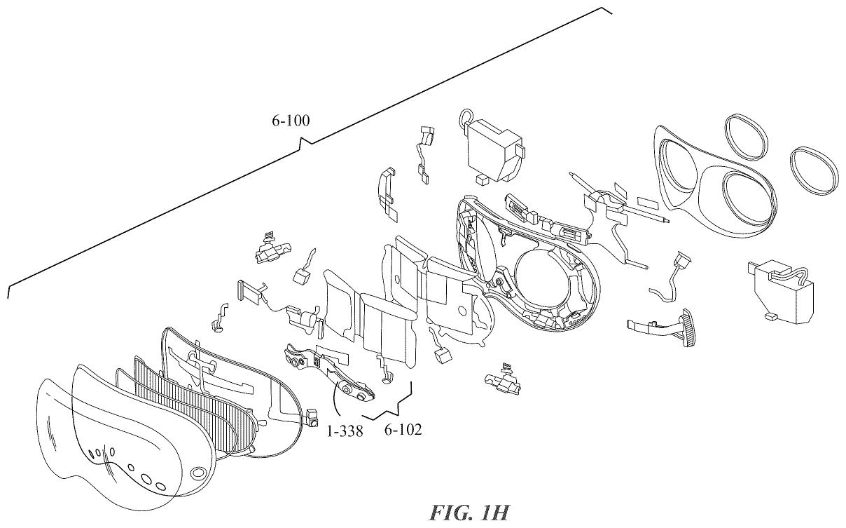

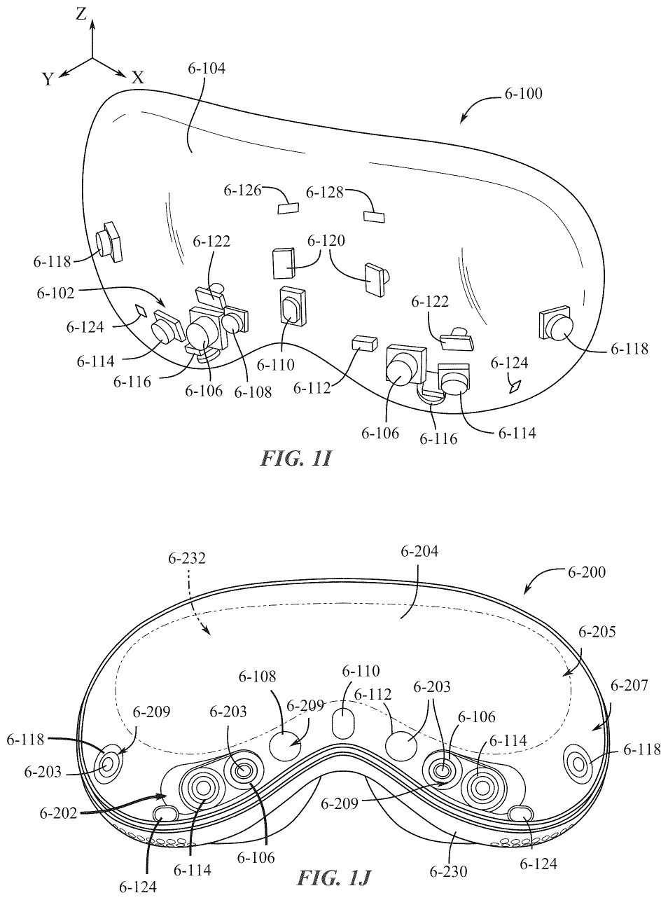

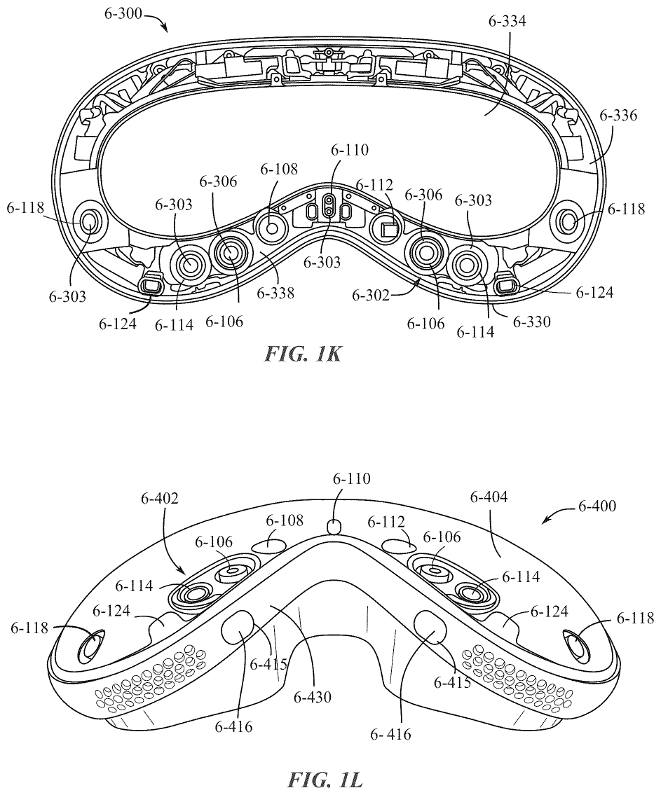

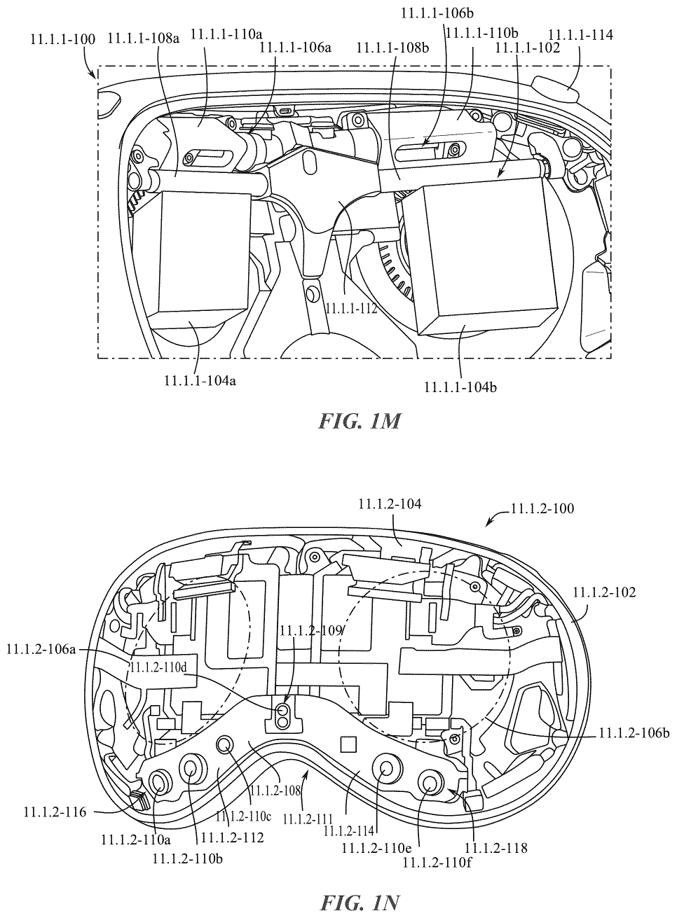

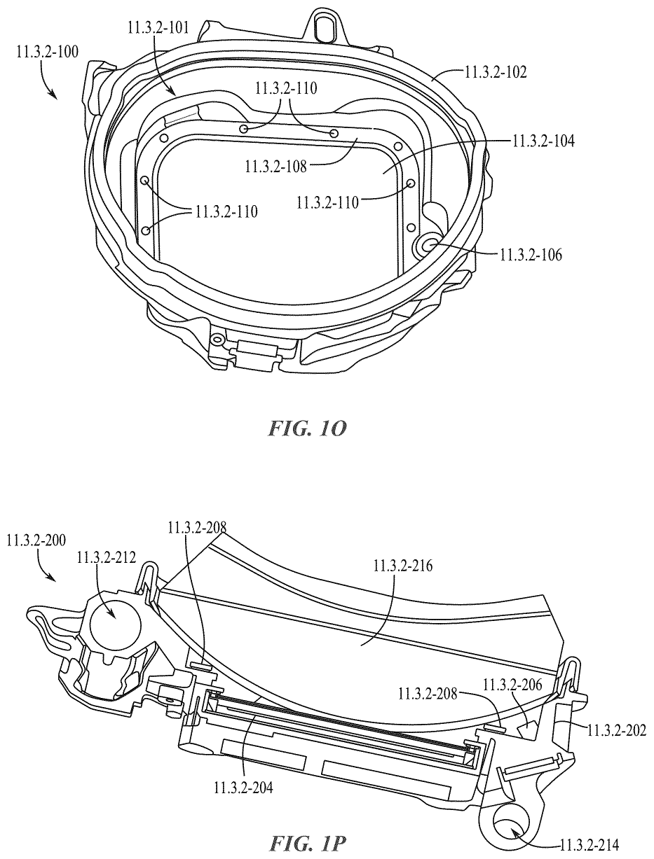

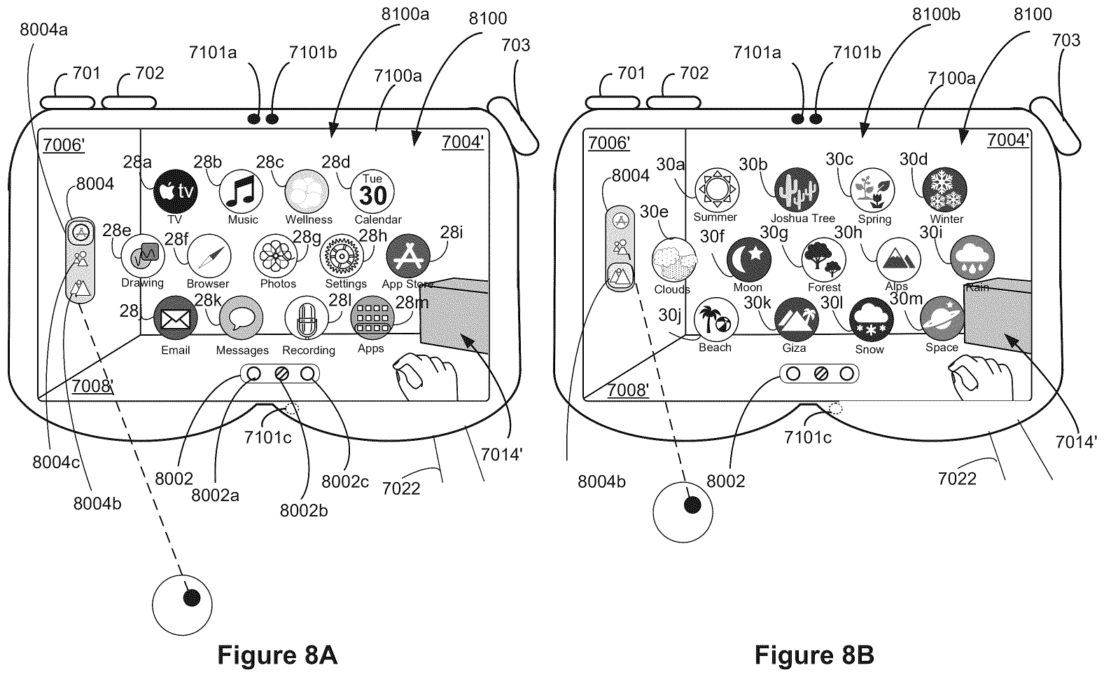

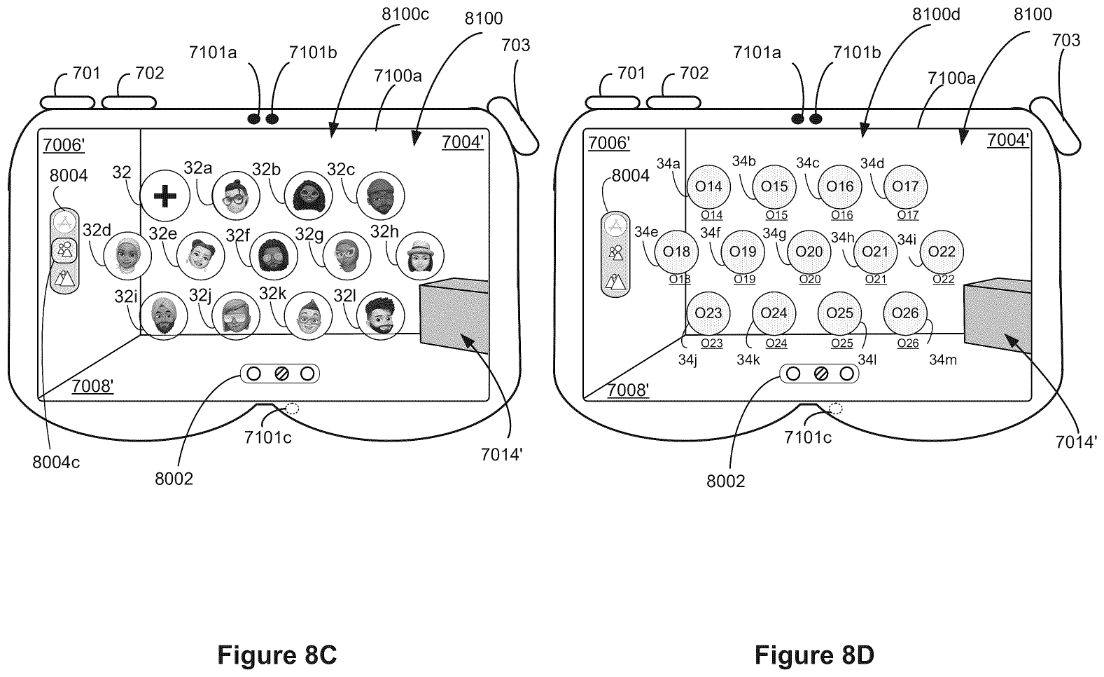

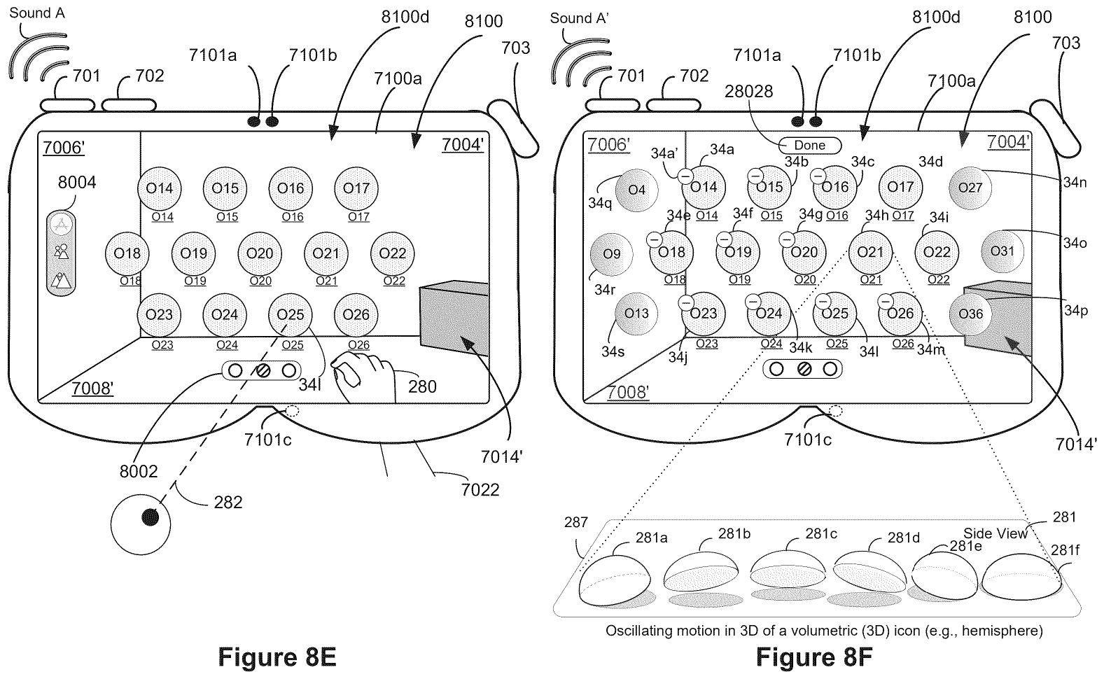

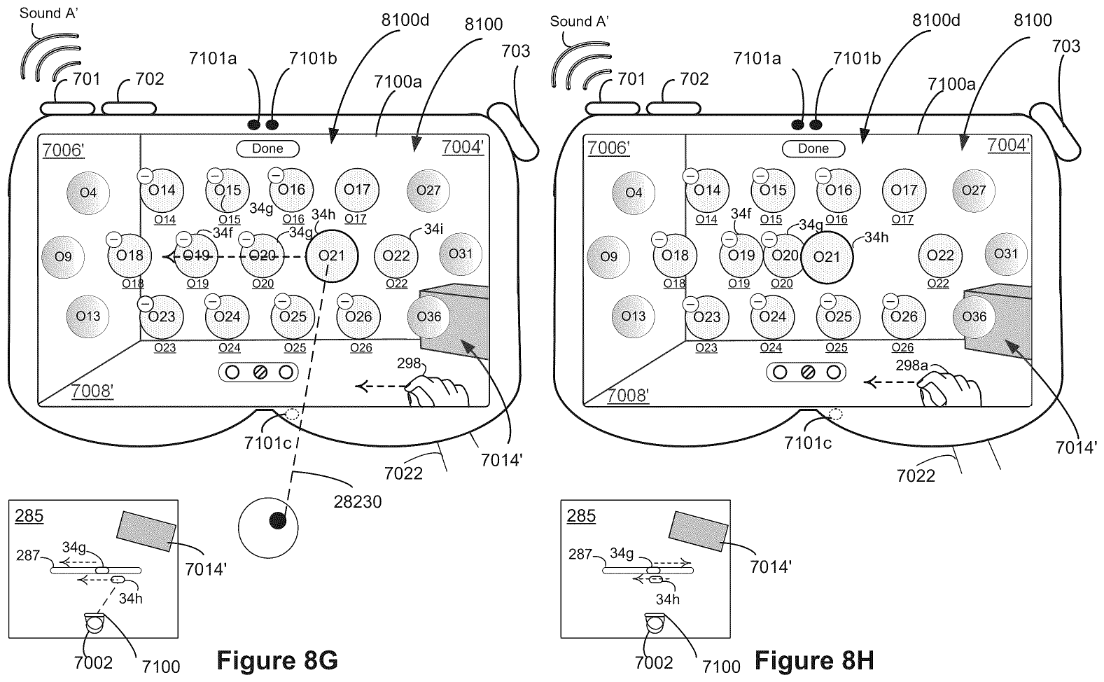

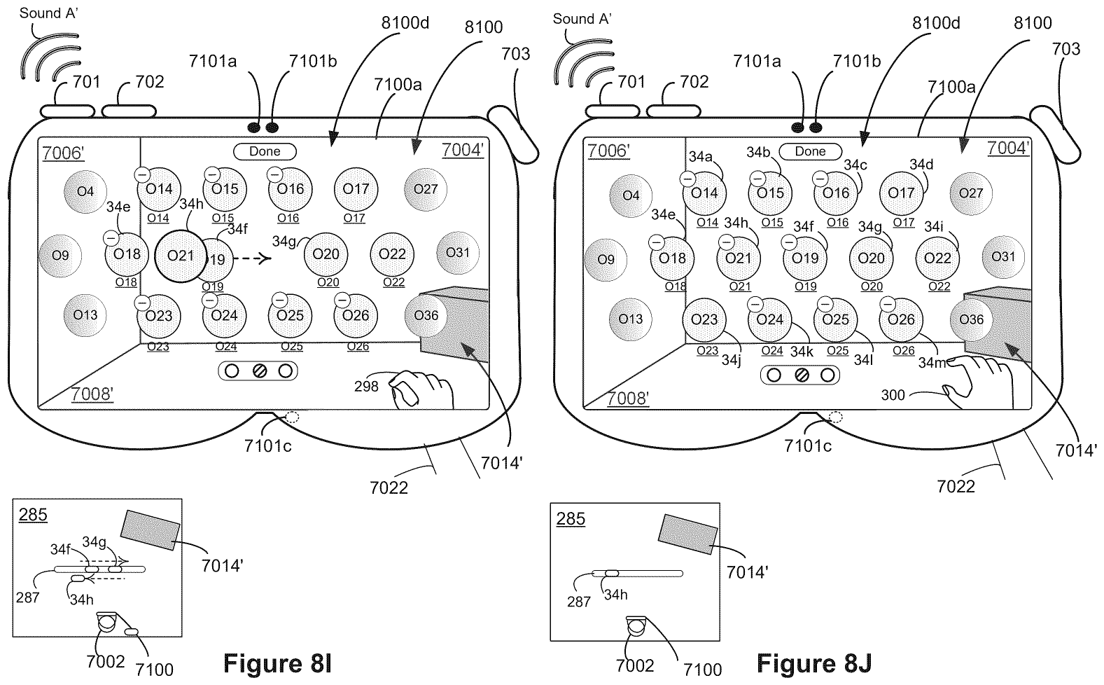

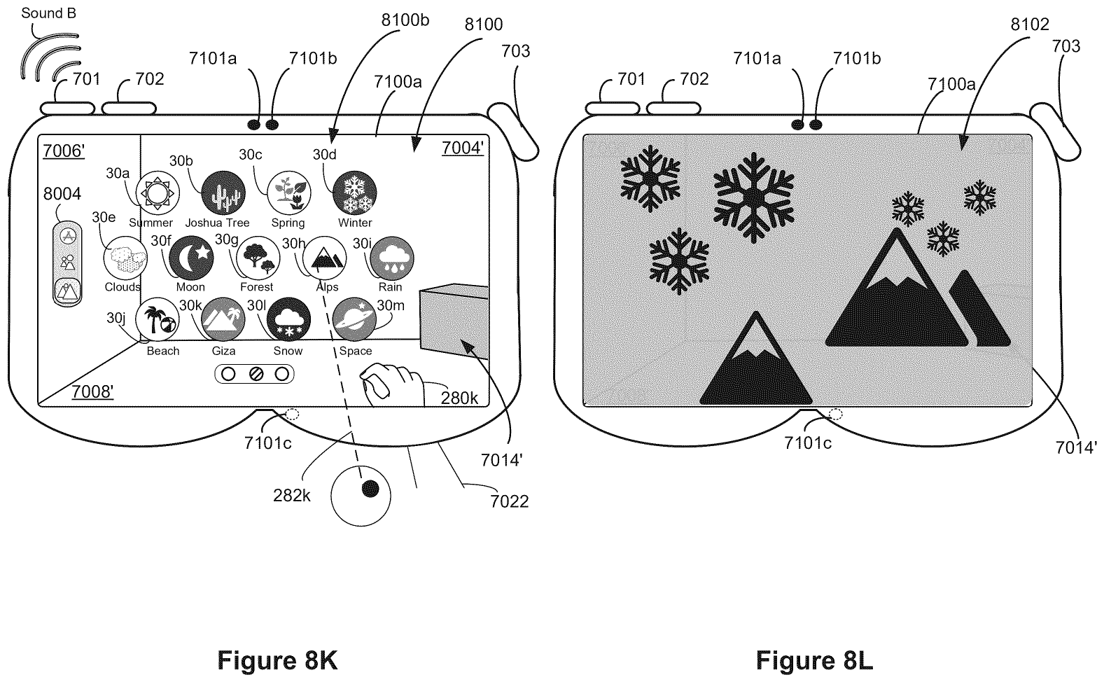

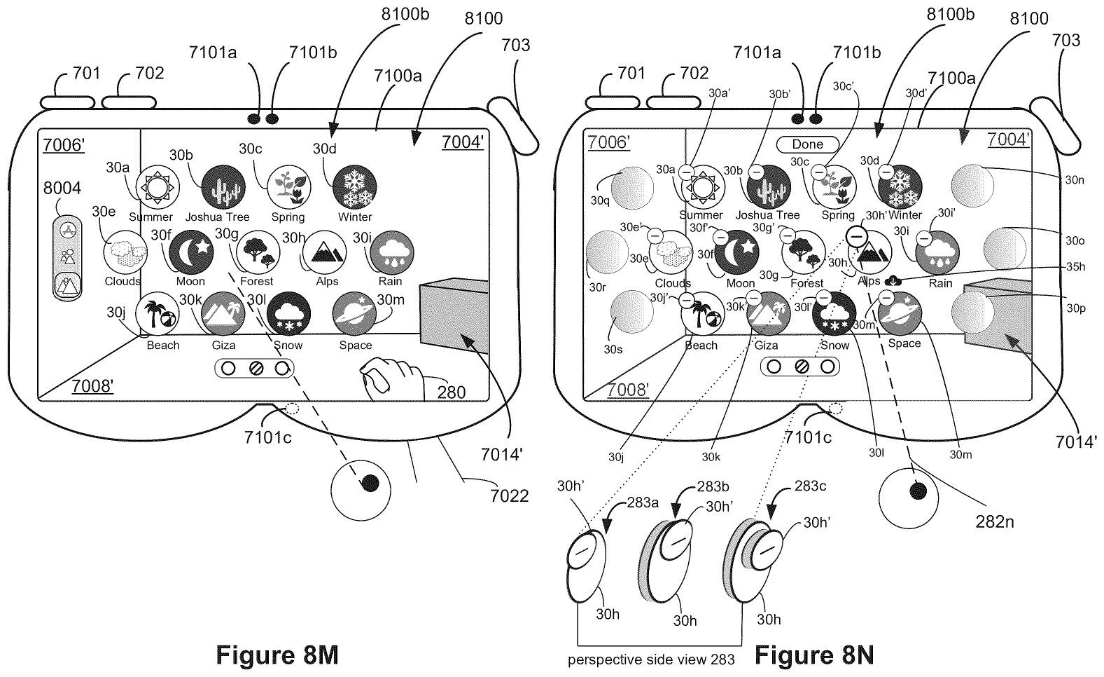

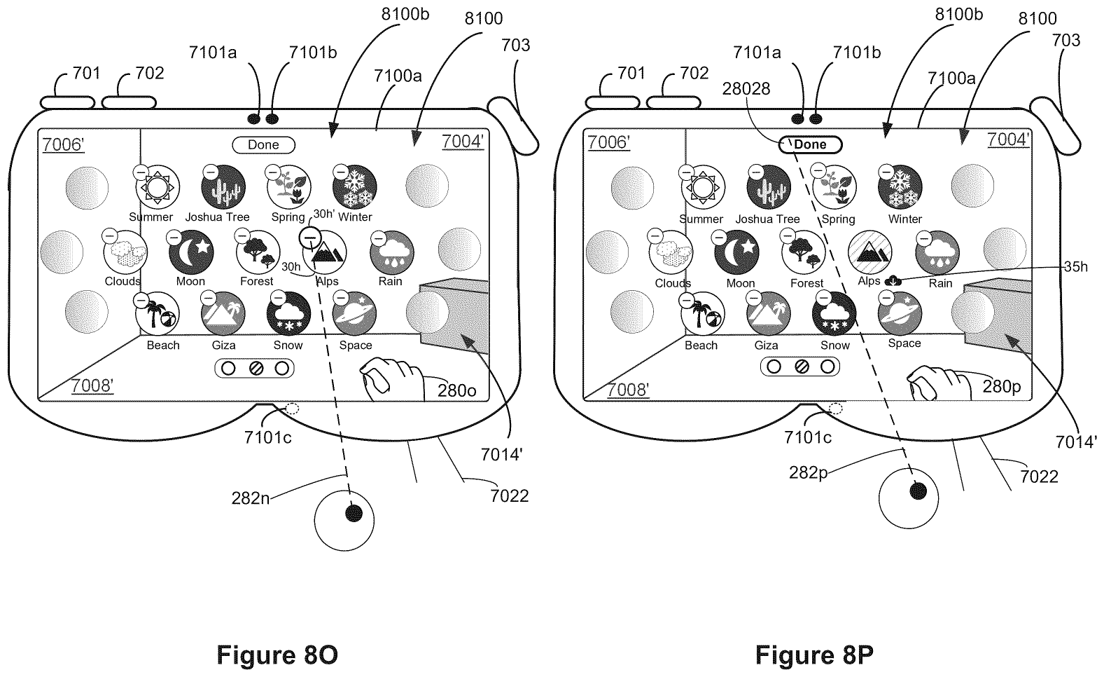

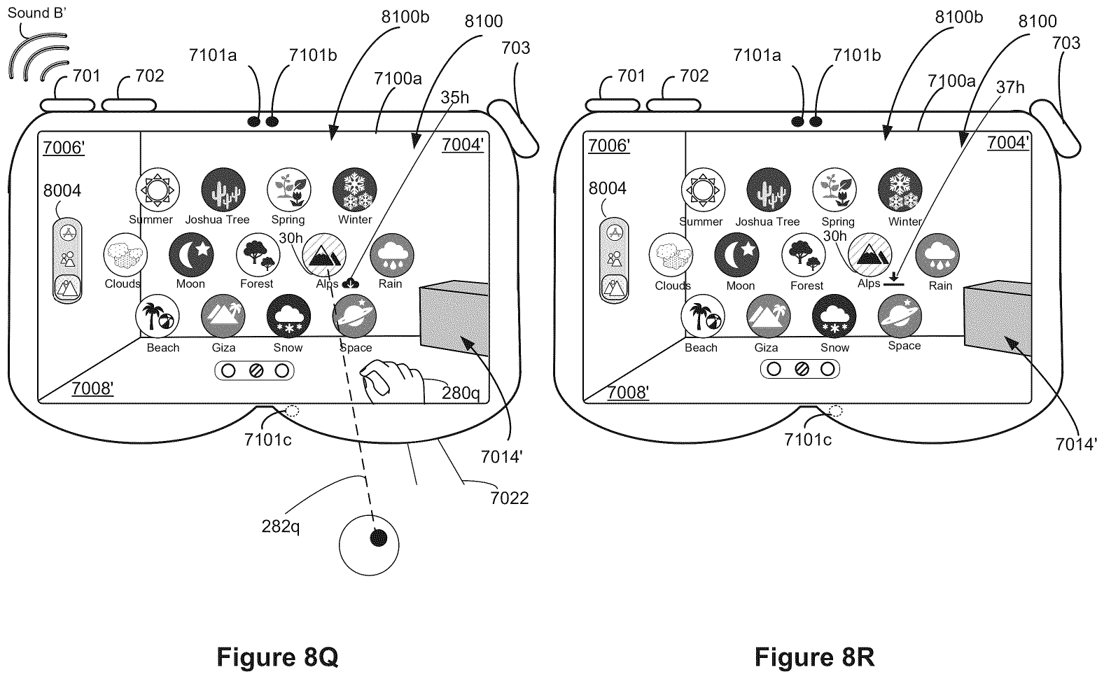

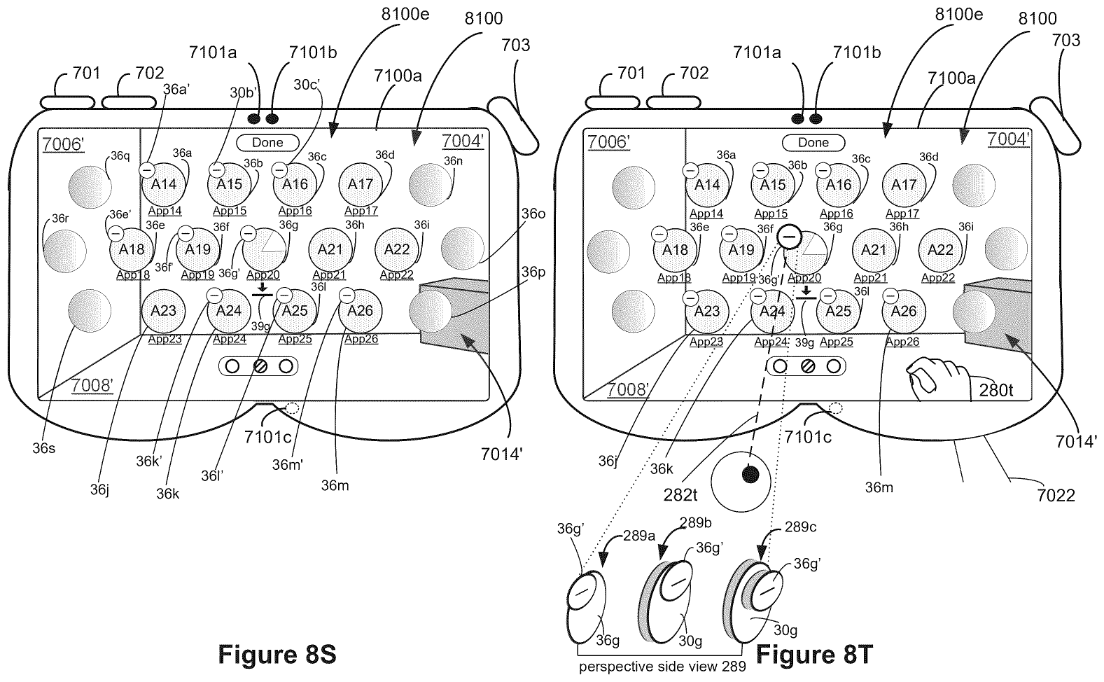

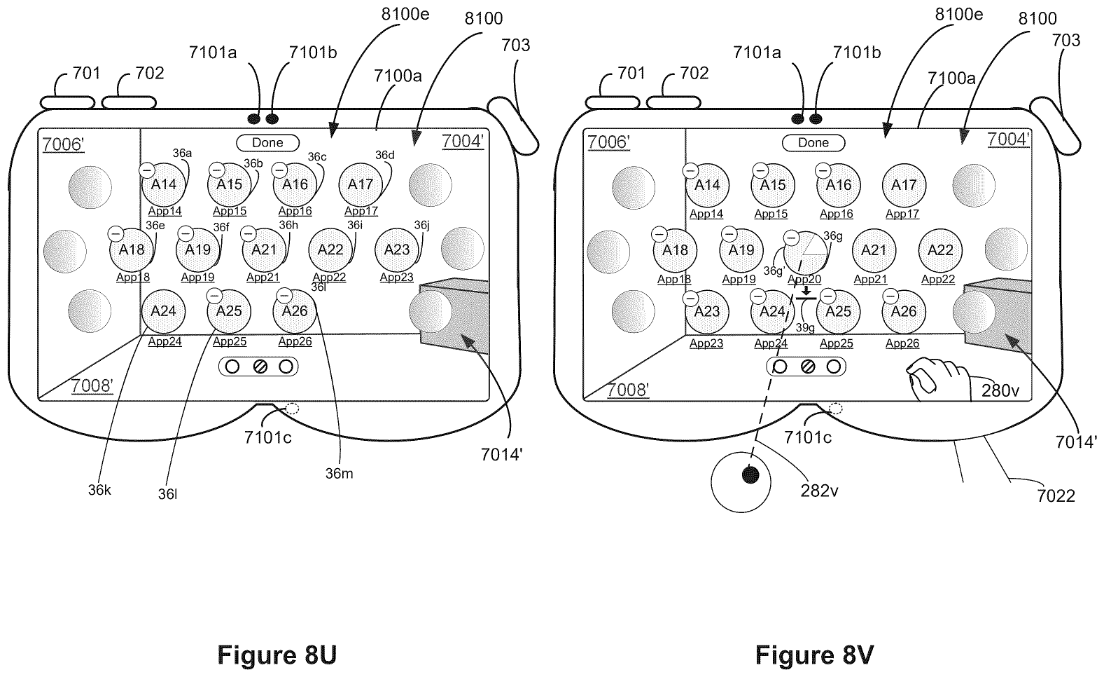

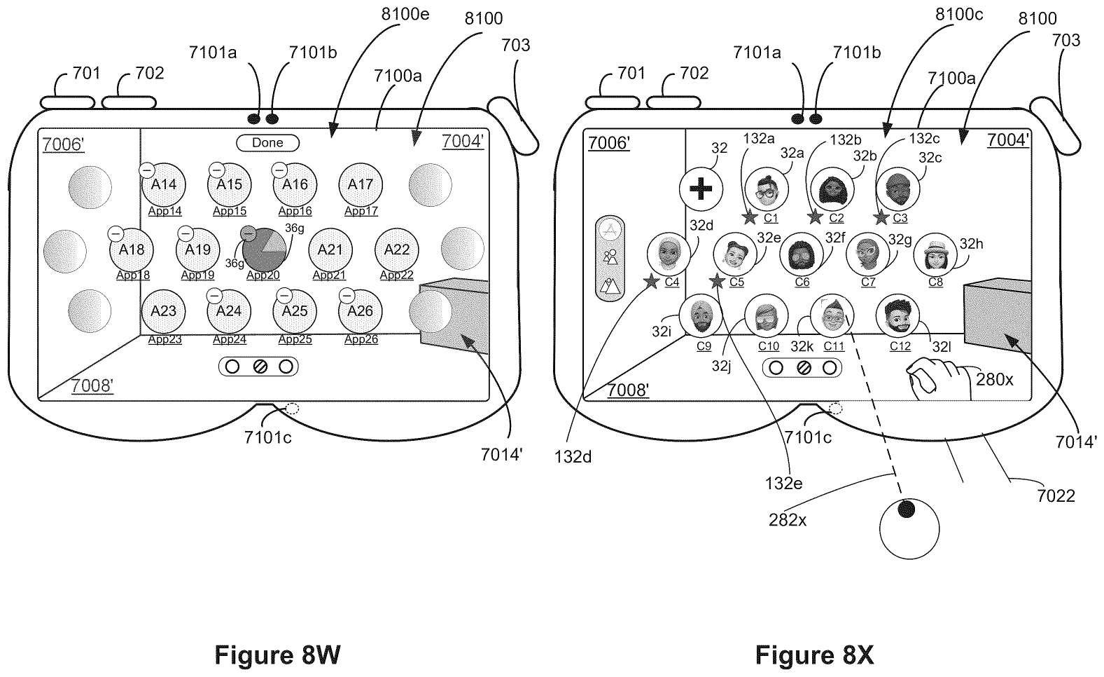

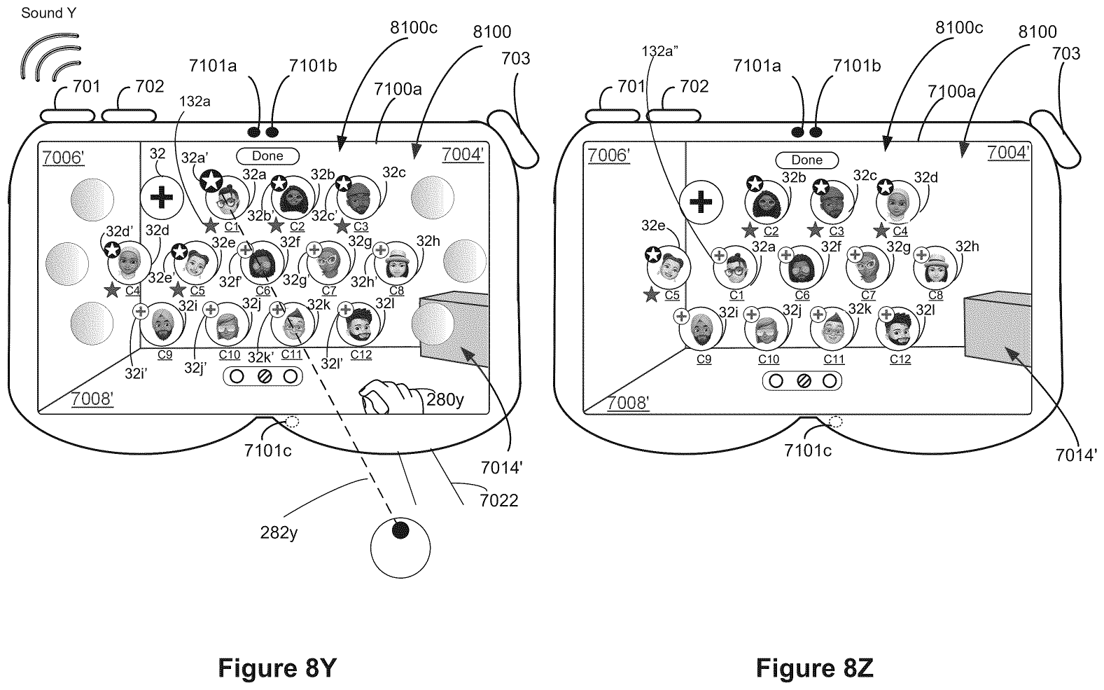

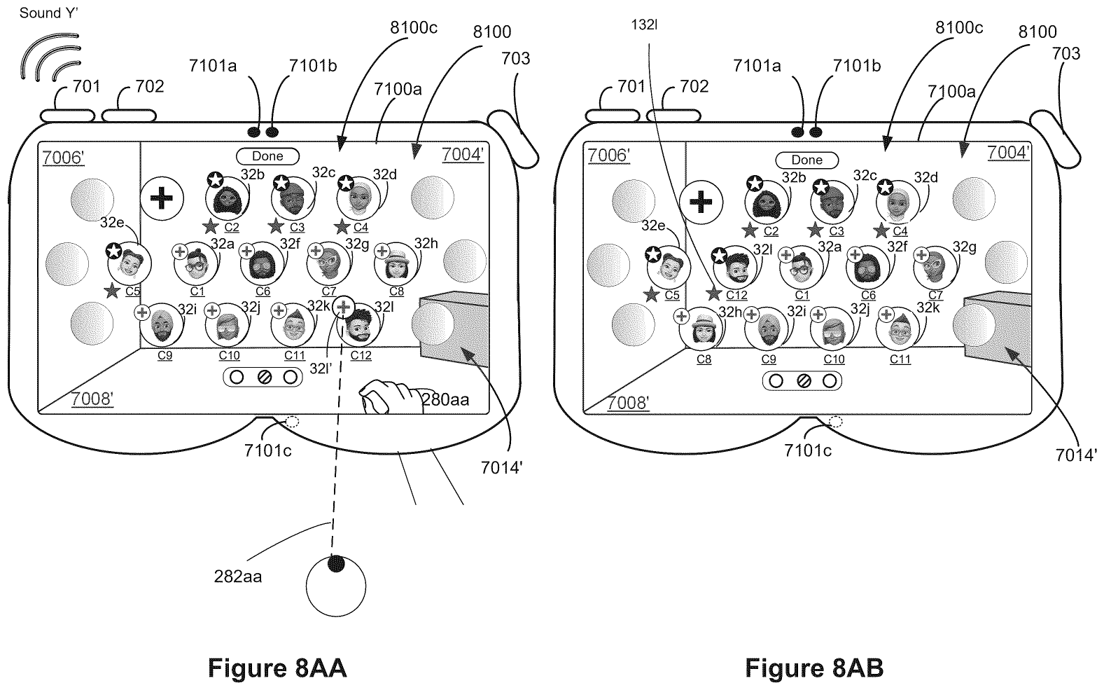

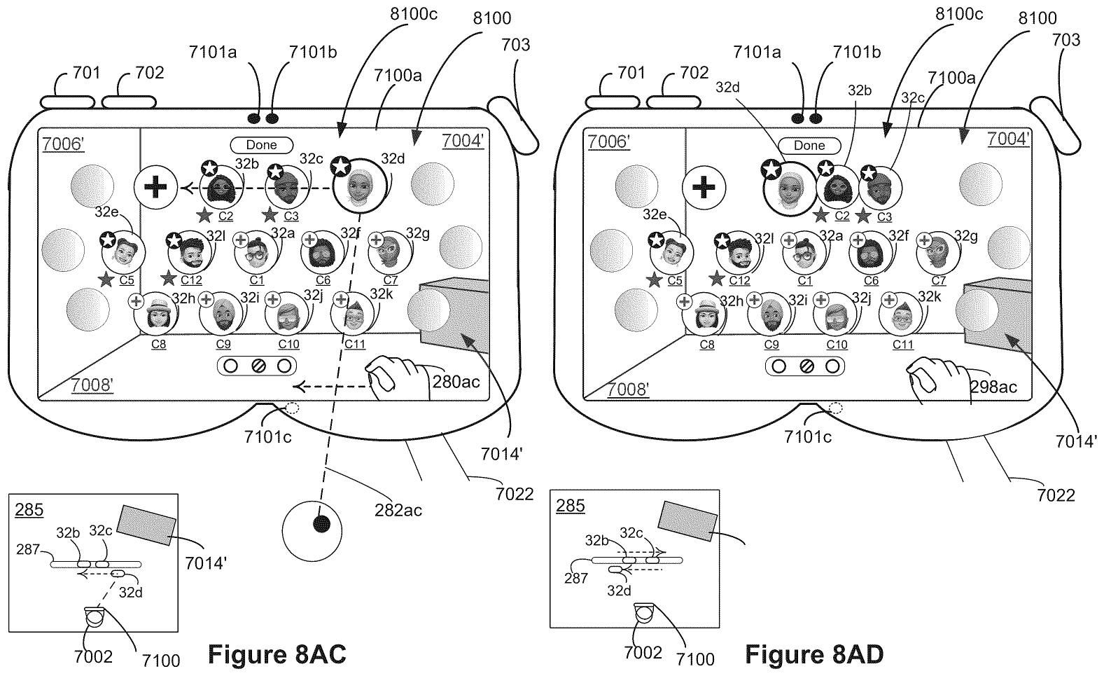

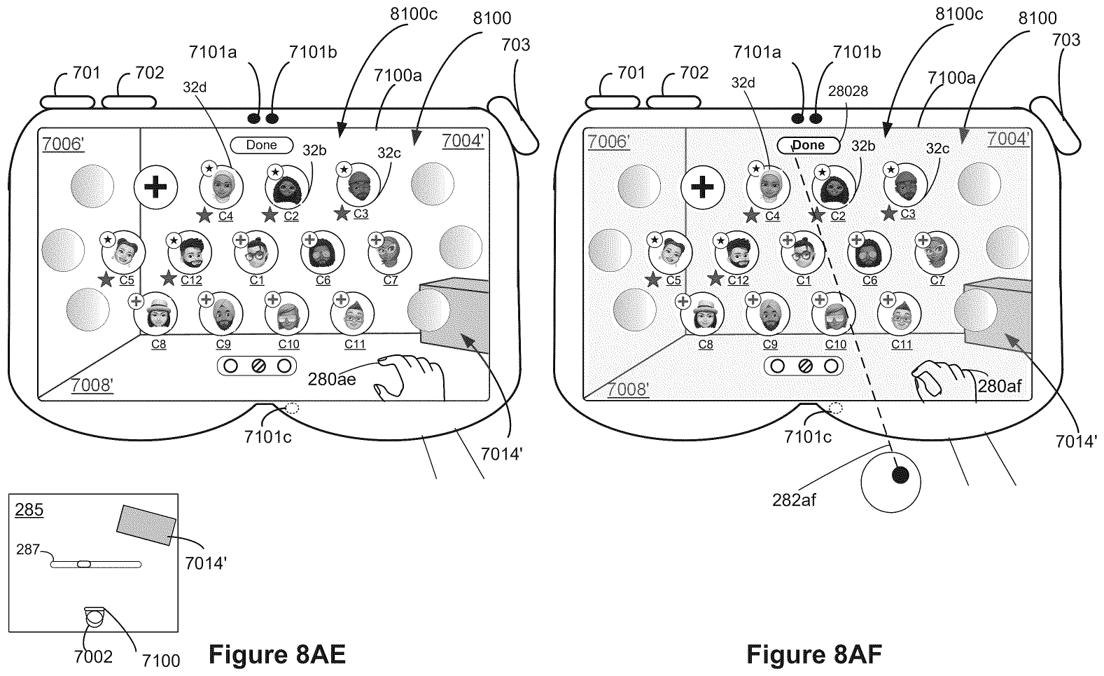

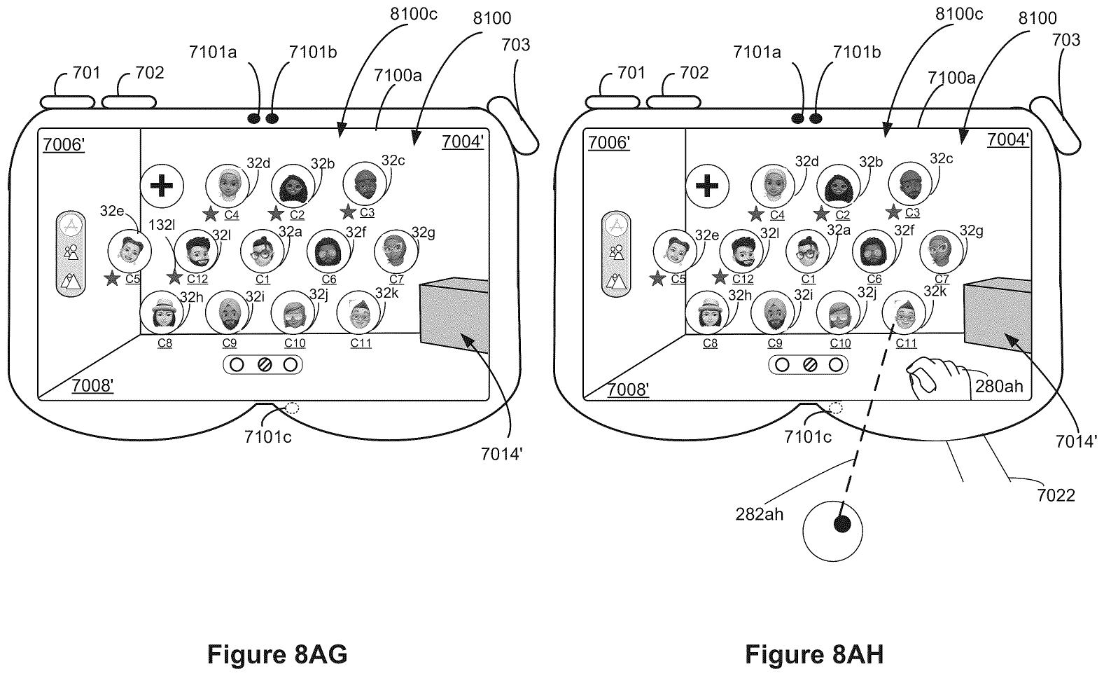

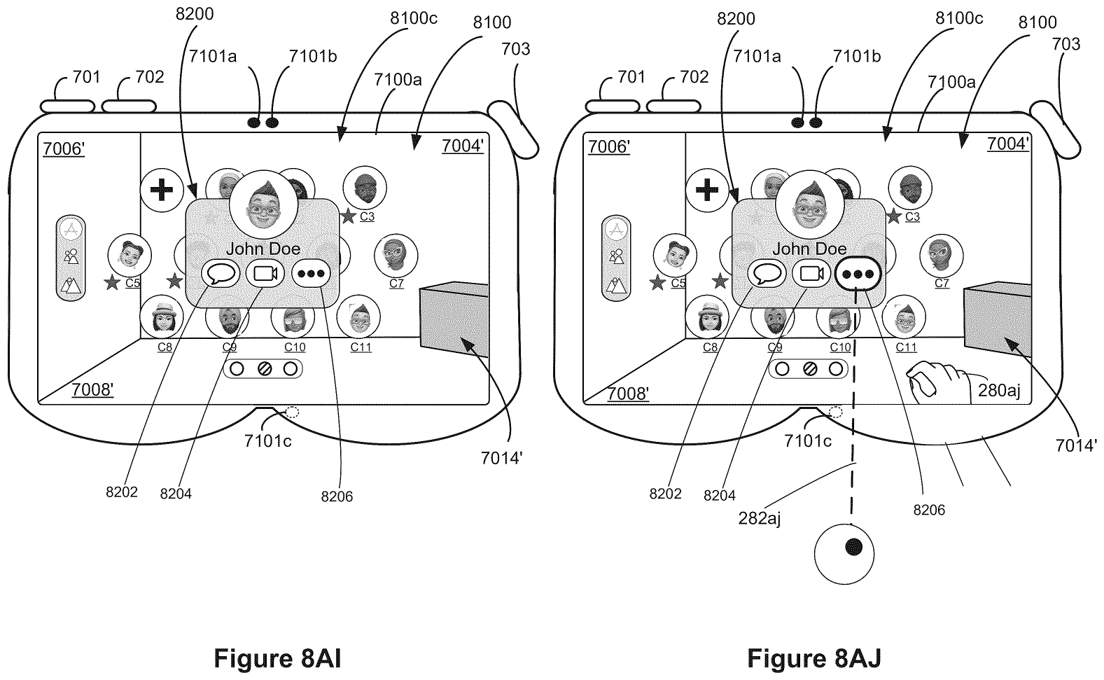

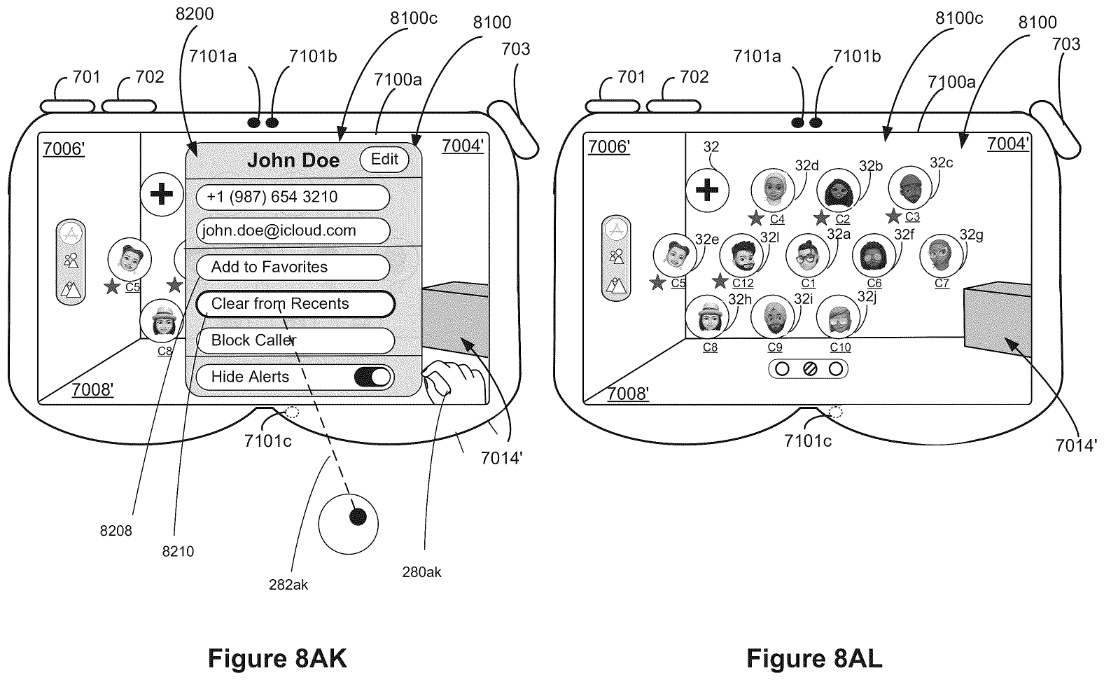

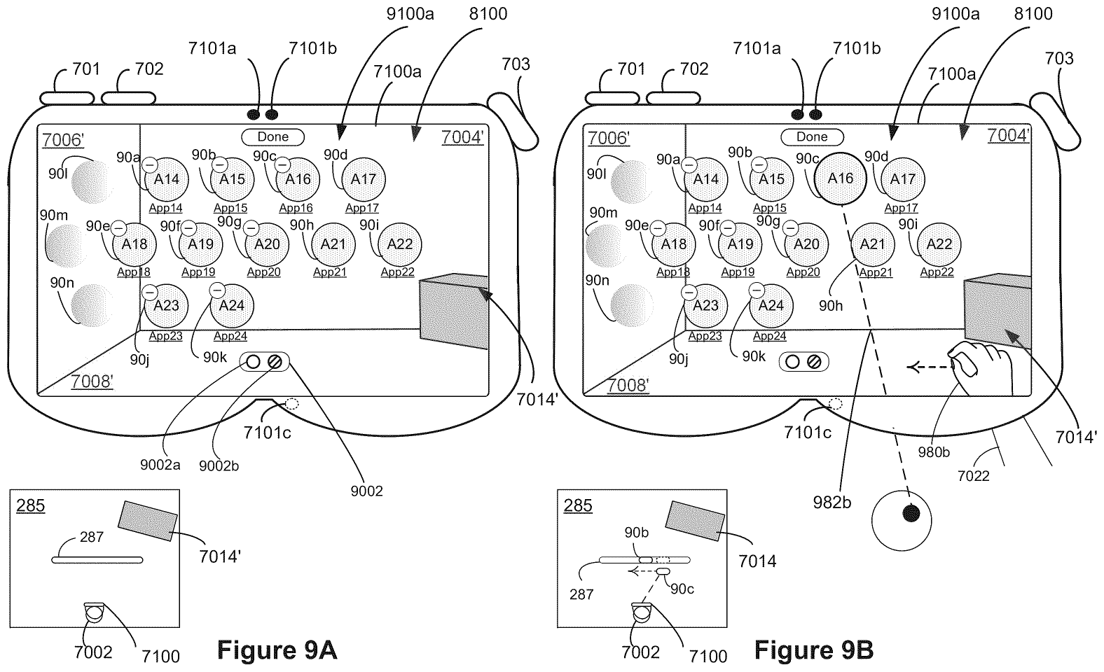

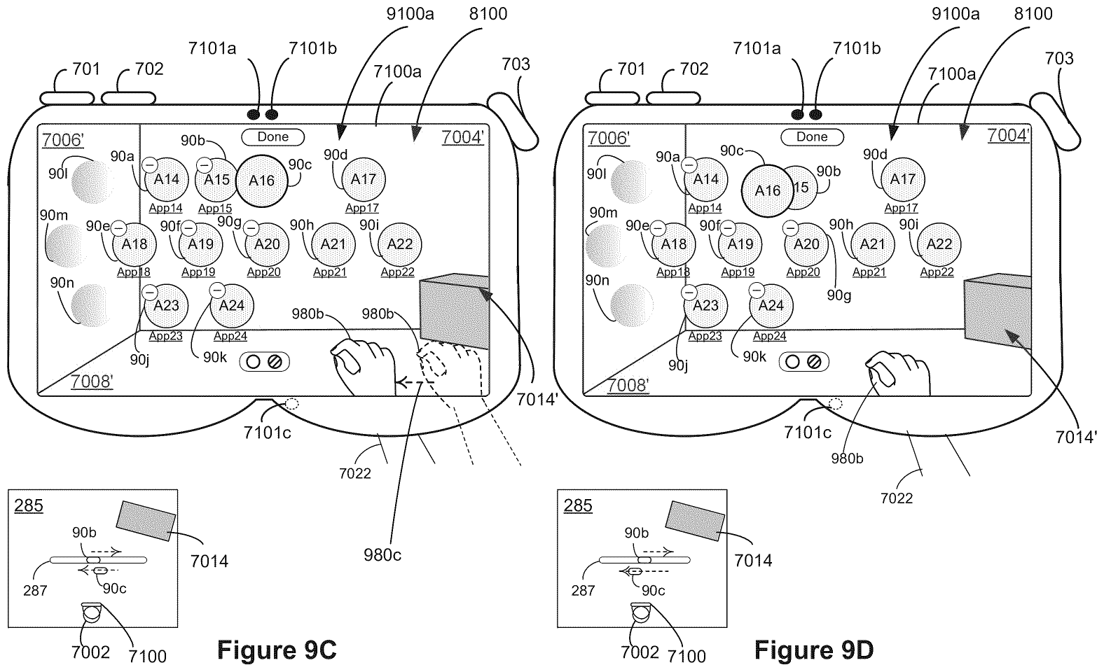

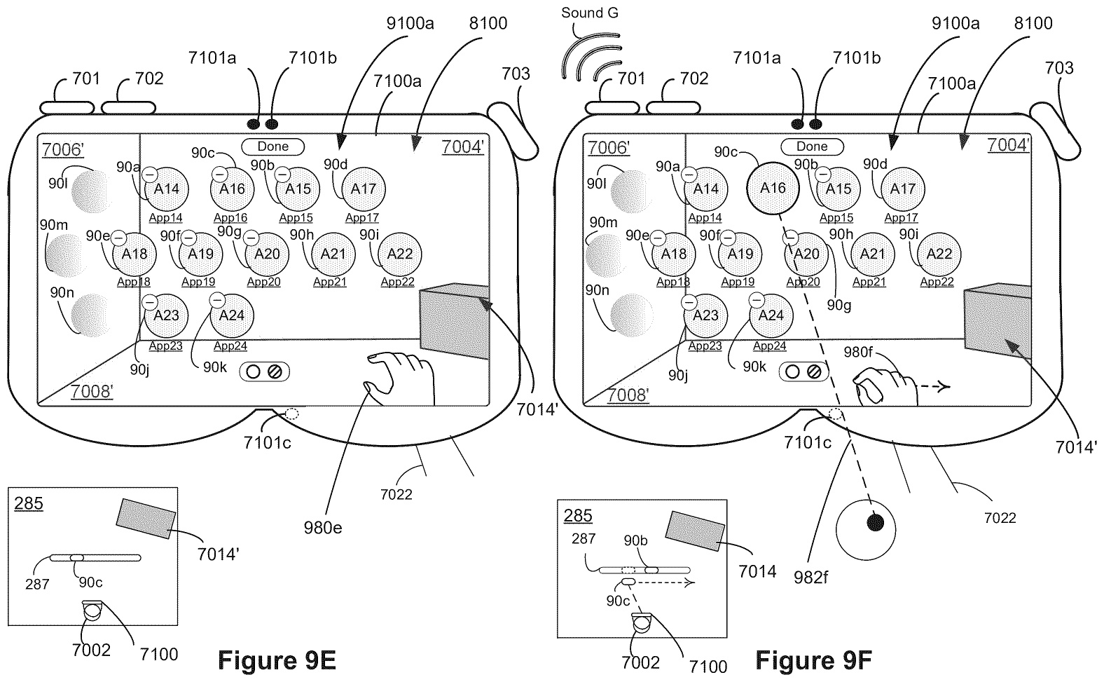

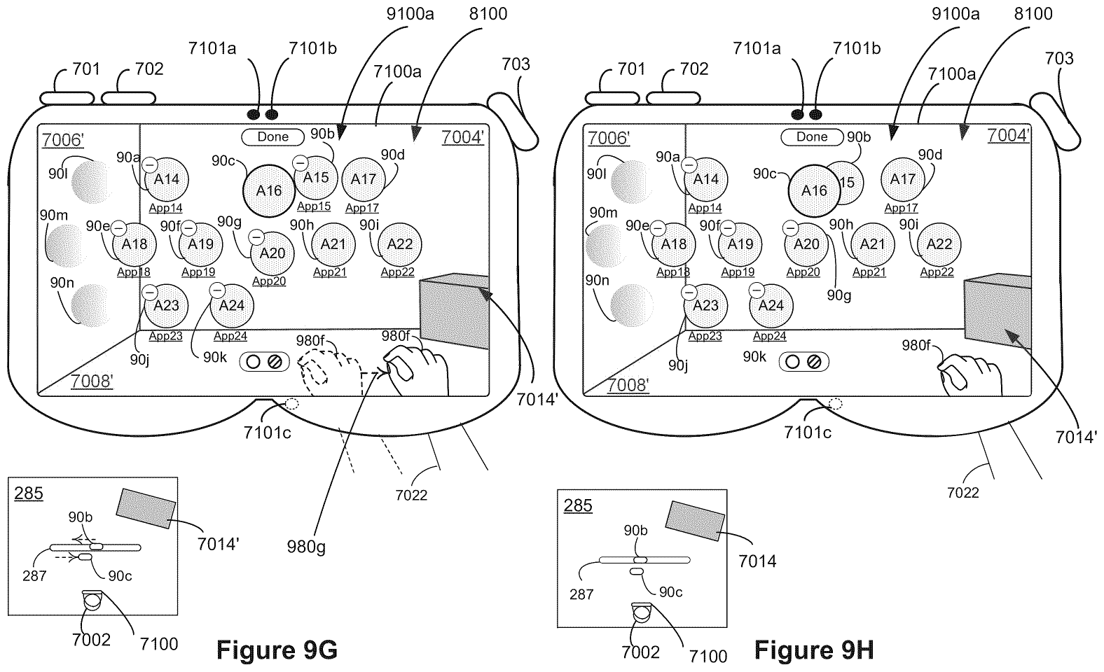

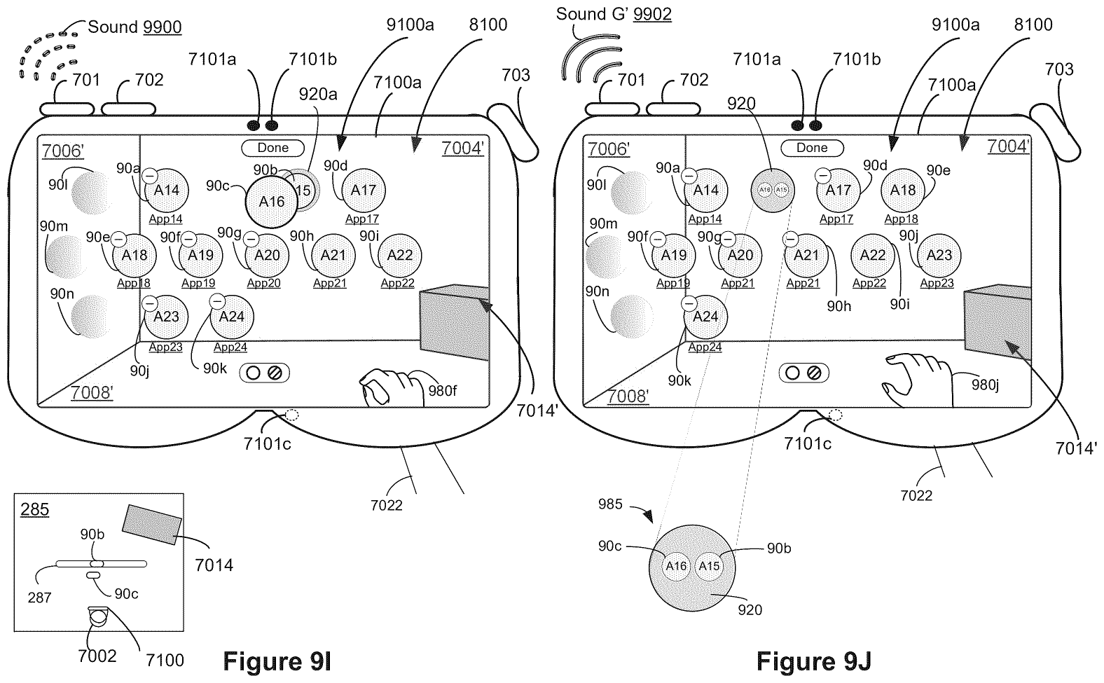

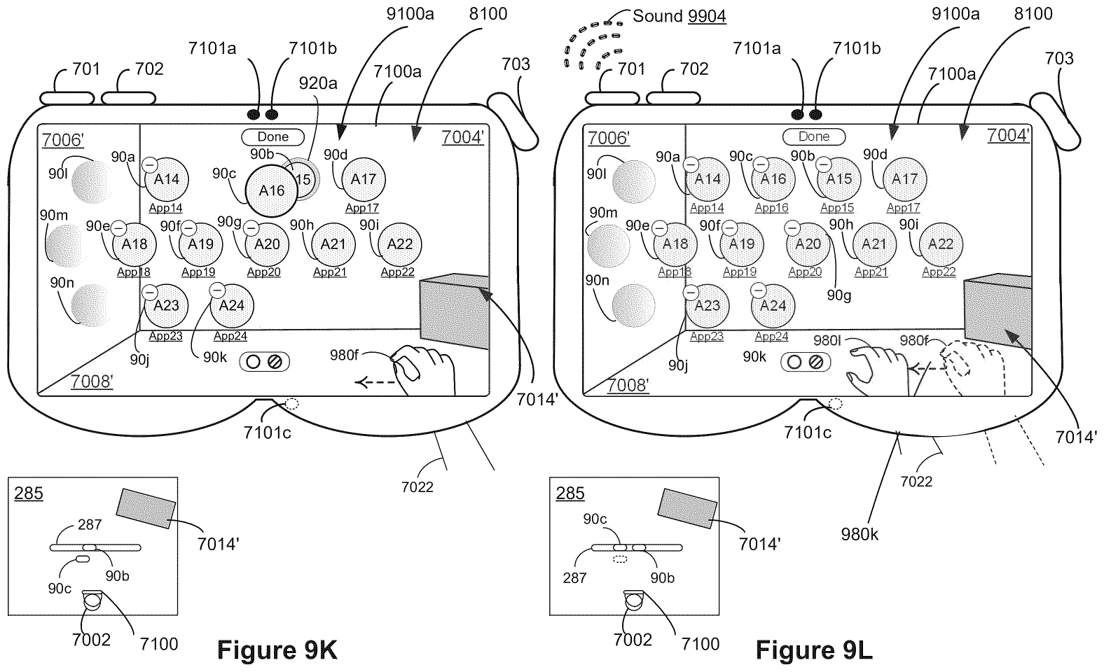

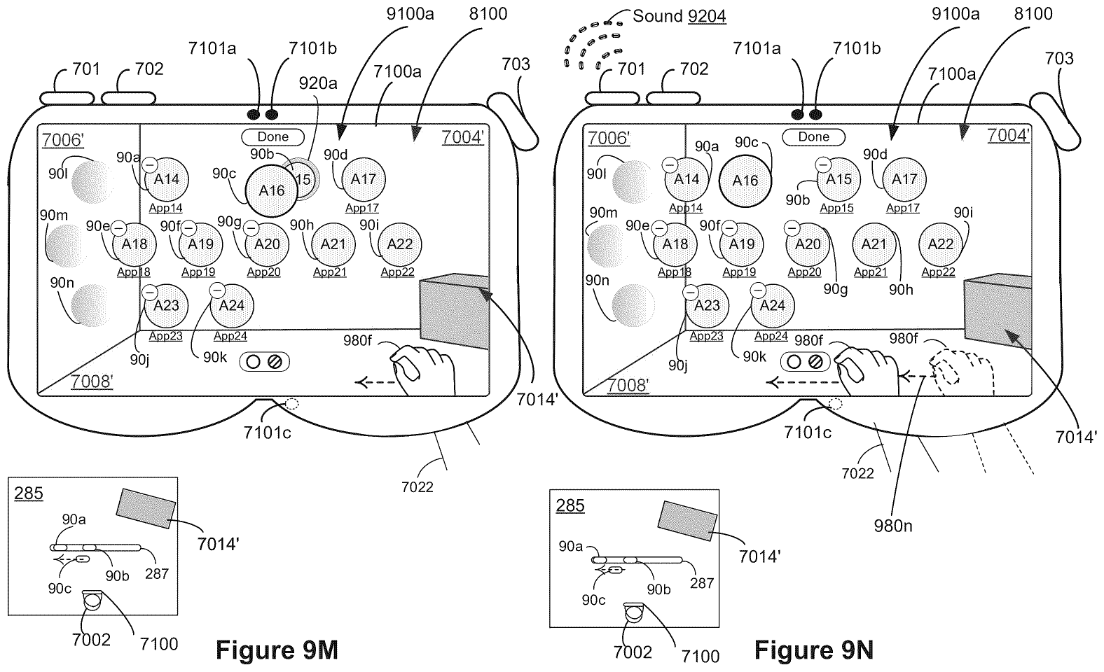

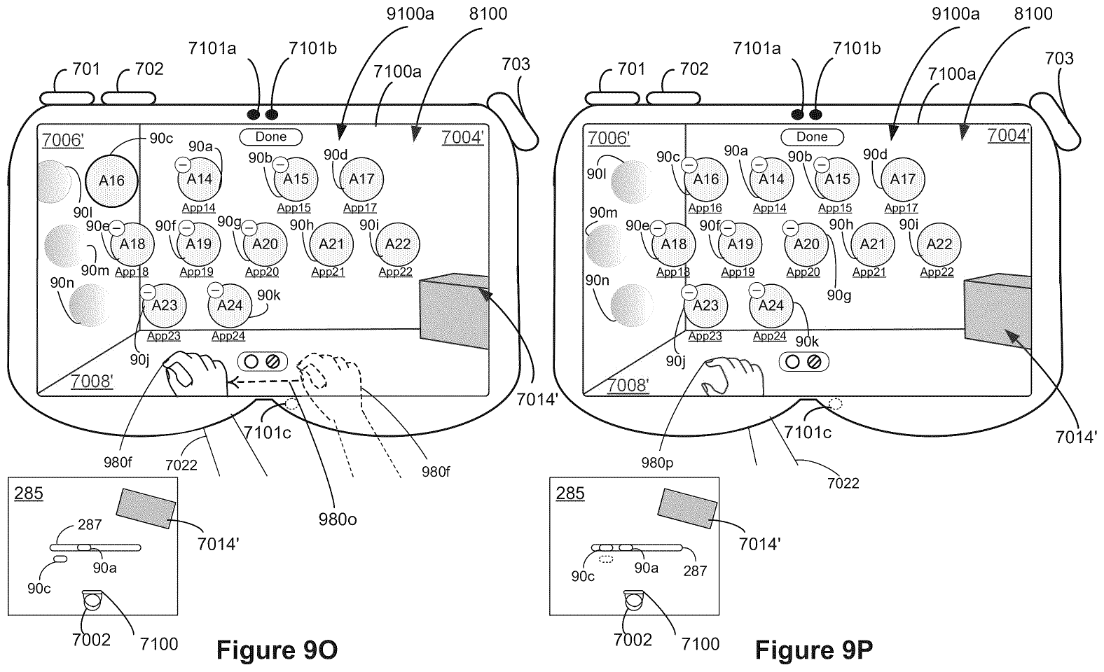

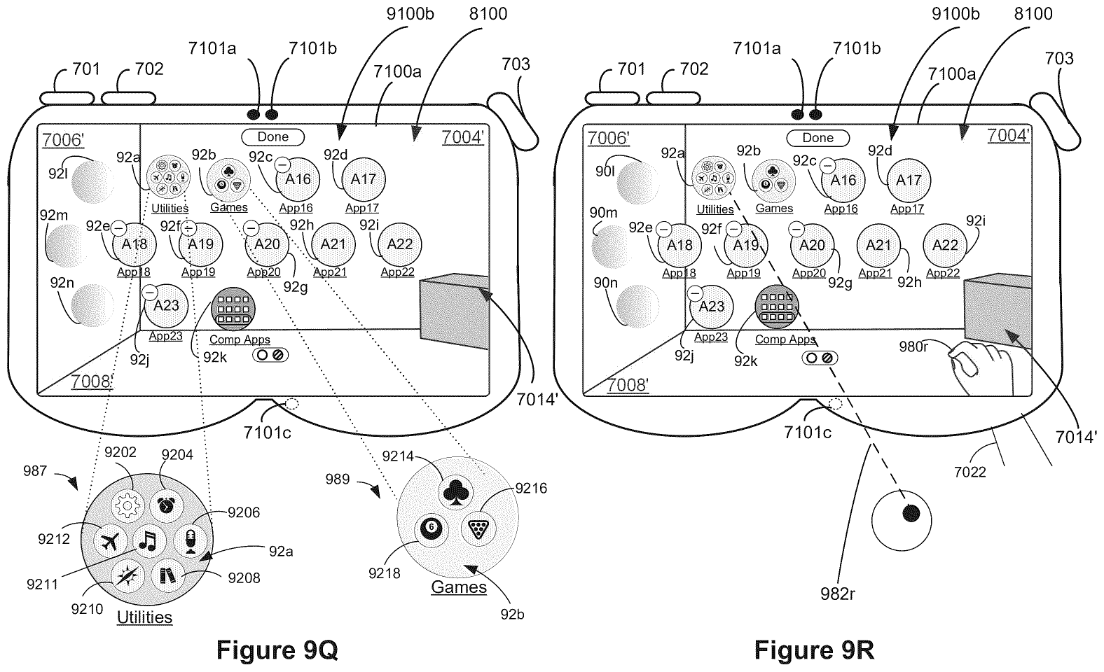

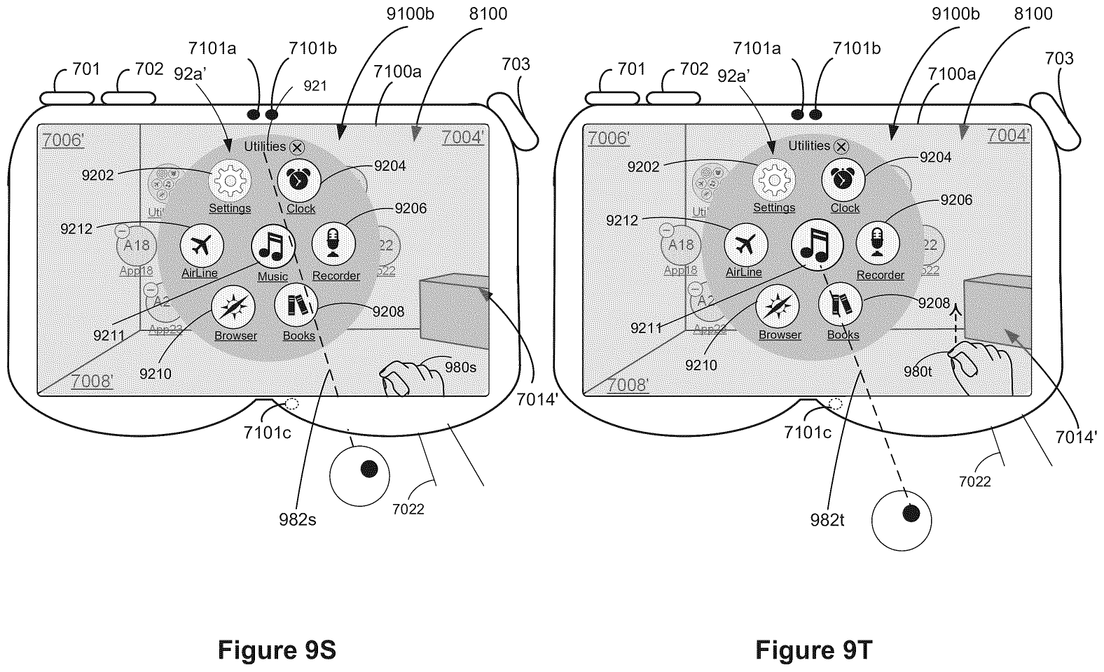

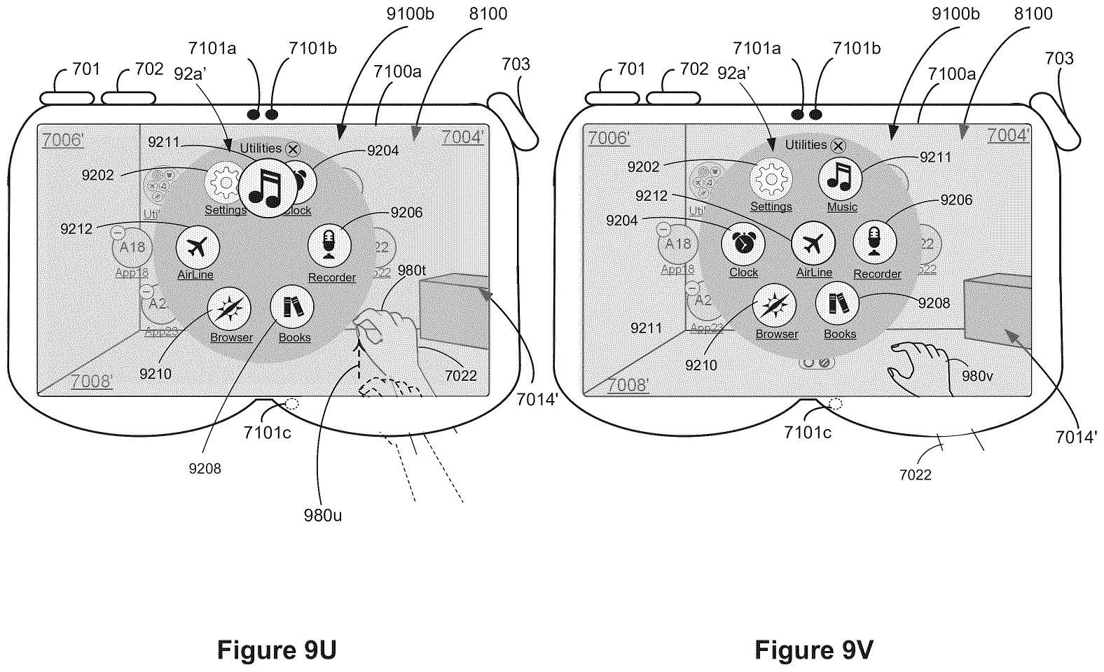

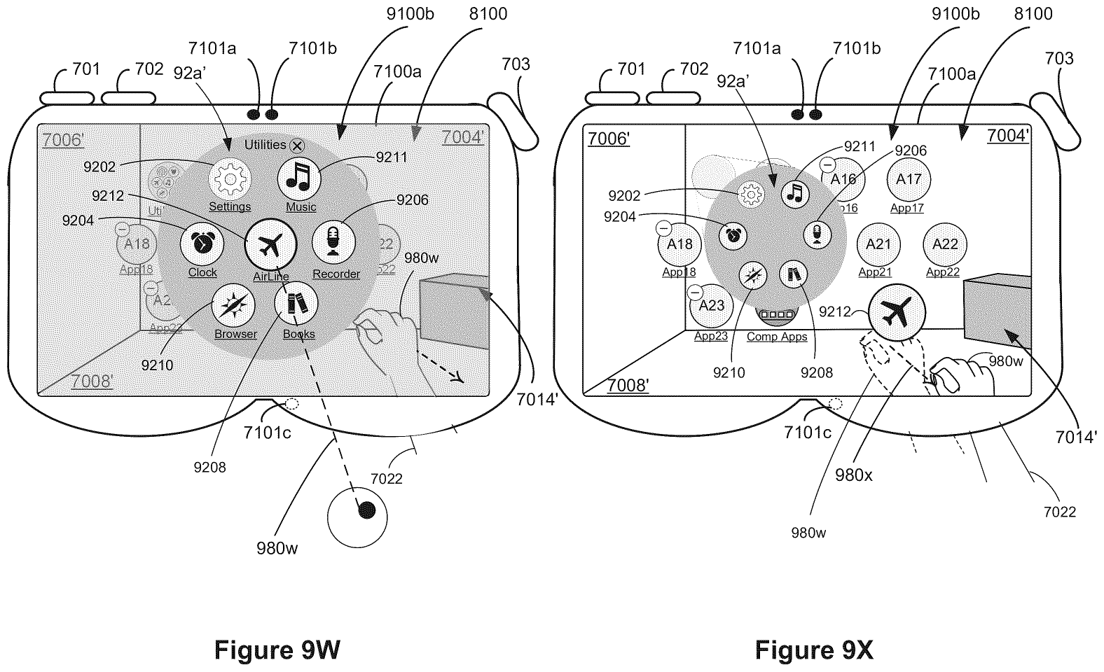

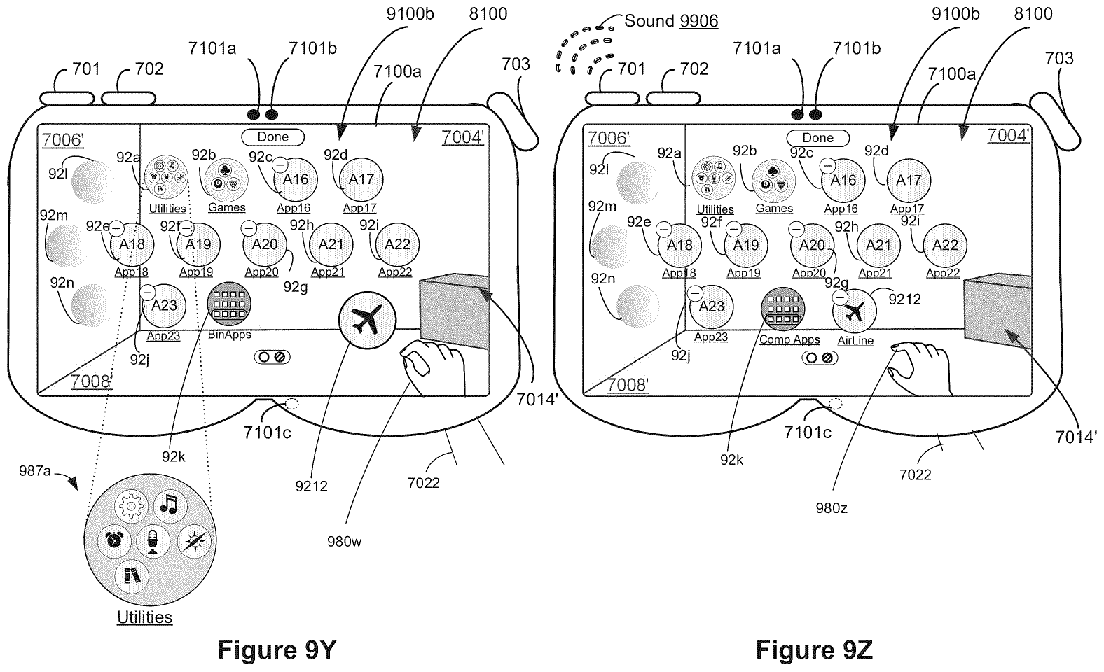

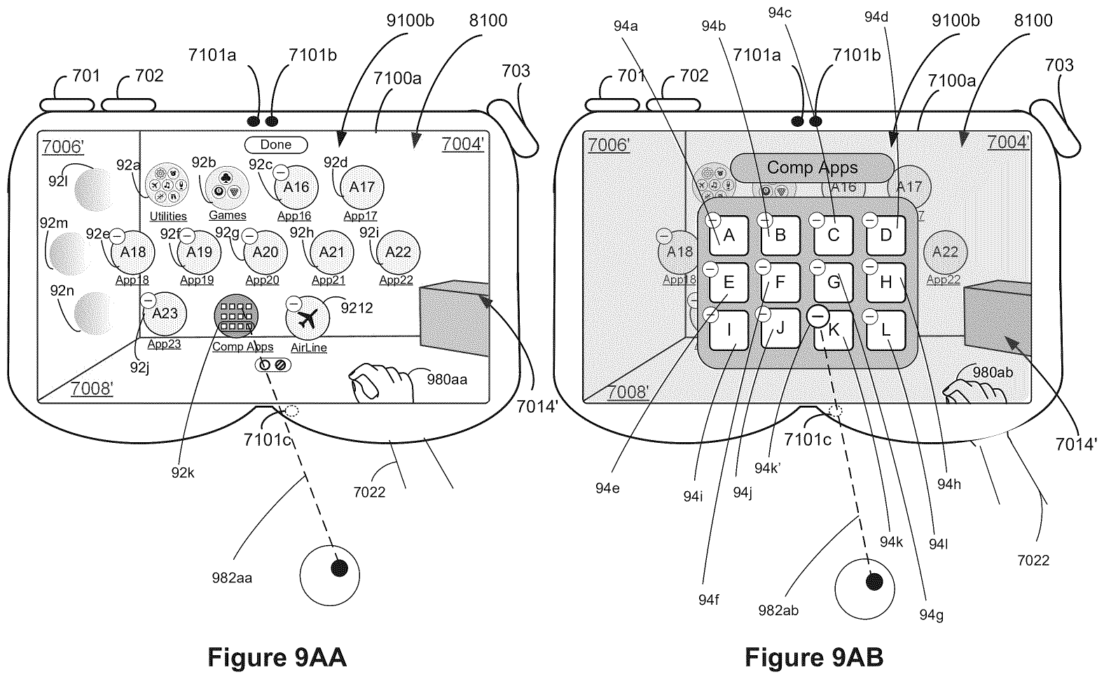

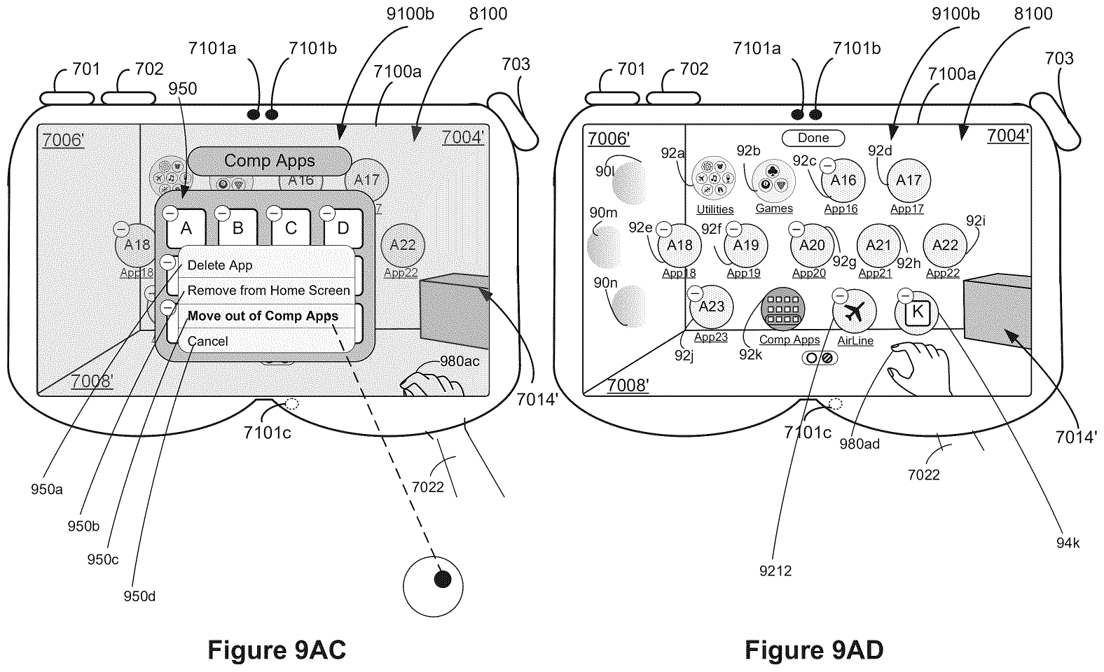

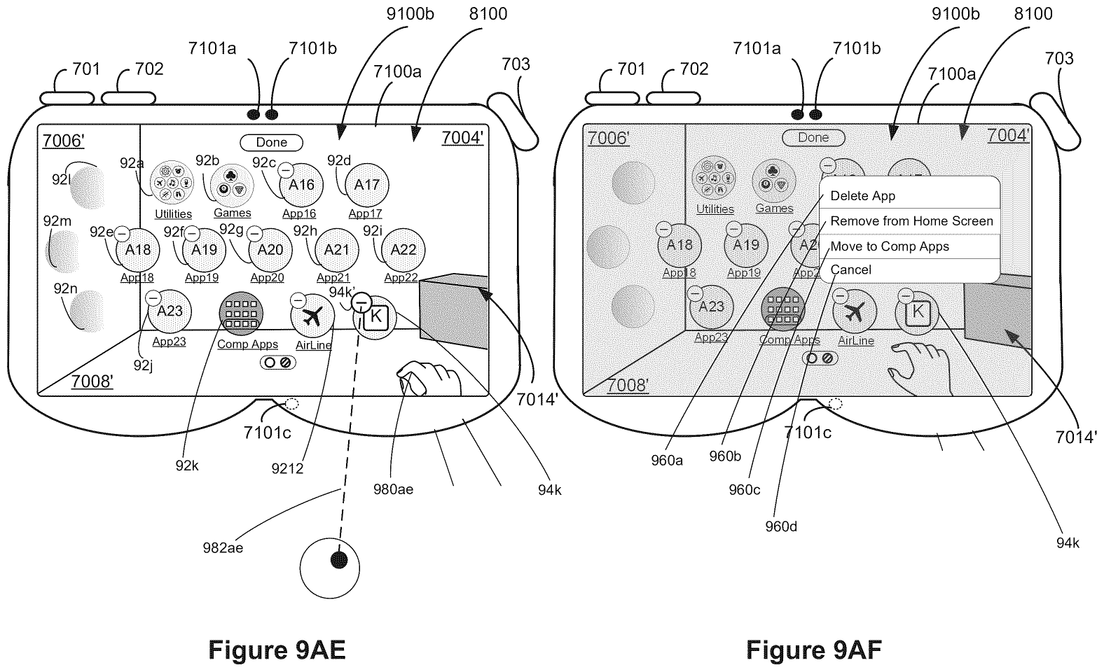

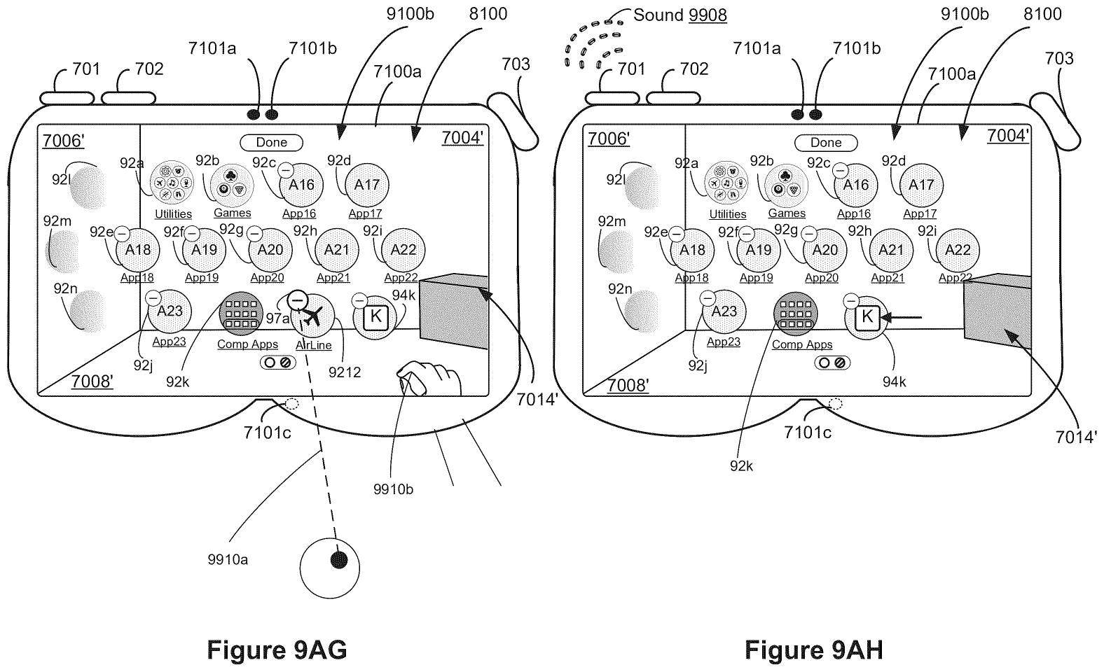

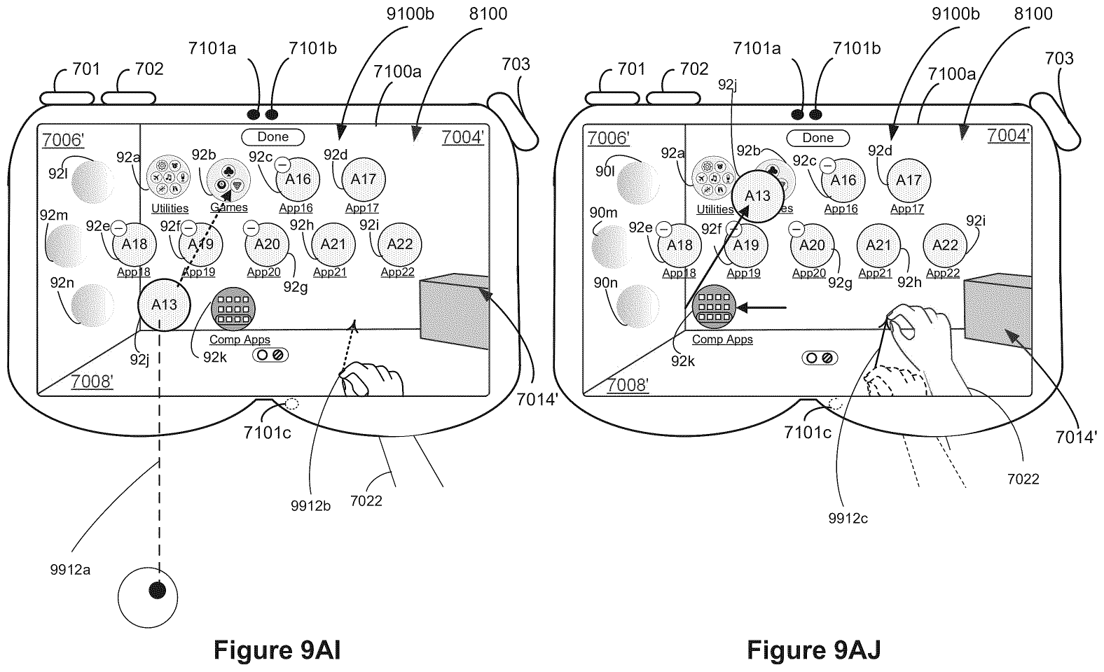

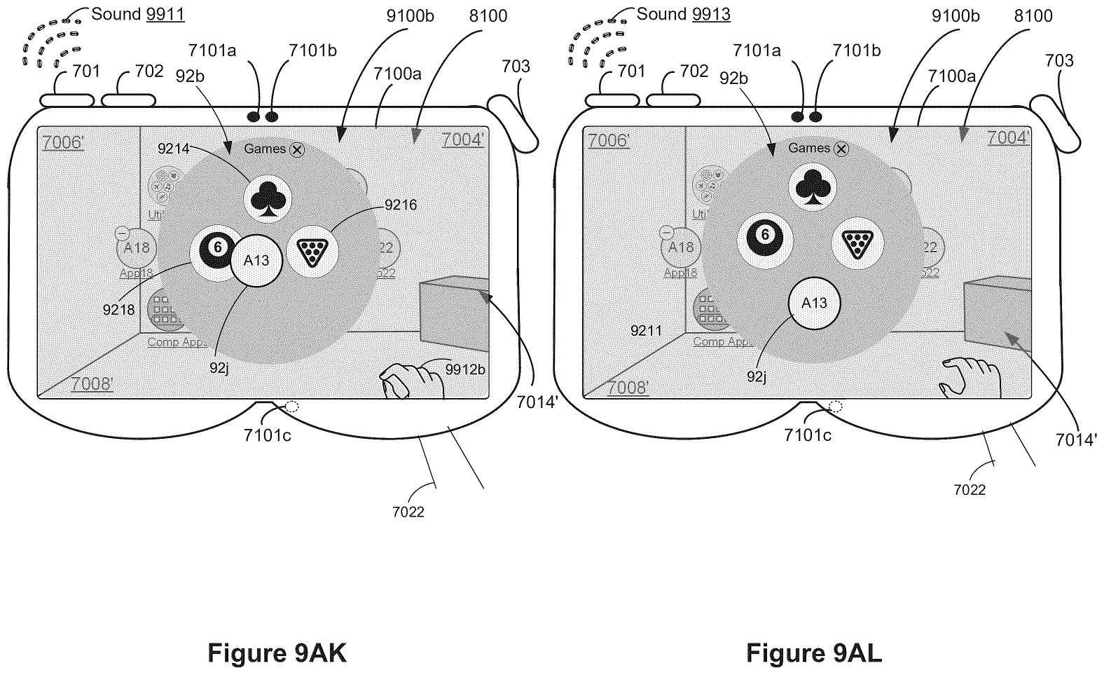

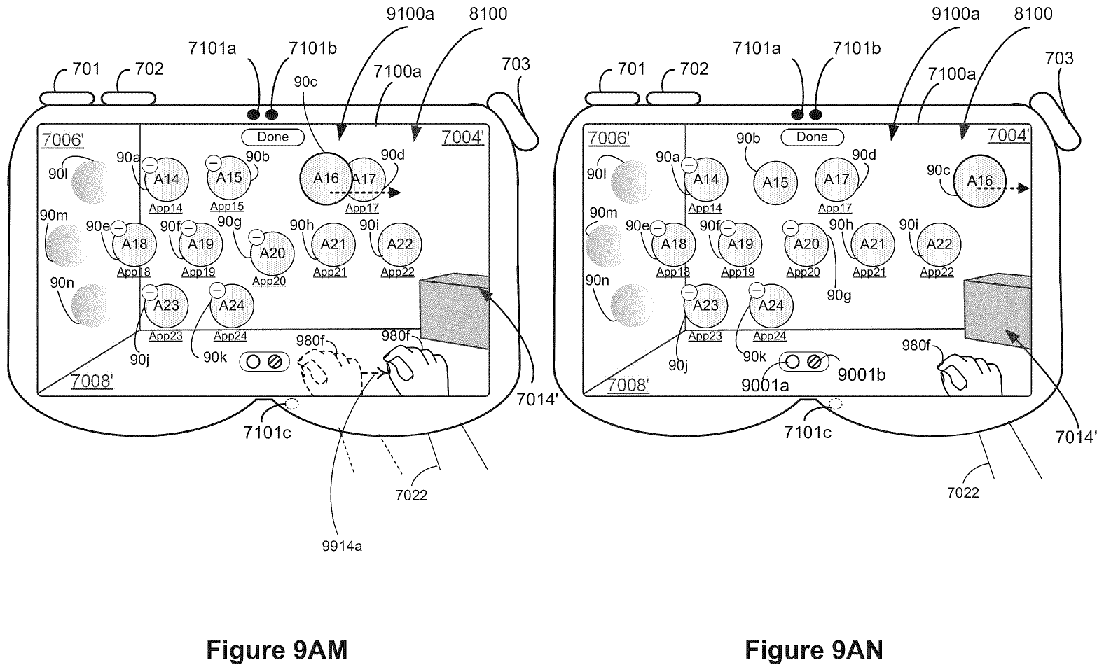

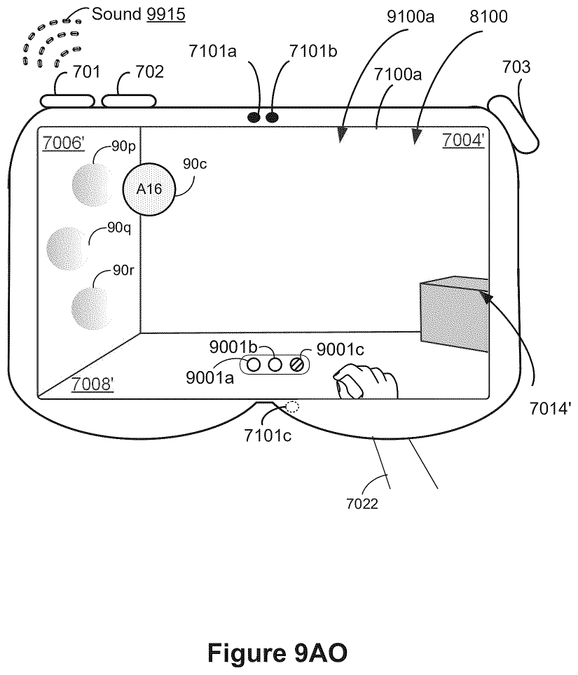

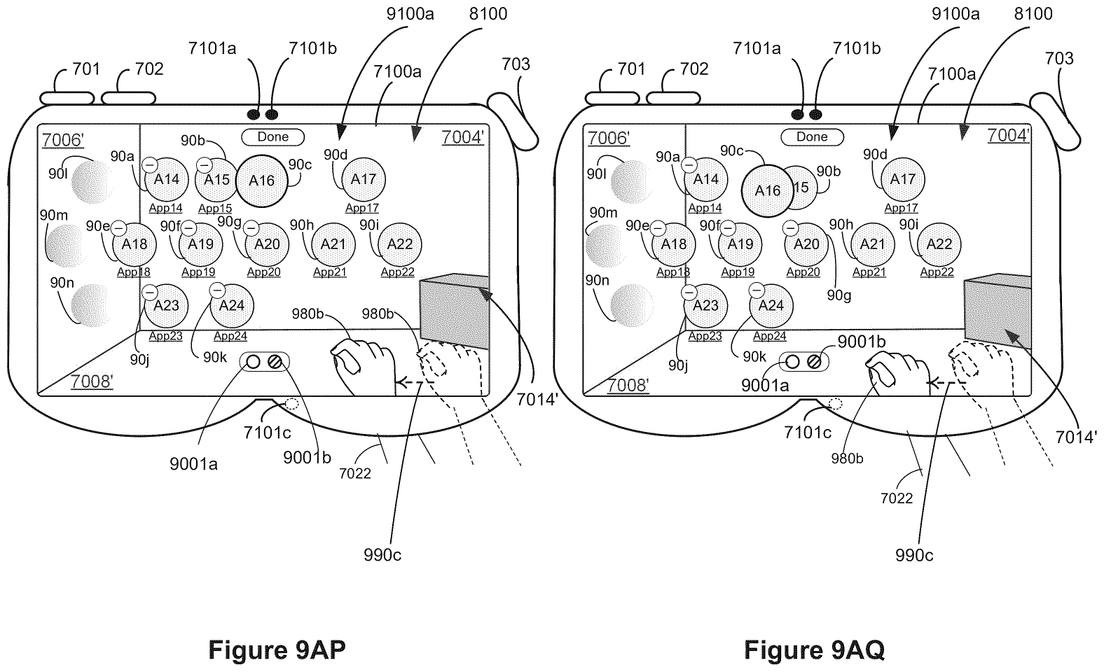

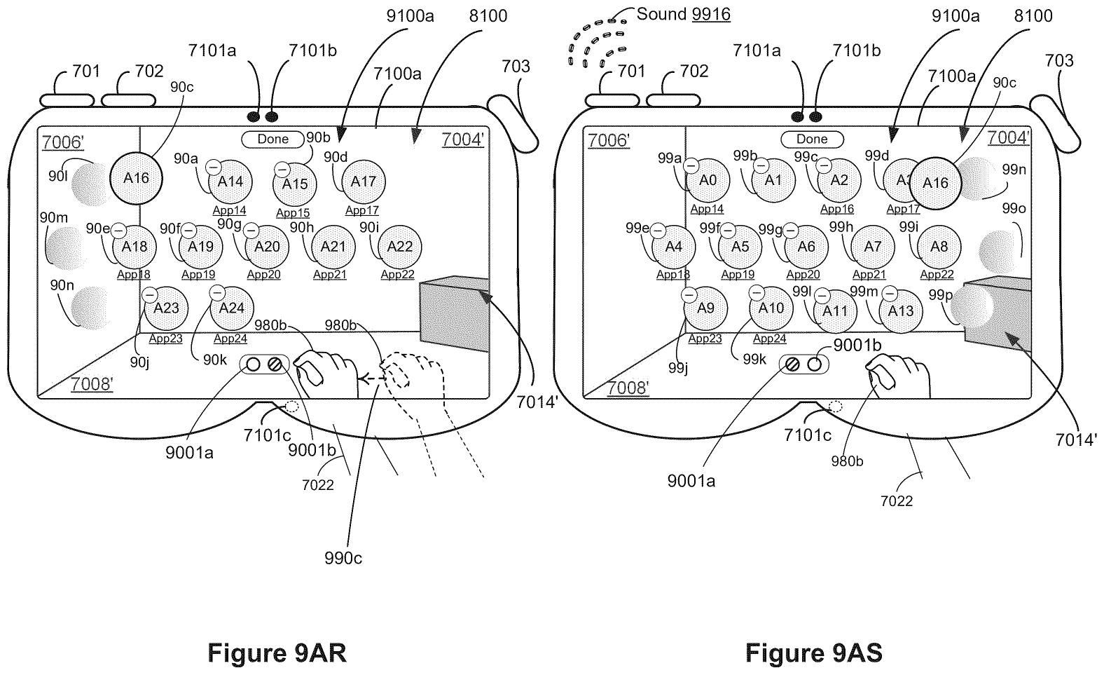

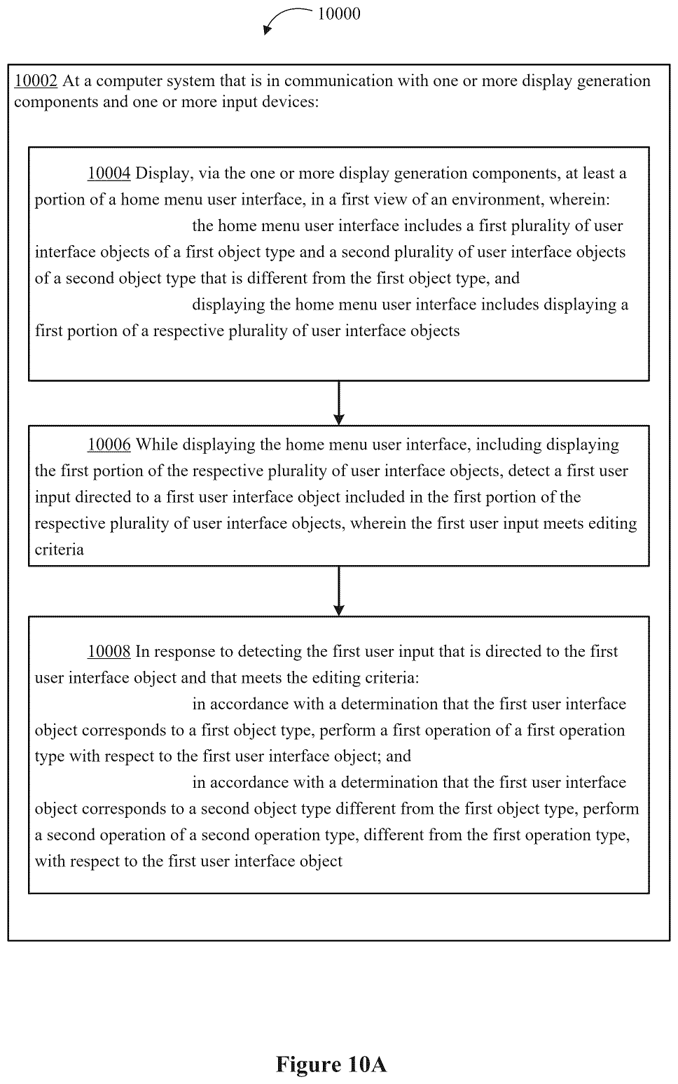

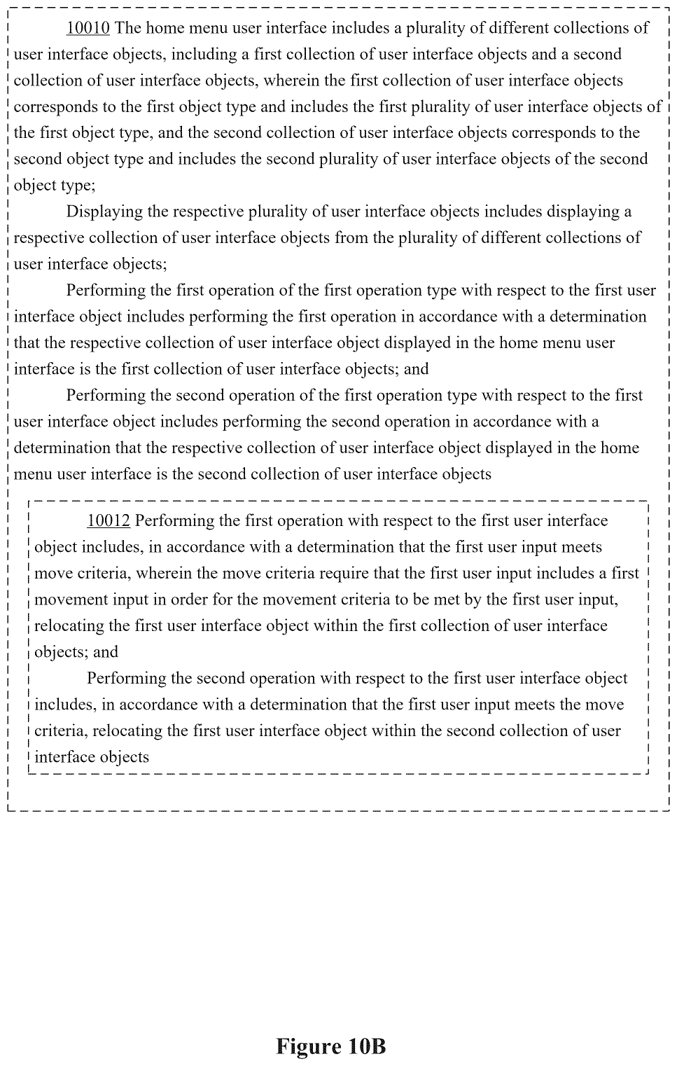

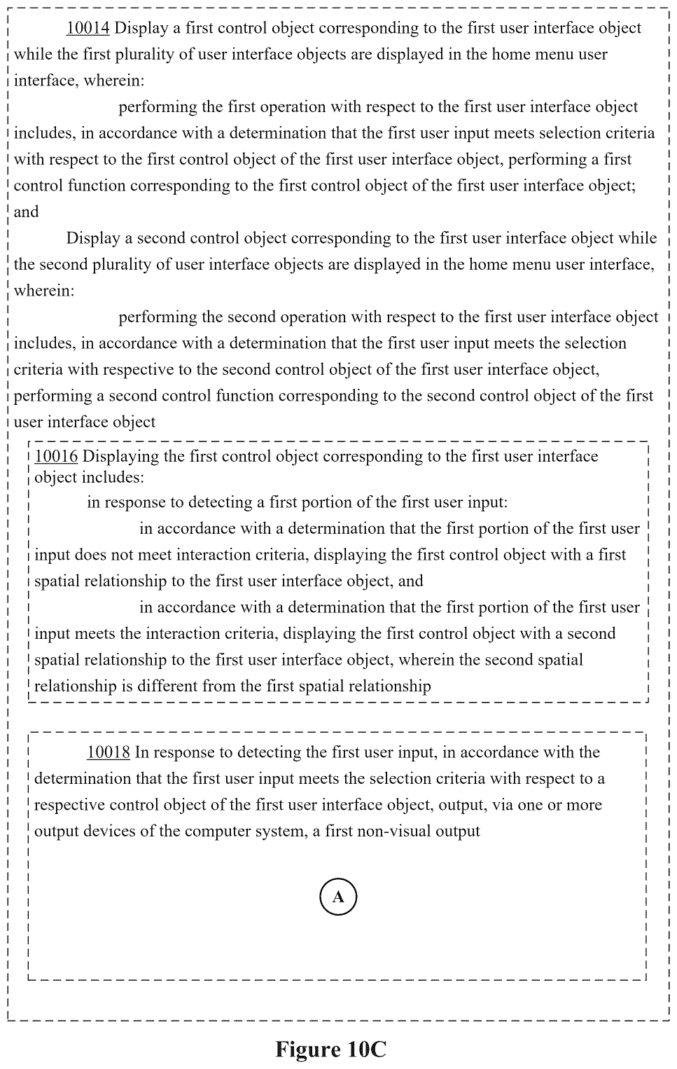

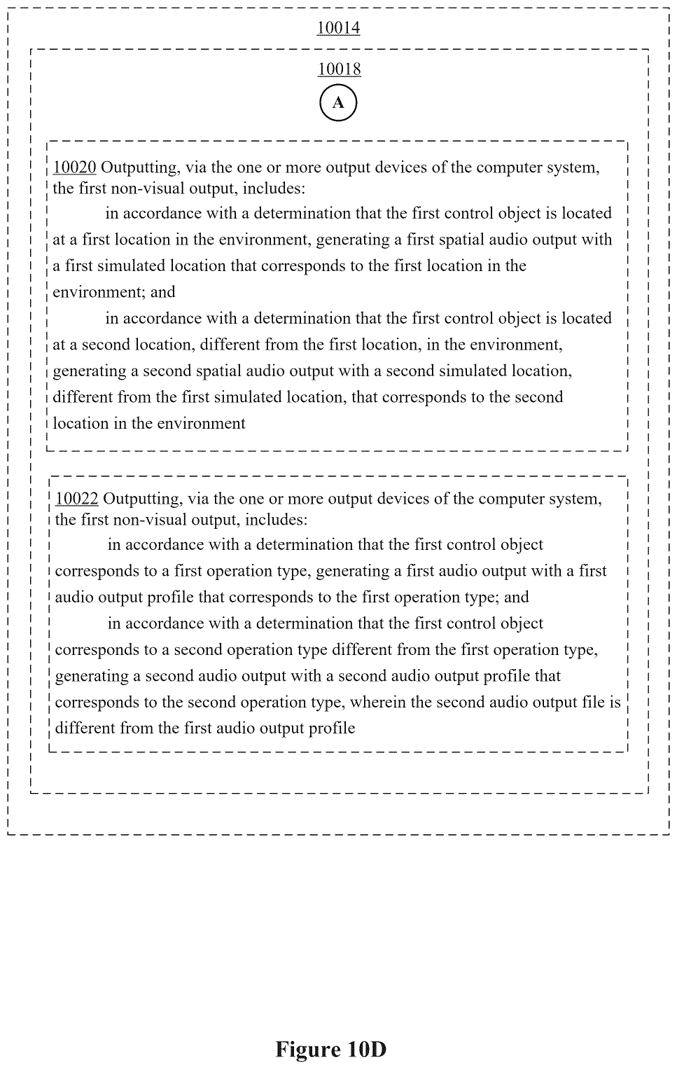

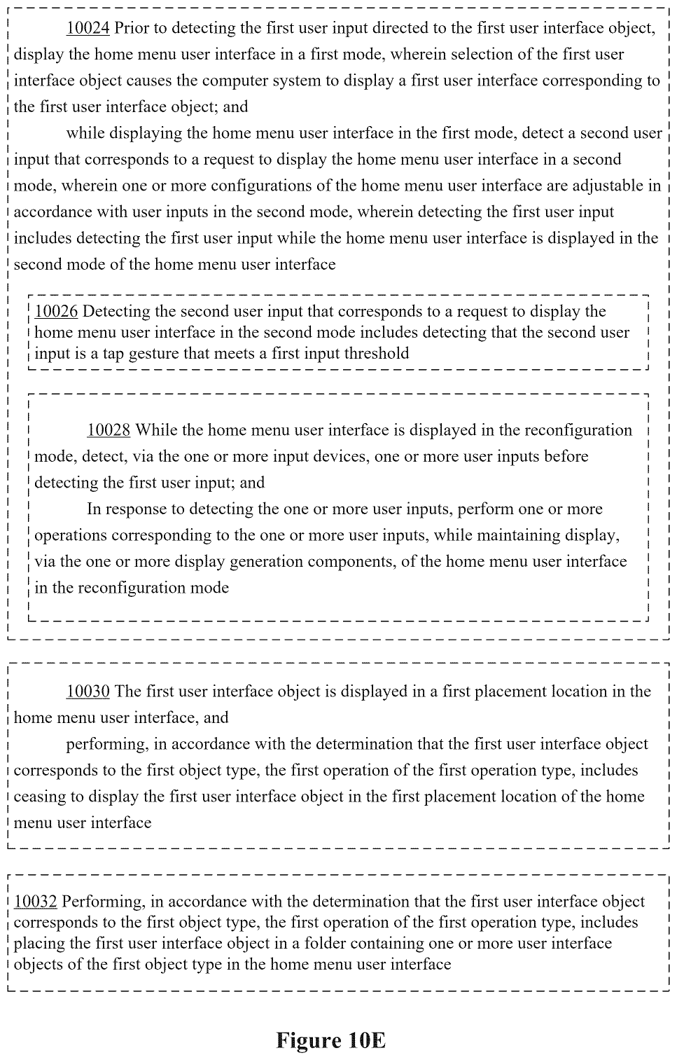

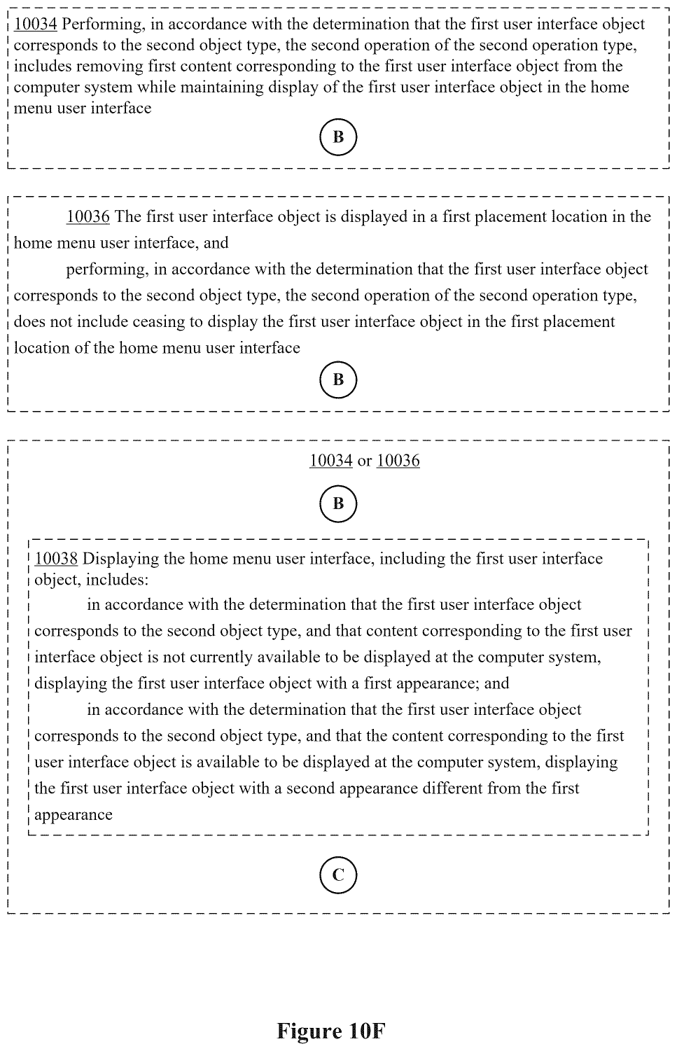

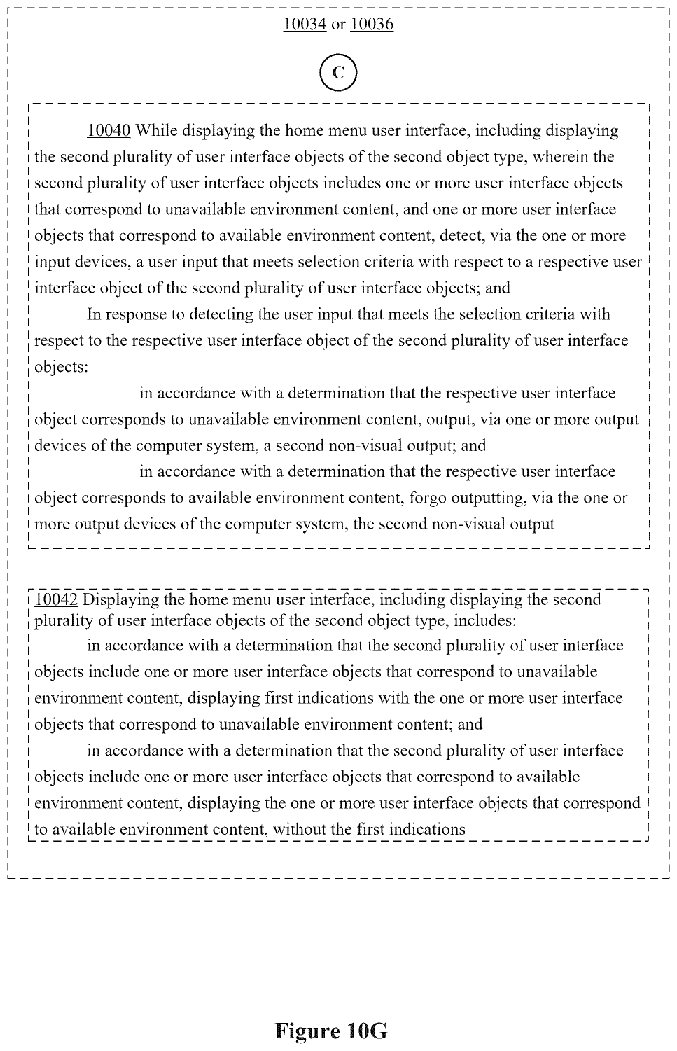

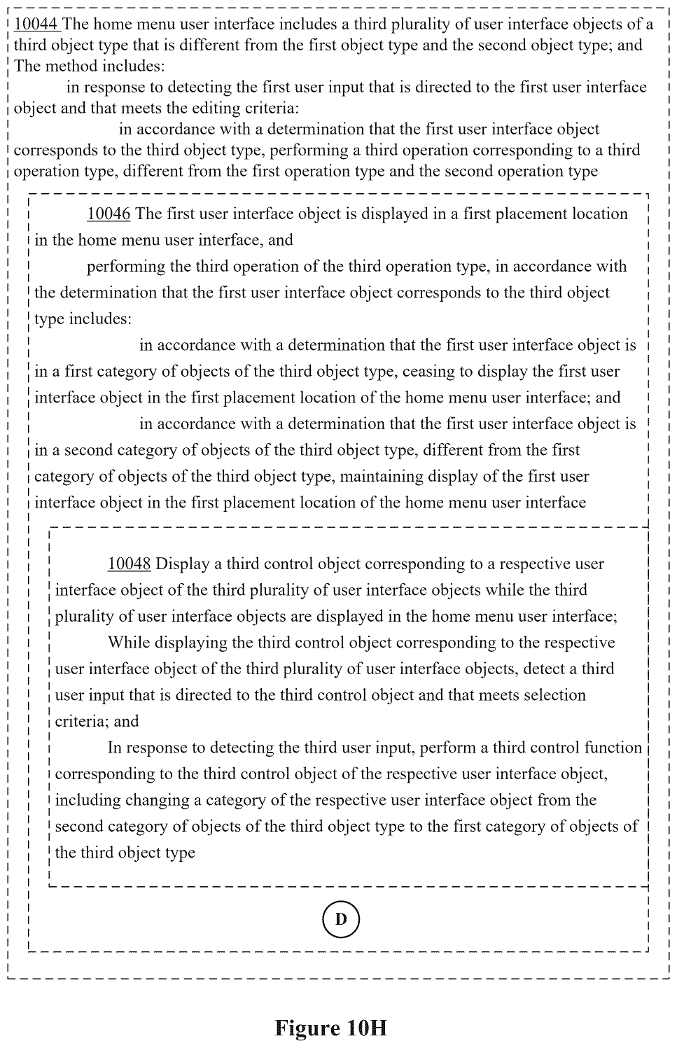

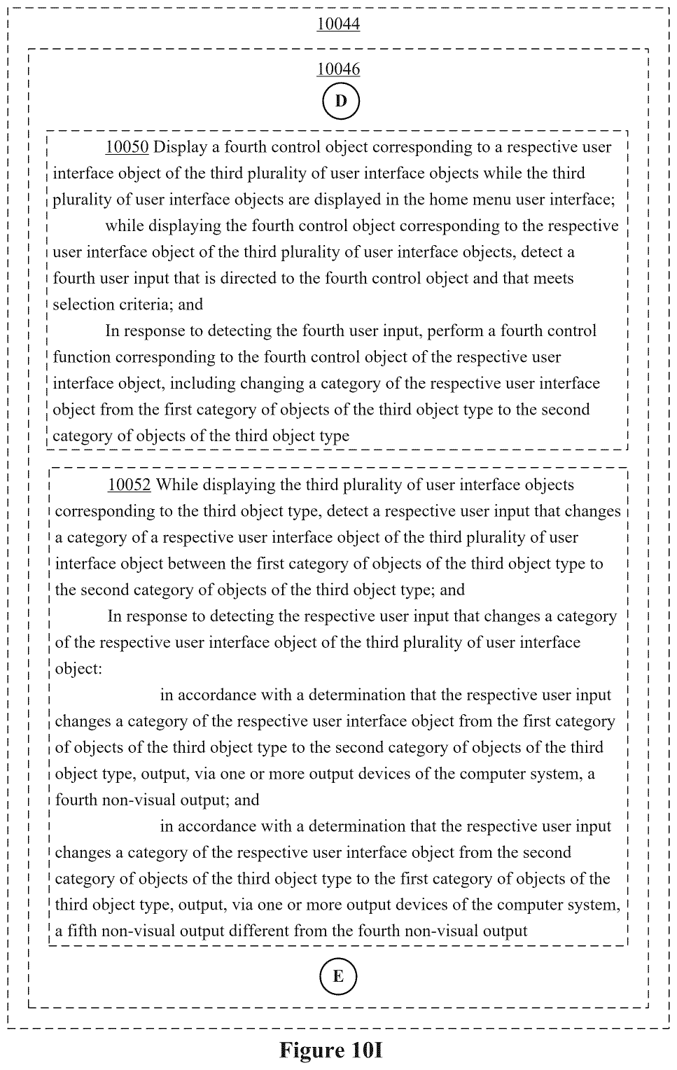

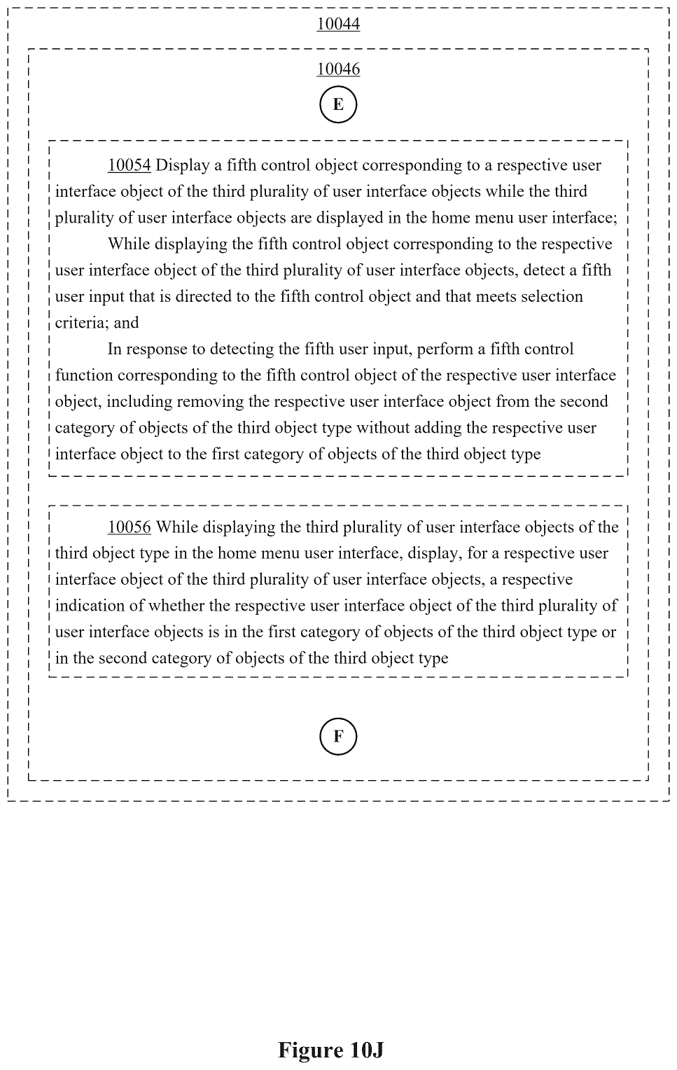

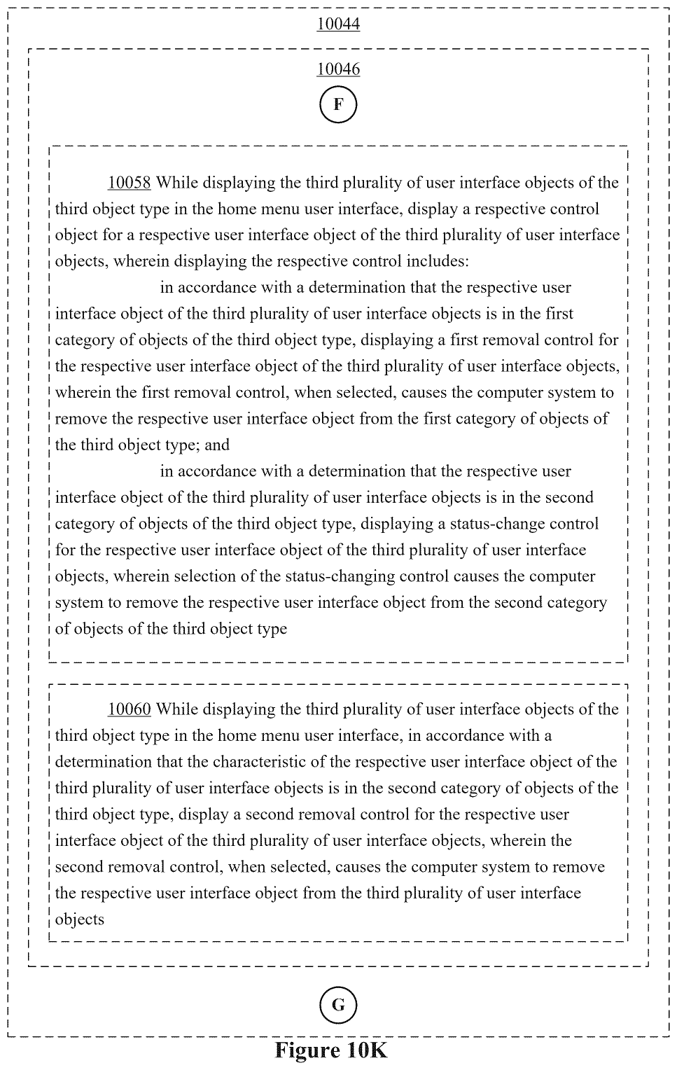

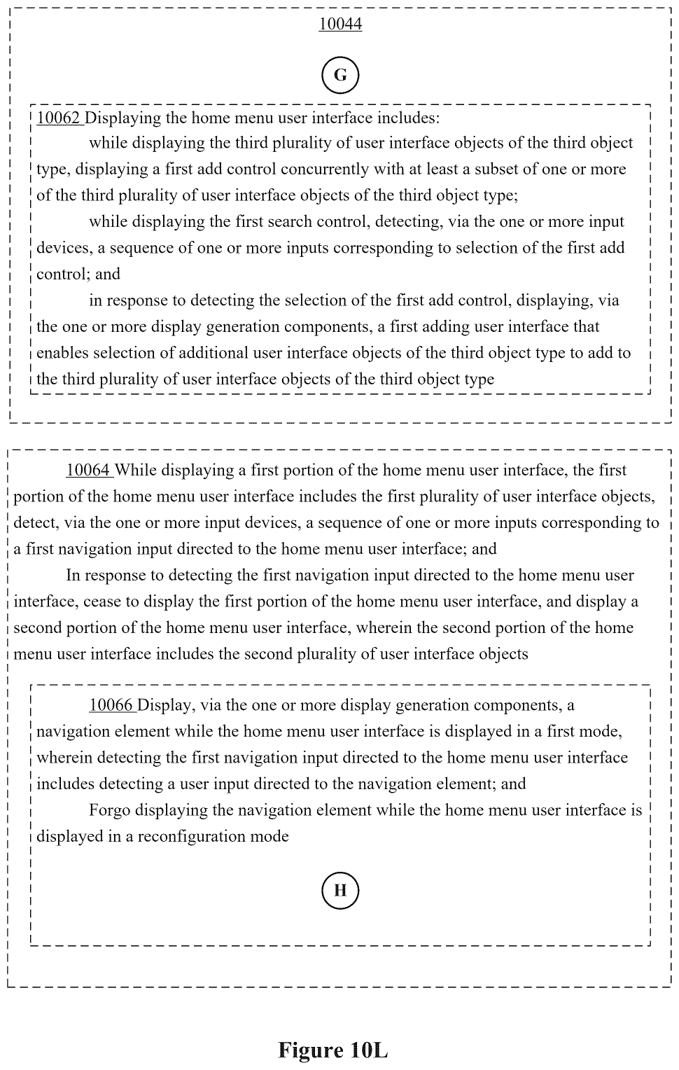

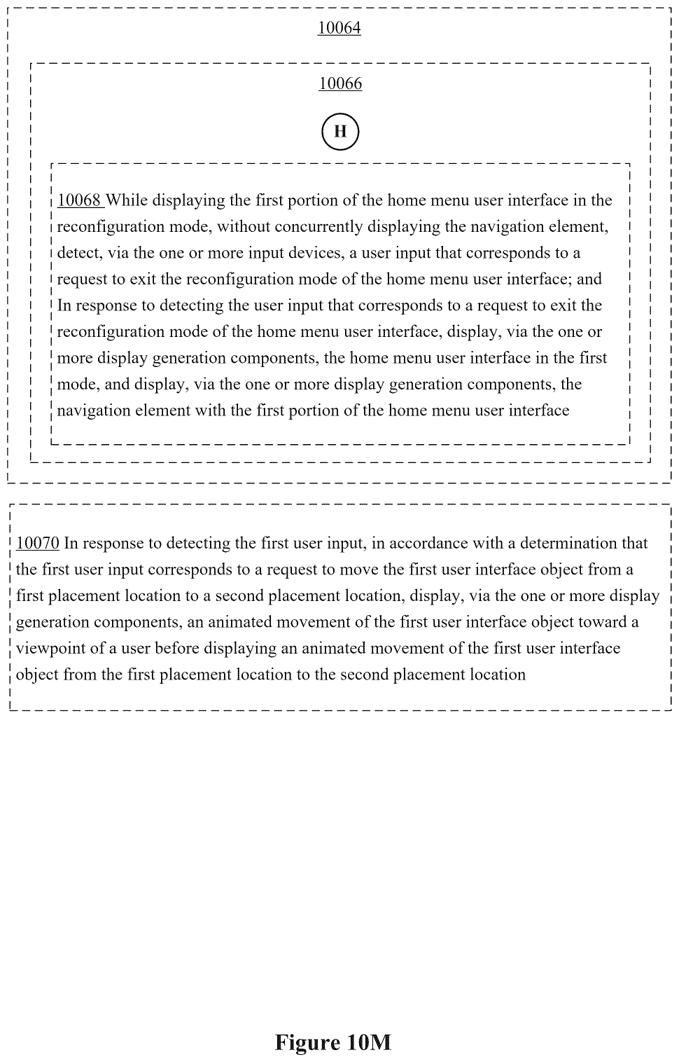

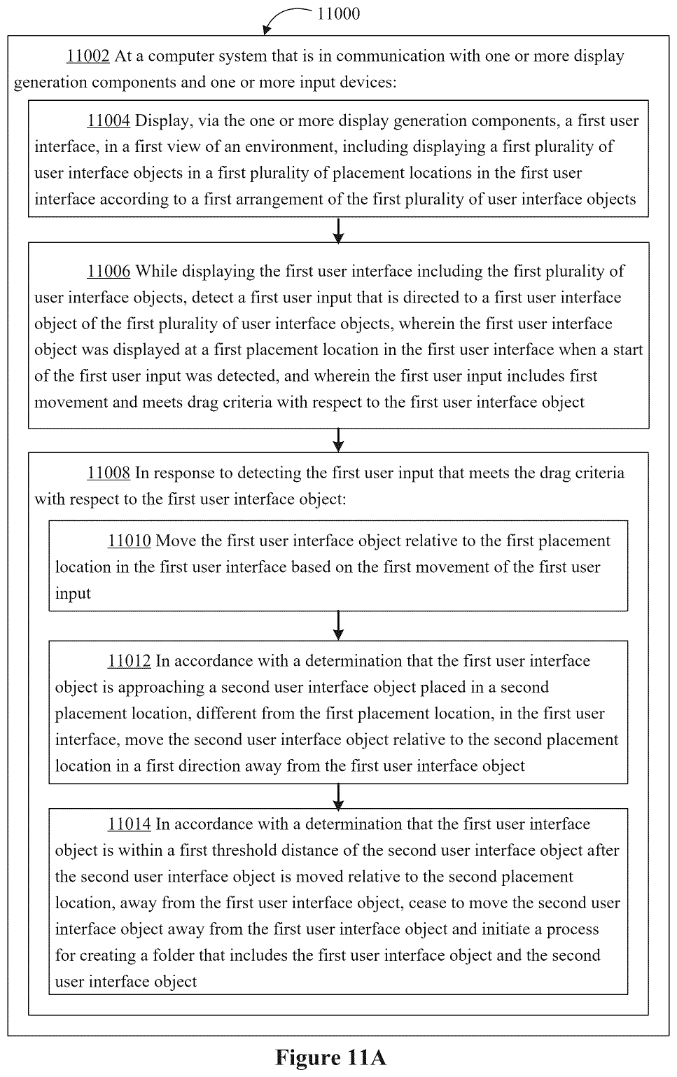

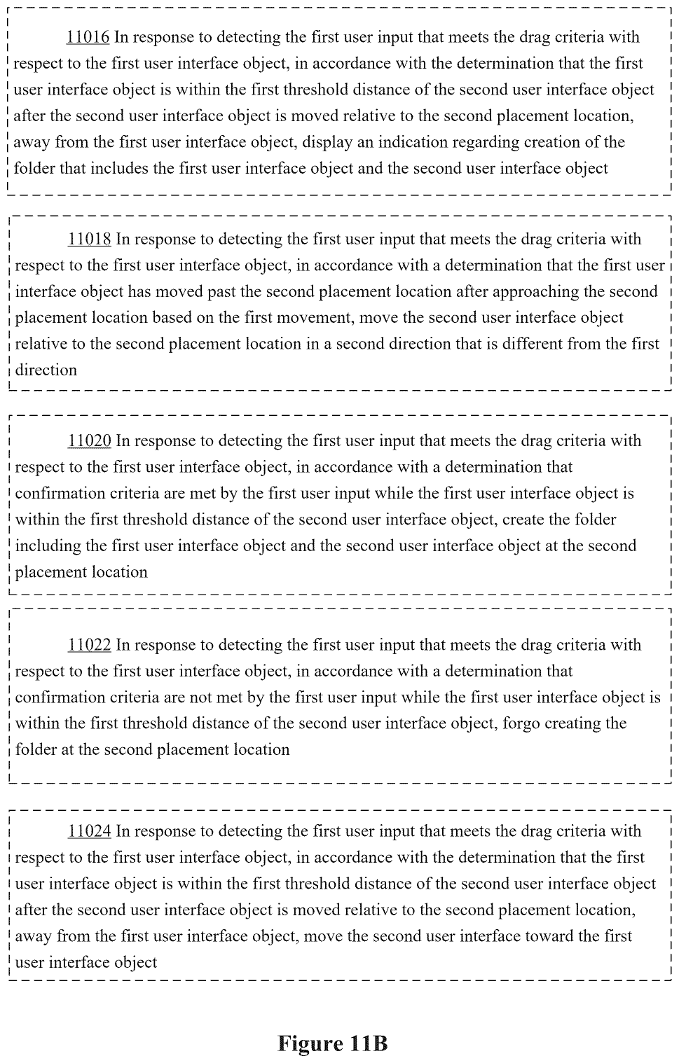

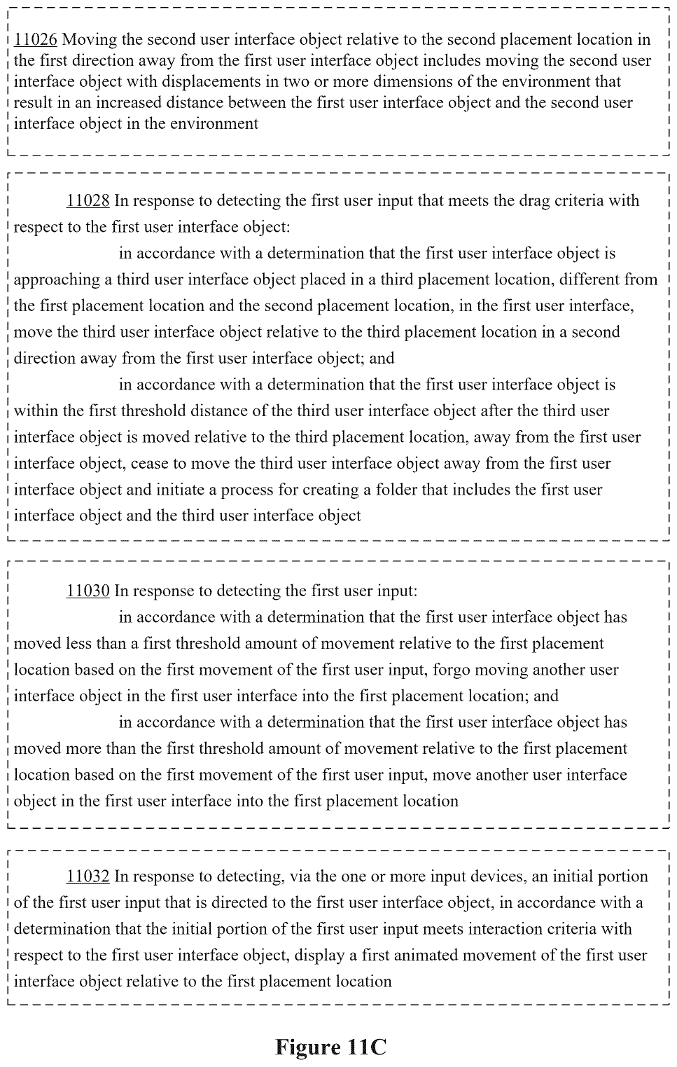

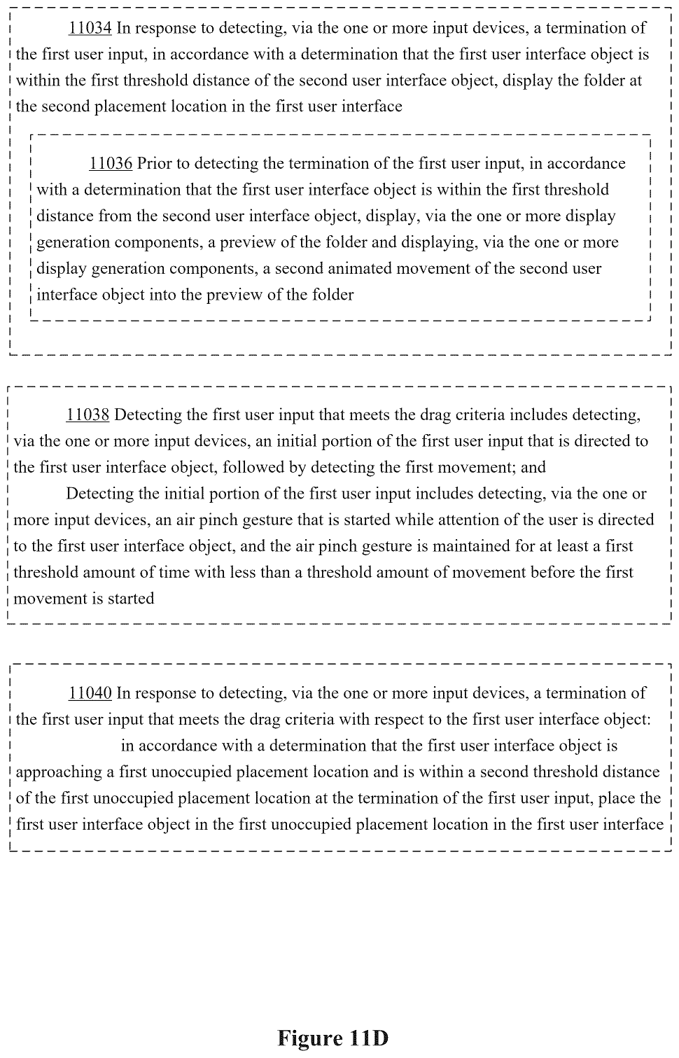

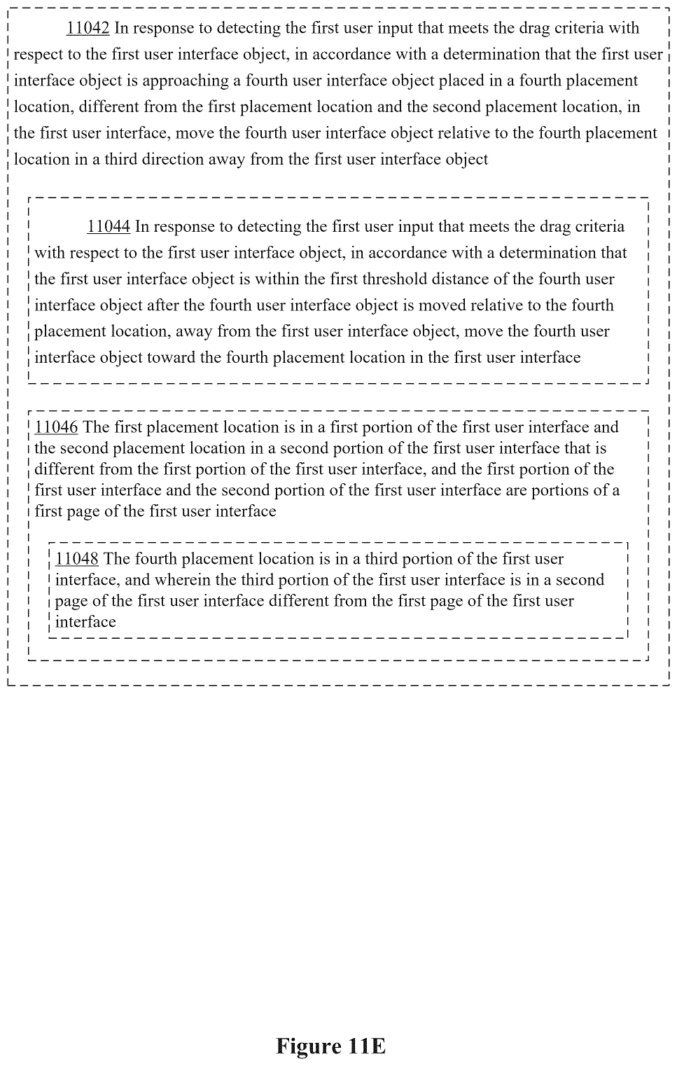

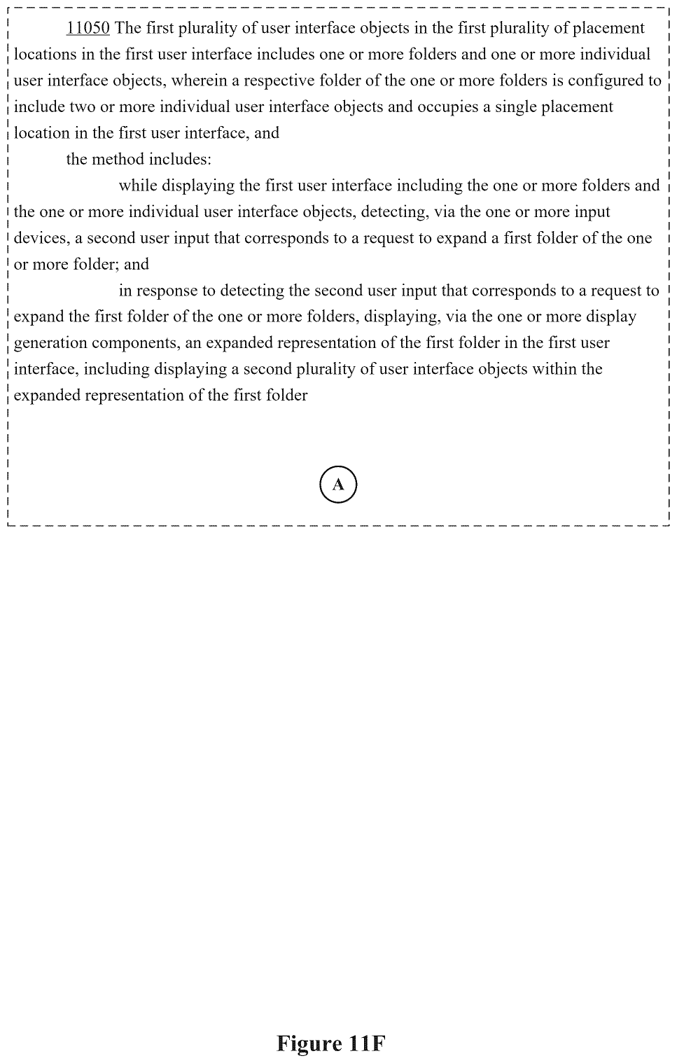

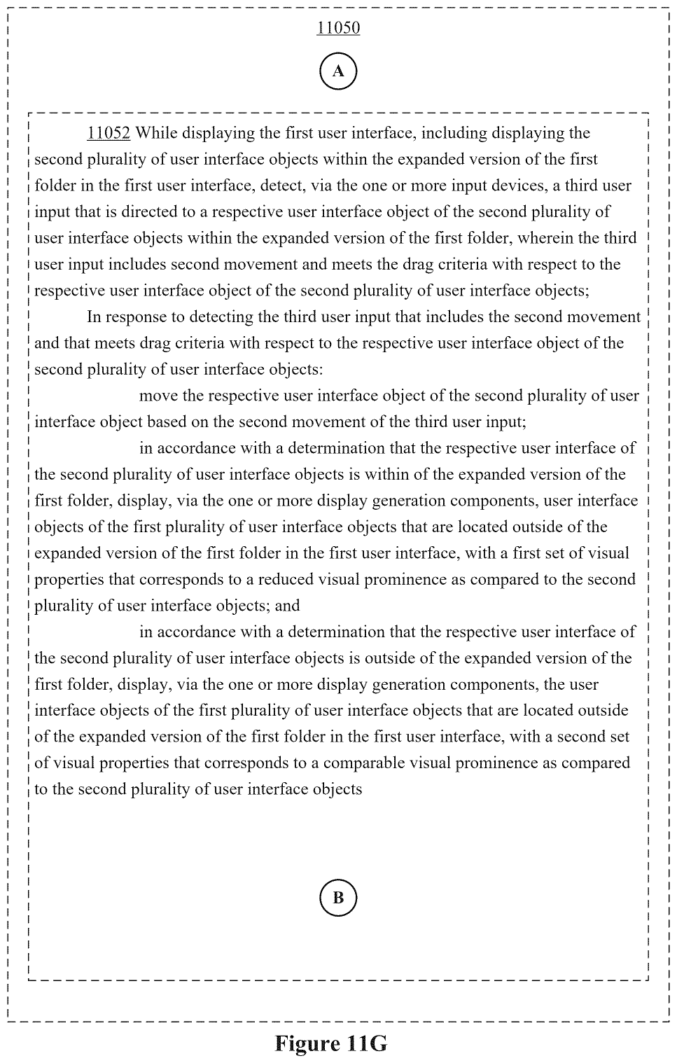

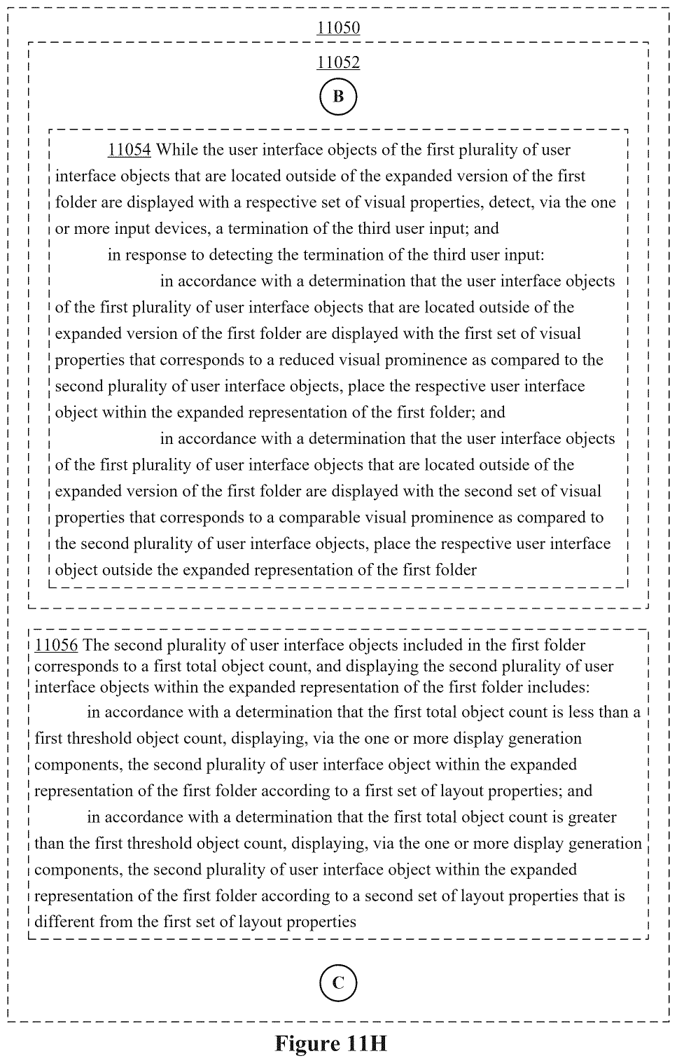

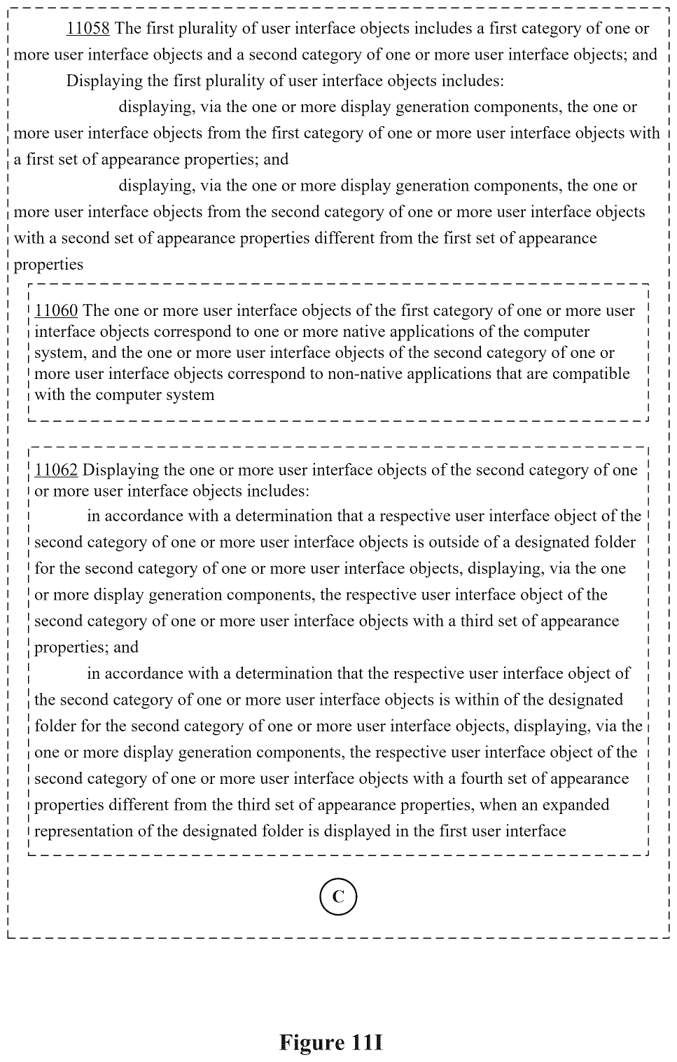

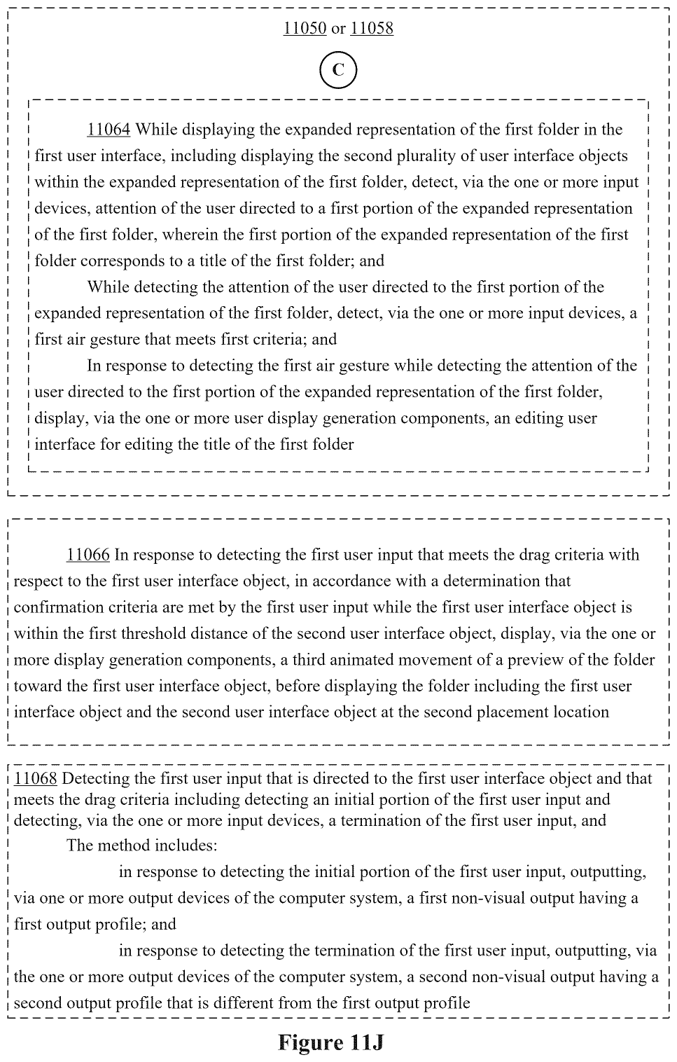

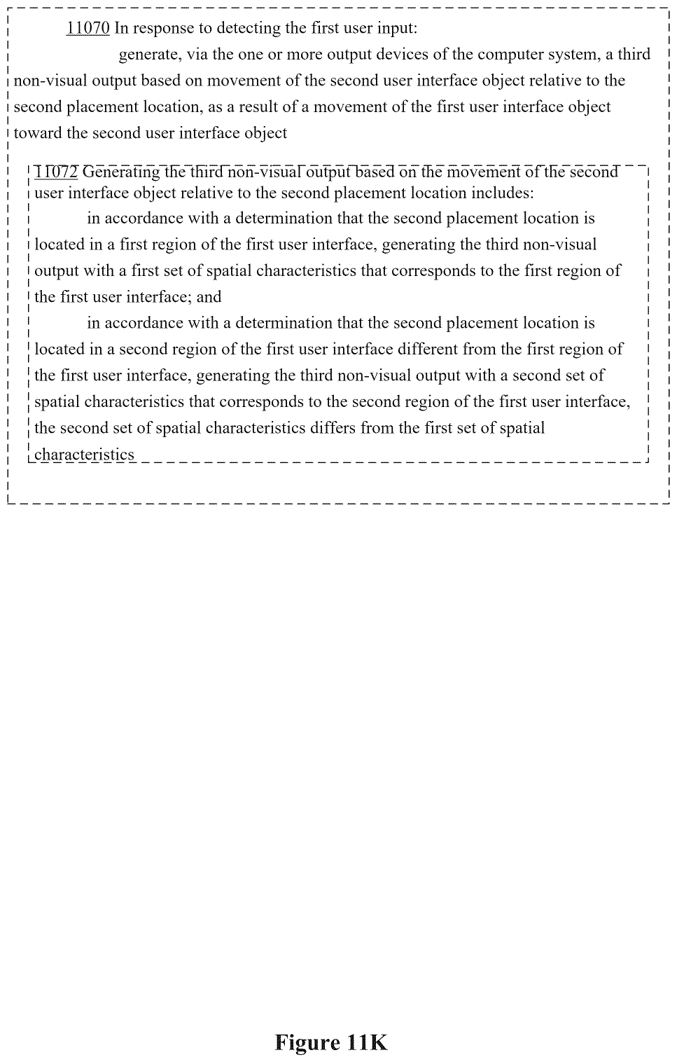

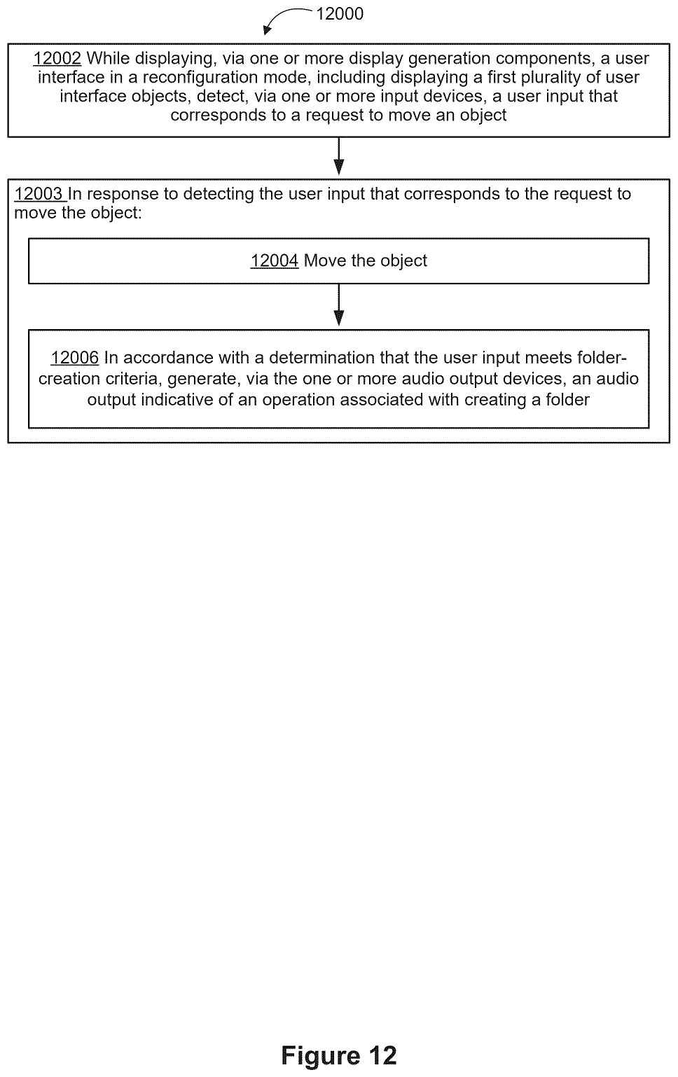

FIGS. 1A-6 provide a description of example computer systems for providing XR experiences to users (such as described below with respect to methods 10000, 11000, and/or 12000). FIGS. 8A-8AL illustrate example user interfaces and interactions for reconfiguring a home user interface with multiple collections of user interface objects in a three-dimensional environment, in accordance with some embodiments. FIGS. 10A-10M are flow diagrams of methods of reconfiguring a home user interface with multiple collections of user interface objects in a three-dimensional environment, in accordance with some embodiments. The user interfaces in FIGS. 8A-8AL are used to illustrate the processes in FIGS. 10A-10M. FIGS. 9A-9AS illustrate example user interfaces and interactions for creating a folder of user interface objects in a three-dimensional environment, in accordance with some embodiments. FIGS. 11A-11K are flow diagrams of methods of creating a folder of user interface objects in a three-dimensional environment, in accordance with various embodiments. FIG. 12 is a flow diagram of methods of generating sounds associated with folder creation operations and other operations performed with respect user interface objects in a three-dimensional environment, in accordance with various embodiments. The user interfaces 9A-9AS in Figures are used to illustrate the processes in FIGS. 11A-11K and 12.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, improving privacy and/or security, providing a more varied, detailed, and/or realistic user experience while saving storage space, and/or additional techniques. These techniques also reduce power usage and improve battery life of the device by enabling the user to use the device more quickly and efficiently. Saving on battery power, and thus weight, improves the ergonomics of the device. These techniques also enable real-time communication, allow for the use of fewer and/or less precise sensors resulting in a more compact, lighter, and cheaper device, and enable the device to be used in a variety of lighting conditions. These techniques reduce energy usage, thereby reducing heat emitted by the device, which is particularly important for a wearable device where a device well within operational parameters for device components can become uncomfortable for a user to wear if it is producing too much heat.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

In some embodiments, as shown in FIG. 1A, the XR experience is provided to the user via an operating environment 100 that includes a computer system 101. The computer system 101 includes a controller 110 (e.g., processors of a portable electronic device or a remote server), a display generation component 120 (e.g., a head-mounted device (HMD), a display, a projector, a touch-screen, etc.), one or more input devices 125 (e.g., an eye tracking device 130, a hand tracking device 140, other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, velocity sensors, etc.), and optionally one or more peripheral devices 195 (e.g., home appliances, wearable devices, etc.). In some embodiments, one or more of the input devices 125, output devices 155, sensors 190, and peripheral devices 195 are integrated with the display generation component 120 (e.g., in a head-mounted device or a handheld device).

When describing an XR experience, various terms are used to differentially refer to several related but distinct environments that the user may sense and/or with which a user may interact (e.g., with inputs detected by a computer system 101 generating the XR experience that cause the computer system generating the XR experience to generate audio, visual, and/or tactile feedback corresponding to various inputs provided to the computer system 101). The following is a subset of these terms:

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Extended reality: In contrast, an extended reality (XR) environment refers to a wholly or partially simulated environment that people sense and/or interact with via an electronic system. In XR, a subset of a person's physical motions, or representations thereof, are tracked, and, in response, one or more characteristics of one or more virtual objects simulated in the XR environment are adjusted in a manner that comports with at least one law of physics. For example, an XR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in an XR environment may be made in response to representations of physical motions (e.g., vocal commands). A person may sense and/or interact with an XR object using any one of their senses, including sight, sound, touch, taste, and smell. For example, a person may sense and/or interact with audio objects that create a 3D or spatial audio environment that provides the perception of point audio sources in 3D space. In another example, audio objects may enable audio transparency, which selectively incorporates ambient sounds from the physical environment with or without computer-generated audio. In some XR environments, a person may sense and/or interact only with audio objects.

Examples of XR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationary with respect to the physical ground.

Examples of mixed realities include augmented reality and augmented virtuality.

Augmented reality: An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

Augmented virtuality: An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

In an augmented reality, mixed reality, or virtual reality environment, a view of a three-dimensional environment is visible to a user. The view of the three-dimensional environment is typically visible to the user via one or more display generation components (e.g., a display or a pair of display modules that provide stereoscopic content to different eyes of the same user) through a virtual viewport that has a viewport boundary that defines an extent of the three-dimensional environment that is visible to the user via the one or more display generation components. In some embodiments, the region defined by the viewport boundary is smaller than a range of vision of the user in one or more dimensions (e.g., based on the range of vision of the user, size, optical properties or other physical characteristics of the one or more display generation components, and/or the location and/or orientation of the one or more display generation components relative to the eyes of the user). In some embodiments, the region defined by the viewport boundary is larger than a range of vision of the user in one or more dimensions (e.g., based on the range of vision of the user, size, optical properties or other physical characteristics of the one or more display generation components, and/or the location and/or orientation of the one or more display generation components relative to the eyes of the user). The viewport and viewport boundary typically move as the one or more display generation components move (e.g., moving with a head of the user for a head mounted device or moving with a hand of a user for a handheld device such as a tablet or smartphone). A viewpoint of a user determines what content is visible in the viewport, a viewpoint generally specifies a location and a direction relative to the three-dimensional environment, and as the viewpoint shifts, the view of the three-dimensional environment will also shift in the viewport. For a head mounted device, a viewpoint is typically based on a location and direction of the head, face, and/or eyes of a user to provide a view of the three-dimensional environment that is perceptually accurate and provides an immersive experience when the user is using the head-mounted device. For a handheld or stationed device, the viewpoint shifts as the handheld or stationed device is moved and/or as a position of a user relative to the handheld or stationed device changes (e.g., a user moving toward, away from, up, down, to the right, and/or to the left of the device). For devices that include display generation components with virtual passthrough, portions of the physical environment that are visible (e.g., displayed, and/or projected) via the one or more display generation components are based on a field of view of one or more cameras in communication with the display generation components which typically move with the display generation components (e.g., moving with a head of the user for a head mounted device or moving with a hand of a user for a handheld device such as a tablet or smartphone) because the viewpoint of the user moves as the field of view of the one or more cameras moves (and the appearance of one or more virtual objects displayed via the one or more display generation components is updated based on the viewpoint of the user (e.g., displayed positions and poses of the virtual objects are updated based on the movement of the viewpoint of the user)). For display generation components with optical passthrough, portions of the physical environment that are visible (e.g., optically visible through one or more partially or fully transparent portions of the display generation component) via the one or more display generation components are based on a field of view of a user through the partially or fully transparent portion(s) of the display generation component (e.g., moving with a head of the user for a head mounted device or moving with a hand of a user for a handheld device such as a tablet or smartphone) because the viewpoint of the user moves as the field of view of the user through the partially or fully transparent portions of the display generation components moves (and the appearance of one or more virtual objects is updated based on the viewpoint of the user).

In some embodiments a representation of a physical environment (e.g., displayed via virtual passthrough or optical passthrough) can be partially or fully obscured by a virtual environment. In some embodiments, the amount of virtual environment that is displayed (e.g., the amount of physical environment that is not displayed) is based on an immersion level for the virtual environment (e.g., with respect to the representation of the physical environment). For example, increasing the immersion level optionally causes more of the virtual environment to be displayed, replacing and/or obscuring more of the physical environment, and reducing the immersion level optionally causes less of the virtual environment to be displayed, revealing portions of the physical environment that were previously not displayed and/or obscured. In some embodiments, at a particular immersion level, one or more first background objects (e.g., in the representation of the physical environment) are visually de-emphasized (e.g., dimmed, blurred, and/or displayed with increased transparency) more than one or more second background objects, and one or more third background objects cease to be displayed. In some embodiments, a level of immersion includes an associated degree to which the virtual content displayed by the computer system (e.g., the virtual environment and/or the virtual content) obscures background content (e.g., content other than the virtual environment and/or the virtual content) around/behind the virtual content, optionally including the number of items of background content displayed and/or the visual characteristics (e.g., colors, contrast, and/or opacity) with which the background content is displayed, the angular range of the virtual content displayed via the display generation component (e.g., 60 degrees of content displayed at low immersion, 120 degrees of content displayed at medium immersion, or 180 degrees of content displayed at high immersion), and/or the proportion of the field of view displayed via the display generation component that is consumed by the virtual content (e.g., 33% of the field of view consumed by the virtual content at low immersion, 66% of the field of view consumed by the virtual content at medium immersion, or 100% of the field of view consumed by the virtual content at high immersion). In some embodiments, the background content is included in a background over which the virtual content is displayed (e.g., background content in the representation of the physical environment). In some embodiments, the background content includes user interfaces (e.g., user interfaces generated by the computer system corresponding to applications), virtual objects (e.g., files or representations of other users generated by the computer system) not associated with or included in the virtual environment and/or virtual content, and/or real objects (e.g., pass-through objects representing real objects in the physical environment around the user that are visible such that they are displayed via the display generation component and/or a visible via a transparent or translucent component of the display generation component because the computer system does not obscure/prevent visibility of them through the display generation component). In some embodiments, at a low level of immersion (e.g., a first level of immersion), the background, virtual and/or real objects are displayed in an unobscured manner. For example, a virtual environment with a low level of immersion is optionally displayed concurrently with the background content, which is optionally displayed with full brightness, color, and/or translucency. In some embodiments, at a higher level of immersion (e.g., a second level of immersion higher than the first level of immersion), the background, virtual and/or real objects are displayed in an obscured manner (e.g., dimmed, blurred, or removed from display). For example, a respective virtual environment with a high level of immersion is displayed without concurrently displaying the background content (e.g., in a full screen or fully immersive mode). As another example, a virtual environment displayed with a medium level of immersion is displayed concurrently with darkened, blurred, or otherwise de-emphasized background content. In some embodiments, the visual characteristics of the background objects vary among the background objects. For example, at a particular immersion level, one or more first background objects are visually de-emphasized (e.g., dimmed, blurred, and/or displayed with increased transparency) more than one or more second background objects, and one or more third background objects cease to be displayed. In some embodiments, a null or zero level of immersion corresponds to the virtual environment ceasing to be displayed and instead a representation of a physical environment is displayed (optionally with one or more virtual objects such as application, windows, or virtual three-dimensional objects) without the representation of the physical environment being obscured by the virtual environment. Adjusting the level of immersion using a physical input element provides for quick and efficient method of adjusting immersion, which enhances the operability of the computer system and makes the user-device interface more efficient.

Viewpoint-locked virtual object: A virtual object is viewpoint-locked when a computer system displays the virtual object at the same location and/or position in the viewpoint of the user, even as the viewpoint of the user shifts (e.g., changes). In embodiments where the computer system is a head-mounted device, the viewpoint of the user is locked to the forward facing direction of the user's head (e.g., the viewpoint of the user is at least a portion of the field-of-view of the user when the user is looking straight ahead); thus, the viewpoint of the user remains fixed even as the user's gaze is shifted, without moving the user's head. In embodiments where the computer system has a display generation component (e.g., a display screen) that can be repositioned with respect to the user's head, the viewpoint of the user is the augmented reality view that is being presented to the user on a display generation component of the computer system. For example, a viewpoint-locked virtual object that is displayed in the upper left corner of the viewpoint of the user, when the viewpoint of the user is in a first orientation (e.g., with the user's head facing north) continues to be displayed in the upper left corner of the viewpoint of the user, even as the viewpoint of the user changes to a second orientation (e.g., with the user's head facing west). In other words, the location and/or position at which the viewpoint-locked virtual object is displayed in the viewpoint of the user is independent of the user's position and/or orientation in the physical environment. In embodiments in which the computer system is a head-mounted device, the viewpoint of the user is locked to the orientation of the user's head, such that the virtual object is also referred to as a “head-locked virtual object.”

Environment-locked virtual object: A virtual object is environment-locked (alternatively, “world-locked”) when a computer system displays the virtual object at a location and/or position in the viewpoint of the user that is based on (e.g., selected in reference to and/or anchored to) a location and/or object in the three-dimensional environment (e.g., a physical environment or a virtual environment). As the viewpoint of the user shifts, the location and/or object in the environment relative to the viewpoint of the user changes, which results in the environment-locked virtual object being displayed at a different location and/or position in the viewpoint of the user. For example, an environment-locked virtual object that is locked onto a tree that is immediately in front of a user is displayed at the center of the viewpoint of the user. When the viewpoint of the user shifts to the right (e.g., the user's head is turned to the right) so that the tree is now left-of-center in the viewpoint of the user (e.g., the tree's position in the viewpoint of the user shifts), the environment-locked virtual object that is locked onto the tree is displayed left-of-center in the viewpoint of the user. In other words, the location and/or position at which the environment-locked virtual object is displayed in the viewpoint of the user is dependent on the position and/or orientation of the location and/or object in the environment onto which the virtual object is locked. In some embodiments, the computer system uses a stationary frame of reference (e.g., a coordinate system that is anchored to a fixed location and/or object in the physical environment) in order to determine the position at which to display an environment-locked virtual object in the viewpoint of the user. An environment-locked virtual object can be locked to a stationary part of the environment (e.g., a floor, wall, table, or other stationary object) or can be locked to a moveable part of the environment (e.g., a vehicle, animal, person, or even a representation of portion of the users body that moves independently of a viewpoint of the user, such as a user's hand, wrist, arm, or foot) so that the virtual object is moved as the viewpoint or the portion of the environment moves to maintain a fixed relationship between the virtual object and the portion of the environment.

In some embodiments a virtual object that is environment-locked or viewpoint-locked exhibits lazy follow behavior which reduces or delays motion of the environment-locked or viewpoint-locked virtual object relative to movement of a point of reference which the virtual object is following. In some embodiments, when exhibiting lazy follow behavior the computer system intentionally delays movement of the virtual object when detecting movement of a point of reference (e.g., a portion of the environment, the viewpoint, or a point that is fixed relative to the viewpoint, such as a point that is between 5-300 cm from the viewpoint) which the virtual object is following. For example, when the point of reference (e.g., the portion of the environment or the viewpoint) moves with a first speed, the virtual object is moved by the device to remain locked to the point of reference but moves with a second speed that is slower than the first speed (e.g., until the point of reference stops moving or slows down, at which point the virtual object starts to catch up to the point of reference). In some embodiments, when a virtual object exhibits lazy follow behavior the device ignores small amounts of movement of the point of reference (e.g., ignoring movement of the point of reference that is below a threshold amount of movement such as movement by 0-5 degrees or movement by 0-50 cm). For example, when the point of reference (e.g., the portion of the environment or the viewpoint to which the virtual object is locked) moves by a first amount, a distance between the point of reference and the virtual object increases (e.g., because the virtual object is being displayed so as to maintain a fixed or substantially fixed position relative to a viewpoint or portion of the environment that is different from the point of reference to which the virtual object is locked) and when the point of reference (e.g., the portion of the environment or the viewpoint to which the virtual object is locked) moves by a second amount that is greater than the first amount, a distance between the point of reference and the virtual object initially increases (e.g., because the virtual object is being displayed so as to maintain a fixed or substantially fixed position relative to a viewpoint or portion of the environment that is different from the point of reference to which the virtual object is locked) and then decreases as the amount of movement of the point of reference increases above a threshold (e.g., a “lazy follow” threshold) because the virtual object is moved by the computer system to maintain a fixed or substantially fixed position relative to the point of reference. In some embodiments the virtual object maintaining a substantially fixed position relative to the point of reference includes the virtual object being displayed within a threshold distance (e.g., 1, 2, 3, 5, 15, 20, 50 cm) of the point of reference in one or more dimensions (e.g., up/down, left/right, and/or forward/backward relative to the position of the point of reference).

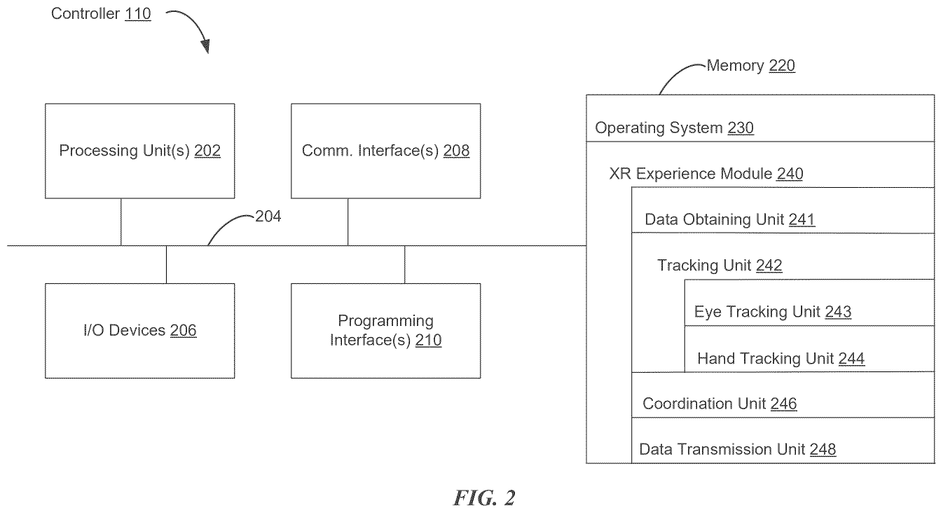

Hardware: There are many different types of electronic systems that enable a person to sense and/or interact with various XR environments. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may have one or more speaker(s) and an integrated opaque display. Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. In some embodiments, the controller 110 is configured to manage and coordinate an XR experience for the user. In some embodiments, the controller 110 includes a suitable combination of software, firmware, and/or hardware. The controller 110 is described in greater detail below with respect to FIG. 2. In some embodiments, the controller 110 is a computing device that is local or remote relative to the scene 105 (e.g., a physical environment). For example, the controller 110 is a local server located within the scene 105. In another example, the controller 110 is a remote server located outside of the scene 105 (e.g., a cloud server, central server, etc.). In some embodiments, the controller 110 is communicatively coupled with the display generation component 120 (e.g., an HMD, a display, a projector, a touch-screen, etc.) via one or more wired or wireless communication channels 144 (e.g., BLUETOOTH, IEEE 802.11x, IEEE 802.16x, IEEE 802.3x, etc.). In another example, the controller 110 is included within the enclosure (e.g., a physical housing) of the display generation component 120 (e.g., an HMD, or a portable electronic device that includes a display and one or more processors, etc.), one or more of the input devices 125, one or more of the output devices 155, one or more of the sensors 190, and/or one or more of the peripheral devices 195, or share the same physical enclosure or support structure with one or more of the above.

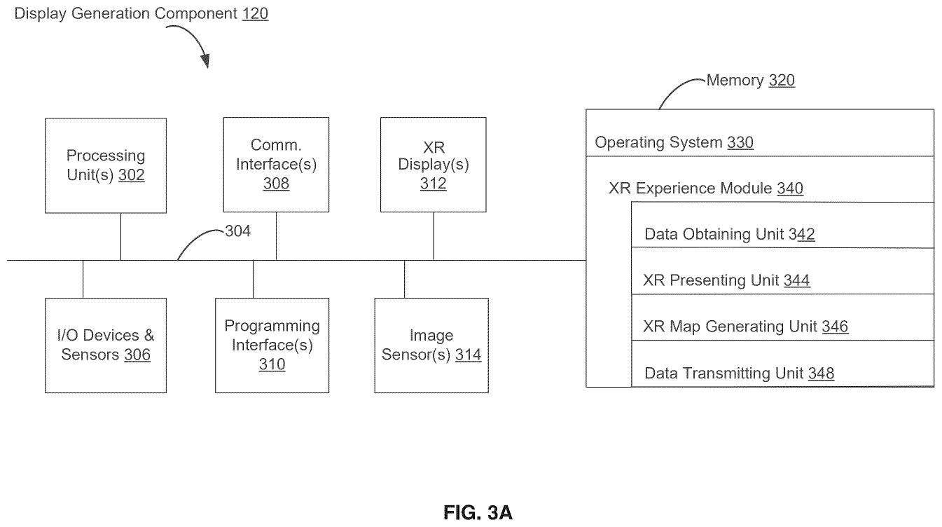

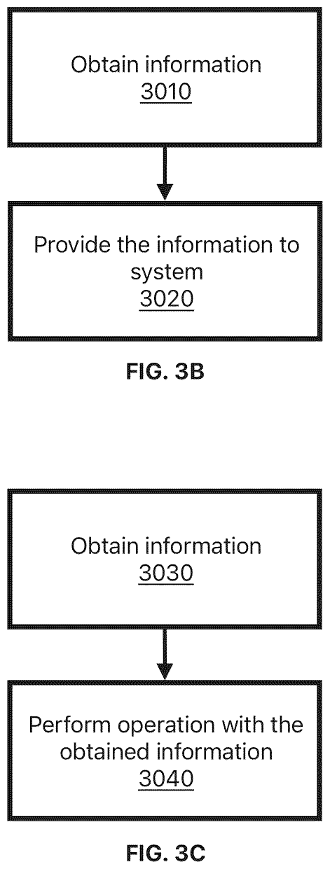

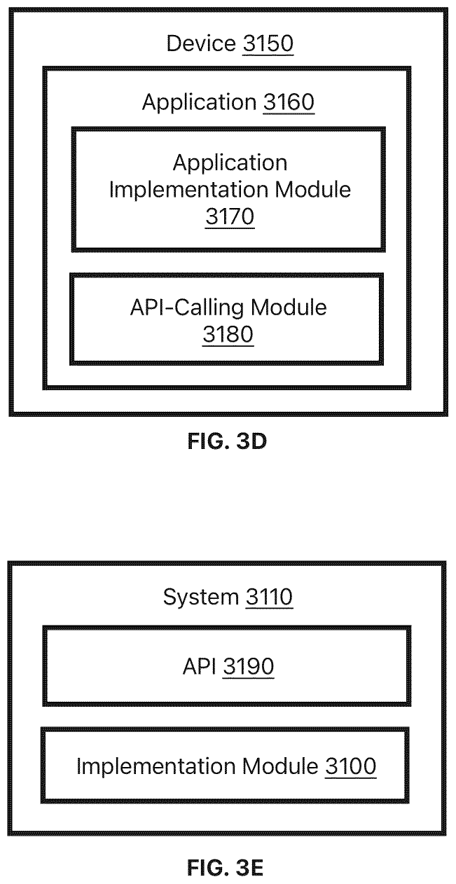

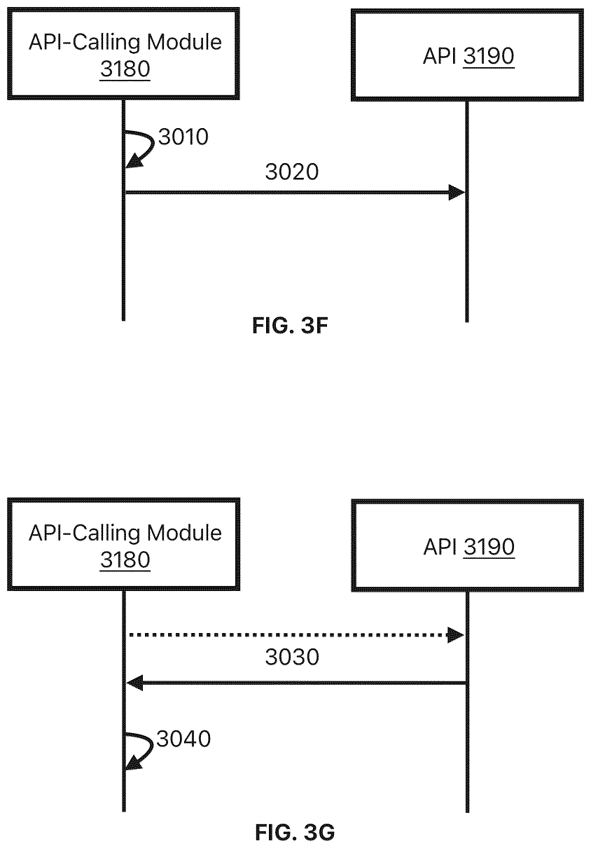

In some embodiments, the display generation component 120 is configured to provide the XR experience (e.g., at least a visual component of the XR experience) to the user. In some embodiments, the display generation component 120 includes a suitable combination of software, firmware, and/or hardware. The display generation component 120 is described in greater detail below with respect to FIG. 3A. In some embodiments, the functionalities of the controller 110 are provided by and/or combined with the display generation component 120.

According to some embodiments, the display generation component 120 provides an XR experience to the user while the user is virtually and/or physically present within the scene 105.

In some embodiments, the display generation component is worn on a part of the user's body (e.g., on his/her head, on his/her hand, etc.). As such, the display generation component 120 includes one or more XR displays provided to display the XR content. For example, in various embodiments, the display generation component 120 encloses the field-of-view of the user. In some embodiments, the display generation component 120 is a handheld device (such as a smartphone or tablet) configured to present XR content, and the user holds the device with a display directed towards the field-of-view of the user and a camera directed towards the scene 105. In some embodiments, the handheld device is optionally placed within an enclosure that is worn on the head of the user. In some embodiments, the handheld device is optionally placed on a support (e.g., a tripod) in front of the user. In some embodiments, the display generation component 120 is an XR chamber, enclosure, or room configured to present XR content in which the user does not wear or hold the display generation component 120. Many user interfaces described with reference to one type of hardware for displaying XR content (e.g., a handheld device or a device on a tripod) could be implemented on another type of hardware for displaying XR content (e.g., an HMD or other wearable computing device). For example, a user interface showing interactions with XR content triggered based on interactions that happen in a space in front of a handheld or tripod mounted device could similarly be implemented with an HMD where the interactions happen in a space in front of the HMD and the responses of the XR content are displayed via the HMD. Similarly, a user interface showing interactions with XR content triggered based on movement of a handheld or tripod mounted device relative to the physical environment (e.g., the scene 105 or a part of the user's body (e.g., the user's eye(s), head, or hand)) could similarly be implemented with an HMD where the movement is caused by movement of the HMD relative to the physical environment (e.g., the scene 105 or a part of the user's body (e.g., the user's eye(s), head, or hand)).

While pertinent features of the operating environment 100 are shown in FIG. 1A, those of ordinary skill in the art will appreciate from the present disclosure that various other features have not been illustrated for the sake of brevity and so as not to obscure more pertinent aspects of the example embodiments disclosed herein.

FIGS. 1A-1P illustrate various examples of a computer system that is used to perform the methods and provide audio, visual and/or haptic feedback as part of user interfaces described herein. In some embodiments, the computer system includes one or more display generation components (e.g., first and second display assemblies 1-120a, 1-120b and/or first and second optical modules 11.1.1-104a and 11.1.1-104b) for displaying virtual elements and/or a representation of a physical environment to a user of the computer system, optionally generated based on detected events and/or user inputs detected by the computer system. User interfaces generated by the computer system are optionally corrected by one or more corrective lenses 11.3.2-216 that are optionally removably attached to one or more of the optical modules to enable the user interfaces to be more easily viewed by users who would otherwise use glasses or contacts to correct their vision. While many user interfaces illustrated herein show a single view of a user interface, user interfaces in a HMD are optionally displayed using two optical modules (e.g., first and second display assemblies 1-120a, 1-120b and/or first and second optical modules 11.1.1-104a and 11.1.1-104b), one for a user's right eye and a different one for a user's left eye, and slightly different images are presented to the two different eyes to generate the illusion of stereoscopic depth, the single view of the user interface would typically be either a right-eye or left-eye view and the depth effect is explained in the text or using other schematic charts or views. In some embodiments, the computer system includes one or more external displays (e.g., display assembly 1-108) for displaying status information for the computer system to the user of the computer system (when the computer system is not being worn) and/or to other people who are near the computer system, optionally generated based on detected events and/or user inputs detected by the computer system. In some embodiments, the computer system includes one or more audio output components (e.g., electronic component 1-112) for generating audio feedback, optionally generated based on detected events and/or user inputs detected by the computer system. In some embodiments, the computer system includes one or more input devices for detecting input such as one or more sensors (e.g., one or more sensors in sensor assembly 1-356, and/or FIG. 1I) for detecting information about a physical environment of the device which can be used (optionally in conjunction with one or more illuminators such as the illuminators described in FIG. 1I) to generate a digital passthrough image, capture visual media corresponding to the physical environment (e.g., photos and/or video), or determine a pose (e.g., position and/or orientation) of physical objects and/or surfaces in the physical environment so that virtual objects ban be placed based on a detected pose of physical objects and/or surfaces. In some embodiments, the computer system includes one or more input devices for detecting input such as one or more sensors for detecting hand position and/or movement (e.g., one or more sensors in sensor assembly 1-356, and/or FIG. 1I) that can be used (optionally in conjunction with one or more illuminators such as the illuminators 6-124 described in FIG. 1I) to determine when one or more air gestures have been performed. In some embodiments, the computer system includes one or more input devices for detecting input such as one or more sensors for detecting eye movement (e.g., eye tracking and gaze tracking sensors in FIG. 1I) which can be used (optionally in conjunction with one or more lights such as lights 11.3.2-110 in FIG. 1O) to determine attention or gaze position and/or gaze movement which can optionally be used to detect gaze-only inputs based on gaze movement and/or dwell. A combination of the various sensors described above can be used to determine user facial expressions and/or hand movements for use in generating an avatar or representation of the user such as an anthropomorphic avatar or representation for use in a real-time communication session where the avatar has facial expressions, hand movements, and/or body movements that are based on or similar to detected facial expressions, hand movements, and/or body movements of a user of the device. Gaze and/or attention information is, optionally, combined with hand tracking information to determine interactions between the user and one or more user interfaces based on direct and/or indirect inputs such as air gestures or inputs that use one or more hardware input devices such as one or more buttons (e.g., first button 1-128, button 11.1.1-114, second button 1-132, and or dial or button 1-328), knobs (e.g., first button 1-128, button 11.1.1-114, and/or dial or button 1-328), digital crowns (e.g., first button 1-128 which is depressible and twistable or rotatable, button 11.1.1-114, and/or dial or button 1-328), trackpads, touch screens, keyboards, mice and/or other input devices. One or more buttons (e.g., first button 1-128, button 11.1.1-114, second button 1-132, and or dial or button 1-328) are optionally used to perform system operations such as recentering content in three-dimensional environment that is visible to a user of the device, displaying a home user interface for launching applications, starting real-time communication sessions, or initiating display of virtual three-dimensional backgrounds. Knobs or digital crowns (e.g., first button 1-128 which is depressible and twistable or rotatable, button 11.1.1-114, and/or dial or button 1-328) are optionally rotatable to adjust parameters of the visual content such as a level of immersion of a virtual three-dimensional environment (e.g., a degree to which virtual-content occupies the viewport of the user into the three-dimensional environment) or other parameters associated with the three-dimensional environment and the virtual content that is displayed via the optical modules (e.g., first and second display assemblies 1-120a, 1-120b and/or first and second optical modules 11.1.1-104a and 11.1.1-104b).

FIG. 1B illustrates a front, top, perspective view of an example of a head-mountable display (HMD) device 1-100 configured to be donned by a user and provide virtual and altered/mixed reality (VR/AR) experiences. The HMD 1-100 can include a display unit 1-102 or assembly, an electronic strap assembly 1-104 connected to and extending from the display unit 1-102, and a band assembly 1-106 secured at either end to the electronic strap assembly 1-104. The electronic strap assembly 1-104 and the band 1-106 can be part of a retention assembly configured to wrap around a user's head to hold the display unit 1-102 against the face of the user.

In at least one example, the band assembly 1-106 can include a first band 1-116 configured to wrap around the rear side of a user's head and a second band 1-117 configured to extend over the top of a user's head. The second strap can extend between first and second electronic straps 1-105a, 1-105b of the electronic strap assembly 1-104 as shown. The strap assembly 1-104 and the band assembly 1-106 can be part of a securement mechanism extending rearward from the display unit 1-102 and configured to hold the display unit 1-102 against a face of a user.

In at least one example, the securement mechanism includes a first electronic strap 1-105a including a first proximal end 1-134 coupled to the display unit 1-102, for example a housing 1-150 of the display unit 1-102, and a first distal end 1-136 opposite the first proximal end 1-134. The securement mechanism can also include a second electronic strap 1-105b including a second proximal end 1-138 coupled to the housing 1-150 of the display unit 1-102 and a second distal end 1-140 opposite the second proximal end 1-138. The securement mechanism can also include the first band 1-116 including a first end 1-142 coupled to the first distal end 1-136 and a second end 1-144 coupled to the second distal end 1-140 and the second band 1-117 extending between the first electronic strap 1-105a and the second electronic strap 1-105b. The straps 1-105a-b and band 1-116 can be coupled via connection mechanisms or assemblies 1-114. In at least one example, the second band 1-117 includes a first end 1-146 coupled to the first electronic strap 1-105a between the first proximal end 1-134 and the first distal end 1-136 and a second end 1-148 coupled to the second electronic strap 1-105b between the second proximal end 1-138 and the second distal end 1-140.

In at least one example, the first and second electronic straps 1-105a-b include plastic, metal, or other structural materials forming the shape the substantially rigid straps 1-105a-b. In at least one example, the first and second bands 1-116, 1-117 are formed of elastic, flexible materials including woven textiles, rubbers, and the like. The first and second bands 1-116, 1-117 can be flexible to conform to the shape of the user' head when donning the HMD 1-100.

In at least one example, one or more of the first and second electronic straps 1-105a-b can define internal strap volumes and include one or more electronic components disposed in the internal strap volumes. In one example, as shown in FIG. 1B, the first electronic strap 1-105a can include an electronic component 1-112. In one example, the electronic component 1-112 can include a speaker. In one example, the electronic component 1-112 can include a computing component such as a processor.

In at least one example, the housing 1-150 defines a first, front-facing opening 1-152. The front-facing opening is labeled in dotted lines at 1-152 in FIG. 1B because the display assembly 1-108 is disposed to occlude the first opening 1-152 from view when the HMD 1-100 is assembled. The housing 1-150 can also define a rear-facing second opening 1-154. The housing 1-150 also defines an internal volume between the first and second openings 1-152, 1-154. In at least one example, the HMD 1-100 includes the display assembly 1-108, which can include a front cover and display screen (shown in other figures) disposed in or across the front opening 1-152 to occlude the front opening 1-152. In at least one example, the display screen of the display assembly 1-108, as well as the display assembly 1-108 in general, has a curvature configured to follow the curvature of a user's face. The display screen of the display assembly 1-108 can be curved as shown to compliment the user's facial features and general curvature from one side of the face to the other, for example from left to right and/or from top to bottom where the display unit 1-102 is pressed.

In at least one example, the housing 1-150 can define a first aperture 1-126 between the first and second openings 1-152, 1-154 and a second aperture 1-130 between the first and second openings 1-152, 1-154. The HMD 1-100 can also include a first button 1-128 disposed in the first aperture 1-126 and a second button 1-132 disposed in the second aperture 1-130. The first and second buttons 1-128, 1-132 can be depressible through the respective apertures 1-126, 1-130. In at least one example, the first button 1-126 and/or second button 1-132 can be twistable dials as well as depressible buttons. In at least one example, the first button 1-128 is a depressible and twistable dial button and the second button 1-132 is a depressible button.

FIG. 1C illustrates a rear, perspective view of the HMD 1-100. The HMD 1-100 can include a light seal 1-110 extending rearward from the housing 1-150 of the display assembly 1-108 around a perimeter of the housing 1-150 as shown. The light seal 1-110 can be configured to extend from the housing 1-150 to the user's face around the user's eyes to block external light from being visible. In one example, the HMD 1-100 can include first and second display assemblies 1-120a, 1-120b disposed at or in the rearward facing second opening 1-154 defined by the housing 1-150 and/or disposed in the internal volume of the housing 1-150 and configured to project light through the second opening 1-154. In at least one example, each display assembly 1-120a-b can include respective display screens 1-122a, 1-122b configured to project light in a rearward direction through the second opening 1-154 toward the user's eyes.

In at least one example, referring to both FIGS. 1B and 1C, the display assembly 1-108 can be a front-facing, forward display assembly including a display screen configured to project light in a first, forward direction and the rear facing display screens 1-122a-b can be configured to project light in a second, rearward direction opposite the first direction. As noted above, the light seal 1-110 can be configured to block light external to the HMD 1-100 from reaching the user's eyes, including light projected by the forward facing display screen of the display assembly 1-108 shown in the front perspective view of FIG. 1B. In at least one example, the HMD 1-100 can also include a curtain 1-124 occluding the second opening 1-154 between the housing 1-150 and the rear-facing display assemblies 1-120a-b. In at least one example, the curtain 1-124 can be elastic or at least partially elastic.

Any of the features, components, and/or parts, including the arrangements and configurations thereof shown in FIGS. 1B and 1C can be included, either alone or in any combination, in any of the other examples of devices, features, components, and parts shown in FIGS. 1D-1F and described herein. Likewise, any of the features, components, and/or parts, including the arrangements and configurations thereof shown and described with reference to FIGS. 1D-1F can be included, either alone or in any combination, in the example of the devices, features, components, and parts shown in FIGS. 1B and 1C.

FIG. 1D illustrates an exploded view of an example of an HMD 1-200 including various portions or parts thereof separated according to the modularity and selective coupling of those parts. For example, the HMD 1-200 can include a band 1-216 which can be selectively coupled to first and second electronic straps 1-205a, 1-205b. The first securement strap 1-205a can include a first electronic component 1-212a and the second securement strap 1-205b can include a second electronic component 1-212b. In at least one example, the first and second straps 1-205a-b can be removably coupled to the display unit 1-202.

In addition, the HMD 1-200 can include a light seal 1-210 configured to be removably coupled to the display unit 1-202. The HMD 1-200 can also include lenses 1-218 which can be removably coupled to the display unit 1-202, for example over first and second display assemblies including display screens. The lenses 1-218 can include customized prescription lenses configured for corrective vision. As noted, each part shown in the exploded view of FIG. 1D and described above can be removably coupled, attached, re-attached, and changed out to update parts or swap out parts for different users. For example, bands such as the band 1-216, light seals such as the light seal 1-210, lenses such as the lenses 1-218, and electronic straps such as the straps 1-205a-b can be swapped out depending on the user such that these parts are customized to fit and correspond to the individual user of the HMD 1-200.

Any of the features, components, and/or parts, including the arrangements and configurations thereof shown in FIG. 1D can be included, either alone or in any combination, in any of the other examples of devices, features, components, and parts shown in FIGS. 1B, 1C, and 1E-1F and described herein. Likewise, any of the features, components, and/or parts, including the arrangements and configurations thereof shown and described with reference to FIGS. 1B, 1C, and 1E-1F can be included, either alone or in any combination, in the example of the devices, features, components, and parts shown in FIG. 1D.

FIG. 1E illustrates an exploded view of an example of a display unit 1-306 of a HMD. The display unit 1-306 can include a front display assembly 1-308, a frame/housing assembly 1-350, and a curtain assembly 1-324. The display unit 1-306 can also include a sensor assembly 1-356, logic board assembly 1-358, and cooling assembly 1-360 disposed between the frame assembly 1-350 and the front display assembly 1-308. In at least one example, the display unit 1-306 can also include a rear-facing display assembly 1-320 including first and second rear-facing display screens 1-322a, 1-322b disposed between the frame 1-350 and the curtain assembly 1-324.

In at least one example, the display unit 1-306 can also include a motor assembly 1-362 configured as an adjustment mechanism for adjusting the positions of the display screens 1-322a-b of the display assembly 1-320 relative to the frame 1-350. In at least one example, the display assembly 1-320 is mechanically coupled to the motor assembly 1-362, with at least one motor for each display screen 1-322a-b, such that the motors can translate the display screens 1-322a-b to match an interpupillary distance of the user's eyes.

In at least one example, the display unit 1-306 can include a dial or button 1-328 depressible relative to the frame 1-350 and accessible to the user outside the frame 1-350. The button 1-328 can be electronically connected to the motor assembly 1-362 via a controller such that the button 1-328 can be manipulated by the user to cause the motors of the motor assembly 1-362 to adjust the positions of the display screens 1-322a-b.

Any of the features, components, and/or parts, including the arrangements and configurations thereof shown in FIG. 1E can be included, either alone or in any combination, in any of the other examples of devices, features, components, and parts shown in FIGS. 1B-1D and 1F and described herein. Likewise, any of the features, components, and/or parts, including the arrangements and configurations thereof shown and described with reference to FIGS. 1B-1D and 1F can be included, either alone or in any combination, in the example of the devices, features, components, and parts shown in FIG. 1E.

FIG. 1F illustrates an exploded view of another example of a display unit 1-406 of a HMD device similar to other HMD devices described herein. The display unit 1-406 can include a front display assembly 1-402, a sensor assembly 1-456, a logic board assembly 1-458, a cooling assembly 1-460, a frame assembly 1-450, a rear-facing display assembly 1-421, and a curtain assembly 1-424. The display unit 1-406 can also include a motor assembly 1-462 for adjusting the positions of first and second display sub-assemblies 1-420a, 1-420b of the rear-facing display assembly 1-421, including first and second respective display screens for interpupillary adjustments, as described above.

The various parts, systems, and assemblies shown in the exploded view of FIG. 1F are described in greater detail herein with reference to FIGS. 1B-1E as well as subsequent figures referenced in the present disclosure. The display unit 1-406 shown in FIG. 1F can be assembled and integrated with the securement mechanisms shown in FIGS. 1B-1E, including the electronic straps, bands, and other components including light seals, connection assemblies, and so forth.

Any of the features, components, and/or parts, including the arrangements and configurations thereof shown in FIG. 1F can be included, either alone or in any combination, in any of the other examples of devices, features, components, and parts shown in FIGS. 1B-1E and described herein. Likewise, any of the features, components, and/or parts, including the arrangements and configurations thereof shown and described with reference to FIGS. 1B-1E can be included, either alone or in any combination, in the example of the devices, features, components, and parts shown in FIG. 1F.

FIG. 1G illustrates a perspective, exploded view of a front cover assembly 3-100 of an HMD device described herein, for example the front cover assembly 3-1 of the HMD 3-100 shown in FIG. 1G or any other HMD device shown and described herein. The front cover assembly 3-100 shown in FIG. 1G can include a transparent or semi-transparent cover 3-102, shroud 3-104 (or “canopy”), adhesive layers 3-106, display assembly 3-108 including a lenticular lens panel or array 3-110, and a structural trim 3-112. The adhesive layer 3-106 can secure the shroud 3-104 and/or transparent cover 3-102 to the display assembly 3-108 and/or the trim 3-112. The trim 3-112 can secure the various components of the front cover assembly 3-100 to a frame or chassis of the HMD device.

In at least one example, as shown in FIG. 1G, the transparent cover 3-102, shroud 3-104, and display assembly 3-108, including the lenticular lens array 3-110, can be curved to accommodate the curvature of a user's face. The transparent cover 3-102 and the shroud 3-104 can be curved in two or three dimensions, e.g., vertically curved in the Z-direction in and out of the Z-X plane and horizontally curved in the X-direction in and out of the Z-X plane. In at least one example, the display assembly 3-108 can include the lenticular lens array 3-110 as well as a display panel having pixels configured to project light through the shroud 3-104 and the transparent cover 3-102. The display assembly 3-108 can be curved in at least one direction, for example the horizontal direction, to accommodate the curvature of a user's face from one side (e.g., left side) of the face to the other (e.g., right side). In at least one example, each layer or component of the display assembly 3-108, which will be shown in subsequent figures and described in more detail, but which can include the lenticular lens array 3-110 and a display layer, can be similarly or concentrically curved in the horizontal direction to accommodate the curvature of the user's face.

In at least one example, the shroud 3-104 can include a transparent or semi-transparent material through which the display assembly 3-108 projects light. In one example, the shroud 3-104 can include one or more opaque portions, for example opaque ink-printed portions or other opaque film portions on the rear surface of the shroud 3-104. The rear surface can be the surface of the shroud 3-104 facing the user's eyes when the HMD device is donned. In at least one example, opaque portions can be on the front surface of the shroud 3-104 opposite the rear surface. In at least one example, the opaque portion or portions of the shroud 3-104 can include perimeter portions visually hiding any components around an outside perimeter of the display screen of the display assembly 3-108. In this way, the opaque portions of the shroud hide any other components, including electronic components, structural components, and so forth, of the HMD device that would otherwise be visible through the transparent or semi-transparent cover 3-102 and/or shroud 3-104.

In at least one example, the shroud 3-104 can define one or more apertures transparent portions 3-120 through which sensors can send and receive signals. In one example, the portions 3-120 are apertures through which the sensors can extend or send and receive signals. In one example, the portions 3-120 are transparent portions, or portions more transparent than surrounding semi-transparent or opaque portions of the shroud, through which sensors can send and receive signals through the shroud and through the transparent cover 3-102. In one example, the sensors can include cameras, IR sensors, LUX sensors, or any other visual or non-visual environmental sensors of the HMD device.

Any of the features, components, and/or parts, including the arrangements and configurations thereof shown in FIG. 1G can be included, either alone or in any combination, in any of the other examples of devices, features, components, and parts described herein. Likewise, any of the features, components, and/or parts, including the arrangements and configurations thereof shown and described herein can be included, either alone or in any combination, in the example of the devices, features, components, and parts shown in FIG. 1G.

FIG. 1H illustrates an exploded view of an example of an HMD device 6-100. The HMD device 6-100 can include a sensor array or system 6-102 including one or more sensors, cameras, projectors, and so forth mounted to one or more components of the HMD 6-100. In at least one example, the sensor system 6-102 can include a bracket 1-338 on which one or more sensors of the sensor system 6-102 can be fixed/secured.

FIG. 1I illustrates a portion of an HMD device 6-100 including a front transparent cover 6-104 and a sensor system 6-102. The sensor system 6-102 can include a number of different sensors, emitters, receivers, including cameras, IR sensors, projectors, and so forth. The transparent cover 6-104 is illustrated in front of the sensor system 6-102 to illustrate relative positions of the various sensors and emitters as well as the orientation of each sensor/emitter of the system 6-102. As referenced herein, “sideways,” “side,” “lateral,” “horizontal,” and other similar terms refer to orientations or directions as indicated by the X-axis shown in FIG. 1J. Terms such as “vertical,” “up,” “down,” and similar terms refer to orientations or directions as indicated by the Z-axis shown in FIG. 1J. Terms such as “frontward,” “rearward,” “forward,” backward,” and similar terms refer to orientations or directions as indicated by the Y-axis shown in FIG. 1J.

In at least one example, the transparent cover 6-104 can define a front, external surface of the HMD device 6-100 and the sensor system 6-102, including the various sensors and components thereof, can be disposed behind the cover 6-104 in the Y-axis/direction. The cover 6-104 can be transparent or semi-transparent to allow light to pass through the cover 6-104, both light detected by the sensor system 6-102 and light emitted thereby.

As noted elsewhere herein, the HMD device 6-100 can include one or more controllers including processors for electrically coupling the various sensors and emitters of the sensor system 6-102 with one or more mother boards, processing units, and other electronic devices such as display screens and the like. In addition, as will be shown in more detail below with reference to other figures, the various sensors, emitters, and other components of the sensor system 6-102 can be coupled to various structural frame members, brackets, and so forth of the HMD device 6-100 not shown in FIG. 1I. FIG. 1I shows the components of the sensor system 6-102 unattached and un-coupled electrically from other components for the sake of illustrative clarity.

In at least one example, the device can include one or more controllers having processors configured to execute instructions stored on memory components electrically coupled to the processors. The instructions can include, or cause the processor to execute, one or more algorithms for self-correcting angles and positions of the various cameras described herein overtime with use as the initial positions, angles, or orientations of the cameras get bumped or deformed due to unintended drop events or other events.

In at least one example, the sensor system 6-102 can include one or more scene cameras 6-106. The system 6-102 can include two scene cameras 6-102 disposed on either side of the nasal bridge or arch of the HMD device 6-100 such that each of the two cameras 6-106 correspond generally in position with left and right eyes of the user behind the cover 6-103. In at least one example, the scene cameras 6-106 are oriented generally forward in the Y-direction to capture images in front of the user during use of the HMD 6-100. In at least one example, the scene cameras are color cameras and provide images and content for MR video pass through to the display screens facing the user's eyes when using the HMD device 6-100. The scene cameras 6-106 can also be used for environment and object reconstruction.

In at least one example, the sensor system 6-102 can include a first depth sensor 6-108 pointed generally forward in the Y-direction. In at least one example, the first depth sensor 6-108 can be used for environment and object reconstruction as well as user hand and body tracking. In at least one example, the sensor system 6-102 can include a second depth sensor 6-110 disposed centrally along the width (e.g., along the X-axis) of the HMD device 6-100. For example, the second depth sensor 6-110 can be disposed above the central nasal bridge or accommodating features over the nose of the user when donning the HMD 6-100. In at least one example, the second depth sensor 6-110 can be used for environment and object reconstruction as well as hand and body tracking. In at least one example, the second depth sensor can include a LIDAR sensor.

In at least one example, the sensor system 6-102 can include a depth projector 6-112 facing generally forward to project electromagnetic waves, for example in the form of a predetermined pattern of light dots, out into and within a field of view of the user and/or the scene cameras 6-106 or a field of view including and beyond the field of view of the user and/or scene cameras 6-106. In at least one example, the depth projector can project electromagnetic waves of light in the form of a dotted light pattern to be reflected off objects and back into the depth sensors noted above, including the depth sensors 6-108, 6-110. In at least one example, the depth projector 6-112 can be used for environment and object reconstruction as well as hand and body tracking.

In at least one example, the sensor system 6-102 can include downward facing cameras 6-114 with a field of view pointed generally downward relative to the HMD device 6-100 in the Z-axis. In at least one example, the downward cameras 6-114 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The downward cameras 6-114, for example, can be used to capture facial expressions and movements for the face of the user below the HMD device 6-100, including the cheeks, mouth, and chin.

In at least one example, the sensor system 6-102 can include jaw cameras 6-116. In at least one example, the jaw cameras 6-116 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The jaw cameras 6-116, for example, can be used to capture facial expressions and movements for the face of the user below the HMD device 6-100, including the user's jaw, cheeks, mouth, and chin.

In at least one example, the sensor system 6-102 can include side cameras 6-118. The side cameras 6-118 can be oriented to capture side views left and right in the X-axis or direction relative to the HMD device 6-100. In at least one example, the side cameras 6-118 can be used for hand and body tracking, headset tracking, and facial avatar detection and re-creation.

In at least one example, the sensor system 6-102 can include a plurality of eye tracking and gaze tracking sensors for determining an identity, status, and gaze direction of a user's eyes during and/or before use. In at least one example, the eye/gaze tracking sensors can include nasal eye cameras 6-120 disposed on either side of the user's nose and adjacent the user's nose when donning the HMD device 6-100. The eye/gaze sensors can also include bottom eye cameras 6-122 disposed below respective user eyes for capturing images of the eyes for facial avatar detection and creation, gaze tracking, and iris identification functions.

In at least one example, the sensor system 6-102 can include infrared illuminators 6-124 pointed outward from the HMD device 6-100 to illuminate the external environment and any object therein with IR light for IR detection with one or more IR sensors of the sensor system 6-102. In at least one example, the sensor system 6-102 can include a flicker sensor 6-126 and an ambient light sensor 6-128. In at least one example, the flicker sensor 6-126 can detect overhead light refresh rates to avoid display flicker. In one example, the infrared illuminators 6-124 can include light emitting diodes and can be used especially for low light environments for illuminating user hands and other objects in low light for detection by infrared sensors of the sensor system 6-102.

In at least one example, multiple sensors, including the scene cameras 6-106, the downward cameras 6-114, the jaw cameras 6-116, the side cameras 6-118, the depth projector 6-112, and the depth sensors 6-108, 6-110 can be used in combination with an electrically coupled controller to combine depth data with camera data for hand tracking and for size determination for better hand tracking and object recognition and tracking functions of the HMD device 6-100. In at least one example, the downward cameras 6-114, jaw cameras 6-116, and side cameras 6-118 described above and shown in FIG. 1I can be wide angle cameras operable in the visible and infrared spectrums. In at least one example, these cameras 6-114, 6-116, 6-118 can operate only in black and white light detection to simplify image processing and gain sensitivity.

Any of the features, components, and/or parts, including the arrangements and configurations thereof shown in FIG. 1I can be included, either alone or in any combination, in any of the other examples of devices, features, components, and parts shown in FIGS. 1J-1L and described herein. Likewise, any of the features, components, and/or parts, including the arrangements and configurations thereof shown and described with reference to FIGS. 1J-1L can be included, either alone or in any combination, in the example of the devices, features, components, and parts shown in FIG. 1I.

FIG. 1J illustrates a lower perspective view of an example of an HMD 6-200 including a cover or shroud 6-204 secured to a frame 6-230. In at least one example, the sensors 6-203 of the sensor system 6-202 can be disposed around a perimeter of the HMD 6-200 such that the sensors 6-203 are outwardly disposed around a perimeter of a display region or area 6-232 so as not to obstruct a view of the displayed light. In at least one example, the sensors can be disposed behind the shroud 6-204 and aligned with transparent portions of the shroud allowing sensors and projectors to allow light back and forth through the shroud 6-204. In at least one example, opaque ink or other opaque material or films/layers can be disposed on the shroud 6-204 around the display area 6-232 to hide components of the HMD 6-200 outside the display area 6-232 other than the transparent portions defined by the opaque portions, through which the sensors and projectors send and receive light and electromagnetic signals during operation. In at least one example, the shroud 6-204 allows light to pass therethrough from the display (e.g., within the display region 6-232) but not radially outward from the display region around the perimeter of the display and shroud 6-204.

In some examples, the shroud 6-204 includes a transparent portion 6-205 and an opaque portion 6-207, as described above and elsewhere herein. In at least one example, the opaque portion 6-207 of the shroud 6-204 can define one or more transparent regions 6-209 through which the sensors 6-203 of the sensor system 6-202 can send and receive signals. In the illustrated example, the sensors 6-203 of the sensor system 6-202 sending and receiving signals through the shroud 6-204, or more specifically through the transparent regions 6-209 of the (or defined by) the opaque portion 6-207 of the shroud 6-204 can include the same or similar sensors as those shown in the example of FIG. 1I, for example depth sensors 6-108 and 6-110, depth projector 6-112, first and second scene cameras 6-106, first and second downward cameras 6-114, first and second side cameras 6-118, and first and second infrared illuminators 6-124. These sensors are also shown in the examples of FIGS. 1K and 1L. Other sensors, sensor types, number of sensors, and relative positions thereof can be included in one or more other examples of HMDs.

Any of the features, components, and/or parts, including the arrangements and configurations thereof shown in FIG. 1J can be included, either alone or in any combination, in any of the other examples of devices, features, components, and parts shown in FIGS. 1I and 1K-1L and described herein. Likewise, any of the features, components, and/or parts, including the arrangements and configurations thereof shown and described with reference to FIGS. 1I and 1K-1L can be included, either alone or in any combination, in the example of the devices, features, components, and parts shown in FIG. 1J.

FIG. 1K illustrates a front view of a portion of an example of an HMD device 6-300 including a display 6-334, brackets 6-336, 6-338, and frame or housing 6-330. The example shown in FIG. 1K does not include a front cover or shroud in order to illustrate the brackets 6-336, 6-338. For example, the shroud 6-204 shown in FIG. 1J includes the opaque portion 6-207 that would visually cover/block a view of anything outside (e.g., radially/peripherally outside) the display/display region 6-334, including the sensors 6-303 and bracket 6-338.

In at least one example, the various sensors of the sensor system 6-302 are coupled to the brackets 6-336, 6-338. In at least one example, the scene cameras 6-306 include tight tolerances of angles relative to one another. For example, the tolerance of mounting angles between the two scene cameras 6-306 can be 0.5 degrees or less, for example 0.3 degrees or less. In order to achieve and maintain such a tight tolerance, in one example, the scene cameras 6-306 can be mounted to the bracket 6-338 and not the shroud. The bracket can include cantilevered arms on which the scene cameras 6-306 and other sensors of the sensor system 6-302 can be mounted to remain un-deformed in position and orientation in the case of a drop event by a user resulting in any deformation of the other bracket 6-226, housing 6-330, and/or shroud.

Any of the features, components, and/or parts, including the arrangements and configurations thereof shown in FIG. 1K can be included, either alone or in any combination, in any of the other examples of devices, features, components, and parts shown in FIGS. 1I-1J and 1L and described herein. Likewise, any of the features, components, and/or parts, including the arrangements and configurations thereof shown and described with reference to FIGS. 1I-1J and 1L can be included, either alone or in any combination, in the example of the devices, features, components, and parts shown in FIG. 1K.

FIG. 1L illustrates a bottom view of an example of an HMD 6-400 including a front display/cover assembly 6-404 and a sensor system 6-402. The sensor system 6-402 can be similar to other sensor systems described above and elsewhere herein, including in reference to FIGS. 1I-1K. In at least one example, the jaw cameras 6-416 can be facing downward to capture images of the user's lower facial features. In one example, the jaw cameras 6-416 can be coupled directly to the frame or housing 6-430 or one or more internal brackets directly coupled to the frame or housing 6-430 shown. The frame or housing 6-430 can include one or more apertures/openings 6-415 through which the jaw cameras 6-416 can send and receive signals.

Any of the features, components, and/or parts, including the arrangements and configurations thereof shown in FIG. 1L can be included, either alone or in any combination, in any of the other examples of devices, features, components, and parts shown in FIGS. 1I-1K and described herein. Likewise, any of the features, components, and/or parts, including the arrangements and configurations thereof shown and described with reference to FIGS. 1I-1K can be included, either alone or in any combination, in the example of the devices, features, components, and parts shown in FIG. 1L.

FIG. 1M illustrates a rear perspective view of an inter-pupillary distance (IPD) adjustment system 11.1.1-102 including first and second optical modules 11.1.1-104a-b slidably engaging/coupled to respective guide-rods 11.1.1-108a-b and motors 11.1.1-110a-b of left and right adjustment subsystems 11.1.1-106a-b. The IPD adjustment system 11.1.1-102 can be coupled to a bracket 11.1.1-112 and include a button 11.1.1-114 in electrical communication with the motors 11.1.1-110a-b. In at least one example, the button 11.1.1-114 can electrically communicate with the first and second motors 11.1.1-110a-b via a processor or other circuitry components to cause the first and second motors 11.1.1-110a-b to activate and cause the first and second optical modules 11.1.1-104a-b, respectively, to change position relative to one another.

In at least one example, the first and second optical modules 11.1.1-104a-b can include respective display screens configured to project light toward the user's eyes when donning the HMD 11.1.1-100. In at least one example, the user can manipulate (e.g., depress and/or rotate) the button 11.1.1-114 to activate a positional adjustment of the optical modules 11.1.1-104a-b to match the inter-pupillary distance of the user's eyes. The optical modules 11.1.1-104a-b can also include one or more cameras or other sensors/sensor systems for imaging and measuring the IPD of the user such that the optical modules 11.1.1-104a-b can be adjusted to match the IPD.

In one example, the user can manipulate the button 11.1.1-114 to cause an automatic positional adjustment of the first and second optical modules 11.1.1-104a-b. In one example, the user can manipulate the button 11.1.1-114 to cause a manual adjustment such that the optical modules 11.1.1-104a-b move further or closer away, for example when the user rotates the button 11.1.1-114 one way or the other, until the user visually matches her/his own IPD. In one example, the manual adjustment is electronically communicated via one or more circuits and power for the movements of the optical modules 11.1.1-104a-b via the motors 11.1.1-110a-b is provided by an electrical power source. In one example, the adjustment and movement of the optical modules 11.1.1-104a-b via a manipulation of the button 11.1.1-114 is mechanically actuated via the movement of the button 11.1.1-114.

Any of the features, components, and/or parts, including the arrangements and configurations thereof shown in FIG. 1M can be included, either alone or in any combination, in any of the other examples of devices, features, components, and parts shown in any other figures shown and described herein. Likewise, any of the features, components, and/or parts, including the arrangements and configurations thereof shown and described with reference to any other figure shown and described herein, either alone or in any combination, in the example of the devices, features, components, and parts shown in FIG. 1M.

FIG. 1N illustrates a front perspective view of a portion of an HMD 11.1.2-100, including an outer structural frame 11.1.2-102 and an inner or intermediate structural frame 11.1.2-104 defining first and second apertures 11.1.2-106a, 11.1.2-106b. The apertures 11.1.2-106a-b are shown in dotted lines in FIG. 1N because a view of the apertures 11.1.2-106a-b can be blocked by one or more other components of the HMD 11.1.2-100 coupled to the inner frame 11.1.2-104 and/or the outer frame 11.1.2-102, as shown. In at least one example, the HMD 11.1.2-100 can include a first mounting bracket 11.1.2-108 coupled to the inner frame 11.1.2-104. In at least one example, the mounting bracket 11.1.2-108 is coupled to the inner frame 11.1.2-104 between the first and second apertures 11.1.2-106a-b.

The mounting bracket 11.1.2-108 can include a middle or central portion 11.1.2-109 coupled to the inner frame 11.1.2-104. In some examples, the middle or central portion 11.1.2-109 may not be the geometric middle or center of the bracket 11.1.2-108. Rather, the middle/central portion 11.1.2-109 can be disposed between first and second cantilevered extension arms extending away from the middle portion 11.1.2-109. In at least one example, the mounting bracket 108 includes a first cantilever arm 11.1.2-112 and a second cantilever arm 11.1.2-114 extending away from the middle portion 11.1.2-109 of the mount bracket 11.1.2-108 coupled to the inner frame 11.1.2-104.

As shown in FIG. 1N, the outer frame 11.1.2-102 can define a curved geometry on a lower side thereof to accommodate a user's nose when the user dons the HMD 11.1.2-100. The curved geometry can be referred to as a nose bridge 11.1.2-111 and be centrally located on a lower side of the HMD 11.1.2-100 as shown. In at least one example, the mounting bracket 11.1.2-108 can be connected to the inner frame 11.1.2-104 between the apertures 11.1.2-106a-b such that the cantilevered arms 11.1.2-112, 11.1.2-114 extend downward and laterally outward away from the middle portion 11.1.2-109 to compliment the nose bridge 11.1.2-111 geometry of the outer frame 11.1.2-102. In this way, the mounting bracket 11.1.2-108 is configured to accommodate the user's nose as noted above. The nose bridge 11.1.2-111 geometry accommodates the nose in that the nose bridge 11.1.2-111 provides a curvature that curves with, above, over, and around the user's nose for comfort and fit.

The first cantilever arm 11.1.2-112 can extend away from the middle portion 11.1.2-109 of the mounting bracket 11.1.2-108 in a first direction and the second cantilever arm 11.1.2-114 can extend away from the middle portion 11.1.2-109 of the mounting bracket 11.1.2-10 in a second direction opposite the first direction. The first and second cantilever arms 11.1.2-112, 11.1.2-114 are referred to as “cantilevered” or “cantilever” arms because each arm 11.1.2-112, 11.1.2-114, includes a distal free end 11.1.2-116, 11.1.2-118, respectively, which are free of affixation from the inner and outer frames 11.1.2-102, 11.1.2-104. In this way, the arms 11.1.2-112, 11.1.2-114 are cantilevered from the middle portion 11.1.2-109, which can be connected to the inner frame 11.1.2-104, with distal ends 11.1.2-102, 11.1.2-104 unattached.

In at least one example, the HMD 11.1.2-100 can include one or more components coupled to the mounting bracket 11.1.2-108. In one example, the components include a plurality of sensors 11.1.2-110a-f. Each sensor of the plurality of sensors 11.1.2-110a-f can include various types of sensors, including cameras, IR sensors, and so forth. In some examples, one or more of the sensors 11.1.2-110a-f can be used for object recognition in three-dimensional space such that it is important to maintain a precise relative position of two or more of the plurality of sensors 11.1.2-110a-f. The cantilevered nature of the mounting bracket 11.1.2-108 can protect the sensors 11.1.2-110a-f from damage and altered positioning in the case of accidental drops by the user. Because the sensors 11.1.2-110a-f are cantilevered on the arms 11.1.2-112, 11.1.2-114 of the mounting bracket 11.1.2-108, stresses and deformations of the inner and/or outer frames 11.1.2-104, 11.1.2-102 are not transferred to the cantilevered arms 11.1.2-112, 11.1.2-114 and thus do not affect the relative positioning of the sensors 11.1.2-110a-f coupled/mounted to the mounting bracket 11.1.2-108.

Any of the features, components, and/or parts, including the arrangements and configurations thereof shown in FIG. 1N can be included, either alone or in any combination, in any of the other examples of devices, features, components, and described herein. Likewise, any of the features, components, and/or parts, including the arrangements and configurations thereof shown and described herein can be included, either alone or in any combination, in the example of the devices, features, components, and parts shown in FIG. 1N.

FIG. 1O illustrates an example of an optical module 11.3.2-100 for use in an electronic device such as an HMD, including HMD devices described herein. As shown in one or more other examples described herein, the optical module 11.3.2-100 can be one of two optical modules within an HMD, with each optical module aligned to project light toward a user's eye. In this way, a first optical module can project light via a display screen toward a user's first eye and a second optical module of the same device can project light via another display screen toward the user's second eye.

In at least one example, the optical module 11.3.2-100 can include an optical frame or housing 11.3.2-102, which can also be referred to as a barrel or optical module barrel. The optical module 11.3.2-100 can also include a display 11.3.2-104, including a display screen or multiple display screens, coupled to the housing 11.3.2-102. The display 11.3.2-104 can be coupled to the housing 11.3.2-102 such that the display 11.3.2-104 is configured to project light toward the eye of a user when the HMD of which the display module 11.3.2-100 is a part is donned during use. In at least one example, the housing 11.3.2-102 can surround the display 11.3.2-104 and provide connection features for coupling other components of optical modules described herein.

In one example, the optical module 11.3.2-100 can include one or more cameras 11.3.2-106 coupled to the housing 11.3.2-102. The camera 11.3.2-106 can be positioned relative to the display 11.3.2-104 and housing 11.3.2-102 such that the camera 11.3.2-106 is configured to capture one or more images of the user's eye during use. In at least one example, the optical module 11.3.2-100 can also include a light strip 11.3.2-108 surrounding the display 11.3.2-104. In one example, the light strip 11.3.2-108 is disposed between the display 11.3.2-104 and the camera 11.3.2-106. The light strip 11.3.2-108 can include a plurality of lights 11.3.2-110. The plurality of lights can include one or more light emitting diodes (LEDs) or other lights configured to project light toward the user's eye when the HMD is donned. The individual lights 11.3.2-110 of the light strip 11.3.2-108 can be spaced about the strip 11.3.2-108 and thus spaced about the display 11.3.2-104 uniformly or non-uniformly at various locations on the strip 11.3.2-108 and around the display 11.3.2-104.

In at least one example, the housing 11.3.2-102 defines a viewing opening 11.3.2-101 through which the user can view the display 11.3.2-104 when the HMD device is donned. In at least one example, the LEDs are configured and arranged to emit light through the viewing opening 11.3.2-101 and onto the user's eye. In one example, the camera 11.3.2-106 is configured to capture one or more images of the user's eye through the viewing opening 11.3.2-101.

As noted above, each of the components and features of the optical module 11.3.2-100 shown in FIG. 1O can be replicated in another (e.g., second) optical module disposed with the HMD to interact (e.g., project light and capture images) of another eye of the user.

Any of the features, components, and/or parts, including the arrangements and configurations thereof shown in FIG. 1O can be included, either alone or in any combination, in any of the other examples of devices, features, components, and parts shown in FIG. 1P or otherwise described herein. Likewise, any of the features, components, and/or parts, including the arrangements and configurations thereof shown and described with reference to FIG. 1P or otherwise described herein can be included, either alone or in any combination, in the example of the devices, features, components, and parts shown in FIG. 1O.

FIG. 1P illustrates a cross-sectional view of an example of an optical module 11.3.2-200 including a housing 11.3.2-202, display assembly 11.3.2-204 coupled to the housing 11.3.2-202, and a lens 11.3.2-216 coupled to the housing 11.3.2-202. In at least one example, the housing 11.3.2-202 defines a first aperture or channel 11.3.2-212 and a second aperture or channel 11.3.2-214. The channels 11.3.2-212, 11.3.2-214 can be configured to slidably engage respective rails or guide rods of an HMD device to allow the optical module 11.3.2-200 to adjust in position relative to the user's eyes for match the user's interpapillary distance (IPD). The housing 11.3.2-202 can slidably engage the guide rods to secure the optical module 11.3.2-200 in place within the HMD.

In at least one example, the optical module 11.3.2-200 can also include a lens 11.3.2-216 coupled to the housing 11.3.2-202 and disposed between the display assembly 11.3.2-204 and the user's eyes when the HMD is donned. The lens 11.3.2-216 can be configured to direct light from the display assembly 11.3.2-204 to the user's eye. In at least one example, the lens 11.3.2-216 can be a part of a lens assembly including a corrective lens removably attached to the optical module 11.3.2-200. In at least one example, the lens 11.3.2-216 is disposed over the light strip 11.3.2-208 and the one or more eye-tracking cameras 11.3.2-206 such that the camera 11.3.2-206 is configured to capture images of the user's eye through the lens 11.3.2-216 and the light strip 11.3.2-208 includes lights configured to project light through the lens 11.3.2-216 to the users' eye during use.

Any of the features, components, and/or parts, including the arrangements and configurations thereof shown in FIG. 1P can be included, either alone or in any combination, in any of the other examples of devices, features, components, and parts and described herein. Likewise, any of the features, components, and/or parts, including the arrangements and configurations thereof shown and described herein can be included, either alone or in any combination, in the example of the devices, features, components, and parts shown in FIG. 1P.

FIG. 2 is a block diagram of an example of the controller 110 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments, the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some embodiments, the one or more communication buses 204 include circuitry that interconnects and controls communications between system components. In some embodiments, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some embodiments, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some embodiments, the memory 220 or the non-transitory computer readable storage medium of the memory 220 stores the following programs, modules and data structures, or a subset thereof including an optional operating system 230 and an XR experience module 240.

The operating system 230 includes instructions for handling various basic system services and for performing hardware dependent tasks. In some embodiments, the XR experience module 240 is configured to manage and coordinate one or more XR experiences for one or more users (e.g., a single XR experience for one or more users, or multiple XR experiences for respective groups of one or more users). To that end, in various embodiments, the XR experience module 240 includes a data obtaining unit 242, a tracking unit 244, a coordination unit 246, and a data transmitting unit 248.

In some embodiments, the data obtaining unit 242 is configured to obtain data (e.g., presentation data, interaction data, sensor data, location data, etc.) from at least the display generation component 120 of FIG. 1A, and optionally one or more of the input devices 125, output devices 155, sensors 190, and/or peripheral devices 195. To that end, in various embodiments, the data obtaining unit 242 includes instructions and/or logic therefor, and heuristics and metadata therefor.

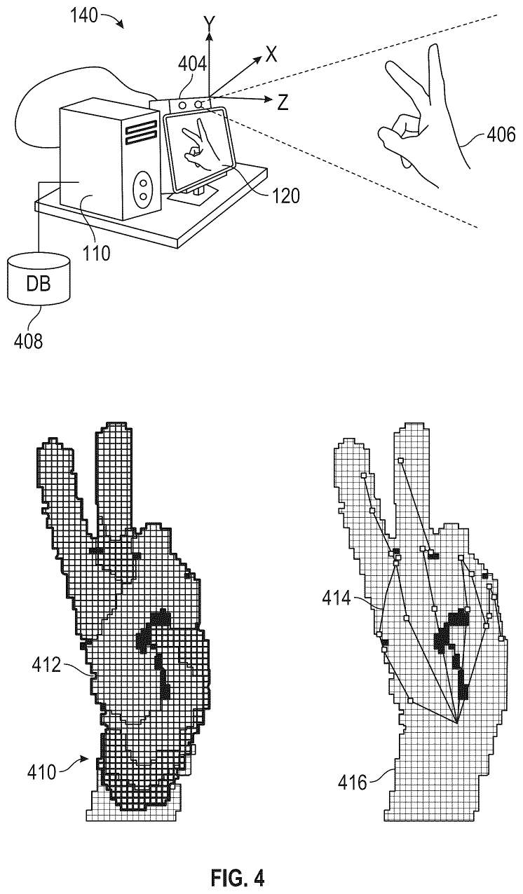

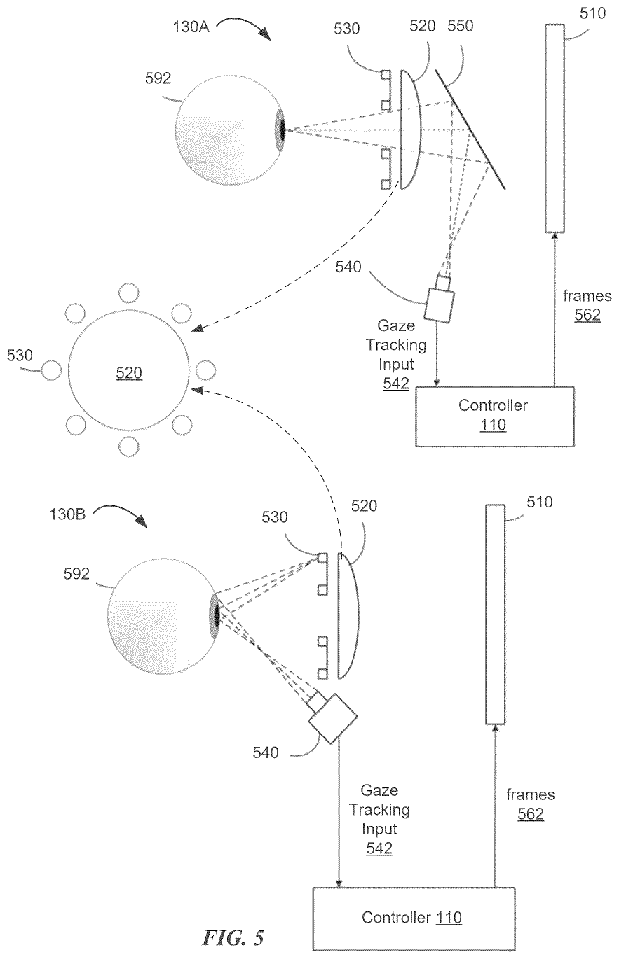

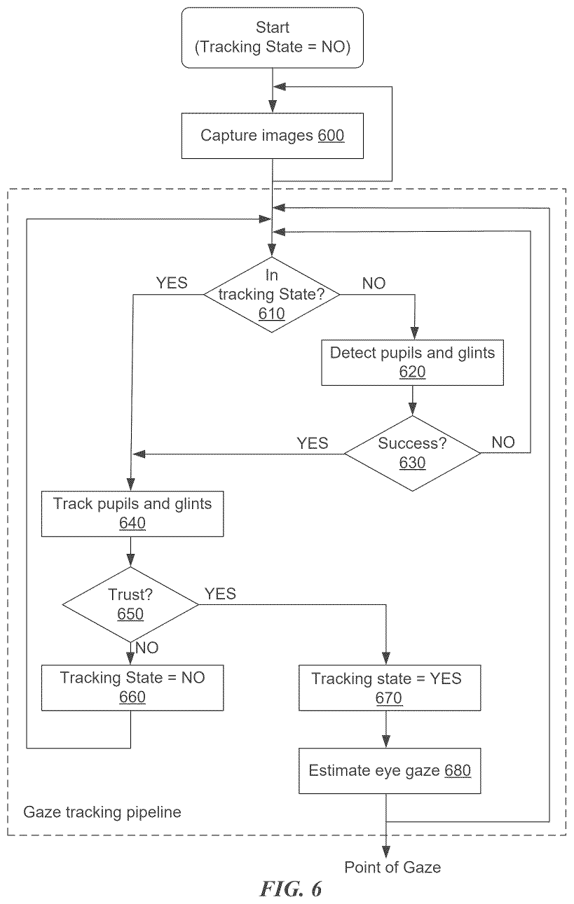

In some embodiments, the tracking unit 244 is configured to map the scene 105 and to track the position/location of at least the display generation component 120 with respect to the scene 105 of FIG. 1A, and optionally, to one or more of the input devices 125, output devices 155, sensors 190, and/or peripheral devices 195. To that end, in various embodiments, the tracking unit 244 includes instructions and/or logic therefor, and heuristics and metadata therefor. In some embodiments, the tracking unit 244 includes hand tracking unit 245 and/or eye tracking unit 243. In some embodiments, the hand tracking unit 245 is configured to track the position/location of one or more portions of the user's hands, and/or motions of one or more portions of the user's hands with respect to the scene 105 of FIG. 1A, relative to the display generation component 120, and/or relative to a coordinate system defined relative to the user's hand. The hand tracking unit 245 is described in greater detail below with respect to FIG. 4. In some embodiments, the eye tracking unit 243 is configured to track the position and movement of the user's gaze (or more broadly, the user's eyes, face, or head) with respect to the scene 105 (e.g., with respect to the physical environment and/or to the user (e.g., the user's hand)) or with respect to the XR content displayed via the display generation component 120. The eye tracking unit 243 is described in greater detail below with respect to FIG. 5.

In some embodiments, the coordination unit 246 is configured to manage and coordinate the XR experience presented to the user by the display generation component 120, and optionally, by one or more of the output devices 155 and/or peripheral devices 195. To that end, in various embodiments, the coordination unit 246 includes instructions and/or logic therefor, and heuristics and metadata therefor.

In some embodiments, the data transmitting unit 248 is configured to transmit data (e.g., presentation data, location data, etc.) to at least the display generation component 120, and optionally, to one or more of the input devices 125, output devices 155, sensors 190, and/or peripheral devices 195. To that end, in various embodiments, the data transmitting unit 248 includes instructions and/or logic therefor, and heuristics and metadata therefor.

Although the data obtaining unit 242, the tracking unit 244 (e.g., including the eye tracking unit 243 and the hand tracking unit 245), the coordination unit 246, and the data transmitting unit 248 are shown as residing on a single device (e.g., the controller 110), it should be understood that in other embodiments, any combination of the data obtaining unit 242, the tracking unit 244 (e.g., including the eye tracking unit 243 and the hand tracking unit 245), the coordination unit 246, and the data transmitting unit 248 may be located in separate computing devices.

Moreover, FIG. 2 is intended more as functional description of the various features that may be present in a particular implementation as opposed to a structural schematic of the embodiments described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 3A is a block diagram of an example of the display generation component 120 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the display generation component 120 (e.g., HMD) includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior- and/or exterior-facing image sensors 314, a memory 320, and one or more communication buses 304 for interconnecting these and various other components.

In some embodiments, the one or more communication buses 304 include circuitry that interconnects and controls communications between system components. In some embodiments, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some embodiments, the one or more XR displays 312 are configured to provide the XR experience to the user. In some embodiments, the one or more XR displays 312 correspond to holographic, digital light processing (DLP), liquid-crystal display (LCD), liquid-crystal on silicon (LCoS), organic light-emitting field-effect transistor (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some embodiments, the one or more XR displays 312 correspond to diffractive, reflective, polarized, holographic, etc. waveguide displays. For example, the display generation component 120 (e.g., HMD) includes a single XR display. In another example, the display generation component 120 includes an XR display for each eye of the user. In some embodiments, the one or more XR displays 312 are capable of presenting MR and VR content. In some embodiments, the one or more XR displays 312 are capable of presenting MR or VR content.

In some embodiments, the one or more image sensors 314 are configured to obtain image data that corresponds to at least a portion of the face of the user that includes the eyes of the user (and may be referred to as an eye-tracking camera). In some embodiments, the one or more image sensors 314 are configured to obtain image data that corresponds to at least a portion of the user's hand(s) and optionally arm(s) of the user (and may be referred to as a hand-tracking camera). In some embodiments, the one or more image sensors 314 are configured to be forward-facing so as to obtain image data that corresponds to the scene as would be viewed by the user if the display generation component 120 (e.g., HMD) was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some embodiments, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some embodiments, the memory 320 or the non-transitory computer readable storage medium of the memory 320 stores the following programs, modules and data structures, or a subset thereof including an optional operating system 330 and an XR presentation module 340.

The operating system 330 includes instructions for handling various basic system services and for performing hardware dependent tasks. In some embodiments, the XR presentation module 340 is configured to present XR content to the user via the one or more XR displays 312. To that end, in various embodiments, the XR presentation module 340 includes a data obtaining unit 342, an XR presenting unit 344, an XR map generating unit 346, and a data transmitting unit 348.

In some embodiments, the data obtaining unit 342 is configured to obtain data (e.g., presentation data, interaction data, sensor data, location data, etc.) from at least the controller 110 of FIG. 1A. To that end, in various embodiments, the data obtaining unit 342 includes instructions and/or logic therefor, and heuristics and metadata therefor.

In some embodiments, the XR presenting unit 344 is configured to present XR content via the one or more XR displays 312. To that end, in various embodiments, the XR presenting unit 344 includes instructions and/or logic therefor, and heuristics and metadata therefor.

In some embodiments, the XR map generating unit 346 is configured to generate an XR map (e.g., a 3D map of the mixed reality scene or a map of the physical environment into which computer-generated objects can be placed to generate the extended reality) based on media content data. To that end, in various embodiments, the XR map generating unit 346 includes instructions and/or logic therefor, and heuristics and metadata therefor.

In some embodiments, the data transmitting unit 348 is configured to transmit data (e.g., presentation data, location data, etc.) to at least the controller 110, and optionally one or more of the input devices 125, output devices 155, sensors 190, and/or peripheral devices 195. To that end, in various embodiments, the data transmitting unit 348 includes instructions and/or logic therefor, and heuristics and metadata therefor.

Although the data obtaining unit 342, the XR presenting unit 344, the XR map generating unit 346, and the data transmitting unit 348 are shown as residing on a single device (e.g., the display generation component 120 of FIG. 1A), it should be understood that in other embodiments, any combination of the data obtaining unit 342, the XR presenting unit 344, the XR map generating unit 346, and the data transmitting unit 348 may be located in separate computing devices.

Moreover, FIG. 3A is intended more as a functional description of the various features that could be present in a particular implementation as opposed to a structural schematic of the embodiments described herein. As recognized by those of ordinary skill in the art, items shown separately could be combined and some items could be separated. For example, some functional modules shown separately in FIG. 3A could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

Implementations within the scope of the present disclosure can be partially or entirely realized using a tangible computer-readable storage medium (or multiple tangible computer-readable storage media of one or more types) encoding one or more computer-executable instructions. It should be recognized that computer-executable instructions can be organized in any format, including applications, widgets, processes, software (e.g., one or more computer programs), and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a communications network, and/or read from a storage device).

Referring to FIG. 3B, FIG. 3D, and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) to which information is provided is an operating system hosted on device 3150. In some embodiments, the system (e.g., 3110 shown in FIG. 3E) is an external device (e.g., a server, a peripheral device, an accessory, and/or a personal computing device) that includes an operating system that includes one or more system processes.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190. FIG. 3E) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-executable instructions) that provides an interface that allows a different module (e.g., API-calling module 3180) to communicate with a system process to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and accessed using API 3190 or uses data types or objects defined in the SDK library and provided by (or accessed using) API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component of device 3150.

In some embodiments, API 3190 allows a developer of API-calling module 3180 (which can be a third-party developer) to leverage a feature provided by implementation module 3100. In such embodiments, there can be one or more API calling modules (e.g., including API-calling module 3180) that communicate with implementation module 3100. In some embodiments, API 3190 allows multiple API calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system, and/or server system) software module (e.g., a collection of computer-executable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure of API 3190.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide the first set of functions, or a subset of the first set of functions, and also provide another set of functions, such as testing or debugging functions which are not in the first set of functions. In some embodiments, implementation module 3100 calls one or more other components via an underlying API and thus is both an API calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a communications network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected, the direct sensor data (e.g., data representing or corresponding to detection of the input) is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls made between steps of interacting with the computer system (e.g., API calls between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform method 10000 (e.g., as discussed herein with respect to FIGS. 10A-10M), method 11000 (e.g., as discussed herein with respect to FIGS. 11A-11K), and/or method 12000 (e.g., as discussed herein with respect to FIG. 12) by calling an application programming interface (API) provided by the system process using one or more parameters.

In some embodiments, example APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, a contact transfer API, a photos API, a camera API, and/or an image processing API.

In some embodiments, at least one API is a software module (e.g., a collection of computer-executable instructions) that provides an interface that allows a different module (e.g., an API calling module) to access and use one or more functions, methods, procedures, data structures, classes, and/or other services provided by an implementation module of the system process. The API can define one or more parameters that are passed between the API calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

FIG. 4 is a schematic, pictorial illustration of an example embodiment of the hand tracking device 140. In some embodiments, hand tracking device 140 (e.g., in FIG. 1A) is controlled by hand tracking unit 245 (e.g., in FIG. 2) to track the position/location of one or more portions of the user's hands, and/or motions of one or more portions of the user's hands with respect to the scene 105 of FIG. 1A (e.g., with respect to a portion of the physical environment surrounding the user, with respect to the display generation component 120, or with respect to a portion of the user (e.g., the user's face, eyes, or head), and/or relative to a coordinate system defined relative to the user's hand. In some embodiments, the hand tracking device 140 is part of the display generation component 120 (e.g., embedded in or attached to a head-mounted device). In some embodiments, the hand tracking device 140 is separate from the display generation component 120 (e.g., located in separate housings or attached to separate physical support structures).

In some embodiments, the hand tracking device 140 includes image sensors 404 (e.g., one or more IR cameras, 3D cameras, depth cameras, and/or color cameras, etc.) that capture three-dimensional scene information that includes at least a hand 406 of a human user. The image sensors 404 capture the hand images with sufficient resolution to enable the fingers and their respective positions to be distinguished. The image sensors 404 typically capture images of other parts of the user's body, as well, or possibly all of the body, and may have either zoom capabilities or a dedicated sensor with enhanced magnification to capture images of the hand with the desired resolution. In some embodiments, the image sensors 404 also capture 2D color video images of the hand 406 and other elements of the scene. In some embodiments, the image sensors 404 are used in conjunction with other image sensors to capture the physical environment of the scene 105, or serve as the image sensors that capture the physical environment of the scene 105. In some embodiments, the image sensors 404 are positioned relative to the user or the user's environment in a way that a field of view of the image sensors or a portion thereof is used to define an interaction space in which hand movement captured by the image sensors are treated as inputs to the controller 110.

In some embodiments, the image sensors 404 output a sequence of frames containing 3D map data (and possibly color image data, as well) to the controller 110, which extracts high-level information from the map data. This high-level information is typically provided via an Application Program Interface (API) to an application running on the controller, which drives the display generation component 120 accordingly. For example, the user may interact with software running on the controller 110 by moving their hand 406 and/or changing their hand posture.

In some embodiments, the image sensors 404 project a pattern of spots onto a scene containing the hand 406 and capture an image of the projected pattern. In some embodiments, the controller 110 computes the 3D coordinates of points in the scene (including points on the surface of the user's hand) by triangulation, based on transverse shifts of the spots in the pattern. This approach is advantageous in that it does not require the user to hold or wear any sort of beacon, sensor, or other marker. It gives the depth coordinates of points in the scene relative to a predetermined reference plane, at a certain distance from the image sensors 404. In the present disclosure, the image sensors 404 are assumed to define an orthogonal set of x, y, z axes, so that depth coordinates of points in the scene correspond to z components measured by the image sensors. Alternatively, the image sensors 404 (e.g., a hand tracking device) may use other methods of 3D mapping, such as stereoscopic imaging or time-of-flight measurements, based on single or multiple cameras or other types of sensors.

In some embodiments, the hand tracking device 140 captures and processes a temporal sequence of depth maps containing the user's hand, while the user moves their hand (e.g., whole hand or one or more fingers). Software running on a processor in the image sensors 404 and/or the controller 110 processes the 3D map data to extract patch descriptors of the hand in these depth maps. The software matches these descriptors to patch descriptors stored in a database 408, based on a prior learning process, in order to estimate the pose of the hand in each frame. The pose typically includes 3D locations of the user's hand joints and fingertips.

The software may also analyze the trajectory of the hands and/or fingers over multiple frames in the sequence in order to identify gestures. The pose estimation functions described herein may be interleaved with motion tracking functions, so that patch-based pose estimation is performed only once in every two (or more) frames, while tracking is used to find changes in the pose that occur over the remaining frames. The pose, motion, and gesture information are provided via the above-mentioned API to an application program running on the controller 110. This program may, for example, move and modify images presented on the display generation component 120, or perform other functions, in response to the pose and/or gesture information.

In some embodiments, a gesture includes an air gesture. An air gesture is a gesture that is detected without the user touching (or independently of) an input element that is part of a device (e.g., computer system 101, one or more input device 125, and/or hand tracking device 140) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, input gestures used in the various examples and embodiments described herein include air gestures performed by movement of the user's finger(s) relative to other finger(s) or part(s) of the user's hand) for interacting with an XR environment (e.g., a virtual or mixed-reality environment), in accordance with some embodiments. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., gaze) to determine the target of the user input (e.g., for direct inputs, as described below). Thus, in implementations involving air gestures, the input gesture is, for example, detected attention (e.g., gaze) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in accordance with performing the input gesture with the user's hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user's hand is not at the position that corresponds to the position of the user interface object in the three-dimensional environment while detecting the user's attention (e.g., gaze) on the user interface object. For example, for direct input gesture, the user is enabled to direct the user's input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user's input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in accordance with some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to make contact with one another, that is, optionally, followed by an immediate (e.g., within 0-1 seconds) break in contact from each other. A long pinch gesture that is an air gesture includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture (e.g., an air drag gesture or an air swipe gesture) includes a pinch gesture (e.g., a pinch gesture or a long pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand. In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture is performed using a first hand of the user (e.g., a pinch input, a long pinch input, or a pinch and drag input), and, in conjunction with performing the pinch input using the first hand, a second pinch input is performed using the other hand (e.g., the second hand of the user's two hands). In some embodiments, movement between the user's two hands is performed (e.g., to increase and/or decrease a distance or relative orientation between the user's two hands).

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

In some embodiments, attention of a user is determined to be directed to a portion of the three-dimensional environment based on detection of gaze directed to the portion of the three-dimensional environment (optionally, without requiring other conditions). In some embodiments, attention of a user is determined to be directed to a portion of the three-dimensional environment based on detection of gaze directed to the portion of the three-dimensional environment with one or more additional conditions such as requiring that gaze is directed to the portion of the three-dimensional environment for at least a threshold duration (e.g., a dwell duration) and/or requiring that the gaze is directed to the portion of the three-dimensional environment while the viewpoint of the user is within a distance threshold from the portion of the three-dimensional environment in order for the device to determine that attention of the user is directed to the portion of the three-dimensional environment, where if one of the additional conditions is not met, the device determines that attention is not directed to the portion of the three-dimensional environment toward which gaze is directed (e.g., until the one or more additional conditions are met).

In some embodiments, the detection of a ready state configuration of a user or a portion of a user is detected by the computer system. Detection of a ready state configuration of a hand is used by a computer system as an indication that the user is likely preparing to interact with the computer system using one or more air gesture inputs performed by the hand (e.g., a pinch, tap, pinch and drag, double pinch, long pinch, or other air gesture described herein). For example, the ready state of the hand is determined based on whether the hand has a predetermined hand shape (e.g., a pre-pinch shape with a thumb and one or more fingers extended and spaced apart ready to make a pinch or grab gesture or a pre-tap with one or more fingers extended and palm facing away from the user), based on whether the hand is in a predetermined position relative to a viewpoint of the user (e.g., below the user's head and above the user's waist and extended out from the body by at least 15, 20, 25, 30, or 50 cm), and/or based on whether the hand has moved in a particular manner (e.g., moved toward a region in front of the user above the user's waist and below the user's head or moved away from the user's body or leg). In some embodiments, the ready state is used to determine whether interactive elements of the user interface respond to attention (e.g., gaze) inputs.

In scenarios where inputs are described with reference to air gestures, it should be understood that similar gestures could be detected using a hardware input device that is attached to or held by one or more hands of a user, where the position of the hardware input device in space can be tracked using optical tracking, one or more accelerometers, one or more gyroscopes, one or more magnetometers, and/or one or more inertial measurement units and the position and/or movement of the hardware input device is used in place of the position and/or movement of the one or more hands in the corresponding air gesture(s). In scenarios where inputs are described with reference to air gestures, it should be understood that similar gestures could be detected using a hardware input device that is attached to or held by one or more hands of a user. User inputs can be detected with controls contained in the hardware input device such as one or more touch-sensitive input elements, one or more pressure-sensitive input elements, one or more buttons, one or more knobs, one or more dials, one or more joysticks, one or more hand or finger coverings that can detect a position or change in position of portions of a hand and/or fingers relative to each other, relative to the user's body, and/or relative to a physical environment of the user, and/or other hardware input device controls, where the user inputs with the controls contained in the hardware input device are used in place of hand and/or finger gestures such as air taps or air pinches in the corresponding air gesture(s). For example, a selection input that is described as being performed with an air tap or air pinch input could be alternatively detected with a button press, a tap on a touch-sensitive surface, a press on a pressure-sensitive surface, or other hardware input. As another example, a movement input that is described as being performed with an air pinch and drag (e.g., an air drag gesture or an air swipe gesture) could be alternatively detected based on an interaction with the hardware input control such as a button press and hold, a touch on a touch-sensitive surface, a press on a pressure-sensitive surface, or other hardware input that is followed by movement of the hardware input device (e.g., along with the hand with which the hardware input device is associated) through space. Similarly, a two-handed input that includes movement of the hands relative to each other could be performed with one air gesture and one hardware input device in the hand that is not performing the air gesture, two hardware input devices held in different hands, or two air gestures performed by different hands using various combinations of air gestures and/or the inputs detected by one or more hardware input devices that are described above.

In some embodiments, the software may be downloaded to the controller 110 in electronic form, over a network, for example, or it may alternatively be provided on tangible, non-transitory media, such as optical, magnetic, or electronic memory media. In some embodiments, the database 408 is likewise stored in a memory associated with the controller 110. Alternatively or additionally, some or all of the described functions of the computer may be implemented in dedicated hardware, such as a custom or semi-custom integrated circuit or a programmable digital signal processor (DSP). Although the controller 110 is shown in FIG. 4, by way of example, as a separate unit from the image sensors 404, some or all of the processing functions of the controller may be performed by a suitable microprocessor and software or by dedicated circuitry within the housing of the image sensors 404 (e.g., a hand tracking device) or otherwise associated with the image sensors 404. In some embodiments, at least some of these processing functions may be carried out by a suitable processor that is integrated with the display generation component 120 (e.g., in a television set, a handheld device, or head-mounted device, for example) or with any other suitable computerized device, such as a game console or media player. The sensing functions of image sensors 404 may likewise be integrated into the computer or other computerized apparatus that is to be controlled by the sensor output.

FIG. 4 further includes a schematic representation of a depth map 410 captured by the image sensors 404, in accordance with some embodiments. The depth map, as explained above, comprises a matrix of pixels having respective depth values. The pixels 412 corresponding to the hand 406 have been segmented out from the background and the wrist in this map. The brightness of each pixel within the depth map 410 corresponds inversely to its depth value, i.e., the measured z distance from the image sensors 404, with the shade of gray growing darker with increasing depth. The controller 110 processes these depth values in order to identify and segment a component of the image (i.e., a group of neighboring pixels) having characteristics of a human hand. These characteristics, may include, for example, overall size, shape and motion from frame to frame of the sequence of depth maps.

FIG. 4 also schematically illustrates a hand skeleton 414 that controller 110 ultimately extracts from the depth map 410 of the hand 406, in accordance with some embodiments. In FIG. 4, the hand skeleton 414 is superimposed on a hand background 416 that has been segmented from the original depth map. In some embodiments, key feature points of the hand (e.g., points corresponding to knuckles, fingertips, center of the palm, end of the hand connecting to wrist, etc.) and optionally on the wrist or arm connected to the hand are identified and located on the hand skeleton 414. In some embodiments, location and movements of these key feature points over multiple image frames are used by the controller 110 to determine the hand gestures performed by the hand or the current state of the hand, in accordance with some embodiments.

FIG. 5 illustrates an example embodiment of the eye tracking device 130 (e.g., in FIG. 1A). In some embodiments, the eye tracking device 130 is controlled by the eye tracking unit 243 (e.g., in FIG. 2) to track the position and movement of the user's gaze with respect to the scene 105 or with respect to the XR content displayed via the display generation component 120. In some embodiments, the eye tracking device 130 is integrated with the display generation component 120. For example, in some embodiments, when the display generation component 120 is a head-mounted device such as headset, helmet, goggles, or glasses, or a handheld device placed in a wearable frame, the head-mounted device includes both a component that generates the XR content for viewing by the user and a component for tracking the gaze of the user relative to the XR content. In some embodiments, the eye tracking device 130 is separate from the display generation component 120. For example, when display generation component is a handheld device or an XR chamber, the eye tracking device 130 is optionally a separate device from the handheld device or XR chamber. In some embodiments, the eye tracking device 130 is a head-mounted device or part of a head-mounted device. In some embodiments, the head-mounted eye-tracking device 130 is optionally used in conjunction with a display generation component that is also head-mounted, or a display generation component that is not head-mounted. In some embodiments, the eye tracking device 130 is not a head-mounted device, and is optionally used in conjunction with a head-mounted display generation component. In some embodiments, the eye tracking device 130 is not a head-mounted device, and is optionally part of a non-head-mounted display generation component.

In some embodiments, the display generation component 120 uses a display mechanism (e.g., left and right near-eye display panels) for displaying frames including left and right images in front of a user's eyes to thus provide 3D virtual views to the user. For example, a head-mounted display generation component may include left and right optical lenses (referred to herein as eye lenses) located between the display and the user's eyes. In some embodiments, the display generation component may include or be coupled to one or more external video cameras that capture video of the user's environment for display. In some embodiments, a head-mounted display generation component may have a transparent or semi-transparent display through which a user may view the physical environment directly and display virtual objects on the transparent or semi-transparent display. In some embodiments, display generation component projects virtual objects into the physical environment. The virtual objects may be projected, for example, on a physical surface or as a holograph, so that an individual, using the system, observes the virtual objects superimposed over the physical environment. In such cases, separate display panels and image frames for the left and right eyes may not be necessary.

As shown in FIG. 5, in some embodiments, eye tracking device 130 (e.g., a gaze tracking device) includes at least one eye tracking camera (e.g., infrared (IR) or near-IR (NIR) cameras), and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NIR light from the light sources directly from the eyes, or alternatively may be pointed towards “hot” mirrors located between the user's eyes and the display panels that reflect IR or NIR light from the eyes to the eye tracking cameras while allowing visible light to pass. The eye tracking device 130 optionally captures images of the user's eyes (e.g., as a video stream captured at 60-120 frames per second (fps)), analyze the images to generate gaze tracking information, and communicate the gaze tracking information to the controller 110. In some embodiments, two eyes of the user are separately tracked by respective eye tracking cameras and illumination sources. In some embodiments, only one eye of the user is tracked by a respective eye tracking camera and illumination sources.

In some embodiments, the eye tracking device 130 is calibrated using a device-specific calibration process to determine parameters of the eye tracking device for the specific operating environment 100, for example the 3D geometric relationship and parameters of the LEDs, cameras, hot mirrors (if present), eye lenses, and display screen. The device-specific calibration process may be performed at the factory or another facility prior to delivery of the AR/VR equipment to the end user. The device-specific calibration process may be an automated calibration process or a manual calibration process. A user-specific calibration process may include an estimation of a specific user's eye parameters, for example the pupil location, fovea location, optical axis, visual axis, eye spacing, etc. Once the device-specific and user-specific parameters are determined for the eye tracking device 130, images captured by the eye tracking cameras can be processed using a glint-assisted method to determine the current visual axis and point of gaze of the user with respect to the display, in accordance with some embodiments.

As shown in FIG. 5, the eye tracking device 130 (e.g., 130A or 130B) includes eye lens(es) 520, and a gaze tracking system that includes at least one eye tracking camera 540 (e.g., infrared (IR) or near-IR (NIR) cameras) positioned on a side of the user's face for which eye tracking is performed, and an illumination source 530 (e.g., IR or NIR light sources such as an array or ring of NIR light-emitting diodes (LEDs)) that emit light (e.g., IR or NIR light) towards the user's eye(s) 592. The eye tracking cameras 540 may be pointed towards mirrors 550 located between the user's eye(s) 592 and a display 510 (e.g., a left or right display panel of a head-mounted display, or a display of a handheld device, a projector, etc.) that reflect IR or NIR light from the eye(s) 592 while allowing visible light to pass (e.g., as shown in the top portion of FIG. 5), or alternatively may be pointed towards the user's eye(s) 592 to receive reflected IR or NIR light from the eye(s) 592 (e.g., as shown in the bottom portion of FIG. 5).

In some embodiments, the controller 110 renders AR or VR frames 562 (e.g., left and right frames for left and right display panels) and provides the frames 562 to the display 510. The controller 110 uses gaze tracking input 542 from the eye tracking cameras 540 for various purposes, for example in processing the frames 562 for display. The controller 110 optionally estimates the user's point of gaze on the display 510 based on the gaze tracking input 542 obtained from the eye tracking cameras 540 using the glint-assisted methods or other suitable methods. The point of gaze estimated from the gaze tracking input 542 is optionally used to determine the direction in which the user is currently looking.

The following describes several possible use cases for the user's current gaze direction, and is not intended to be limiting. As an example use case, the controller 110 may render virtual content differently based on the determined direction of the user's gaze. For example, the controller 110 may generate virtual content at a higher resolution in a foveal region determined from the user's current gaze direction than in peripheral regions. As another example, the controller may position or move virtual content in the view based at least in part on the user's current gaze direction. As another example, the controller may display particular virtual content in the view based at least in part on the user's current gaze direction. As another example use case in AR applications, the controller 110 may direct external cameras for capturing the physical environments of the XR experience to focus in the determined direction. The autofocus mechanism of the external cameras may then focus on an object or surface in the environment that the user is currently looking at on the display 510. As another example use case, the eye lenses 520 may be focusable lenses, and the gaze tracking information is used by the controller to adjust the focus of the eye lenses 520 so that the virtual object that the user is currently looking at has the proper vergence to match the convergence of the user's eyes 592. The controller 110 may leverage the gaze tracking information to direct the eye lenses 520 to adjust focus so that close objects that the user is looking at appear at the right distance.

In some embodiments, the eye tracking device is part of a head-mounted device that includes a display (e.g., display 510), two eye lenses (e.g., eye lens(es) 520), eye tracking cameras (e.g., eye tracking camera(s) 540), and light sources (e.g., illumination sources 530 (e.g., IR or NIR LEDs)), mounted in a wearable housing. The light sources emit light (e.g., IR or NIR light) towards the user's eye(s) 592. In some embodiments, the light sources may be arranged in rings or circles around each of the lenses as shown in FIG. 5. In some embodiments, eight illumination sources 530 (e.g., LEDs) are arranged around each lens 520 as an example. However, more or fewer illumination sources 530 may be used, and other arrangements and locations of illumination sources 530 may be used.

In some embodiments, the display 510 emits light in the visible light range and does not emit light in the IR or NIR range, and thus does not introduce noise in the gaze tracking system. Note that the location and angle of eye tracking camera(s) 540 is given by way of example, and is not intended to be limiting. In some embodiments, a single eye tracking camera 540 is located on each side of the user's face. In some embodiments, two or more NIR cameras 540 may be used on each side of the user's face. In some embodiments, a camera 540 with a wider field of view (FOV) and a camera 540 with a narrower FOV may be used on each side of the user's face. In some embodiments, a camera 540 that operates at one wavelength (e.g., 850 nm) and a camera 540 that operates at a different wavelength (e.g., 940 nm) may be used on each side of the user's face.

Embodiments of the gaze tracking system as illustrated in FIG. 5 may, for example, be used in computer-generated reality, virtual reality, and/or mixed reality applications to provide computer-generated reality, virtual reality, augmented reality, and/or augmented virtuality experiences to the user.

FIG. 6 illustrates a glint-assisted gaze tracking pipeline, in accordance with some embodiments. In some embodiments, the gaze tracking pipeline is implemented by a glint-assisted gaze tracking system (e.g., eye tracking device 130 as illustrated in FIGS. 1A and 5). The glint-assisted gaze tracking system may maintain a tracking state. Initially, the tracking state is off or “NO.” When in the tracking state, the glint-assisted gaze tracking system uses prior information from the previous frame when analyzing the current frame to track the pupil contour and glints in the current frame. When not in the tracking state, the glint-assisted gaze tracking system attempts to detect the pupil and glints in the current frame and, if successful, initializes the tracking state to “YES” and continues with the next frame in the tracking state.

As shown in FIG. 6, the gaze tracking cameras may capture left and right images of the user's left and right eyes. The captured images are then input to a gaze tracking pipeline for processing beginning at 610. As indicated by the arrow returning to element 600, the gaze tracking system may continue to capture images of the user's eyes, for example at a rate of 60 to 120 frames per second. In some embodiments, each set of captured images may be input to the pipeline for processing. However, in some embodiments or under some conditions, not all captured frames are processed by the pipeline.

At 610, for the current captured images, if the tracking state is YES, then the method proceeds to element 640. At 610, if the tracking state is NO, then as indicated at 620 the images are analyzed to detect the user's pupils and glints in the images. At 630, if the pupils and glints are successfully detected, then the method proceeds to element 640. Otherwise, the method returns to element 610 to process next images of the user's eyes.

At 640, if proceeding from element 610, the current frames are analyzed to track the pupils and glints based in part on prior information from the previous frames. At 640, if proceeding from element 630, the tracking state is initialized based on the detected pupils and glints in the current frames. Results of processing at element 640 are checked to verify that the results of tracking or detection can be trusted. For example, results may be checked to determine if the pupil and a sufficient number of glints to perform gaze estimation are successfully tracked or detected in the current frames. At 650, if the results cannot be trusted, then the tracking state is set to NO at element 660, and the method returns to element 610 to process next images of the user's eyes. At 650, if the results are trusted, then the method proceeds to element 670. At 670, the tracking state is set to YES (if not already YES), and the pupil and glint information is passed to element 680 to estimate the user's point of gaze.

FIG. 6 is intended to serve as one example of eye tracking technology that may be used in a particular implementation. As recognized by those of ordinary skill in the art, other eye tracking technologies that currently exist or are developed in the future may be used in place of or in combination with the glint-assisted eye tracking technology describe herein in the computer system 101 for providing XR experiences to users, in accordance with various embodiments.

In some embodiments, the captured portions of real-world environment 602 are used to provide a XR experience to the user, for example, a mixed reality environment in which one or more virtual objects are superimposed over representations of real-world environment 602.

Thus, the description herein describes some embodiments of three-dimensional environments (e.g., XR environments) that include representations of real-world objects and representations of virtual objects. For example, a three-dimensional environment optionally includes a representation of a table that exists in the physical environment, which is captured and displayed in the three-dimensional environment (e.g., actively via cameras and displays of a computer system, or passively via a transparent or translucent display of the computer system). As described previously, the three-dimensional environment is optionally a mixed reality system in which the three-dimensional environment is based on the physical environment that is captured by one or more sensors of the computer system and displayed via a display generation component. As a mixed reality system, the computer system is optionally able to selectively display portions and/or objects of the physical environment such that the respective portions and/or objects of the physical environment appear as if they exist in the three-dimensional environment displayed by the computer system. Similarly, the computer system is optionally able to display virtual objects in the three-dimensional environment to appear as if the virtual objects exist in the real world (e.g., physical environment) by placing the virtual objects at respective locations in the three-dimensional environment that have corresponding locations in the real world. For example, the computer system optionally displays a vase such that it appears as if a real vase is placed on top of a table in the physical environment. In some embodiments, a respective location in the three-dimensional environment has a corresponding location in the physical environment. Thus, when the computer system is described as displaying a virtual object at a respective location with respect to a physical object (e.g., such as a location at or near the hand of the user, or at or near a physical table), the computer system displays the virtual object at a particular location in the three-dimensional environment such that it appears as if the virtual object is at or near the physical object in the physical world (e.g., the virtual object is displayed at a location in the three-dimensional environment that corresponds to a location in the physical environment at which the virtual object would be displayed if it were a real object at that particular location).

In some embodiments, real world objects that exist in the physical environment that are displayed in the three-dimensional environment (e.g., and/or visible via the display generation component) can interact with virtual objects that exist only in the three-dimensional environment. For example, a three-dimensional environment can include a table and a vase placed on top of the table, with the table being a view of (or a representation of) a physical table in the physical environment, and the vase being a virtual object.

In a three-dimensional environment (e.g., a real environment, a virtual environment, or an environment that includes a mix of real and virtual objects), objects are sometimes referred to as having a depth or simulated depth, or objects are referred to as being visible, displayed, or placed at different depths. In this context, depth refers to a dimension other than height or width. In some embodiments, depth is defined relative to a fixed set of coordinates (e.g., where a room or an object has a height, depth, and width defined relative to the fixed set of coordinates). In some embodiments, depth is defined relative to a location or viewpoint of a user, in which case, the depth dimension varies based on the location of the user and/or the location and angle of the viewpoint of the user. In some embodiments where depth is defined relative to a location of a user that is positioned relative to a surface of an environment (e.g., a floor of an environment, or a surface of the ground), objects that are further away from the user along a line that extends parallel to the surface are considered to have a greater depth in the environment, and/or the depth of an object is measured along an axis that extends outward from a location of the user and is parallel to the surface of the environment (e.g., depth is defined in a cylindrical or substantially cylindrical coordinate system with the position of the user at the center of the cylinder that extends from a head of the user toward feet of the user). In some embodiments where depth is defined relative to viewpoint of a user (e.g., a direction relative to a point in space that determines which portion of an environment that is visible via a head mounted device or other display), objects that are further away from the viewpoint of the user along a line that extends parallel to the direction of the viewpoint of the user are considered to have a greater depth in the environment, and/or the depth of an object is measured along an axis that extends outward from a line that extends from the viewpoint of the user and is parallel to the direction of the viewpoint of the user (e.g., depth is defined in a spherical or substantially spherical coordinate system with the origin of the viewpoint at the center of the sphere that extends outwardly from a head of the user). In some embodiments, depth is defined relative to a user interface container (e.g., a window or application in which application and/or system content is displayed) where the user interface container has a height and/or width, and depth is a dimension that is orthogonal to the height and/or width of the user interface container. In some embodiments, in circumstances where depth is defined relative to a user interface container, the height and or width of the container are typically orthogonal or substantially orthogonal to a line that extends from a location based on the user (e.g., a viewpoint of the user or a location of the user) to the user interface container (e.g., the center of the user interface container, or another characteristic point of the user interface container) when the container is placed in the three-dimensional environment or is initially displayed (e.g., so that the depth dimension for the container extends outward away from the user or the viewpoint of the user). In some embodiments, in situations where depth is defined relative to a user interface container, depth of an object relative to the user interface container refers to a position of the object along the depth dimension for the user interface container. In some embodiments, multiple different containers can have different depth dimensions (e.g., different depth dimensions that extend away from the user or the viewpoint of the user in different directions and/or from different starting points). In some embodiments, when depth is defined relative to a user interface container, the direction of the depth dimension remains constant for the user interface container as the location of the user interface container, the user and/or the viewpoint of the user changes (e.g., or when multiple different viewers are viewing the same container in the three-dimensional environment such as during an in-person collaboration session and/or when multiple participants are in a real-time communication session with shared virtual content including the container). In some embodiments, for curved containers (e.g., including a container with a curved surface or curved content region), the depth dimension optionally extends into a surface of the curved container. In some situations, z-separation (e.g., separation of two objects in a depth dimension), z-height (e.g., distance of one object from another in a depth dimension), z-position (e.g., position of one object in a depth dimension), z-depth (e.g., position of one object in a depth dimension), or simulated z dimension (e.g., depth used as a dimension of an object, dimension of an environment, a direction in space, and/or a direction in simulated space) are used to refer to the concept of depth as described above.

In some embodiments, a user is optionally able to interact with virtual objects in the three-dimensional environment using one or more hands as if the virtual objects were real objects in the physical environment. For example, as described above, one or more sensors of the computer system optionally capture one or more of the hands of the user and display representations of the hands of the user in the three-dimensional environment (e.g., in a manner similar to displaying a real world object in three-dimensional environment described above), or in some embodiments, the hands of the user are visible via the display generation component via the ability to see the physical environment through the user interface due to the transparency/translucency of a portion of the display generation component that is displaying the user interface or due to projection of the user interface onto a transparent/translucent surface or projection of the user interface onto the user's eye or into a field of view of the user's eye. Thus, in some embodiments, the hands of the user are displayed at a respective location in the three-dimensional environment and are treated as if they were objects in the three-dimensional environment that are able to interact with the virtual objects in the three-dimensional environment as if they were physical objects in the physical environment. In some embodiments, the computer system is able to update display of the representations of the user's hands in the three-dimensional environment in conjunction with the movement of the user's hands in the physical environment.

In some of the embodiments described below, the computer system is optionally able to determine the “effective” distance between physical objects in the physical world and virtual objects in the three-dimensional environment, for example, for the purpose of determining whether a physical object is directly interacting with a virtual object (e.g., whether a hand is touching, grabbing, holding, etc. a virtual object or within a threshold distance of a virtual object). For example, a hand directly interacting with a virtual object optionally includes one or more of a finger of a hand pressing a virtual button, a hand of a user grabbing a virtual vase, two fingers of a hand of the user coming together and pinching/holding a user interface of an application, and any of the other types of interactions described here. For example, the computer system optionally determines the distance between the hands of the user and virtual objects when determining whether the user is interacting with virtual objects and/or how the user is interacting with virtual objects. In some embodiments, the computer system determines the distance between the hands of the user and a virtual object by determining the distance between the location of the hands in the three-dimensional environment and the location of the virtual object of interest in the three-dimensional environment. For example, the one or more hands of the user are located at a particular position in the physical world, which the computer system optionally captures and displays at a particular corresponding position in the three-dimensional environment (e.g., the position in the three-dimensional environment at which the hands would be displayed if the hands were virtual, rather than physical, hands). The position of the hands in the three-dimensional environment is optionally compared with the position of the virtual object of interest in the three-dimensional environment to determine the distance between the one or more hands of the user and the virtual object. In some embodiments, the computer system optionally determines a distance between a physical object and a virtual object by comparing positions in the physical world (e.g., as opposed to comparing positions in the three-dimensional environment). For example, when determining the distance between one or more hands of the user and a virtual object, the computer system optionally determines the corresponding location in the physical world of the virtual object (e.g., the position at which the virtual object would be located in the physical world if it were a physical object rather than a virtual object), and then determines the distance between the corresponding physical position and the one of more hands of the user. In some embodiments, the same techniques are optionally used to determine the distance between any physical object and any virtual object. Thus, as described herein, when determining whether a physical object is in contact with a virtual object or whether a physical object is within a threshold distance of a virtual object, the computer system optionally performs any of the techniques described above to map the location of the physical object to the three-dimensional environment and/or map the location of the virtual object to the physical environment.

In some embodiments, the same or similar technique is used to determine where and what the gaze of the user is directed to and/or where and at what a physical stylus held by a user is pointed. For example, if the gaze of the user is directed to a particular position in the physical environment, the computer system optionally determines the corresponding position in the three-dimensional environment (e.g., the virtual position of the gaze), and if a virtual object is located at that corresponding virtual position, the computer system optionally determines that the gaze of the user is directed to that virtual object. Similarly, the computer system is optionally able to determine, based on the orientation of a physical stylus, to where in the physical environment the stylus is pointing. In some embodiments, based on this determination, the computer system determines the corresponding virtual position in the three-dimensional environment that corresponds to the location in the physical environment to which the stylus is pointing, and optionally determines that the stylus is pointing at the corresponding virtual position in the three-dimensional environment.

Similarly, the embodiments described herein may refer to the location of the user (e.g., the user of the computer system) and/or the location of the computer system in the three-dimensional environment. In some embodiments, the user of the computer system is holding, wearing, or otherwise located at or near the computer system. Thus, in some embodiments, the location of the computer system is used as a proxy for the location of the user. In some embodiments, the location of the computer system and/or user in the physical environment corresponds to a respective location in the three-dimensional environment. For example, the location of the computer system would be the location in the physical environment (and its corresponding location in the three-dimensional environment) from which, if a user were to stand at that location facing a respective portion of the physical environment that is visible via the display generation component, the user would see the objects in the physical environment in the same positions, orientations, and/or sizes as they are displayed by or visible via the display generation component of the computer system in the three-dimensional environment (e.g., in absolute terms and/or relative to each other). Similarly, if the virtual objects displayed in the three-dimensional environment were physical objects in the physical environment (e.g., placed at the same locations in the physical environment as they are in the three-dimensional environment, and having the same sizes and orientations in the physical environment as in the three-dimensional environment), the location of the computer system and/or user is the position from which the user would see the virtual objects in the physical environment in the same positions, orientations, and/or sizes as they are displayed by the display generation component of the computer system in the three-dimensional environment (e.g., in absolute terms and/or relative to each other and the real world objects).

In the present disclosure, various input methods are described with respect to interactions with a computer system. When an example is provided using one input device or input method and another example is provided using another input device or input method, it is to be understood that each example may be compatible with and optionally utilizes the input device or input method described with respect to another example. Similarly, various output methods are described with respect to interactions with a computer system. When an example is provided using one output device or output method and another example is provided using another output device or output method, it is to be understood that each example may be compatible with and optionally utilizes the output device or output method described with respect to another example. Similarly, various methods are described with respect to interactions with a virtual environment or a mixed reality environment through a computer system. When an example is provided using interactions with a virtual environment and another example is provided using mixed reality environment, it is to be understood that each example may be compatible with and optionally utilizes the methods described with respect to another example. As such, the present disclosure discloses embodiments that are combinations of the features of multiple examples, without exhaustively listing all features of an embodiment in the description of each example embodiment.

### User Interfaces and Associated Processes

Attention is now directed towards embodiments of user interfaces (“UI”) and associated processes that may be implemented on a computer system, such as a portable multifunction device or a head-mounted device, in communication with one or more display generation, one or more input devices, and optionally one or more cameras.

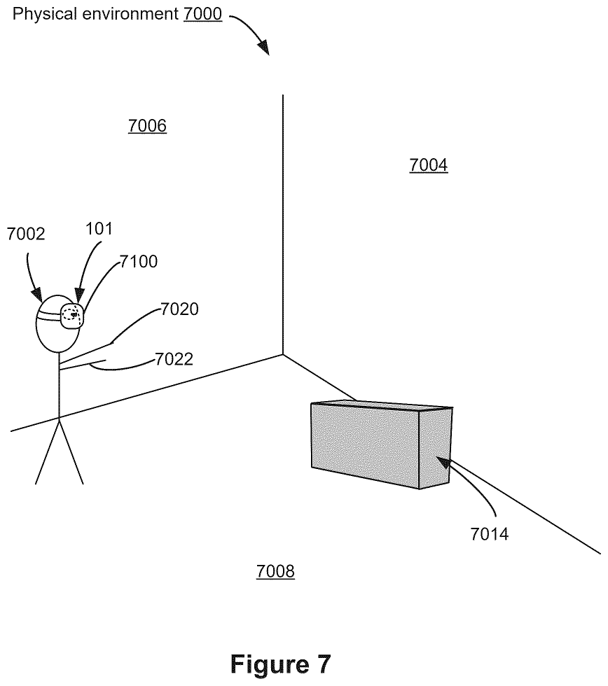

FIGS. 7, 8A-8AL, and 9A-9AS illustrate three-dimensional environments that are visible via a display generation component (e.g., a display generation component, such as HMD 7100a, or a display generation component 120) of a computer system (e.g., computer system 101) and interactions that occur in the three-dimensional environments caused by user inputs directed to the three-dimensional environments and/or inputs received from other computer systems and/or sensors. In some embodiments, an input is directed to a virtual object within a three-dimensional environment by a user's gaze detected in the region occupied by the virtual object, or by a hand gesture performed at a location in the physical environment that corresponds to the region of the virtual object. In some embodiments, an input is directed to a virtual object within a three-dimensional environment by a hand gesture that is performed (e.g., optionally, at a location in the physical environment that is independent of the region of the virtual object in the three-dimensional environment) while the virtual object has input focus (e.g., while the virtual object has been selected by a concurrently and/or previously detected gaze input, selected by a concurrently or previously detected pointer input, and/or selected by a concurrently and/or previously detected gesture input). In some embodiments, an input is directed to a virtual object within a three-dimensional environment by an input device that has positioned a focus selector object (e.g., a pointer object or selector object) at the position of the virtual object. In some embodiments, an input is directed to a virtual object within a three-dimensional environment via other means (e.g., voice and/or control button). In some embodiments, an input is directed to a representation of a physical object or a virtual object that corresponds to a physical object by the user's hand movement (e.g., whole hand movement, whole hand movement in a respective posture, movement of one portion of the user's hand relative to another portion of the hand, and/or relative movement between two hands) and/or manipulation with respect to the physical object (e.g., touching, swiping, tapping, opening, moving toward, and/or moving relative to). In some embodiments, the computer system displays some changes in the three-dimensional environment (e.g., displaying additional virtual content, ceasing to display existing virtual content, and/or transitioning between different levels of immersion with which visual content is being displayed) in accordance with inputs from sensors (e.g., image sensors, temperature sensors, biometric sensors, motion sensors, and/or proximity sensors) and contextual conditions (e.g., location, time, and/or presence of others in the environment). In some embodiments, the computer system displays some changes in the three-dimensional environment (e.g., displaying additional virtual content, ceasing to display existing virtual content, and/or transitioning between different levels of immersion with which visual content is being displayed) in accordance with inputs from other computers used by other users that are sharing the computer-generated environment with the user of the computer system (e.g., in a shared computer-generated experience, in a shared virtual environment, and/or in a shared virtual or augmented reality environment of a communication session). In some embodiments, the computer system displays some changes in the three-dimensional environment (e.g., displaying movement, deformation, and/or changes in visual characteristics of a user interface, a virtual surface, a user interface object, and/or virtual scenery) in accordance with inputs from sensors that detect movement of other persons and objects and movement of the user that may not qualify as a recognized gesture input for triggering an associated operation of the computer system.

In some embodiments, a three-dimensional environment that is visible via a display generation component described herein is a virtual three-dimensional environment that includes virtual objects and content at different virtual positions in the three-dimensional environment without a representation of the physical environment. In some embodiments, the three-dimensional environment is a mixed reality environment that displays virtual objects at different virtual positions in the three-dimensional environment that are constrained by one or more physical aspects of the physical environment (e.g., positions and orientations of walls, floors, surfaces, direction of gravity, time of day, and/or spatial relationships between physical objects). In some embodiments, the three-dimensional environment is an augmented reality environment that includes a representation of the physical environment. In some embodiments, the representation of the physical environment includes respective representations of physical objects and surfaces at different positions in the three-dimensional environment, such that the spatial relationships between the different physical objects and surfaces in the physical environment are reflected by the spatial relationships between the representations of the physical objects and surfaces in the three-dimensional environment. In some embodiments, when virtual objects are placed relative to the positions of the representations of physical objects and surfaces in the three-dimensional environment, they appear to have corresponding spatial relationships with the physical objects and surfaces in the physical environment. In some embodiments, the computer system transitions between displaying the different types of environments (e.g., transitions between presenting a computer-generated environment or experience with different levels of immersion, adjusting the relative prominence of audio/visual sensory inputs from the virtual content and from the representation of the physical environment) based on user inputs and/or contextual conditions.

In some embodiments, the display generation component includes a pass-through portion in which the representation of the physical environment is displayed or visible. In some embodiments, the pass-through portion of the display generation component is a transparent or semi-transparent (e.g., see-through) portion of the display generation component revealing at least a portion of a physical environment surrounding and within the field of view of a user (sometimes called “optical passthrough”). For example, the pass-through portion is a portion of a head-mounted display or heads-up display that is made semi-transparent (e.g., less than 50%, 40%, 30%, 20%, 15%, 10%, or 5% of opacity) or transparent, such that the user can see through it to view the real world surrounding the user without removing the head-mounted display or moving away from the heads-up display. In some embodiments, the pass-through portion gradually transitions from semi-transparent or transparent to fully opaque when displaying a virtual or mixed reality environment. In some embodiments, the pass-through portion of the display generation component displays a live feed of images or video of at least a portion of physical environment captured by one or more cameras (e.g., rear facing camera(s) of a mobile device or associated with a head-mounted display, or other cameras that feed image data to the computer system) (sometimes called “digital passthrough”). In some embodiments, the one or more cameras point at a portion of the physical environment that is directly in front of the user's eyes (e.g., behind the display generation component relative to the user of the display generation component). In some embodiments, the one or more cameras point at a portion of the physical environment that is not directly in front of the user's eyes (e.g., in a different physical environment, or to the side of or behind the user).

In some embodiments, when displaying virtual objects at positions that correspond to locations of one or more physical objects in the physical environment (e.g., at positions in a virtual reality environment, a mixed reality environment, or an augmented reality environment), at least some of the virtual objects are displayed in place of (e.g., replacing display of) a portion of the live view (e.g., a portion of the physical environment captured in the live view) of the cameras. In some embodiments, at least some of the virtual objects and content are projected onto physical surfaces or empty space in the physical environment and are visible through the pass-through portion of the display generation component (e.g., viewable as part of the camera view of the physical environment, or through the transparent or semi-transparent portion of the display generation component). In some embodiments, at least some of the virtual objects and virtual content are displayed to overlay a portion of the display and block the view of at least a portion of the physical environment visible through the transparent or semi-transparent portion of the display generation component.

In some embodiments, the display generation component displays different views of the three-dimensional environment in accordance with user inputs or movements that change the virtual position of the viewpoint of the currently displayed view of the three-dimensional environment relative to the three-dimensional environment. In some embodiments, when the three-dimensional environment is a virtual environment, the viewpoint moves in accordance with navigation or locomotion requests (e.g., in-air hand gestures, and/or gestures performed by movement of one portion of the hand relative to another portion of the hand) without requiring movement of the user's head, torso, and/or the display generation component in the physical environment. In some embodiments, movement of the user's head and/or torso, and/or the movement of the display generation component or other location sensing elements of the computer system (e.g., due to the user holding the display generation component or wearing the HMD), relative to the physical environment, cause corresponding movement of the viewpoint (e.g., with corresponding movement direction, movement distance, movement speed, and/or change in orientation) relative to the three-dimensional environment, resulting in corresponding change in the currently displayed view of the three-dimensional environment. In some embodiments, when a virtual object has a preset spatial relationship relative to the viewpoint (e.g., is anchored or fixed to the viewpoint), movement of the viewpoint relative to the three-dimensional environment would cause movement of the virtual object relative to the three-dimensional environment while the position of the virtual object in the field of view is maintained (e.g., the virtual object is said to be head locked). In some embodiments, a virtual object is body-locked to the user, and moves relative to the three-dimensional environment when the user moves as a whole in the physical environment (e.g., carrying or wearing the display generation component and/or other location sensing component of the computer system), but will not move in the three-dimensional environment in response to the user's head movement alone (e.g., the display generation component and/or other location sensing component of the computer system rotating around a fixed location of the user in the physical environment). In some embodiments, a virtual object is, optionally, locked to another portion of the user, such as a user's hand or a user's wrist, and moves in the three-dimensional environment in accordance with movement of the portion of the user in the physical environment, to maintain a preset spatial relationship between the position of the virtual object and the virtual position of the portion of the user in the three-dimensional environment. In some embodiments, a virtual object is locked to a preset portion of a field of view provided by the display generation component, and moves in the three-dimensional environment in accordance with the movement of the field of view, irrespective of movement of the user that does not cause a change of the field of view.

In some embodiments, 8A-8AL and 9A-9AS, the representation(s) of a user's hand(s), arm(s), and/or wrist(s) are included in the views of a three-dimensional environment. In some embodiments, the representation(s) of a user's hand(s), arm(s), and/or wrist(s) are included in the views of a three-dimensional environment as part of the representation of the physical environment provided via the display generation component. In some embodiments, the representations are not part of the representation of the physical environment and are separately captured (e.g., by one or more cameras pointing toward the user's hand(s), arm(s), and wrist(s)) and displayed in the three-dimensional environment independent of the currently displayed view of the three-dimensional environment. In some embodiments, the representation(s) include camera images as captured by one or more cameras of the computer system(s), or stylized versions of the arm(s), wrist(s) and/or hand(s) based on information captured by various sensors). In some embodiments, the representation(s) replace display of, are overlaid on, or block the view of, a portion of the representation of the physical environment. In some embodiments, when the display generation component does not provide a view of a physical environment, and provides a completely virtual environment (e.g., no camera view and no transparent pass-through portion), real-time visual representations (e.g., stylized representations or segmented camera images) of one or both arms, wrists, and/or hands of the user are, optionally, still displayed in the virtual environment. In some embodiments, if a representation of the user's hand is not provided in the view of the three-dimensional environment, the position that corresponds to the user's hand is optionally indicated in the three-dimensional environment, e.g., by the changing appearance of the virtual content (e.g., through a change in translucency and/or simulated reflective index) at positions in the three-dimensional environment that correspond to the location of the user's hand in the physical environment. In some embodiments, the representation of the user's hand or wrist is outside of the currently displayed view of the three-dimensional environment while the virtual position in the three-dimensional environment that corresponds to the location of the user's hand or wrist is outside of the current field of view provided via the display generation component; and the representation of the user's hand or wrist is made visible in the view of the three-dimensional environment in response to the virtual position that corresponds to the location of the user's hand or wrist being moved within the current field of view due to movement of the display generation component, the user's hand or wrist, the user's head, and/or the user as a whole.

FIG. 7 illustrates an example physical environment 7000 that includes a user 7002 interacting with a computer system 101. Computer system 101 is worn on a head of the user 7002 and typically positioned in front of user 7002. In FIG. 7, the left hand 7020 and the right hand 7022 of the user 7002 are free to interact with computer system 101. Physical environment 7000 includes a physical object 7014, physical walls 7004 and 7006, and a physical floor 7008. As shown in the examples in FIGS. 8A-8AL and 9A-9AS, a display generation component of computer system 101 is a head-mounted display (HMD) 7100a (e.g., also referred to as HMD 7100a) worn on the head of the user 7002 (e.g., FIGS. 8A-8AL and 9A-9AS illustrate views of an environment, such as a three-dimensional extended-reality environment, visible via HMD 7100a of computer system 101 through a viewport that corresponds to a viewpoint of the user 7002 wearing the HMD 7100a).

In some embodiments, the head mounted display (HMD) 7100a includes one or more displays that display a representation of a portion of the three-dimensional environment (e.g., three-dimensional environment visible via HMD 7100a in FIGS. 8A-8AL and in FIGS. 9A-9AS) that corresponds to the perspective of the user 7002. While an HMD typically includes multiple displays including a display for a right eye and a separate display for a left eye that display slightly different images to generate user interfaces with stereoscopic depths, a single image is shown in FIGS. 8A-8AL and 9A-9AS, that corresponds to the image for a single eye and corresponding depth information is indicated with other annotations and/or in the description of the figures. In some embodiments, HMD 7100a includes one or more sensors (e.g., one or more interior- and/or exterior-facing image sensors 314), such as sensor 7101a, sensor 7101b and/or sensor 7101c (e.g., in FIGS. 8A-8AL and 9A-9AS) for detecting a state of the user, including facial and/or eye tracking of the user (e.g., using one or more inward-facing sensors 7101a and/or 7101b) and/or tracking hand, torso, or other movements of the user (e.g., using one or more outward-facing sensors 7101c). In some embodiments, HMD 7100a includes one or more input devices that are optionally located on a housing of HMD 7100a, such as one or more buttons, trackpads, touchscreens, scroll wheels, digital crowns that are rotatable and/or depressible, and/or other input devices that are in communication with the HMD via wired or wireless communication channels. In some embodiments, input elements are mechanical input elements; in some embodiments, input elements are solid state input elements that respond to activation inputs based on detected pressure and/or other measures of input intensity. For example, in FIGS. 8A-8AL and 9A-9AS, HMD 7100a includes one or more of button 701, button 702 and digital crown 703 for providing inputs to HMD 7100a. It will be understood that additional and/or alternative input devices may be included in HMD 7100a, in accordance with various embodiments.

In some embodiments, the display generation component of computer system 101 includes a touchscreen display, such as a touch-screen display positioned in front of user 7002. In some embodiments, the display generation component is a standalone display, a projector, or another type of display. In some embodiments, the computer system is in communication with one or more input devices, including cameras or other sensors and input devices that detect movement of the user's fingers, hand(s), torso, body, and/or head, as a whole or relative to other parts of the user's body, in the physical environment. In some embodiments, the one or more input devices detect the movement and the current postures, orientations, and positions of the user's hand(s), face, torso, and/or body, as a whole or relative to other parts of the user's body. For example, in some embodiments, while the user 7002's hand 7020 (e.g., left hand) is within the field of view of the one or more sensors of HMD 7100a (e.g., within the viewport through which a view of the environment is visible), a representation of the user 7002's hand 7020 is visible in the view of the environment (e.g., as a passthrough representation and/or as a virtual representation of the user 7002's hand 7020) on the display of HMD 7100a. In some embodiments, while the user's hand 7022 (e.g., a right hand) is within the field of view of the one or more sensors of HMD 7100a (e.g., within the viewport through which a view of the environment is visible), a representation of the user's hand 7022 is visible in the view of the environment (e.g., as a passthrough representation and/or as a virtual representation of the user's hand 7022) on the display of HMD 7100a. In some embodiments, the user 7002's hand 7020 and/or the user 7002's hand 7022 are used to perform one or more gestures (e.g., one or more air gestures, and/or touch gestures), optionally in combination with a gaze input. In some embodiments, the one or more gestures performed with the user's hand(s) 7020 and/or 7022 include a direct air gesture input that is based on a position of the representation of the user's hand(s) 7020 and/or 7022 within the environment displayed via the display of HMD 7100a. For example, a direct air gesture input is determined as being directed to a user interface object when the position of the user interface object in the environment intersects with the position of the representation of the user's hand(s) 7020′ and/or 7022′ in the environment. In some embodiments, the one or more gestures performed with the user 7002's hand(s) 7020 and/or 7022 include an indirect air gesture input that is based on a location of the user's attention at a time of the indirect air gesture input (e.g., as opposed to a position of the representation of the user's hand(s) 7020 and/or 7022). For example, an indirect air gesture is determined as being directed to a user interface object when the user's attention (e.g., based on gaze, wrist direction, head direction, and/or other indication of user attention) is directed to the user interface object at a time that the indirect air gesture is performed (e.g., at the start of and during a pinch gesture, and/or at the start of a pinch and drag gesture). In some embodiments, an indication of the location of the user's attention (e.g., a focus selector, a cursor, a spotlight, a gaze glow, and/or other indications) is displayed in the environment shown via the HMD, as the attention of the user moves and/or dwells in the environment. In some embodiments, a representation of the user's hand is not displayed and/or is suppressed from view in the view of the environment provided via the HMD, even if the position of the hand is within the viewport through which the view of the environment is visible and/or the hand is used to provide gestural inputs to the HMD.

In some embodiments, user inputs are detected via a touch-sensitive surface or touchscreen. In some embodiments, the one or more input devices include one or more eye tracking components that detect location and movement of the user's gaze. In some embodiments, the display generation component(s), and optionally, the one or more input devices and the computer system, are parts of a head-mounted device that moves and rotates with the user's head in the physical environment, and changes the viewpoint of the user in the three-dimensional environment provided via the display generation component(s). In some embodiments, the display generation component is a heads-up display that does not move or rotate with the user's head or the user's body as a whole, but, optionally, changes the viewpoint of the user in the three-dimensional environment in accordance with the movement of the user's head or body relative to the display generation component. In some embodiments, the display generation component (e.g., a touchscreen) is optionally moved and rotated by the user's hand relative to the physical environment or relative to the user's head, and changes the viewpoint of the user in the three-dimensional environment in accordance with the movement of the display generation component relative to the user's head or face, and/or relative to the physical environment.

In some embodiments, one or more portions of the view of physical environment 7000 that is visible to user 7002 via HMD 7100a are digital passthrough portions that include representations of corresponding portions of physical environment 7000 captured via one or more image sensors of computer system 101. In some embodiments, one or more portions of the view of physical environment 7000 that is visible to user 7002 via HMD 7100a are optical passthrough portions, in that user 7002 can see one or more portions of physical environment 7000 through one or more transparent or semi-transparent portions of HMD 7100a.

FIGS. 8A-8AL illustrate example techniques for reconfiguring a home user interface with multiple collections of user interface objects in a three-dimensional environment, in accordance with some embodiments. FIG. 10A-10M is a flow diagram of an exemplary method 10000 for reconfiguring a home user interface with multiple collections of user interface objects in a three-dimensional environment, in accordance with some embodiments. The user interfaces in FIGS. 8A-8AL are used to illustrate the processes described below, including the processes in FIGS. 10A-10M.

FIGS. 8A-8AL illustrate views of a three-dimensional environment that is visible to a user, such as user 7002 in FIG. 7, via a display generation component of computer system, such as HMD 7100a of computer system 101, as described in further detail with reference to FIG. 7. The three-dimensional environment of FIGS. 8A-8AL includes a representation (e.g., a camera view or an optical view) of a portion of physical environment 7000, in accordance with some embodiments. For example, the view of the environment shown in FIG. 8A includes representations 7004′, 7006′, 7008′, and 7014′ (e.g., camera views or optical views) of wall 7004, wall 7006, floor 7008, and box 7014, respectively. In some embodiments, the environment does not include a representation of the physical environment, and is a virtual three-dimensional environment. In some embodiments, the environment is a pseudo-three-dimensional environment that differentiates different depths based on display layers, visual obfuscation, simulated parallax effects, simulated shadows, and/or other simulated visual effects.

In some embodiments, in addition to the representation (e.g., camera view or optical view) of a portion of physical environment 7000, the views of the three-dimensional environment shown in FIGS. 8A-8C include respective views of home user interface 8100. In some embodiments, the home user interface 8100 includes user interface objects that are arranged into the different collections of user interface objects by object type and displayed in respective views of the home user interface 8100 (e.g., views 8100a, 8100b, 8100c, and/or 8100d, as described in further detail below with respect to FIGS. 8A-8D). For example, the three-dimensional environment in FIG. 8A includes an applications view 8100a of home user interface 8100, that includes a collection of application icons (e.g., for launching, opening, and/or otherwise causing the computer system 101 to display a respective user interface of a corresponding application of an application icon). The three-dimensional environment in FIG. 8B includes an environments view 8100b of home user interface 8100, that includes a collection of virtual environment icons (e.g., for launching, opening, and/or otherwise causing the computer system 101 to display a corresponding virtual environment and/or virtual three-dimensional experience of an environment icon). The three-dimensional environment in FIG. 8C includes a contacts view 8100c of home user interface 8100, that includes a collection of contact icons (e.g., for initiating a communication with and/or opening a user interface with contact information for a corresponding contact of a contact icon). The three-dimensional environment in FIG. 8D includes an objects view 8100d of home user interface 8100 that includes a collection of object icons of the same object type (e.g., a collection of application icons, a collection of environment icons, a collection of contact icons, a collection of system controls, a collection of representations of messages and/or conversations, a collection of notifications, or a collection of other objects of the same type). The applications view 8100a, the environments view 8100b, the contacts view 8100c, and the objects view 8100d are collectively referred to as views 8100a-8100d. In the description below, various aspects of the view 8100d of home menu user interface 8100 in the descriptions below are applicable to other views and/or collections of objects, and vice versa. In some embodiments, a respective view of the home menu user interface is also referred to as an arrangement or multi-section arrangement of a plurality of user interface objects of a respective type, such as an arrangement or multi-section arrangement of application icons, an arrangement or multi-section arrangement of environment icons, an arrangement or multi-section arrangement of contact icons, an arrangement or multi-section arrangement of controls, or an arrangement or multi-section arrangement of objects of another object type.

In some embodiments, a respective view of home user interface 8100 (e.g., views 8100a-8100d) optionally includes multiple sections (e.g., also referred to as pages, portions, segments, groups of objects, and/or sub-arrangements of objects) with user interface objects of the same object type. For example, a respective view of the home user interface 8100 spans over more than one section (e.g., a total lateral dimension of a single collection in a view of the home user interface 8100 exceeds a span of a viewport provided via HMD 7100a). In another example, the number of icons in a collection exceeds the number of icons that make up or fit on a single section in a respective view of home user interface 8100. In such cases, the collection of icons is divided into two or more sections (e.g., also referred to as pages), and the collection of user interface objects are displayed section-by-section (e.g., or page-by-page) in a respective view of the home user interface 8100, with a single section or page in focus at a time. In some embodiments, a preview of one or more adjacent sections is optionally provided concurrently with the section that is in focus, in a view of the home menu user interface; however, an individual icon in the preview is not responsive to user inputs, e.g., non-responsive at all or not responding in the same manner as an icon in the section of the view that is currently in focus.

In some embodiments, home user interface 8100 includes a section indicator object 8002 that indicates both the total number of sections (sometimes referred to as pages) in a respective view (e.g., views 8100a-8100d) and an ordinal position of a respective section in a sequence of sections of the respective view (e.g., views 8100a-8100d) of home user interface 8100. For example, in the example scenarios of FIGS. 8A-8D, the home user interface 8100 includes three sections or pages for a respective view that is currently displayed, a respective section of the three sections is indicated by a respective section indicator icon (e.g., a circle or dot) in section indicator object 8002, such as section indicator icon 8002a, section indicator icon 8002b, and section indicator icon 8002c. In the scenarios of FIGS. 8A-8D, the second section of a respective view of home user interface 8100 is visible in the three-dimensional environment and this is indicated by different appearance of the section indicator icon 8002b relative to section indicators 8002a an 8002c (e.g., a filled circle indicates currently displayed section and unfilled circles in the section indicator object 8002 indicate other sections that are not currently visible, such as section indicator icons 8002a and 8002c). In some embodiments, section indicator object 8002 is visible in the home user interface 8100 irrespective of which section of a view or which view of home user interface 8100 is visible. In some embodiments, visibility of section indicator object 8002 is maintained when sections of home user interface 8100 are scrolled (e.g., in conjunction with changing appearance of section indicator icons to indicate what section is currently active). In some embodiments, section indicator object 8002 is displayed while a home user interface is in a reconfiguration mode. In some embodiments, an input directed to a respective section indicator icon of 8002a, 8002b, and 8002c (e.g., an air pinch detected while attention of the user is directed to the respective section indicator icon, or another selection input directed to the respective section indicator icon), causes the computer system 101 to navigate to a respective section corresponding to the selected section indicator icon. In some embodiments, other gestures directed at section indicator object 8002 (e.g., one or more taps, swipes, air pinches, air pinch and drags, mouse clicks, mouse drags, and other types of inputs) cause the computer system 101 to switch from displaying one section to displaying another section of the multi-section arrangement of the collection of user interface objects. Although section indicator object 8002 is displayed at a bottom portion of home user interfaces 8100, section indicator object 8002 may instead be positioned at a different portion (e.g., a top portion, or an edge portion) of home user interfaces 8100. In some embodiments, the sections of a respective view of the home user interface 8100 optionally include multiple user-arranged sections (e.g., the sections shown in FIGS. 8A-8D) and a system-generated icon library section that includes all user interface objects from the collection of user interface objects. In some embodiments, the icon library section is optionally located before or after the user-arranged sections of the respective view or multi-section arrangement of the collection of user interface objects. In some embodiments, the icon library section is available for one or more views and not available for one or more other views of the home user interface. In some embodiments, the icon library section of a respective view optionally includes user interface objects that are deleted from user-arranged sections of the respective view, in addition to the user interface objects in the user-arranged sections of the home user interface.

In some embodiments, a home user interface includes a tab menu for navigating between the different views (e.g., applications view 8100a, environments view 8100b, contacts view 8100c, and/or another view or arrangement for objects of another object type) corresponding to different collections of user interface objects of respective object types. For example, tab menu 8004 (e.g., as shown in FIGS. 8A-8D) has multiple tabs 8004a, 8004b, and 8004c corresponding to different views of home user interface 8100. For example, tab 8004a, when selected by a selection input, causes the computer system 101 to display applications view 8100a of home user interface 8100. In FIG. 8A, tab 8004a is visually emphasized (e.g., enlarged and encircled) to indicate that the view that is currently displayed (e.g., applications view 8100a) corresponds to tab 8004a. Further, tab 8004b, when selected by a selection input, causes the computer system 101 to display environments view 8100b of home user interface 8100 (and cease to display another view of home user interface 8100). Tab 8004c, when selected by a selection input, causes the computer system 101 to display contacts view 8100c of home user interface 8100 (and cease to display another view of home user interface 8100). Accordingly, a user can toggle between displaying different views of the home user interface corresponding to different collections of icons corresponding to respective object types (e.g., icons for applications, icons for contacts, icons for virtual environments or experiences, icons for controls, and/or icons or objects of another object type).

In some embodiments, applications view 8100a, environments view 8100b, and contacts view 8100c, and tab menu 8004 are components of home user interface 8100. In some embodiments, when a respective view of views 8100a-8100c is being displayed via HMD 7100a (e.g., in a normal mode or a reconfiguration mode), other views of home user interface 8100 are not displayed. Segmenting home user interface 8100 into different views or arrangements according to object type reduces the number of inputs and the amount of time needed to locate an icon on home user interface 8100 and/or to reconfigure home user interface 8100, in accordance with some embodiments. The views described herein are illustrative examples, and a person or ordinary skills in the art can understand that other object types and other criteria for grouping objects into respective collections of objects and displaying the respective collections of objects in different views of a user interface (e.g., a home menu, an object library, a control panel, and/or other types of system user interfaces) for easy navigation, location, and/or configuration, are possible, in accordance with various embodiments.

FIG. 8A illustrates applications view 8100a of home user interface 8100, in accordance with some embodiments. Applications view 8100a of home user interface 8100 includes a collection of application icons (e.g., for launching or opening corresponding applications). For example, applications view 8100a is a multi-section arrangement of a collection of application icons that has three sections, and the section currently visible via HMD 7100a includes a subset of the collection of application icons, e.g., application icons 28a, 28b, 28c, 28d, 28e, 28f, 28g, 28h, 28i, 28j, 28k, and 28l (also collectively referred to as application icons 28a-28l), and optionally, a folder icon 28m. In some embodiments, application icons 28a-28l and folder icon 28m in applications view 8100a are arranged in accordance with a regular pattern (e.g., in a grid pattern, a honeycomb pattern, linearly along a line, radially along multiple radii of a circle, circumferentially around a geometric shape, and/or other patterns), and/or placed into placement locations that are arranged in accordance with the regular pattern. In some embodiments, not all placement locations in the regular pattern are occupied by a corresponding icon, and some placement locations in the regular pattern may be unoccupied at a given time. In some embodiments, application icons 28a-28l correspond to various software applications that are installed and/or can be executed on computer system 101 (e.g., an email application, a web browser, a messaging application, a maps application, a video player, or an audio player, or other software applications). In some embodiments, the sizes of application icons 28a-28l and folder icon 28m are the same (e.g., each having a size that is within a threshold variation such as +1-5% of a respective size such as an average size of the application icon). In some embodiments, the folder icon 28m, when selected by a selection input, opens a folder user interface that includes one or more application icons included in the folder corresponding to folder icon 28m. In some embodiments, user input (e.g., one or more air pinches, taps, mouse clicks, button inputs, and/or other inputs) directed to one of application icons 28a-28l in applications view 8100a launches a software application associated with the respective application icon. In some embodiments, application icon 28a, when selected, causes computer system 101 to open a TV application (as illustrated by the label “TV” below application icon 28a); application icon 28b, when selected, causes computer system 101 to open a music application (as illustrated by the label “Music” below application icon 28b); application icon 28c, when selected, causes computer system 100 to open a wellness application (as illustrated by the label “Wellness” below application icon 28c); application icon 28d, when selected, causes computer system 101 to open a calendar application (as illustrated by the label “Calendar” below application icon 28d); application icon 28e, when selected, causes computer system 101 to open a drawing application (as illustrated by the label “Drawing” below application icon 28e); application icon 28f, when selected, causes computer system 101 to open a browser application (as illustrated by the label “Browser” below application icon 28f); application icon 28g, when selected, causes computer system 101 to open a photos application (as illustrated by the label “Photos” below application icon 28g); application icon 28h, when selected, causes computer system 101 to open a settings application (as illustrated by the label “Settings” below application icon 28h); application icon 28i, when selected, causes computer system 101 to open an application store application (as illustrated by the label “App Store” below application icon 28i); application icon 28j, when selected, causes computer system 101 to open an email application (as illustrated by the label “Email” below application icon 28j); application icon 28k, when selected, causes computer system 101 to open a messages application (as illustrated by the label “Messages” below application icon 28k); application icon 28l, when selected, causes computer system 101 to open opening a media recording application (as illustrated by the label “Recording” below application icon 28l); and folder icon 28m, when selected, causes computer system 101 to open a folder with additional application icons (as illustrated by the label “Apps” below folder icon 28m) in the collection of application icons. In some embodiments, folder icon 28m corresponds to a folder 92k for “compatible” applications as described below with reference to FIG. 9Q and FIGS. 9AA-9AC. In some embodiments, applications view 8100a is a multi-section arrangement of a collection of application icons that includes three sections (e.g., as indicated by page indicator icons 8002a-8002c), and the second section, currently visible via HMD 7100a, displays a subset of the collection of application icons (e.g., application icons 28a-28l and folder icon 28m). In some embodiments, application view 8100a includes more or fewer than three sections, depending on the manual distribution of application icons among the different sections, and/or the total number of application icons included in the collection of application icons.

In FIG. 8A, the computer system 101 detects attention of user 7002 (e.g., based on user 7002's gaze, and/or other indications of user's attention) directed to tab 8004b for environments view 8100b. In response to detecting the attention of user 7002 (e.g., based on user 7002's gaze, and/or other indications of user's attention) directed to tab 8004b, the computer system 101 puts tab 8004b in focus (e.g., optionally displaying a visual feedback at the location of the user's attention, such as a gaze glow on tab 8004b, or otherwise visually highlighting tab 8004b relative to other tabs of tab menu 8004). While tab 8004b has input focus, the computer system 101 detects a selection input, such as an air pinch gesture performed with user 7002's hand 7022 while user's gaze is directed to tab 8004b.

FIG. 8B illustrates a transition from FIG. 8A that has occurred in response to the detection of the air pinch gesture while tab 8004b has input focus. In response to detecting the air pinch gesture while tab 8004b has input focus, the computer system 101 switches from displaying applications view 8100a in FIG. 8A to displaying environments view 8100b in FIG. 8B. FIG. 8B illustrates environments view 8100b of home user interface 8100, shown in a currently displayed view of the three-dimensional environment. Environments view 8100b of home user interface 8100 includes a multi-section arrangement of a collection of virtual environment icons (e.g., for opening a corresponding virtual environment or three-dimensional experience). In some embodiments, environments view 8100b provides a system user interface for browsing and/or selecting a three-dimensional environment (e.g., an environment picker user interface) to replace a currently displayed environment and/or serve as a background environment for the currently displayed applications, communication sessions, user interfaces, and/or windows. Virtual environments, when activated or opened using the corresponding environment icons, cause the computer system 101 to generate a sound and display visual effects that emulate virtual or extended reality environments different from the physical environment 7000, optionally in conjunction with, reducing or eliminating visual and audible signals from the physical environment. Example environments can be immersive worlds of mountains, outer space, ocean, and/or various other environments. In some embodiments, a level of immersion by which the virtual or extended reality environments are provided is adjustable through multiple discrete levels or a continuous range of immersion (e.g., via rotational inputs detected by digital crown 703, air gestures, touch gestures, and/or other inputs, optionally, through manipulation of a virtual immersion control object displayed in the view of the environment). In some embodiments, environments view 8100b is a multi-section arrangement of a collection of virtual environment icons that includes three sections and the second section, currently visible via HMD 7100a, displays a subset of the collection of virtual environment icons (e.g., virtual environment icons 30a, 30b, 30c, 30d, 30e, 30f, 30g, 30h, 30i, 30j, 30k, 30l, and 30m (also collectively referred to as virtual environment icons 30a-30m, or, simply, icons 30a-30m). Similar to application icons 28a-28l and folder icon 28m in applications view 8100a, virtual environment icons 30a-30m are arranged in a regular pattern (e.g., in a grid pattern, a honeycomb pattern, linearly along a line, radially along multiple radii of a circle, circumferentially around a geometric shape, and/or other patterns), and/or placed into placement locations that are arranged in accordance with the regular pattern. For example, in a hexagonal gird with three rows of 4+5+4 icons (e.g., 4 icons in the top row, 5 icons in the middle row, and 4 icons in the bottom row), the icons are placed into placement locations in a zig zag or honeycomb arrangement, as illustrated in FIGS. 8A-8D with reference to views 8100a-8100d, respectively. In some embodiments, not all placement locations in the regular pattern are occupied by a corresponding icon, and some placement locations in the regular pattern may be unoccupied at a given time. In some embodiments, unoccupied placement locations are filled automatically by reflowing icons into vacated placement locations in accordance with a sequential ordering of the placement locations (e.g., in a top-down and left-right ordering, or bottom-up and right-left ordering). In some embodiments, a respective virtual environment icon of virtual environment icons 30a-30m, when selected by a selection input, causes the computer system 101 to cease display or remove passthrough of the physical environment 7000 and display a virtual immersive environment corresponding to the selected virtual environment icon. In some embodiments, environments view 8100b displays labels indicating names, types, or other textual identifications of respective environments corresponding to virtual environment icons 30a-30m. In FIG. 8B, tab 8004b is visually emphasized (e.g., enlarged and encircled) to indicate that the view of home user interface 8100 that is currently displayed (e.g., environments view 8100b) corresponds to tab 8004b.

In FIG. 8B, the computer system 101 detects user's attention (e.g., based on user 7002's gaze, or other indications of the user's attention) directed to tab 8004c for contacts view 8100c. In response to detecting the user's attention (e.g., based on user 7002's gaze or other indications of user's attention) directed to tab 8004c, the computer system 101 puts tab 8004c in focus. While tab 8004c has input focus, the computer system 101 detects a selection input (e.g., an air pinch gesture performed with user 7002's hand 7022 while user's gaze is directed to tab 8004c).

FIG. 8C illustrates a transition from FIG. 8B that has occurred in response to the detection of the air pinch gesture while tab 8004c has input focus. In response to detecting the air pinch gesture while tab 8004c has input focus, the computer system 101 switches from displaying environments view 8100b to displaying contacts view 8100c in the currently displayed view of the three-dimensional environment. In some embodiments, if the air pinch gesture were detected while the user's attention is directed to tab 8004a, the computer system would switch from displaying environments view 8100b (e.g., as shown FIG. 8B) to displaying applications view 8100a (e.g., as shown in FIG. 8A) instead. FIG. 8C illustrates contacts view 8100c of home user interface 8100. Contacts view 8100c displays an arrangement of a collections of icons corresponding to contacts that are associated with the computer system 101 and/or with a user profile that is currently active on (e.g., logged into) the computer system 101. In some embodiments, contacts view 8100c is a system user interface from which a user can select a contact from among contacts associated with a profile of user 7002, and initiate communication with the selected contact. Contacts view 8100c also allows a user to retrieve information, such as telephone numbers, addresses, emails, and/or other contact information for a respective contact using the contact icon of the respective contact. In some embodiments, contacts view 8100c is a multi-section arrangement of a collection of contact icons that includes three sections and the second section. A currently displayed section of contact view 8100c, visible via HMD 7100a, includes a subset of the collection of contact icons, e.g., contact icons 32a, 32b, 32c, 32d, 32e, 32f, 32g, 32h, 32i, 32j, 32k, and 32l (also collectively referred to contact icons 32a-32l), and affordance 32 for adding a new contact to the contact view 8100c. In some embodiments, selection of affordance 32 causes the computer system to display a user interface for creating a new contact and entering contact information for the new contact. In some embodiments, contact icons contact icons 32a-32l include avatar representations of corresponding contacts.

Similar to applications view 8100a and environments view 8100b, contact icons 32a-30l are arranged in a regular pattern (e.g., in a grid pattern, a honeycomb pattern, linearly along a line, radially along multiple radii of a circle, circumferentially around a geometric shape, and/or other patterns), and/or placed into placement locations that are arranged in accordance with the regular pattern. In some embodiments, the regular patterns used to arrange the icons in different views of the home user interface do not have to be the same, and the grid sizes and/or grid patterns used for the different views of the home user interface are optionally different from one another based on the object types and/or quantities of objects associated with the different views. In some embodiments, a respective contact icon of contact icons 32a-32l, when selected by a selection input, causes the computer system 101 to display a user interface with controls for initiating communication with the respective contact (e.g., controls for sending a message, composing an email, making a phone or video call, and/or reviewing communication history, and/or other controls related to a communication session or message), as described in further detail below with reference to FIG. 8AI-8AJ. In some embodiments, contacts view 8100c displays labels indicating the names of the contacts under respective contact icons 32a-32l, as illustrated in FIG. 8X. In FIG. 8C, tab 8004c is visually emphasized (e.g., enlarged and encircled) to indicate that the view that is currently displayed (e.g., contact view 8100c) corresponds to tab 8004c.

In some embodiments, applications view 8100a, environments view 8100b, and contacts view 8100c are individually configurable. In some embodiments, user interface objects within a respective view of views 8100a-8100c are repositionable within the respective view (e.g., from one location to another in one section or to different sections of the same view), but cannot be relocated to a different view with user interface objects of a different type. For example, in some embodiments, application icons displayed in applications view 8100a cannot be moved to environments view 8100b or contacts view 8100c, but application icons can be repositioned across sections and/or within a respective section of applications view 8100a. Similarly, in some embodiments, contact icons displayed in contacts view 8100c cannot be moved to environments view 8100b or applications view 8100a, but contact icons can be repositioned across sections and/or within a respective section of contacts view 8100c. Similarly, in some embodiments, environment icons cannot be moved to applications view 8100a or contacts view 8100c, but environment icons can be repositioned across sections and/or within a respective section of environments view 8100b. Accordingly, home user interface 8100 is segmented into different views 8100a-8100c based on object type, and one view is reconfigurable at a time.

In some embodiments, the number of sections included in a view of home user interface 8100 depends on the number of user interface objects in the respective collection of objects included in the view. For example, each section in a view (e.g., views 8100a-8100c) has a predetermined number of placement locations that can be occupied by respective icons and are optionally arranged in a grid pattern (e.g., 3+4+3; 4+5+4; 5+6+5; and/or other number of placement locations and/or grid configurations).

FIG. 8D illustrates a view 8100d of home user interface 8100 that includes a collection of user interface objects of the same type (e.g., application icons, contact icons, virtual environment icons, documents, images, folders or another collection of icons and/or objects that correspond to user interface objects of the same type). In some embodiments, view 8100d corresponds to a respective view of views 8100a-8100c. In some embodiments, the collection of user interface objects in view 8100d spreads over multiple sections. For example, view 8100d of home user interface 8100 in FIG. 8D displays the second section in a sequence of three sections of view 8100d. The second section includes a subset of icons in the collection of icons of the same type in view 8100d. The subset of icons in the second section includes icon O14 34a (referred to as icon 34a), icon O15 34b (referred to as icon 34b), icon O16 34c (referred to as icon 34c), icon O17 34d (referred to as icon 34d), icon O18 34e (referred to as icon 34e), icon O19 34f (referred to as icon 34f), icon O20 34g (referred to as icon 34g), icon O21 34h (referred to as icon 34h), icon O22 34i (referred to as icon 34i), icon O23 34j (referred to as icon 34j), icon O24 34k (referred to as icon 34k), icon O25 34l (referred to as icon 34l), and icon O26 34m (referred to as icon 34m) (collectively referred to as icons 34a-34m). In some embodiments, some placement locations in a respective section are not occupied, e.g., left unoccupied based on the user's configuration inputs and/or based on spatial clustering of icons. In some embodiments, view 8100d of home user interface 8100 corresponds to one of views 8100a-8100c. In some embodiments, techniques, interactions, and user interfaces described in relation to view 8100d of home user interface 8100 are applicable to views 8100a-8100c of home user interface 8100, and vice versa.

In the examples provided with reference to FIGS. 8A-8AL, gaze and/or air gestures, including direct or indirect air gestures, such as pinch gestures, long pinch gestures, pinch and drag gestures, and/or double pinch gestures are used to interact with user interface objects in home user interface 8100 (e.g., application icons 28a-28l and folder icon 28m in applications view 8100a; contact icons 32a-32l and affordance 32 in contacts view 8100c; virtual environment icons 30a-30m in environments view 8100c; icons 34a-34m in view 8100d of home user interface 8100; and/or other computer-generated content in the three-dimensional environment visible via HMD 7100a), according to some embodiments. In some embodiments, in addition to or alternatively to using air gestures and/or gaze, other types of inputs, other indications of user's attention, and/or other selectors of targeted locations and objects for inputs, are used. For example, in some embodiments, touch inputs detected via a touch sensitive surface (e.g., touch-sensitive surface of a display generation component or a trackpad), point, click, and/or drag inputs detected via a mouse, and/or rotation and activation inputs detected via a dial, button, or other hardware controls, are used to interact with computer-generated content or objects in the three-dimensional environment.

In some embodiments, when a reconfiguration mode of a respective view of a home user interface is active (e.g., an icon reconfiguration mode is activated by a user from the respective view displayed in the normal mode), positions and/or availability of icons in a collection of icons in the respective view of the home user interface (e.g., a collection of application icons 28a-28l in applications view 8100a; a collection of virtual environment icons 30a-30m in environments view 8100b; a collection of contact icons 32a-30l in contacts view 8100c; or a collection of icons 34a-34m in view 8100d) can be adjusted in response to user inputs. In contrast, positions and/or availability of icons in a respective view of the home user interface displayed in a normal mode (e.g., a non-reconfiguration mode in which icons are used to cause the computer system to perform their corresponding functions, such as launching applications, displaying environments, and initiating communications) are not adjustable. Home user interface 8100 visible via HMD 7100a is in the normal mode in the scenarios of FIGS. 8A-8D. In some embodiments, in conjunction with activating the reconfiguration mode (e.g., after, before, in response to, or in response to an event that cause the device to enter the reconfiguration mode, substantially simultaneously with activating the reconfiguration mode, or concurrently with activating the reconfiguration mode), the computer system 101 displays a preview of portions (e.g., one or more icons) on adjacent pages or sections of the currently displayed section, as described in further detail with reference to FIGS. 8E-8F.

In FIG. 8E, the computer system 101 detects a long pinch gesture 280 performed with user 7002's hand 7022 while icon 34l has input focus. The computer system 101 puts icon 34l into focus in response to the detection of gaze 282 of user 7002 that is directed to icon 34l for more than a threshold amount of time with less than a threshold amount of movement. In some embodiments, the computer system provides visual feedback indicating that icon 34l has gained input focus, e.g., by enlarging icon 34l, and/or lifting icon 34l toward the viewpoint of the user. In some embodiments, detecting the long pinch gesture 280 includes detecting a pinch gesture (e.g., two or more fingers coming into contact with one another to form a pinched posture) that is maintained for at least a threshold amount of time (optionally, with less than a threshold amount of movement as a whole) before the pinched posture of the hand ceases to detected (e.g., when the pinching fingers break contact from one another).

In some embodiments, an icon or user interface object gains input focus as a result of selection by a concurrently and/or previously detected gaze input, a concurrently or previously detected pointer input, and/or a concurrently and/or previously detected gesture input (e.g., concurrently and/or previously detected in relation to a hand gesture, such as an air pinch gesture). For example, in FIG. 28E, icon 34l gains input focus as a result of concurrently and/or previously detected gaze input 282 of user 7002 directed to icon 34l. In some embodiments, gestures described in relation to FIGS. 8A-8AL can be indirect air gestures or direct air gesture (e.g., performed at a location in the physical environment 7000 that corresponds to or intersects with a region or location of a target object in the three-dimensional environment visible via HMD 7100a). In response to the detection of long pinch gesture 280 while icon 34l has input focus, the computer system 101 activates the reconfiguration mode of view 8100d, as illustrated in FIG. 8F.

In some embodiments, the reconfiguration mode of a respective view can be activated in a number of ways, including, but not limited to, pinching and holding on an icon for at least a first threshold amount of time with less than a threshold amount of movement (optionally, triggering display of a contextual menu associated with the icon), followed by dragging the icon in a respective view of home user interface 8100 while maintaining the pinch and hold gesture (e.g., without the need to select a menu option from the contextual menu or perform a different input to activate the reconfiguration mode before dragging the icon); selecting a menu option (optionally, displayed in a contextual menu) for activating the reconfiguration mode (e.g., the menu is optionally displayed in response to pinching and holding on the icon for at least a first threshold amount of time with less than a threshold amount of movement); using a long air pinch gesture directed to an icon in the collection of icons or directed at the collection of icons but not necessarily at a specific icon, where the long air pinch gesture includes pinching and holding for at least a second threshold amount of time (optionally, longer than the first threshold amount of time) with less than a threshold amount of movement; and/or using a direct air gesture such as air tap or long air tap directed at the collection of icons and/or at a particular icon in the collection of icons.

FIG. 8F is a transition from FIG. 8E in response to the detection of long pinch gesture 280 while icon 34l has input focus. In response, the computer system 101 activates the reconfiguration mode of view 8100d of home user interface 8100. In conjunction with activating the reconfiguration mode of view 8100d, the computer system 101 optionally displays a preview of portions (e.g., one or more icons) of adjacent pages (e.g., the first column of icons in the grid of icons on the subsequent page and/or the last column of icons on grid of icons on the previous page) concurrently with the page in focus. For example, the computer system 101 displays in view 8100d of FIG. 8F, a preview of icons 34n, 340, and 34p included in the third section of view 8100d of home user interface 8100 (e.g., displayed in the right hand side relative to the arrangement of icons 34a-34m in the middle section), and a preview of icons 34q, 34r, and 34s included in the first section of view 8100d (e.g., displayed in the left hand side relative to the arrangement of icons 34a-34m in the middle section). In some embodiments, if there is no adjacent section or page on the left side, right side, or both sides, the computer system 101 forgoes displaying the previews of any icons on the left side, right side, or both sides, respectively. In some embodiments, icons 34q, 34r, 34s, 34n, 340, and 34p in the previews are visually deemphasized relative to icons 34a-34m in the middle section (e.g., that is currently in focus). For example, icons 34q, 34r, 34s, 34n, 340, and 34p in the previews are dimmed, blurred, faded, reduced in size, made more translucent, pushed away from a viewpoint of user 7002, and/or otherwise visually deemphasized relative to icons 34a-34m in the section that is currently in focus. In some embodiments, instead of or in addition to displaying portions of the adjacent sections as previews of the adjacent sections, the computer system 101 displays some other indication of the adjacent sections in conjunction with activating the reconfiguration mode (e.g., partial frame or outline of the respective adjacent section, outlines of placement locations for icons on the respective adjacent section, user interface element(s) or navigation control(s) that point to the adjacent section or indicate the adjacent section, and/or other visual indications). In embodiments in which the display generation component of computer system 101 is a head-mounted display, icons 34q, 34r, 34s, 34n, 340, and 34p are displayed in a peripheral region of a field of view of user 7002 or viewport into the three-dimensional environment, as provided via HMD 7100a. In some embodiments, icons in the second section and the preview of icons in the adjacent sections are displayed on a curved surface, with the icons in the middle section closer to the viewpoint of the user, and the icons in the adjacent sections farther away from the viewpoint.

In some embodiments, in the reconfiguration mode of view 8100d, the computer system 101 displays deletion affordances on or near icons that can be deleted from view 8100d and does not display deletion affordance at or near application icons that cannot be deleted from view 8100d (e.g., such as applications that are part of the pre-installed applications on the operating system or system applications that a user cannot delete via inputs in the reconfiguration mode). In some embodiments, in the reconfiguration mode of view 8100d, the computer system 101 displays different accessory affordances (e.g., a pin/unpin affordance, a favoriting/unfavoriting affordance, a close/add affordance, an offload/download affordance, and/or other affordance for performing an edit function with respect to a user interface object in the home user interface 8100) in association with icons. In some embodiments, accessory affordances with respect to icons in the home user interface 8100 include affordances for editing a state, property, location, priority, and/or other characteristics of corresponding icons, and/or other types of affordance for reconfiguring the home user interface 8100 with respect to corresponding icons, as described in further detail below in relation to FIGS. 8N-8P (e.g., illustrating offload affordances displayed at or near environment icons 30a-30m when environments view 8100b is in the reconfiguration mode) and FIGS. 8AA-8AD (e.g., illustrating affordances for marking a contact “favorite” and affordances for making a contact “not favorite”, displayed at or near contact icons 32a-32l).

In the scenario of FIG. 8F, in conjunction with activating the reconfiguration mode of view 8100d, and while view 8100d of home user interface 8100 is in the reconfiguration mode, the computer system 101 displays respective deletion affordances on or near respective icons 34a, 34b, 34c, 34e, 34f, 34g, 34j, 34k, 34l, and 34m for deleting the respective icons, such as deletion affordance 34a′ for deleting icon 34a, while icons 34d, 34h, 34i are displayed without corresponding deletion affordances as their corresponding objects cannot be deleted from the computer system 101 (e.g., uninstalled, removed, offloaded, and/or otherwise deleted) by a user. As shown in FIG. 8F, the preview of the adjacent pages that includes a view of icons 34q, 34r, and 34s in the first section of view 8100d, and a view of icons 34n, 340, and 34p in the third section of view 8100d, do not include respective deletion affordances for the icons in the adjacent sections, because icons displayed in the preview cannot gain input focus unless their corresponding section is currently in focus (e.g., becomes the currently displayed section).

In some embodiments, while the tab menu 8004 is visible when a respective view of the home user interface 8100 is displayed in the normal mode, the computer system 101 optionally ceases to display the tab menu 8004, in accordance with a determination that the respective view of the home user interface 8100 has transitioned from the normal mode into the reconfiguration mode (e.g., as illustrated in FIG. 8F, where view 8100d of home user interface 8100 is displayed in the reconfiguration mode without tab menu 8004, compared with FIG. 8E where view 8100d of home user interface 8100 is displayed in the normal mode with tab menu 8004). For example, in some embodiments, the computer system 101 can use the tab menu 8004 displayed in the normal mode to switch to a different view of views 8100a-8100c of home user interface 8100, after finishing the rearrangement or reconfiguration of the currently displayed view (e.g., view 8100d in the scenario of FIG. 8F) and exiting the reconfiguration mode. In some embodiments, switching to a different view of home user interface 8100 while the home user interface 8100 is in the reconfiguration mode is not enabled. Accordingly, the computer system 101 forgoes displaying tab menu 8004 for switching between different views ((e.g., views 8100a-8100c and/or 8100d) of home user interface 8100 when home user interface 8100 is in the reconfiguration mode (e.g., as illustrated in FIG. 8F).

In some embodiments, in the reconfiguration mode of a respective view of home user interface 8100, the computer system 101 displays a control for saving any changes or modifications that are made to the respective view of home user interface 8100 (e.g., changes made in one of views 8100a-8100d). For example, in conjunction with activating the reconfiguration mode of view 8100d, and while view 8100d of home user interface 8100 is in the reconfiguration mode, the computer system 101 displays “Done” button 28028 in home user interface 8100 that, when selected, causes the computer system 101 to exit the reconfiguration mode while also maintaining any changes that were made to view 8100d (e.g., including the addition, deletion, change of status and/or property, and/or relocation of icons in one or more sections of view 8100d). In contrast, in some embodiments, other ways for exiting the reconfiguration mode (e.g., an air pinch gesture detected in conjunction with a gaze directed to an unoccupied portion of the three-dimensional environment) cause the computer system 101 to exit the reconfiguration mode without maintaining the changes made during the reconfiguration mode (e.g., view 8100d of home user interface 8100 is restored to the state it was in before entering the reconfiguration mode).

In some embodiments, in conjunction with activating the reconfiguration mode (e.g., in response to long air pinch gesture 280 detected in FIG. 8E) and displaying the preview of icons on adjacent sections, the computer system 101 provides additional visual feedback that icons in the home user interface 8100 can be repositioned, deleted, rearranged, and/or otherwise modified. For example, while in the reconfiguration mode, icons 34a-34m oscillate in three dimensions to provide visual feedback on the operational state of the computer system 101. Example oscillating motions of icons 34a-34m are illustrated using icon O21 34h in side view 281 in FIG. 8F. Side view 281 illustrates a series of different intermediate states 281a, 281b, 281c, 281d, 281e, and 281f of the oscillating motion of icon O21 34h. In some embodiments, the oscillations of the respective icon O21 34h includes clockwise or counter-clockwise spinning motions and back and forward wobble motions of the respective icon O21 34h (e.g., relative to an anchor position associated with the respective icon, such as a center or central axis of the placement location for the respective icon, or the center or central axis of the icon itself). Further, graphical layers of the respective icon O21 34h are used to create a simulated parallax effect during the movement of the respective icon.

In some embodiments, icons 34a-34m oscillate rotationally around respective centers, and/or axes that go through the respective centers of respective icons and perpendicular to a platter or surface (e.g., optionally not visible in the three-dimensional environment but illustrated in side view 281) on which icons 34a-34m are placed in the three-dimensional environment. In some embodiments, other icons in home user interface 8100 included in other views 8100a-8100c are also placed on the same platter (e.g., are located on the same plane or surface in the three-dimensional environment, such as plane 287 illustrated in side view 281, and/or at the same distance away from the viewpoint of user 7002).

In some embodiments, icons 34a-34m (and other icons in home user interface 8100 included in other views 8100a-8100c) are volumetric or three-dimensional (e.g., as opposed to two dimensional) shapes, as illustrated in side view 281 in FIG. 8F. Optionally, icons 34a-34m have a convex, rounded, disc, or dome shape (e.g., such as a hemisphere or similar three-dimensional shape). In some embodiments, icons 34a-34m have synchronized movements or asynchronized movements in the lateral dimensions of the arrangement and/or in the depth dimension relative to the viewpoint of the user. In some embodiments, the oscillations of different icons 34a-34m are synchronized and/or have the same amplitudes, phases, and/or frequencies. In some embodiments, the oscillations of different icons 34a-34m are asynchronized, and/or have the different amplitudes, phases, and/or frequencies. In some embodiments, the icons 34a-34m each oscillate around an anchor position (e.g., a center or central axis) as if the curved edges of the respective icons 34a-34m are oscillating and/or wobbling on a flat surface (e.g., as if coins are dropped on a floor, imitating a plate spinning oscillation). In some embodiments, the sides of icons 34a-34m that are opposite of user 7002's viewpoint are optionally flat and parallel to a plane, such as plane 287, when in normal mode, and tilt and wobble back and forth relative to the plane in the depth dimension, as illustrated in side view 281.

In some embodiments, while home user interface 8100 is in the normal mode, as illustrated in FIG. 8E, the computer system 101 outputs a first ambient sound (optionally, continuous ambient sound) to indicate that the computer system 101 is operational and, optionally, that the home user interface 8100 is visible via HMD 7100a, as illustrated by sound waves marked A in FIG. 8E. In some embodiments, the ambident sound A is chosen by a user from a plurality of ambient sounds provided by the computer system. In some embodiments, the ambient sound A is automatically chosen by the computer system. In some embodiments, the ambident sound A is chosen based on a theme or environment that is applied in the three-dimensional environment. In some embodiments, the ambient sound A is optionally chosen based on a three-dimensional virtual environment last launched from the environments view 8100b. In some embodiments, the computer system 101 outputs the ambient sound A while the computer system is running or while it is mounted on user 7002's head (e.g., and not necessarily dependent on whether a home user interface is visible). In FIG. 8E, the ambient sound A is played or outputted while the home user interface 8100 is visible via HMD 7100a and is in the normal mode (e.g., as opposed to a reconfiguration mode). Optionally, the ambient sound A is stopped, in accordance with a determination that the home user interface 8100 is no longer visible and, optionally, changed or replaced with a different ambient sound. In some embodiments, the ambient sound A, optionally, spatially spans the three-dimensional environment and forms part of the three-dimensional experience in the environment, as opposed to serving as audio feedback that is played in response to inputs and/or events with respect to an individual object in the environment. In some embodiments, in conjunction with activating the reconfiguration mode, the computer system 101 changes the output parameters of the ambient sound A. For example, after entering the reconfiguration mode, the computer system 101 reduces the volume of the ambient sound A, removes the ambient sound A, or changes the ambient sound A to a different ambient sound A′ (e.g., with a different amplitude, frequency, phase, and/or wave pattern), as illustrated by sound waves marked A′ in FIG. 8F. In some embodiments, FIGS. 8F-8J illustrate that the ambient sound A′ is playing continuously while the home user interface 8100, visible via HMD 7100a, is in the reconfiguration mode. In some embodiments, the same ambient sound A′ is generated and outputted while the home user interface 8100 is in the icons reconfiguration mode irrespective of which view of views 8100a-8100d is visible via HMD 7100a. Optionally, a different ambient sound is generated or outputted depending on which view of views 8100a-8100d is visible via HMD 7100a.

In some embodiments, the ambient sounds A and A′ that are playing in the environment are part of the experience provided by computer system 101 and, optionally, indicate that a system user interface such as a home user interface 8100 is currently displayed in the environment. The ambient sounds A and A′ that are playing in the environment while the home user interface 8100 is displayed (e.g., respectively in normal mode and reconfiguration mode) are different from sounds that are generated by the computer system 101 in response to the detection of user inputs (e.g., gaze inputs and/or air gestures). For example, in FIG. 8E, the computer system 101 can generate a distinctive “hover” sound (e.g., a sound that is played when a user's attention is detected on a potential target of a gesture input, or another type of audio feedback) in accordance with a determination that gaze 282 is directed to icon O25 34l (e.g., gaze 282 is maintained on icon O25 34l for more than a threshold amount of time to put icon O25 34l in focus). In some embodiments, the same distinctive hover sound is generated when the user 7002's gaze shifts from one icon to another or shifts the attention from one user interface object to another that causes the input focus to shift to the other icon or user interface object (e.g., to provide audio feedback that a respective user interface object is in focus). In some embodiments, the hover sound used in the normal mode is removed, changed, or replaced with a different hover sound (e.g., a sound that is lower in volume, higher in volume, higher in frequency, lower in frequency, having a different wave pattern, or otherwise different in one or more audio qualities) while the home user interface 8100 is in the reconfiguration mode. For example, a different hover sound is generated when user 7002's gaze 294 is directed to icon O21 34h. In some embodiments, the hover sound indicating that user's attention is directed to a respective user interface object is different from the continuous ambient sounds A and A′. In some embodiments, the hover sound is outputted in response to the detection of shifts in user 7002's attention to a respective user interface object, whereas the ambient sound A and/or ambient sound A′ are continuously outputted (e.g., while home user interface 8100 is visible). In some embodiments, in FIG. 8E, the computer system 101 generates another sound (e.g., a selection input sound) in accordance with a determination that long pinch gesture 280 is detected. In some embodiments, the computer system 101 ceases to generate and output the selection input sound, in accordance with a determination that the long pinch gesture 280 is released. In some embodiments, the hover sound is different from the selection input sound. In some embodiments, the selection input sound is different from the continuous ambient sounds A and A′ and, optionally, is outputted while the continuous ambient sound A or A′ is ongoing.

In some embodiments, in conjunction with activating the reconfiguration mode and displaying the preview of portions of the adjacent section(s) (e.g., displaying a preview of icons 34q, 34r, 34s, 34n, 340, and 34p) of view 8100d of home user interface 8100, passthrough portions of the three-dimensional environment visible via HMD 7100a (e.g., camera view and/or optical passthrough view of the physical environment) are visually deemphasized (e.g., darkened, blurred, made more translucent, less saturated, relative to the passthrough portions of the three-dimensional environment visible via HMD 7100a in FIG. 8E before activating the reconfiguration mode), as illustrated in FIGS. 8F-8J. For example, in the reconfiguration mode, passthrough portions become darker while icons in view 8100d of home user interface 8100 maintain their brightness.

In some embodiments, while the reconfiguration mode is active, icons in a respective view of views 8100a-8100c can be relocated within a section (e.g., moved from one placement location to another in the same section) or to another section of the respective view of views 8100a-8100c. FIGS. 8G-8J illustrate relocating an icon within the same row of the same section in view 8100d of home user interface 8100, in accordance with some embodiments.

FIG. 8G illustrates view 8100d of home user interface 8100 in the reconfiguration mode. View 8100d in FIG. 8G illustrates the same collection and arrangement of icons as illustrated in FIG. 8F. In FIG. 8G, the computer system 101 detects gaze input 28230 of user 7002 directed to icon 34h (e.g., with less than a threshold amount of movement for more than a threshold amount of time) that causes the computer system 101 to put icon 34h in focus. In some embodiments, in response to detecting the gaze input 28230, the computer system 101 generates and outputs a hover sound indicating that user's attention has moved input focus to icon 34h. Further, in FIG. 8G, the computer system 101 detects an air pinch gesture 298 performed with user 7002's hand 7022 while icon 34h has input focus (e.g., as a result of gaze input 28230). In response to the detection of air pinch gesture 298 while icon 34h is in focus, the computer system 101 selects icon 34h and optionally lifts icon 34h towards the viewpoint of the user 7002 and away from plane 287 (e.g., moving the selected icon 34h closer to the viewpoint of user 7002) resulting in an increased distance in depth between icon 34h and plane 287, as illustrated in top view 285 in FIG. 8G. In some embodiments, if the air pinch gesture 298 was detected while view 8100d is in the normal mode (e.g., as opposed to the reconfiguration mode) and does not meet a first input threshold before termination (e.g., is not a long air pinch, or a pinch and drag gesture), the computer system 101 opens the respective object and/or content that corresponds to the selected icon 34h (e.g., opens a user interface of corresponding application, opens a user interface with respect to a corresponding contact, and/or opens a virtual environment). FIG. 8G further illustrates that user 7002's hand is about to move in a leftward direction while maintaining the air pinch gesture, as illustrated by the dashed arrow. Top view 285 in FIG. 8G illustrates the position of icon 34h relative to icon 34g in plane 287 and the direction of movement of icon 34h towards icon 34g with a dashed arrow.

FIG. 8H is a transition from FIG. 8G in response to the detection of movement input 298a while the pinch gesture 298 of user 7002's hand 7022 is maintained. Movement input 298a is detected while icon 34h is selected (e.g., as a result of the pinch gesture 298 detected in FIG. 8G while icon 34h is in focus). In response to the detection of movement input 298a while icon 34h is selected, the computer system 101 moves icon 34h in a leftward direction towards icon 34g, in accordance with the characteristics of movement input 298a (e.g., direction, speed, amount, acceleration, and/or other movement characteristics). For example, in FIG. 8H, icon 34h is moved closer or adjacent to icon 34g (e.g., relative to location of icon 34h in FIG. 8G) in accordance with movement input 298a. The movement of icon 34h is additionally illustrated in top view 285 in which icon 34h has moved along the dashed arrow in accordance with the movement input 298a.

In some embodiments, when an icon is being dragged or moved, the computer system 101 assists a user by providing visual feedback (e.g., to indicate that the computer system 101 is responding to user 7002's inputs) and automatically moves icons to fill up vacated placement locations in the grid of icons or to move away from a dragged icon or icons. For example, when an icon is being dragged, the dragged icon initially pushes away respective one or more adjacent icons in the grid toward which the dragged icon is moved. The respective one or more icons are pushed away until some movement criteria with respect to the dragged icon is satisfied. In accordance with a determination that the movement criteria are satisfied, the computer system 101 ceases to push away the respective one or more icons and causes one of the respective one or more icons to move in the opposite direction toward the dragged icon, to pass the dragged icon (e.g., appear to slide underneath the dragged icon), and to move into a placement location in the grid that was previously occupied by the dragged icon. Optionally, the computer system 101 further restores locations of other icons, if any, of the respective one or more icons that were initially pushed. In some embodiments, the movement criteria include a determination whether the dragged icon has passed a midpoint of one of the respective one or more icons (and/or a midpoint of corresponding placement location of one of the respective one or more icons). In some embodiments, the dragged icon and the one or more other icons near the dragged icon move like air bubbles in water (e.g., repelling one another, before attracting one another).

FIGS. 8H-8J illustrate that user 7002 is dragging icon 34h within the same row in the gird of icons in view 8100d while home user interface 8100 is in the reconfiguration mode. As illustrated in FIG. 8H, the dragged icon 34h initially pushes the adjacent icon 34g in a direction away from dragged icon 34h (e.g., adjacent icon 34g is pushed leftward because it is an icon toward which dragged icon 34h is moved). Top view 285 in FIG. 8H illustrates the position of icon 34h relative to icon 34g. Top view 285 further illustrates that icon 34g is about to move in the opposite direction toward icon 34h (e.g., as opposed to in a direction pointing away from icon 34h as illustrated in FIG. 8G), and continue to move past icon 34h to fill up the placement location vacated by icon 34h (e.g., as illustrated by the dashed arrows in FIG. 8H).

FIG. 8I is a transition from FIG. 8H in response to the detection of further movement 298a that causes icon 34h to be further dragged in the leftward direction. FIG. 8I illustrates that icon 34g that was initially pushed away from icon 34h has since moved toward and past icon 34h and moved into the placement location in the grid that was occupied by icon 34h (e.g., in accordance with a determination that icon 34h passed a midpoint of the placement location that was occupied by icon 34g). Further, FIG. 8I illustrates that icon 34f, after having been pushed away by icon 34h toward icon 34e, has reversed its movement direction and is about to slide underneath icon 34h to move into the placement location previously occupied by icon 34g. Top view 285 in FIG. 8I illustrates the position of icon 34h relative to icons 34f and 34g. Further, top view 285 illustrates that icon 34f is moving toward icon 34g to fill up the placement location vacated by icon 34g (e.g., as illustrated by the dashed arrow in top view 285 of FIG. 8I).

FIG. 8J is a transition from FIG. 8I in response to the detection of a release 300 of air pinch gesture 298 (e.g., pinched fingers breaking contact with one another, or other types of termination of the air pinch gesture). In response to the detection of the release 300 of air pinch gesture 298, the computer system 101 places icon 34h in the placement location previously occupied by icon 34f and shifts icon 34f to the placement location previously occupied by icon 34g. Icon 34g has already been moved to the placement location originally occupied by icon 34h in FIG. 8I. Accordingly, icon 34h has been moved within the middle row by two spots in the leftward direction and icons 34f and 34g have automatically shifted and moved away to make room for the dragged icon 34h and to fill in the placement location vacated by icon 34h. FIG. 8J shows a stable state of the rearrangement of icons 34h, 34g, and 34g in view 8100d of home user interface 8100, after the termination of both the pinch gesture 298 and the movement input 298a.

FIGS. 8K-8T illustrate interactions with icons in a respective view (e.g., environments view 8100b) in a normal mode (e.g., opening a virtual environment that is loaded on computer system 101), before the respective environment is edited in a reconfiguration mode (e.g., editing environments view 8100b in the reconfiguration mode). Further, FIGS. 8K-8T illustrate editing operations with respect to virtual environments represented by environment icons in environments view 8100b (e.g., offloading a virtual environment and selecting an offloaded virtual environment to reload the virtual environment) and results of the editing operations, in accordance with some embodiments.

FIG. 8K illustrates the same collection of virtual environment icons 30a-30m in environments view 8100b as illustrated in FIG. 8B. In FIG. 8K, environment view 8100b of the home user interface 8100 is displayed in the normal mode (e.g., as opposed to the reconfiguration mode). In the scenario of FIG. 8K, the virtual environments represented by environment icons 30a-30m are downloaded and loaded on computer system 101 and are available for user access (e.g., can be opened and displayed in response to user selection). The computer system 101 detects an air pinch gesture 280k corresponding to a selection input performed with user 7002's hand 7022 while environment icon 30h has input focus (e.g., as a result of gaze input 282k directed to environment icon 30h). In response to the detection of air pinch gesture 280k while environment icon 30h has input focus, the computer system 101 opens a three-dimensional virtual or extended reality environment “Alps” corresponding to environment icon 30h (e.g., because the environment “Alps” is already downloaded and loaded on computer system 101). In some embodiments, in response to the selection of environment icon 30h, the computer system 101 generates a selection sound B corresponding to a sound for selecting a virtual or extended reality environment that is downloaded and loaded and that can be successfully displayed right away. In contrast, a different selection sound B′ is generated when the environment icon for an offloaded environment is selected to alert the user that additional steps are required to display the selected environment, as described below with reference to FIG. 8Q.

FIG. 8L is a transition from FIG. 8K in response to the detection of air pinch gesture 280k while environment icon 30h has input focus. FIG. 8L illustrates that a three-dimensional virtual or extended reality environment “Alps” 8102 corresponding to the selected environment icon 30h is displayed via HMD 7100a. In some embodiments, the environment “Alps” 8102 is a virtual three-dimensional environment that replaces a previously displayed three-dimensional environment (e.g., the augmented reality environment including the home user interface 8100 and a passthrough view of the physical environment 7000). FIG. 8L illustrates that passthrough portions of the three-dimensional environment that were previously visible (e.g., walls 7004′ and 7006′ and floor 7008′) have been obscured and/or replaced by computer generated content corresponding to virtual environment “Alps” 8102, thereby resulting in a more immersive experience. In some embodiments, in addition to displaying virtual environment “Alps” 8102, the computer system 101 ceases display of home user interface 8100. Further, in some embodiments, the computer system 101 generates and outputs an ambient sound (e.g., recorded or simulated sound of winds and nature in a snowy mountain range) that forms part of experience in the virtual environment “Alps” 8102, thereby further enhancing the immersive experience.

FIG. 8M illustrates the same collection of environment icons 30a-30m in environments view 8100b as illustrated in FIG. 8K. For example, the state of environments view 8100b in FIG. 8M is the same as the state of environments view 8100b in FIG. 8K. FIG. 8M illustrates one or more inputs that cause the computer system 101 to active the reconfiguration mode. For example, in FIG. 8M, the computer system 101 detects a long pinch gesture 280m performed with user 7002's hand 7022 while gaze input 282m is directed toward environments view 8100b (e.g., a location in the collection of icons 30a-30m but not necessarily toward a particular virtual environment icon).

FIG. 8N is a transition from FIG. 8M. In response to the detection of long pinch gesture 280m while gaze input 282m is directed toward view 8100b, the computer system 101 activates the reconfiguration mode of environments view 8100b, and displays environments view 8100b in the reconfiguration mode. Displaying environments view 8100b in the reconfiguration mode includes displaying offload affordances in association with respective environment icons 30a-30m that are currently loaded on the computer system and available for user access in the normal mode. For example, in conjunction with activating the reconfiguration mode, the computer system 101 displays offload affordance 30a′ in association with environment icon 30a corresponding to virtual or extended-reality environment “Summer,” displays offload affordance 30b′ in association with environment icon 30b corresponding to virtual or extended-reality environment “Joshua Tree,” displays offload affordance 30c′ in association with environment icon 30c corresponding to virtual or extended-reality environment “Spring,” displays offload affordance 30d′ in association with environment icon 30d corresponding to virtual or extended-reality environment “Winter,” displays offload affordance 30e′ in association with environment icon 30e corresponding to virtual or extended-reality environment “Clouds,” displays offload affordance 30f′ in association with environment icon 30f corresponding to virtual or extended-reality environment “Moon,” displays offload affordance 30g′ in association with environment icon 30g corresponding to virtual or extended-reality environment “Forest,” displays offload affordance 30h′ in association with environment icon 30h corresponding to virtual or extended-reality environment “Alps,” displays offload affordance 30i′ in association with environment icon 30i corresponding to virtual or extended-reality environment “Rain,” displays offload affordance 30j′ in association with environment icon 30j corresponding to virtual or extended-reality environment “Beach,” displays offload affordance 30k′ in association with environment icon 30k corresponding to virtual or extended-reality environment “Giza,” displays offload affordance 30l′ in association with environment icon 30l corresponding to virtual or extended-reality environment “Snow,” and displays offload affordance 30m′ in association with environment icon 30m corresponding to virtual or extended-reality environment “Space.” Further, in conjunction with activating the reconfiguration mode, the computer system 101 displays a preview of adjacent sections, including a preview of icons 30n, 30o and 30p in the third section of environments view 8100b and a preview of icons 30q, 30r and 30s in the first section of environments view 8100b. As illustrated, icons 30n, 30o, 30p, 30q, 30r and 30s in the previews are visually deemphasized relative to icons 30a-30m that are displayed in the section of environments view 8100b that is in focus. Further, in conjunction with activating the reconfiguration mode, the computer system 101 visually deemphasizes passthrough portions of the three-dimensional environment visible via HMD 7100a (e.g., similar to FIG. 8F in which view 8100d of home user interface 8100 is in the reconfiguration mode).

In some embodiments, environment icons 30a-30m and other environment icons in environments view 8100b can be rearranged or relocated within sections of in environments view 8100b (e.g., similar to how icon 34h is relocated in FIGS. 8G-8J). In some embodiments, positions of environment icons in environments view 8100b cannot be changed by a user (e.g., even while the reconfiguration mode is active) unlike other icons in other views, such as application icons 28a-28l in applications view 8100a, irrespective of whether the reconfiguration mode is active. For example, different sets of reconfiguration operations are enabled for different views of home user interface in the reconfiguration mode, and the different sets of reconfiguration operations may or may not include repositioning operations, pinning/unpinning operations, deletion/addition operations, offloading/downloading operations, favoriting operations, and/or other operations for icons, depending on the object types of the icons or views of the home user interface, in accordance with some embodiments.

In FIG. 8N, user's attention (e.g., based on gaze input 282n) is directed to offload affordance 30h′ associated with environment icon 30h corresponding to virtual or extended-reality environment “Alps” (e.g., same environment that is opened in FIG. 8K and displayed in FIG. 8L). In response to the detection of the user's attention (e.g., based on gaze input 282n) directed to offload affordance 30h′, the computer system 101 puts offload affordance 30h′ in focus. Further, the computer system 101 lifts offload affordance 30h′ towards the viewpoint of user 7002 and, optionally, enlarges and/or otherwise visually emphasizes offload affordance 30h′ (e.g., causing offload affordance 30h′ to become brighter, highlighted, less translucent, and/or displayed with other visual or non-visual emphasizing effect). For example, the offload affordance 30h′ lifts off and moves away from environment icon 30h resulting in an increased gap in depth between offload affordance 30h′ and environment icon 30h, as illustrated in perspective side view 283. Perspective side view 283 illustrates different stages 283a, 283b, and 283c of the process of moving offload affordance 30h′ towards the viewpoint of user 7002 (e.g., and/or away from environment icon 30h) while maintaining the reduced distance of environment icon 30h from the viewpoint of the user 7002. For example, stage 283a shows the environment 30h and offload affordance 30h′ at their original depths with minimal gap in between, stage 383b shows environment icon 30h has been lifted away from its original depth toward the viewpoint of the user and offload affordance 30h has been lifted away from environment icon 30h toward the viewpoint of the user to create a first amount of gap between environment icon 30h and offload affordance 30h′, and stage 383c shows that after environment icon 30h has stopped at a first reduced depth from the viewpoint of the user, offload affordance is lifted further away from environment icon 30h toward the viewpoint of the user until a second amount of gap is created between environment icon 30h and offload affordance 30h, in accordance with some embodiments.

In some embodiments, in response to gaze input 282n directed toward offload affordance 30h′, the computer system 101 generates a hover sound in association with putting offload affordance 30h′ in focus. In some embodiments, the sounds that are outputted in response to user inputs directed toward user interface objects (e.g., objects, icons, controls, and/or other affordances in home user interface 8100) in the three-dimensional environment are spatial audio outputs. For example, a spatial audio output creates a perception or sensation that a sound is coming from a respective location in the three-dimensional environment corresponding to a location of a user interface object with respect to which the user input is performed. The hover sound generated in response to gaze input 282n directed toward offload affordance 30h′ sounds as if it is coming from a location in the three-dimensional environment corresponding to offload affordance 30h′, location corresponding to environment icon 30h (or vicinity of environment icon 30h), and/or coming from the direction of environment icon 30h. In some embodiments, in contrast, the ambient sounds played in the three-dimensional environment have a surround sound effect as opposed to a spatial sound effect.

In FIG. 8O, the computer system 101 detects air pinch gesture 2800 corresponding to a selection input while gaze input 282n is directed toward offload affordance 30h′ (as illustrated in FIG. 8N). In response, the computer system 101 offloads the virtual or extended-reality environment “Alps” corresponding to the environment icon 30h. For example, the computer system 101 removes data stored (e.g., data stored locally on the computer system 101 and/or date stored remotely in associated with a user account of the computer system 101) with respect to the environment “Alps” while keeping a link or metadata related to the environment “Alps” on computer system 101 (e.g., keeping a link to the removed data of the environment “Alps” on the home user interface or an environment library, without deleting the environment “Alps” completely from the computer system). In some embodiments, offloading the environment “Alps” clears memory space on computer system 101 without deleting or uninstalling the virtual environment “Alps” (e.g., allowing a user to reload the virtual environment “Alps” later and, optionally, resume an experience from last saved state of the virtual environment “Alps”). In some embodiments, even though offload affordances (e.g., offload affordance 30h′) have the same or similar appearance as deletion affordances (e.g., deletion affordance 34a′ in view 8100d in FIG. 8F) and/or are placed in the same or similar location relative to the associated icon, an offload affordance, when selected, performs a different function from the function that is performed when a deletion affordance is selected. In some embodiments, deletion operation is available for some types of objects, but not available for some other types of objects. In some embodiments, offloading operation is available for some types of objects, but not available for some other types of objects. In some embodiments, some types of objects that have deletion operation enabled do not have offloading operation enabled. In some embodiments, some types of objects that have offloading operation enabled do not have deletion operation enabled. In some embodiments, some types of objects have both deletion operation and offloading operation enabled, and the two operations are activated respectively using different affordances displayed in association with a respective object.

In some embodiments, in conjunction with activating the offload affordance 30h′ (e.g., in response to the detection of air pinch gesture 2800 while offload affordance 30h′ is in focus) and performing the offload operation associated with the offload affordance 30h′, the computer system 101 generates an interaction sound C in association with offload affordance 30h′. In some embodiments, the computer system 101 outputs the interaction sounds C with a spatial sound effect. For example, the interaction sound C sounds as if it is coming from a respective location in the three-dimensional environment corresponding to a location of the offload affordance 30h′. In some embodiments, the interaction sound C associated with an affordance has a different audio output profile from that of a hover sound, a selection sound for an icon, or an ambient sound of the three-dimensional environment or home user interface.

FIG. 8P is a transition from FIG. 8O after the computer system 101 offloads the environment “Alps” (e.g., in response to the selection of offload affordance 30h′). FIG. 8P illustrates that, while environment icon 30h representing the virtual or extended-reality environment “Alps” remains displayed in environments view 8100b, the appearance of environment icon 30h is changed (e.g., relative to that shown in FIG. 8O before the environment “Alps” is offloaded) to indicate that the environment “Alps” has been offloaded. For example, environment icon 30h is dimmed or darkened, the offload affordance 30h′ is removed (e.g., because the environment is already offloaded), and a reload affordance 35h is displayed next to the “Alps” label to indicate that the environment “Alps” is offloaded that the environment “Alps” is not currently available to be opened on the computer system 101, and/or that the environment can be reloaded onto the computer system 101 (e.g., by selecting the reload affordance 35h). In some embodiments, reloading an environment includes downloading and/or restoring (e.g., from a server or another data storage device) the data that were associated with the environment (e.g., the data that had been removed from the computer system or memory of the computer system, in response to selection of the offload affordance associated with the environment). In some embodiments, the reload affordances for offloaded environments are displayed in the reconfiguration mode of the environments view 8100b, but are not displayed in the normal mode of the environments view 8100b. In some embodiments, the reload affordances for offloaded environments are displayed in the reconfiguration mode of the environments view 8100b, and in the normal mode of the environments view 8100b. Further, in FIG. 8P, the computer system 101 detects an air pinch gesture 280p while Done button 28028 has input focus (e.g., as a result of gaze input 282p directed to Done button 28028).

FIG. 8Q is a transition from FIG. 8P in response to selecting Done button 28028. In response to the selection of Done button 28028, the computer system 101 exits or deactivates the reconfiguration mode while maintaining or persisting the changes made to environments view 8100b during the reconfiguration mode. For example, in FIG. 8Q, environments view 8100b is displayed in the normal mode (e.g., as opposed to the reconfiguration mode) and the environment “Alps” is offloaded from computer system 101, as indicated by the dimmed or darkened appearance of environment icon 30h and the reload affordance 35h displayed next to the label “Alps” corresponding to the environment icon 30h. Further, in accordance with a determination that the environments view 8100b of home user interface 8100 is no longer in the reconfiguration mode, the computer system 101 redisplays tab menu 8004 for switching between different views of home user interface 8100.

Figure, 8Q further illustrates a selection input selecting the environment icon 30h for the offloaded environment “Alps”. For example, the computer system 101 detects user's attention (e.g., based on gaze input 282q directed to environment icon 30h) that puts environment icon 30h in focus. While the environment icon 30h has input focus, the computer system 101 detects an air pinch gesture 280q (e.g., two or more fingers coming into contact with one another followed by the fingers breaking contact from one another within a threshold of amount of time) performed with user 7002's hand 7022. In response to the detection of air pinch gesture 280q while environment icon 30h has input focus, the computer system 101 (e.g., in accordance with a determination that the air pinch gesture does not meet a first input threshold, such as a first duration threshold, before termination of the air pinch gesture), initiates a process for reloading the virtual environment “Alps” (e.g., as opposed to opening and displaying the environment “Alps” as described in relation with FIGS. 8K-8L before the environment “Alps” was offloaded). In some embodiments, in response to the selection of the environment icon 30h by the air pinch gesture 280q, the computer system 101 does not start reloading and restoring the data for the environment “Alps” right away, and instead, presents a prompt (e.g., a pop-up window and/or error alert) that alerts the user that the selected environment is not currently available to be displayed, and request the user's confirmation before starting to reload and restoring the data for the environment “Alps.” In some embodiments, once a user input confirming the request to reload the environment “Alps” is received, the computer system 101 proceeds to reload the environment “Alps” (e.g., as shown in FIG. 8R). In some embodiments, if the air pinch gesture 280q is detected while reload affordance 35h is in focus (e.g., based on a gaze input directed to the reload affordance 35h), the computer system initiates reloading of the environment “Alps” without requesting further confirmation from the user and without displaying the alert that the environment “Alps” is not currently available to be displayed.

FIG. 8R is a transition from FIG. 8Q. FIG. 8Q illustrates that the virtual environment “Alps” is being reloaded in response to the selection of environment icon 30h representing the offloaded environment “Alps (or, optionally, in response to selection of the reload affordance 35h associated with the offloaded environment “Alps”. For example, to illustrate that the environment “Alps” is being reloaded, the computer system 101 replaces the reload affordance 35h displayed next to the label “Alps” with download indicator 37h. In some embodiments, once the environment “Alps” is reloaded and becomes available again, the download indicator 37h ceases to be displayed, the function and appearance of the environment icon 70h is restored to those of environment icon 70h shown in FIG. 8K. In some embodiments, the process for reloading an offloaded environment as described with respect to environment “Alps” above can also be performed in the reconfiguration mode (e.g., by selecting the environment icon 30h, or reload affordance 35h shown in FIG. 8P). In some embodiments, the process for reloading an offloaded environment as described with respect to environment “Alps” above are not enabled in the reconfiguration mode. In some embodiments, if the user exits the reconfiguration mode without selecting the Done button 28028, the environments that are unloaded in the reconfiguration mode are restored automatically and remain available for display once the environments view 8100b is displayed in the normal mode.

FIG. 8S-8W illustrate interactions with applications view 8100e of home user interface 8100, in accordance with some embodiments. For example, FIG. 8S-8W illustrate editing operations (e.g., deleting an application and/or pausing an installation of an application) with respect to applications represented by icons in the applications view 8100e, in accordance with some embodiments.

FIG. 8S illustrates applications view 8100e of home user interface 8100 displayed via HMD 7100a. The application icons 36a-36m optionally correspond to the application icons 28a-28l and folder icon 28m shown in FIG. 8A, but are shown with a generic appearance for improved visual clarity. The applications view 8100e is displayed in the reconfiguration mode, as indicated by the darkened passthrough portions of the three-dimensional environment visible via HMD 7100a (e.g., relative to applications view 8100a in FIG. 8A). Further, in the reconfiguration mode, the computer system 101 displays deletion affordances that are not displayed when the applications view 8100e is in the normal mode, including the deletion affordance 36a′ associated with application icon 36a; deletion affordance 36b′ associated with application icon 36b; deletion affordance 36c′ associated with application icon 36c; deletion affordance 36e′ associated with application icon 36e; deletion affordance 36f associated with application icon 36f; deletion affordance 36g′ associated with application icon 36g; deletion affordance 36k′ associated with application icon 36k; deletion affordance 36l′ associated with application icon 36l; and deletion affordance 36m′ associated with application icon 36m. In some embodiments, if icon 36m corresponds to a folder icon 28m, the icon 36m is optionally displayed without a corresponding deletion affordance in the reconfiguration mode. In some embodiments, application icons 36d, 36h, 36i, and 36j correspond to applications that cannot be deleted by a user (e.g., because they represent system applications, preinstalled application, and/or other applications that are not available to be removed in response to user inputs), and the computer system 101 forgoes displaying deletion affordances with respect to application icons 36d, 36h, 36i, and 36j. For example, absence of a deletion affordance for a respective object indicates that the respective object cannot be removed or deleted from the computer system by a user. Further, in the reconfiguration mode, the computer system 101 displays a preview of section(s) adjacent to the currently displayed section of applications view 8100e, including dimmed icons 36n, 360, and 36p from the third section of applications view 8100e and dimmed icons 36q, 36r, and 36s from the first section of applications view 8100e. In some embodiments, application icons 36a-36m in applications view 8100e are the same, different, and/or some are the same and some are different than the application icons 28a-28l in applications view 8100a in FIG. 8A, but the interactions described with respect to application view 8100e are applicable to application view 8100a, and vice versa.

In FIG. 8S, the application “App20” represented by application icon 36g in applications view 8100e is in the process of being installed (and/or downloaded) on computer system 101. Download icon 39g displayed near application icon 36g indicates that the application “App20” represented by application icon 36g is being installed or downloaded on computer system 101, while the absence of a respective download icon indicates that a corresponding application is already installed on computer system 101. In some embodiments, as shown in FIG. 8S, the appearance of application icon 36g indicates the progress of the download and/or installation (e.g., the application icon 36g is dimmed and a progress indicator is displayed within the application icon 36g). In some embodiments, the appearance of application icon 36g is the same in the reconfiguration mode and the normal mode, during the downloading and/or installation of the application “App20,” but deletion affordance 36g′ is not displayed when the application view 8100e is in the normal mode. In some embodiments, selection of application icon 36g (e.g., by an air pinch gesture directed to application icon 36g) in the normal mode causes the computer system to pause the download and installation of application “App20.”

In FIG. 8T, the computer system 101 detects user's attention (e.g., based on gaze input 282t) directed to the deletion affordance 36g′. In some embodiments, similar to when the user's attention (e.g., based on the gaze input 282n in FIG. 8N) is directed to the offload affordance 30h′ in FIG. 8N, the computer system 101 in FIG. 8T moves deletion affordance 36g′ towards the viewpoint of user 7002 and, optionally, enlarges and/or otherwise visually emphasizes deletion affordance 36g′ relative to its previous appearance. For example, the deletion affordance 36g′ lifts off and moves away from application icon 36g, resulting in an increased gap in depth between deletion affordance 36g′ and application icon 36g (as illustrated in perspective side view 289). Similar to perspective side view 283 in FIG. 8N, perspective side view 289 in FIG. 8T illustrates different stages 289a, 289b, and 289c of the process of moving deletion affordance 36g′ in depth towards the viewpoint of user 7002 (e.g., and/or away from application icon 36g) while maintaining the reduced distance between application icon 36g from the viewpoint of the user 7002. Further, in FIG. 8T, the computer system 101 detects an input selecting the deletion affordance 36g′ associated with application icon 36g (e.g., the application icon representing the application “App20” that is being downloaded). For example, the computer system 101 detects an air pinch gesture 280t while deletion affordance 36g′ has input focus (e.g., as a result of the detection of gaze input 282t directed to the deletion affordance 36g′) and; in response, the computer system 101 selects the deletion affordance 36g′ and, optionally, generates a respective selection sound (optionally, with spatial audio effect that corresponds to the location of the application icon 36g and/or deletion affordance 36g′).

FIG. 8U is a transition from FIG. 8W in response to the selection of deletion affordance 36g′. In response to the selection of deletion affordance 36g′, the computer system 101 deletes application icon 36g (e.g., irrespective of the installation or downloading of the application “App20”) and/or cancels the installation of the application “App20” corresponding to application icon 36g. In conjunction with removing application icon 36g from home user interface 8100, the computer system 101 reflows application icons 36h-36m to fill up the placement location in applications view 8100e that is vacated by the deleted application icon 36g. FIG. 8U illustrates the state of applications view 8100e after application icon 36g is deleted and after the application icons 36h-36m shifted to fill up the placement location vacated by the deleted application icon 36g. In some embodiments, the interactions with deletion affordance 36g′ as described above are also applicable to the deletion affordances of other application icons that correspond to applications that are fully downloaded and installed. Selection of a deletion affordance for an application icon that corresponds to an application that is fully downloaded and installed causes the application to be deleted from the applications view 8100e and other application icons to reflow into the vacated placement location of the deleted application icon. In some embodiments, selection of an application icon that does not have a corresponding deletion affordance does not delete the corresponding application of the application icon. In some embodiments, prior to deleting an application, the computer system displays a prompt requesting confirmation from the user regarding whether to proceed with deleting the application. In some embodiments, when deleting an application, the data related to the application is removed from the computer system, and the application is no longer available on the computer system. In some embodiments, when an application is deleted from applications view 8100e using its deletion affordance, the application icon of the application is still available in an application library or a “deleted” folder from which deleted applications can be selected to be opened and/or restored to the applications view 8100e.

FIG. 8V illustrates applications view 8100e in the same state as in FIG. 8S (e.g., prior to the deletion of application icon 36g and the cancellation of the installation and/or the downloading of “App20”). For example, in FIG. 8V, the application “App20” is in the process of being installed (and/or downloaded) on computer system 101, as indicated by download icon 39g near application icon 36g representing “App20” in applications view 8100e. In FIG. 8V, the computer system 101 detects an input selecting application icon 36g while “App20” is being downloaded and/or installed (e.g., as opposed to selecting the deletion affordance 36g′ as in FIG. 8T). For example, the computer system 101 detects an air pinch gesture 280v while application icon 36g has input focus (e.g., as a result of the detection of user's attention (e.g., based on gaze input 282v) directed to the application icon 36g) and, in response, the computer system 101 selects the application icon 36g.

FIG. 8W is a transition from FIG. 8V in response to the selection of application icon 36g while “App20”, represented by application icon 36g, is being downloaded and/or installed on computer system 101. In response to the selection of application icon 36g while “App20” is being downloaded and/or installed, the computer system 101 pauses or suspends the downloading and/or installation. The absence of download icon 39g in applications view 8100e visually indicates that application “App20” is no longer being downloaded and/or installed. Further, the computer system 101 darkens or otherwise visually deemphasizes application icon 36g relative to other application icons in applications view 8100e to indicate that the download and/or installation of “App20” is incomplete. In some embodiments, the progress indicator inside the application icon 36g is replaced with a pause indicator. In some embodiments, a selection input directed to application icon 36g in FIG. 8W (e.g., while the download “App20” is paused), causes the computer system to resume the downloading and/or installation of “App20,” and to redisplay the download indicator 39g until the download and/or installation is completed.

FIG. 8X-8AL illustrate interactions with contacts view 8100c of home user interface 8100. For example, FIG. 8X-8AL illustrate editing operations (e.g., marking a contact as “favorite”, marking a contact as “not favorite”, rearranging “favorite” contact icons in contacts view 8100c, and/or removing a contact from recent contacts in contacts view 8100c) with respect to contacts represented by icons in the contacts view 8100c, in accordance with some embodiments.

FIG. 8X illustrates contacts view 8100c of home user interface 8100 in the normal mode (e.g., as opposed to the reconfiguration mode), in accordance with some embodiments. The tab menu 8004 is visible in home user interface 8100 while contacts view 8100c is in the normal mode. Contact view 8100c in FIG. 8X is similar to contacts view 8100c in FIG. 8C. For example, contact view 8100c in FIG. 8X include the same contact icons as in FIG. 8C, e.g., contact icons 32a-32l. Below respective contact icons 32a-32l, the computer system 101 optionally displays a textual label indicating a name of a contact represented by a respective contact icon of the contact icons 32a-32l. Some contacts are marked as “favorite” in contacts view 8100c and/or pinned to a “favorites” portion of the currently displayed section of contacts view 8100c, as shown in FIG. 8X. For example, star indicator 132a near label C1 of contact icon 32a indicates that contact C1 represented by contact icon 32a in contacts view 8100c is marked as “favorite”; star indicator 132b near label C2 of contact icon 32b indicates that contact C2 represented by contact icon 32b is marked as “favorite”; star indicator 132c near label C3 of contact icon 32c indicates that contact C3 represented by contact icon 32c is marked as “favorite”; star indicator 132d near label C4 of contact icon 32d indicates that contact C4 represented by contact icon 32d is marked as “favorite”; and star indicator 132e near label C5 of contact icon 32e indicates that contact C5 represented by contact icon 32e is marked as “favorite”. The absence of star indicators near labels C6-C12 of respective contact icons 32f-32l indicates that the respective contacts C6-C12 are not marked as “favorite” and/or are marked as “not favorite”. In some embodiments, marking a contact as “favorite” causes the computer system 101 to display the corresponding contact icon at the top or front (e.g., a “favorites” portion of the contacts view 8100c that has a more prominent or easily accessible position than the portion allocated to contact icons that are not marked as “favorite”) in contacts view 8100c (e.g., the icons of the contacts that are marked as “favorite” are pinned and displayed first and at the top of contacts view 8100c before any contact icons for contacts that are marked as “not favorite”). For example, contact icons 32a-32e representing contacts C1-C5 that are marked as “favorite” are displayed at the top in contacts view 8100c in FIG. 8X. In some embodiments, the remaining contacts C6-C12 in contacts view 8100c are recent contacts that are not marked as “favorite.” In some embodiments, recent contacts correspond to contacts that the user 7002 has recently (e.g., within a time window and/or relative to other contacts) communicated with using the computer system 101. In some embodiments, the contact icons for contacts that are marked as “favorite” can be manually reordered by a user within the “favorites” portion of the contacts view 8100c, while the contact icons for contacts that are not marked as “favorite” are automatically ordered by the computer system based on system or user-selected ordering criteria, such as alphabetical ordering, reverse-alphabetical ordering, recency of last communication, frequency of communication, and/or other ordering criteria, and cannot be reordered manually by a user.

In some embodiments, in FIG. 8X, affordance 32 for adding a new contact, when selected by a user, causes the computer system 101 to display an add user interface (e.g., a search user interface for searching contacts and/or recent communications and/or a user interface with a list of selectable contact representations and/or recent communication, and/or a user interface for inputting contact information for a new contact) for adding a new contact to the contacts view 8100c. Selecting a respective contact representation or a recent communication in a search user interface and/or list and/or inputting contacting information for a new contact in the add user interface, causes the computer system 101 to add a contact icon to the collection of contact icons in contacts view 8100c, for the new contact. In some embodiments, affordance 32 for adding a new contact is displayed in other sections of contacts view 8100c when those sections are the currently displayed sections visible via HMD 7100a (optionally, when the reconfiguration mode is active, inactive, and/or both).

Further, in FIG. 8X, the computer system 101 detects one or more inputs for activating the reconfiguration mode. For example, the computer system 101 detects a long air pinch gesture 280x while contact icon 32k has input focus, e.g., as a result of gaze input 282x directed to contact icon 32k. In some embodiments, a long air tap gesture can be used to activate the configuration mode when the pinch gesture is maintained with less than a threshold amount of movement for at least a first threshold amount of time.

FIGS. 8Y-8Z illustrate an editing operation with respect to contact C1 that is marked as “favorite” in contacts view 8100c. In particular, FIGS. 8Y-8Z illustrate changing the status of contact C1 from “favorite” to “not favorite” (e.g., in response to the selection of a “favoriting/unfavoriting” control).

FIG. 8Y is a transition from FIG. 8X after the computer system 101 activates the reconfiguration mode (e.g., in response to the long air pinch gesture 280x while contact icon 32k has input focus). In FIG. 8Y, contacts view 8100c of home user interface 8100 is displayed in the reconfiguration mode. In conjunction with activating the reconfiguration mode, the computer system 101 displays controls for marking contacts as “favorite” and/or controls for marking contacts as “not favorite.” In some embodiments, what type of control is displayed depends on whether the respective contact is currently marked as “favorite” or marked as “not favorite.” For example, in conjunction with activating the reconfiguration mode, the computer system 101 displays controls 32a′, 32b′, 32c′, 32d′, and 32e′ for marking a contact as “not favorite” at or adjacent to corresponding contacts that are already marked as “favorite;” and the computer system displays controls 32f′, 32g′, 32h′, 32i′, 32j′, 32k′, and 32l′ for marking a contact as “favorite” at or adjacent to corresponding contacts that are not currently marked “favorite.” In particular, control 32a′ for marking contact C1 as “not favorite” is displayed in association with contact icon 32a representing contact C1 that is currently marked as “favorite”; control 32b′ for marking contact C2 as “not favorite” is displayed in association with contact icon 32b representing contact C2 that is currently marked as “favorite”; control 32c′ for marking contact C3 as “not favorite” is displayed in association with contact icon 32c representing contact C3 that is currently marked as “favorite”; control 32d′ for marking contact C4 as “not favorite” is displayed in association with contact icon 32d representing contact C4 that is currently marked as “favorite”; and control 32e′ for marking contact C5 as “not favorite” is displayed in association with contact icon 32e representing contact C5 that is currently marked as “favorite.” Further, control 32f′ for marking contact C6 as “favorite” is displayed in association with contact icon 32f representing contact C6 that is currently marked as “not favorite”; control 32g′ for marking contact C7 as “favorite” is displayed in association with contact icon 32g representing contact C7 that is currently marked as “not favorite”; control 32h′ for marking contact C8 as “favorite” is displayed in association with contact icon 32h representing contact C8 that is currently marked as “not favorite”; control 32i′ for marking contact C9 as “favorite” is displayed in association with contact icon 32i representing contact C9 that is currently marked as “not favorite”; control 32j′ for marking contact C10 as “favorite” is displayed in association with contact icon 32j representing contact C10 that is currently marked as “not favorite”; control 32k′ for marking contact C11 as “favorite” is displayed in association with contact icon 32k representing contact C11 that is currently marked as “not favorite”; and control 32l′ for marking contact 12 as “favorite” is displayed in association with contact icon 32l representing contact C12 that is currently marked as “not favorite.”

In FIG. 8Y, the computer system 101 detects selection of control 32a′ for marking contact C1 represented by contact icon 32a as “not favorite.” For example, the computer system 101 detects user's attention (e.g., based on gaze input 282y) directed to control 32a′ that causes the computer system 101 to put control 32a′ in focus. In some embodiments, similar to when user's attention (e.g., based on the gaze input 282n) is directed to the offload affordance 30h′ in FIG. 8N, the computer system 101 in FIG. 8Y moves control 32a′ towards the viewpoint of user 7002 and, optionally, enlarges and/or otherwise visually emphasizes control 32a′ relative to its previous appearance. For example, the control 32a′ lifts off and moves away from contact icon 32a, resulting in an increased gap in depth between control 32a′ and contact icon 32a. In some embodiments, as user 7002's gaze or attention is on control 32a′, the computer system 101 generates a hover sound (e.g., optionally, in conjunction with lifting off and moving control 32a′ toward the viewpoint of user 7002). Further, in FIG. 8Y, the computer system 101 detects an air pinch gesture 280y while control 32a′ has input focus (e.g., as a result of gaze input 282y directed toward control 32a′). In some embodiments, an air tap gesture can be used to select control 32a′. In response to detecting the air pinch gesture that selects control 32a′, the computer system 101 generates a selection sound Y associated with selecting a control for marking a contact as “not favorite.” In some embodiments, the selection sound Y is a spatial audio output that has spatial characteristics corresponding to the location of the selected control in the three-dimensional environment.

FIG. 8Z is a transition from FIG. 8Y in response to the selection of control 32a′ for marking contact C1 as “not favorite.” FIG. 8Z shows a state of contacts view 8100c after the contact C1 represented by contact icon 32a is marked as “not favorite”. In response to the selection of control 32a′ for marking contact C1 as “not favorite”, the computer system 101 rearranges contacts view 8100c by removing contact icon 32a from the top of contacts view 8100c (e.g., removes contact icon 32a from the portion of view 8100c for displaying “favorite” contacts, such as contacts CS1-CS5 represented by contact icons 32a-32e, respectively) and placing contact icon 32a in the region of contacts view 8100c for displaying contact icons that are marked as “not favorite” (e.g., contact icon 32a is moved from the first position in the top row to the second row in front of the contact icons 32f-32l representing the other contacts C6-C12 that are marked as “not favorite”). The placement location of contact icon 32a upon being marked as “not favorite” is, optionally, determined according to relative recency of interaction between user 7002 and contact C1 via computer system 101 to other contacts that are marked as “not favorite.” Further, in response to the selection of control 32a′, the computer system 101 removes the star indicator 132a near label C1 of contact icon 32a. The absence of star indicator 132a near label C1 of contact icon 32a indicates that contact C1 is not marked as “favorite” and/or is marked as “not favorite.” Further, the computer system replaces the control 32a′ for marking contact C1 as “not favorite” with control 32a″ for marking contact C1 as “favorite.” In addition to removing the star indicator 132a, relocating contact icon 32a, and replacing control 32a′ with control 32a″, the computer system 101 optionally shifts, moves, or reflows contact icons 32b-32e in a leftward and upward direction by one placement location to fill up the placement location that was vacated by contact icon 32a, as illustrated in FIG. 8Z, in accordance with some embodiments.

FIGS. 8AA-8AB illustrate an editing operation with respect to contact C12 that is marked as “not favorite” in contacts view 8100c. In particular, FIGS. 8AA-8AB illustrate changing the status of contact C12 from “not favorite” to “favorite” (e.g., in response to the selection of a control), in accordance with some embodiments.

In FIG. 8AA, contacts view 8100c is in the same or similar state as contacts view 8100c in FIG. 8Z (e.g., after the status of contact C1 is changed from “favorite” to “not favorite”).

In FIG. 8AA, the computer system 101 detects selection of control 32l′ for marking contact C12 represented by contact icon 32l as “favorite.” For example, the computer system 101 detects user's attention (e.g., based on gaze input 282aa) directed to control 32l′ that causes the computer system 101 to put control 32l′ into focus. In some embodiments, similar to when the user's attention (e.g., based on gaze input 282y) is directed to control 32a′ in FIG. 8Y, the computer system 101, as shown in FIG. 8AA, moves control 32l′ towards the viewpoint of user 7002 and, optionally, enlarges and/or otherwise visually emphasizes control 32″ relative to its previous appearance. In some embodiments, as user 7002's gaze or attention is on control 32l′, the computer system 101 generates a hover sound (e.g., optionally, in conjunction with lifting off and moving control 32l′ toward the viewpoint of user 7002). Further, the computer system 101 detects an air pinch gesture 280aa while control 32l′ has input focus (e.g., as a result of gaze input 282aa directed toward control 32l′). In some embodiments, an air tap gesture can be used to select control 32l′. In response to detecting selection of control 32l′, the computer system 101 generates a selection sound Y′ associated with selecting a control for marking a contact as “favorite”. In some embodiments, the selection sound Y′ is a spatial audio output that has spatial characteristics corresponding to a location of the control 32l′. In some embodiments, selection sounds for selecting an object in the reconfiguration mode is different in one or more aspects (e.g., volume, frequency, duration, and/or wave patterns) from selection sounds for selecting an object (e.g., the same object, a different object of the same object type, and/or a different object or a different object type) in the normal mode. In some embodiments, the selection sound Y generated when a control for marking a contact as “not favorite” is selected is different from the selection sound Y′ generated when a control for marking a contact as “favorite” is selected (e.g., sounds Y and Y′ different frequencies, magnitudes, patterns, duration, and/or other audio characteristics).

FIG. 8AB is a transition from FIG. 8AA in response to the selection of control 32l′ for marking contact C12 as “favorite.” FIG. 8AB shows a state of contacts view 8100c after the contact C12 represented by contact icon 32l is marked as “favorite.” In response to the selection of control 32l′ for marking contact C12 represented by contact icon 32l as “favorite,”, the computer system 101 rearranges contacts view 8100c by adding contact icon 32l to the portion of contacts view 8100c for displaying contacts marked as “favorite” (e.g., ahead of or in front of the “recent” contacts in contacts view 8100c that are marked as “not favorite”), and removing contact icon 32l from the portion of contact view 8100c for displaying contacts C1 and C6-C11 represented by contact icons 32a and 32f-32k. For example, as shown in FIG. 8AB, contact icon 32l is moved from the last position in the bottom row to the second row after contact icons 32b-32e representing the other contacts C2-C5 that are marked as “favorite.” The placement location of contact icon 32l upon being marked as “favorite” is determined according to relative recency of interaction between user 7002 and contact C12 via computer system 101 to other contacts that are marked as “favorite.” Further, in response to the selection of control 32l′, the computer system 101 adds a star indicator 132l near label C12 of contact icon 32l. The absence of star indicator 132l near label C12 of contact icon 32l in FIG. 8AA indicates that contact C12 is marked as “not favorite” in FIG. 8AA. Further, the computer system 101 replaces the control 32l′ for marking contact C12 as “favorite” with control 32l″ for marking contact C12 as “not favorite.” In addition to adding the star indicator 132l, relocating contact icon 32l, and replacing control 32l′ with control 32l″, the computer system 101 optionally shifts, moves, or reflows contact icons 32a and 32f-32k in a rightward and downward direction by one placement location to make room for contact icon 32l, as illustrated in FIG. 8AB.

In some embodiments, contact icons of contacts that are marked as “favorite” can be rearranged in response to user inputs, while contact icons of contacts that are marked as “not favorite” cannot be rearranged in response to user inputs (e.g., a system determined order of respective contact icons cannot be overridden by user inputs). In some embodiments, the spatial extent within which the contact icons of contacts that are marked as “favorite” can be rearranged is limited to the spatial range occupied by the list of contacts that are marked as “favorite.” For example, a contact icon of a contact that is marked as “favorite” cannot be added to the list of contact icons for contacts marked as “not favorite,” but a contact icon of a contact that is marked as “favorite” can take the placement location of the contact icon of another contact that is marked as “favorite” based on user inputs. In some embodiments, contact icons of contacts that are marked as “not favorite” can be rearranged within the list of contact icons of contacts that are marked as “not favorite.” For example, the contact icon of a contact that is marked as “not favorite” cannot be added to the list of contacts marked as “favorite” in contacts view 8100c, but a contact icon of a contact that is marked as “not favorite” can take the placement location of the contact icon of another contact that is marked as “not favorite” based on user inputs.

FIGS. 8AC-8AE illustrate repositioning a contact icon representing a contact that is marked as “favorite” within the list of contact icons representing contacts that are marked as “favorite”, in accordance with some embodiments. For example, contact icon 32d in contacts view 8100c in FIG. 8AC is moved within the same row similarly to how icon 34h in FIGS. 8G-8J is moved within the same row, in accordance with some embodiments.

In FIG. 8AC, the computer system 101 detects user's attention (e.g., based on a gaze input 282ac of user 7002) directed to contact icon 32d that causes the computer system 101 to put contact icon 32d in focus. Further, the computer system 101 detects an air pinch gesture 280ac performed with user 7002's hand 7022 while contact icon 32d has input focus (e.g., as a result of gaze input 282ac). In response to the detection of the air pinch gesture 298 while contact icon 32d has input focus, the computer system 101 selects contact icon 32d and optionally moves contact icon 32d towards the viewpoint of the user 7002 and away from plane 287 (e.g., moving the selected contact icon 32d closer to the viewpoint of user 7002) resulting in an increased distance in depth between contact icon 32d and plane 287, as illustrated in top view 285 in FIG. 8AC. FIG. 8AC further illustrates that user 7002's hand 7022 is about to move in a leftward direction while maintaining the air pinch gesture 280ac, as illustrated by the dashed arrow. Top view 285 in FIG. 8AC illustrates the position and direction of movement of contact icon 32d relative to contact icons 32b and 32c in plane 287.

FIG. 8AD is a transition from FIG. 8AC in response to the detection of movement input 298ac in the leftward direction while the pinch gesture of the user 7002's hand 7022 that holds contact icon 32d is maintained. In response to the detection of movement input 298ac while contact icon 32d is selected, the computer system 101 moves contact icon 32d in the leftward direction, in accordance with the characteristics of movement input 298a (e.g., direction, speed, amount, acceleration, and other movement characteristics). For example, in FIG. 8AD, contact icon 32d is moved past contact icons 32c and 32b to the first placement location in the top row in contacts view 8100c. The movement of contact icon 32d is additionally illustrated in top view 285 in which contact icon 32d has moved along the dashed arrow in accordance with the movement input 298ac.

FIG. 8AE is a transition from FIG. 8AD in response to the detection of termination of the pinch and drag input directed to contact icon 32d (e.g., a release 280ae of the pinch gesture 280ac after the movement input 298ac). In response to the detection of the termination of the pinch and drag input directed to contact icon 32d, the computer system 101 places contact icon 32d in the placement location previously occupied by contact icon 32b, moves contact icon 32d back to plane 287 (e.g., away from the viewpoint of user 7002), and automatically shifts contact icons 32b and 32c in the rightward direction to fill up the placement location vacated by contact icon 32d. FIG. 8AE shows a state of the rearrangement of contact icons in contacts view 8100c after the termination of the pinch gesture 280ac following the movement input 298ac.

FIG. 8AF illustrates the same state of contacts view 8100c as in FIG. 8AE. Further, in FIG. 8AF, the computer system 101 detects a selection input directed to Done button 28028. For example, the computer system 101 detects an air pinch gesture 280af while Done button 28028 has input focus as a result of gaze input 282af directed to Done button 28028, in accordance with some embodiments.

FIG. 8AG is a transition from FIG. 8AF in response to the selection of Done button 28028. In response to the selection of Done button 28028, the computer system 101 exits reconfiguration mode while maintaining the changes made to contacts view 8100c during the reconfiguration mode in FIGS. 8Y-8AE. For example, the changes that are maintained include marking contact C1 as “not favorite” and removing contact icon 32a from the collection of icons marked as “favorite” and adding contact icon 32a to the collection of icons marked as “not favorite,” marking contact C12 as “favorite” and removing contact icon 32l from the collection of icons marked as “not favorite” and adding contact icon 32l to the collection of icons marked as “favorite,” and repositioning contact icon 32d corresponding to contact C4 within the first row of contact icons corresponding to contacts marked as “favorite.” As illustrated in FIG. 8AG, star indicator 132a previously displayed in association with contact icon 32a remains removed and star indicator 132l displayed in association with contact icon 32l, as a result of marking contact C12 as “favorite”, remains displayed, after exiting the reconfiguration mode.

In FIG. 8AH, contacts view 8100c is in the same state as shown in FIG. 8AG. In FIG. 8AH, the computer system 101 detects selection of contact icon 32k representing contact C11 in contacts view 8100c displayed in the normal mode. For example, the computer system 101 detects an air pinch gesture 280ah while contact icon 32k has input focus, optionally, as a result of gaze input 282ah directed to contact icon 32k. In response to the selection of contact icon 32k in the normal mode, the computer system 101, optionally, in accordance with a determination that the air pinch gesture 280ah does not meet a first input threshold before termination of the air pinch gesture 280h (e.g., the duration of the air pinch gesture 280ah is less than a threshold amount of time before the release of the air pinch gesture is detected), displays contact user interface 8200 for initiating communication with contact C11.

FIG. 8AI is a transition from FIG. 8AH in response to the selection of contact icon 32k (e.g., in accordance with a determination that the selection input does not meet an input threshold such as a duration threshold required for a long air pinch gesture). FIG. 8AI illustrates contact user interface 8200 for initiating communication with contact C11. In some embodiments, contact user interface 8200 includes control 8202 for sending messages, control 8204 for initiating a video call, and control 8206 for expanding contact user interface 8200 to display additional contact information and control options related to communication with contact C11. In some embodiments, the controls and modes of communications that are initially included in contact user interface 8200 may be different from that shown in FIG. 8AI, and optionally are dynamically determined based on relative frequencies and/or availability of various modes of communication with contact C11. In some embodiments, selection of control 8202 (e.g., by an air pinch gesture detected while user's attention is directed to control 8202, or another selection input that does not meet an input threshold such as a duration threshold required for a long air pinch gesture) causes the computer system to initiate messages communication with contact C11 (e.g., displaying previously exchanged messages and displaying a user interface for composing a new message to C11 using a messages application installed on the computer system). In some embodiments, selection of control 8204 (e.g., by an air pinch gesture detected while user's attention is directed to control 8204, or another selection input that does not meet an input threshold such as a duration threshold required for a long air pinch gesture) causes the computer system to initiate a video call with contact C11 (e.g., sending a video call request to the contact C11 and establishing a video call connection between the computer system 101 and a device of contact C11).

In FIG. 8AJ, the computer system 101 detects a selection input directed to control 8206. For example, the computer system 101 detects an air pinch gesture 280aj while control 8206 has input focus, optionally, as a result of gaze input 282aj directed to control 8206. In response to the selection of control 8206, the computer system 101 expands contact user interface 8200 to include additional control options, as illustrated in FIG. 8AK.

FIG. 8AK is a transition from FIG. 8AJ in response to the selection of control 8206 that causes the computer system 101 to expand the contact user interface 8200. For example, expanded contact user interface 8200 includes a control 8208 for marking a selected contact (e.g., “John Doe” in this example) as “favorite” (e.g., the “App to Favorites” option in the expanded contact user interface 8200) and control 8210 for removing a selected contact from a list or collection of contacts with which user 7002 have recently communicated with (e.g., the “Clear from Recents” option in the expanded contact user interface 8200). In some embodiments, other than the contacts that are marked as “favorite” and pinned to the “favorite” portion of the contacts view 8100c, the contact icons displayed in contacts view 8100c includes contact icons for contacts with which user 7002 have recently communicated with (e.g., had communication with the user within a recent time window, and/or is a newly added contact). For example, instead of displaying the entire collection of contact icons for known contacts in contacts view 8100c, the computer system 101 displays a subset of the contacts that are associated with computer system 101 that are frequently and/or recently used. Further, in FIG. 8AK, the computer system 101 detects a selection input directed to control 8210 (e.g., the “Clear from Recents” option in the expanded contact user interface 8200). For example, the computer system 101 detects an air pinch gesture 280ak while control 8210 has input focus, optionally, as a result of gaze input 282ak directed to control 8210. In response to the selection of control 8210, the computer system 101 removes the selected contact C11 represented by contact icon 32k from contact view 8100c and redisplays the contacts view 8100c of home user interface 8100, as shown in FIG. 8AL. Even though contact icon 32k is removed from contacts view 8100c, contact C11 optionally remains saved and/or stored in the list of contacts stored on compute system 101 or stored in association with a respective user profile of user 7002, and can be added back to the contacts view 8100c using the affordance 32 (e.g., through searching and/or browsing a full list of known contacts).

FIG. 8AL is a transition from FIG. 8AJ after the contact icon 32k is removed from the collection of icons shown in contacts view 8100c as a result of the selection of control 8210. Accordingly, contact C11 is removed from the collection of recent contacts that is directly selectable in contacts view 8100c.

Additional descriptions regarding FIGS. 8A-8AL are provided below in reference to method 10000 described with respect to FIGS. 10A-10M.

FIGS. 9A-9AS illustrate example processes for creating a folder of user interface objects in a three-dimensional environment, in accordance with some embodiments. FIGS. 11A-11K is a flow diagram of an exemplary method 11000 for creating a folder of user interface objects in a three-dimensional environment, in accordance with some embodiments. The user interfaces in FIGS. 9A-9AS are used to illustrate the processes described below, including the processes in FIGS. 11A-11K and 12.

FIGS. 9A-9AS illustrate a three-dimensional environment that is visible to a user, such as user 7002 in FIG. 7, via a display generation component of a computer system, such as HMD 7100a of computer system 101, as described in further detail with reference to FIG. 7. The three-dimensional environment of FIGS. 9A-9AS, optionally, includes a representation (e.g., a camera view or an optical passthrough view) of a portion of physical environment 7000. For example, the three-dimensional environment visible via HMD 7100a in FIG. 9A includes representations 7004′, 7006′, 7008′, and 7014′ (e.g., camera views or optical passthrough views) of wall 7004, wall 7006, floor 7008, and box 7014, respectively.

In addition to the representation (e.g., a camera view or an optical passthrough view) of the portion of physical environment 7000, the three-dimensional environment in FIGS. 9A-9AS includes a respective view of a user interface that includes an arrangement of user interface objects of a respective object type, such as a respective view of home user interface 8100. In some embodiments, as described in further detail with respect to FIGS. 8A-8AL, the home user interface 8100 includes (e.g., is segmented into, divided, and/or otherwise arranged into) different views of user interface objects that include respective collections of user interface objects of a common object type (e.g., the user interface objects included in the home user interface 8100 are arranged into the different collections by object type and displayed in respective views of the home user interface 8100, such as views 8100a, 8100b, 8100c, and/or 8100d described with respect to FIGS. 8A-8AL. In FIGS. 9A-9AS, an applications view 9100a is visible via HMD 7100a. The example interfaces, methods, and interactions described with reference to FIGS. 9A-9AS are, optionally, applicable to other views of the home user interface 8100 (e.g., applications view 8100a, contacts view 8100c, environments view 8100b, and/or view 8100d with other user interface objects of the same type), and vice versa.

In FIG. 9A, the three-dimensional environment includes an applications view 9100a of home user interface 8100. The applications view 9100a includes a collection of application icons (e.g., for launching, opening, and/or otherwise causing the computer system 101 to display a respective user interface of a corresponding application). Applications view 9100a in FIG. 9A is similar or different from applications view 8100a in FIG. 8A, in various embodiments. For example, applications view 9100a optionally includes the same application icons, different application icons, or some application icons that are the same and some application icons that are different, as compared to application view 8100a. In this example, applications view 9100a is a multi-section view that includes two sections, as indicated by the section indicator object 9002 with two section indicator icons 9002a and 9002b. In some embodiments, a respective section of applications view 9100a includes a respective group of application icons. The section that is currently displayed via HMD 7100a in FIG. 9A corresponds to the second and last section in applications view 9100a. The filled or colored appearance of section indicator 9002b indicates that the currently displayed section of application views 9100a in FIG. 9A is the second section of application view 9100a. The second section of applications view 9100a includes a subset of the collection of application icons included in applications view 9100a. The subset of the collection of icons in the second section includes application icons 90a, 90b, 90c, 90d, 90e, 90f, 90g, 90h, 90i, 90j, and 90k (also collectively referred to as application icons 90a-90k, or a group of application icons 90a-90k). Application icons 90a-90k of applications view 9100a are arranged in a regular pattern (e.g., in a grid pattern, a honeycomb pattern, linearly along a line, radially along multiple radii of a circle, circumferentially around a geometric shape, and/or other regular patterns). In some embodiments, application icons 90a-90k correspond to various software applications that can be executed on computer system 101 (e.g., an email application, a web browser, a messaging application, a maps application, a video player, an audio player, and/or other software applications). Textual labels displayed below a respective application icon of application icons 90a-90k provide a description or name of the respective software application represented by the respective application icon. In some embodiments, application icons 90a-90k are placed or positioned in placement locations on the same plane and/or at the same distance away from user 7002 or from a viewpoint of user 7002, as illustrated in top view 285 in FIG. 9A. For example, application icons 90a-90k in the second section of applications view 9100a are located in plane 287 (e.g., a planar surface or a volumetric layer with planar surfaces and a finite thickness). In some embodiments, other application icons in other sections of applications view 9100a are also located in the same plane 287 in the three-dimensional environment and/or at substantially the same distance away from user 7002 or the viewpoint of user 7002. In some embodiments, similar to icons 34a-34m in FIG. 8F, application icons 90a-90k in applications view 9100a are volumetric or three-dimensional (e.g., as opposed to two dimensional). In some embodiments, the sizes of application icons 90a-90k are the same or substantially the same with minor variations less than a few pixels. Further, optionally, the spacing between a pair of adjacent icons is equal or substantially the same in applications view 9100a. For example, the spacing between application icons 90a and 90b, the spacing between application icons 90b and 90c, the spacing between application icons 90c and 90d are equal or substantially the same. Similarly, the spacing between pair of adjacent icons in the first row is the same as the spacing between pair of adjacent icons in another row. For example, the spacing between application icons 90a and 90b in the first row is the same or substantially the same as the spacing between application icons 90j and 90k in the last row. In some embodiments, the spacing between the first row of application icons 90a-90d and the second row of application icons 90e-90i is the same or substantially the same as the spacing between the second row of application icons 90e-90i and the third row of application icons 90j-90k in applications view 9100a. In some embodiments, the spacing between adjacent icons is measured by the distance between the centers of the adjacent icons. In some embodiments, the spacing between adjacent icons is measured by the distance between the outer edges of the adjacent icons. In some embodiments, a threshold distance based on a spacing between two application icons is optionally replaced by a threshold distance based on a spacing between one of the two application icons and the placement location of the other application icon. In some embodiments, the spacing between placement locations are uniform in one or more dimensions of the grid or pattern of the placement locations.

In FIG. 9A, applications view 9100a is displayed in the reconfiguration mode. In the reconfiguration mode, a preview of a portion of adjacent sections, if any, of applications view 9100a is optionally displayed (e.g., dimmed versions of application icons 90l, 90m, and 90n in the first section are displayed) concurrently with the application icons 90a-90k in the second section of applications view 9100a (e.g., the section that is currently in focus). Further, in the reconfiguration mode, passthrough portions of the three-dimensional environment visible via HMD 7100a are optionally visually deemphasized (e.g., darkened, blurred, made more translucent, less saturated, relative to the passthrough portions of the three-dimensional environment visible via HMD 7100a when the normal mode was active). In some embodiments, similar to icons 34a-34m in FIG. 8F, application icons 90a-90k in applications view 9100a oscillate in three dimensions while the reconfiguration mode is active (e.g., to provide visual feedback of the operational state of the computer system 101).

In some embodiments, when a respective icon is dragged in home user interface 8100 in response to a respective drag input that is directed to the respective icon (e.g., the respective drag input started with a selection input that is directed to the respective icon and continues with a movement input while the selection of the respective icon is maintained), the computer system 101 disambiguates between initiating a folder creation process (e.g., to include the dragged icon and another icon in the same folder) and moving other adjacent icons out of the way of the dragged icon (e.g., to vacate a placement location to drop the dragged icon). In some embodiments, the disambiguation is based on characteristics of the respective drag input that is directed to the respective icon. FIGS. 9B-9E illustrate a scenario in which the computer system 101 moves an icon out of the way of a dragged application icon 90c to automatically fill in a placement location in applications view 9100a vacated by the dragged icon (e.g., as opposed to initiating a folder creation process). FIGS. 9F-9J illustrate a scenario in which the computer system 101 initiates a folder creation process with respect to a dragged icon (e.g., as opposed to reflowing and/or moving icons out of the way without initiating a folder creation process, as described with references to FIGS. 9B-9E).

FIG. 9B illustrates applications view 9100a of home user interface 8100 in the reconfiguration mode. Applications view 9100a illustrates the same collection and arrangement of icons as illustrated in FIG. 9A. In FIG. 9B, the computer system 101 detects user's attention (e.g., based on gaze input 982b of user 7002) directed to application icon 90c (e.g., with less than a threshold amount of movement for more than a threshold amount of time) that causes the computer system 101 to put application icon 90c in focus. Further, the computer system 101 detects an air pinch and hold gesture 980b performed with user 7002's hand 7022 while application icon 90c has input focus (e.g., as a result of gaze input 982b). In response to the detection of air pinch and hold gesture 980b while application icon 90c is in focus, the computer system 101 selects and holds application icon 90c for subsequent manipulation by the user. Optionally, the computer system also moves application icon 90c towards the viewpoint of the user 7002 and away from plane 287 (e.g., moving the selected application icon 90c closer to the viewpoint of user 7002), resulting in an increased distance in depth between application icon 90c and plane 287, as illustrated in top view 285 in FIG. 9B. In some embodiments, if an air pinch gesture was detected while applications view 9100a is in the normal mode (e.g., as opposed to the reconfiguration mode), the computer system 101 opens the respective application that is represented by application icon 90c, in accordance with a determination that the air pinch gesture is terminated with a release of the air pinch gesture within a threshold amount of time. FIG. 9B further illustrates that user 7002's hand 7022, while holding application icon 90c via the air pinch and hold gesture 980b, is about to move in a leftward direction, as illustrated by the dashed arrow leading from hand 7022. Top view 285 in FIG. 9B illustrates the position of application icon 90c relative to the adjacent application icon 90b in plane 287 and the direction of movement of application icon 90c.

FIG. 9C is a transition from FIG. 9B in response to the detection of movement input 980c while the air pinch and hold gesture 980b continues to hold application icon 90c (e.g., while maintaining the air pinch and hold gesture 980b). For example, movement input 980c is detected while application icon 90c is selected (e.g., as a result of the air pinch and hold gesture 980b in FIG. 9B while application icon 90c is in focus). In response to the detection of movement input 980c while application icon 90c is selected, the computer system 101 moves application icon 90c in a leftward direction towards adjacent application icon 90b and the placement location of application icon 90b, in accordance with the characteristics of movement input 980c (e.g., direction, speed, amount, acceleration, and other movement characteristics). For example, in FIG. 9C, application icon 90c is moved closer or adjacent to application icon 90b (e.g., relative to location of application icon 90c in FIG. 9B) in accordance with movement input 980c. The movement of application icon 90c is additionally illustrated in top view 285 in which application icon 90c has moved along the dashed arrow in accordance with the movement input 980c. The dragged application icon 90c initially pushes application icon 90b away. For example, while application icons 90c is dragged in the leftward direction toward application icon 90b, the computer system 101 dislodges application icon 90b from its original location and moves application icon 90b in the leftward direction away from the dragged application icon 90c and/or toward application icon 90a. As illustrated in FIG. 9C, application icon 90b is moved closer to application icon 90a (e.g., spacing or gap between application icons 90a and 90b is reduced) as a result of dragging application icon 90c toward application icon 90b). In some embodiments, in conjunction with dislodging or moving application icon 90b relative to its placement location in the applications view 9100a, the computer system 101 generates a sound indicative of moving an application icon, in this example application icon 90b. In some embodiments, the sound indicative of moving application icon 90b has spatial audio characteristics indicating a position or a region in three-dimensional environment from which the application icon 90b is dislodged.

In some embodiments, application icon 90b is pushed away from application icon 90c (and/or toward application icon 90a) until one or more of the following conditions and/or a combination thereof are satisfied. For example, the computer system 101 ceases moving application icon 90b away from application icon 90c, in accordance with a determination that a respective distance between application icons 90b and 90c (e.g., a distance between the centers of application icons 90b and 90c or a distance between the outer edges of application icons 90b and 90c, resulting in a reduced amount of spacing or an increased amount of overlap between application icons 90b and 90c) is less than a threshold distance (or equivalently, less than a threshold amount of spacing, or more than a threshold amount of overlap). In some embodiments, the computer system 101 ceases moving application icon 90b away from application icon 90c, in accordance with a determination that a respective distance between application icon 90c and the original placement location of application icon 90b (e.g., the center of the application icon 90c and the center of the placement location of application icon 90b) is less than a threshold distance. In another example, the computer system 101 ceases moving application icon 90b away from application icon 90c, in accordance with a determination that spacing between application icon 90b and other adjacent icons, such as application icon 90a, is reduced to less than a threshold amount (e.g., as if application icon 90a blocks further movement of application icon 90b and there is room to further push application icon 90b). In another example, the computer system 101 ceases moving application icon 90b away from application icon 90c, in accordance with a determination that application icon 90c has moved past a midpoint of the original placement location of application icon 90b or has moved past a midpoint of application icon 90b. In another example, the computer system 101 ceases moving application icon 90b away from application icon 90c, in accordance with a determination that movement of application icon 90c toward application icon 90b has stopped (e.g., application icon 90c is released and/or application icon 90c is dragged in another direction, increasing and/or creating a gap between application icons 90b and 90c.

In some embodiments, after the computer system 101 stops pushing the application icon 90b away from application icon 90c, the computer system 101 starts moving the application icon 90b toward the placement location vacated by the application icon 90c (e.g., to fill up the fill the vacated placement location). In some embodiments, the computer system 101 starts moving the application icon 90b toward the placement location vacated by the application icon 90c, in accordance with a determination that application icon 90c (e.g., a center or edge of application icon 90c) has moved past a midpoint of application icon 90b and/or a midpoint of the original placement location of application icon 90b. In some embodiments, in accordance with a determination that the computer system 101 stopped pushing application icon 90b away from application icon 90c and, in accordance with a determination that the application icon 90c (e.g., a center or outer edge of application icon 90c) continues moving in the same direction (e.g., leftward direction) past a midpoint of application icon 90b, the computer system 101 initiates a reflowing process that moves application icon 90b out of the way of application icon 90c and toward the placement location vacated by application icon 90c (e.g., toward the third placement location in the top row in the grid of application icons in applications view 9100a.

FIG. 9D is a transition from FIG. 9C after the computer system 101 stopped pushing application icon 90b away from application icon 90c and started moving application icon 90b toward the placement location vacated by the application icon 90c. As illustrated in FIG. 9D, application icon 90b appears to slide underneath application icon 90c while moving toward the placement location vacated by the application icon 90c. In some embodiments, the computer system 101 displays a simulated shadow cast onto application icon 90b and plane 287 to indicate the presence of a gap in depth between application icon 90c and application icon 90b and between application icon 90c and plane 287. In FIG. 9D, user 7002 continues to hold and, optionally, drag application icon 90c (e.g., the air pinch and hold gesture 980b is maintained) while application icon 90b slides underneath application icon 90c. In some embodiments, the application icon 90b slides with greater speed while underneath application icon 90c, and slows down when getting closer to and over the vacated placement location of application icon 90c. In some embodiments, in this example, because folder-creation criteria are not met with respect to application icons 90c and 90b, the computer system 101 does not initiate a folder creation process and, instead, swaps positions of application icons 90c and 90b. Initiating a folder-creation process is described with reference to FIGS. 9F-9J below.

FIG. 9E is transition from FIG. 9D in response to detecting a release 980e of the air pinch and hold gesture 980b while application icon 90c is within a threshold distance of the original placement location of application icon 90b. In some embodiments, the release 980e of the air pinch and hold gesture 980b is detected after the computer system 101 started moving application icon 90b toward the placement location vacated by the application icon 90c. In response to the detection of the release 980e of the air pinch and hold gesture 980b, the computer system 101 places application icon 90c in the placement location previously occupied by application icon 90b. In some embodiments, the application icon 90b is already moved into the placement location previously occupied by application icon 90c or it is placed there in response to the detection of release 980e of the air pinch and hold gesture 980b. FIG. 9E shows a state of the rearrangement of application icons 90b and 90c in applications view 9100a of home user interface 8100 after the termination of the pinch and hold gesture 980b and the movement input 980c. Further, in response to the detection of the release 980e of the air pinch and hold gesture 980b after the movement input 908c, the computer system 101 moves application icon 90c back to plane 287 (e.g., snaps application icon 90c back to into a placement location in plane 287), as illustrated in top view 285. Further, in FIG. 9E, equal or substantially equal spacing between respective pairs of application icons 90a-90d in applications view 9100a is restored. For example, the spacing between application icons 90a and 90c is the same or substantially the same as the spacing between application icons 90c and 90b and the spacing between application icons 90b and 90d.

FIGS. 9F-9J illustrate a scenario in which the computer system 101 initiates a folder creation process with respect to a dragged icon and another icon toward which the dragged icon is being moved (e.g., as opposed to reflowing and/or moving icons out of the way without initiating a folder creation process, as described with reference to FIGS. 9B-9E).

FIG. 9F illustrates the same arrangement of application icons 90a-90k in applications view 9100a as that shown in FIG. 9E. In FIG. 9F, the computer system 101 detects selection of application icon 90c. For example, the computer system 101 detects attention of the user (e.g., based on gaze input 982f of user 7002) directed to application icon 90c (e.g., with less than a threshold amount of movement for more than a threshold amount of time) that causes the computer system 101 to put application icon 90c in focus. Further, the computer system 101 detects an air pinch and hold gesture 980f (e.g., an air pinch gesture that is maintained and not released) performed with user 7002's hand 7022 while application icon 90c has input focus (e.g., as a result of gaze input 982f directed to application icon 90c). In response to the detection of the air pinch and hold gesture 980f while application icon 90c is in focus, the computer system 101 selects and hold application icon 90c and, optionally, moves application icon 90c towards the viewpoint of the user 7002 away from plane 287, thereby resulting in an increased distance in depth between application icon 90c and plane 287, as illustrated in top view 285 in FIG. 9F. In some embodiments, in response to the selection of application icon 90c (e.g., as a result of the air pinch and hold gesture 980f), the computer system 101 generates a selection sound G, such as a spatial audio output that has spatial characteristics corresponding to the location of application icon 90c. Further, FIG. 9F illustrates that user 7002's hand 7022 is about to move in a rightward direction while holding application icon 90c (e.g., by maintain the air pinch and hold gesture 980f), as illustrated by the dashed arrow leading from hand 7022. Top view 285 in FIG. 9F illustrates the position of application icon 90c relative to the adjacent application icon 90b in plane 287 and the direction of subsequent movement of application icon 90c based on a drag movement of the hand 7022.

FIG. 9G is a transition from FIG. 9F in response to the detection of movement input 980g while the air pinch and hold gesture 980f is maintained to hold application icon 90c. For example, the movement input 980g is detected while application icon 90c is selected (e.g., as a result of the air pinch and hold gesture 980f detected in FIG. 9F while application icon 90c is in focus). In response to the detection of movement input 980g while application icon 90c is selected, computer system 101 moves application icon 90c in a rightward direction towards adjacent application icon 90b, in accordance with the characteristics of movement input 980g (e.g., direction, speed, amount, acceleration, and other movement characteristics of movement input 980g). For example, in FIG. 9G, application icon 90c is moved closer to application icon 90b and/or the placement location of application icon 90b (e.g., relative to location of application icon 90c in FIG. 9B) in accordance with movement input 980g. The movement of application icon 90c is additionally illustrated in top view 285 in which application icon 90c has moved along the dashed arrow in the rightward direction and the spacing between application icon 90c and application icon 90b (and/or the spacing between application icon 90c and the placement location of application icon 90b) is reduced. The dragged application icon 90c initially pushes application icon 90b away, in some embodiments. For example, while application icon 90c is dragged in the rightward direction toward application icon 90b and the placement location of application icon 90b, the computer system 101 moves application icon 90b in a direction that includes a rightward direction, away from the dragged application icon 90c, away from the placement location of application icon 90b, and/or toward application icon 90d (and/or the placement location of application icon 90d). As illustrated in FIG. 9G, application icon 90b is moved closer to application icon 90d and/or the placement location of application icon 90d (e.g., spacing or gap between application icons 90b and 90d, and/or the spacing or gap between application icon 90b and the placement location of application icon 90d, are reduced) as a result of dragging application icon 90c toward application icon 90b. In some embodiments, as the gap or spacing between application icons 90b and 90d, and/or the gap or spacing between application icon 90b and the placement location of application icon 90d, are reducing, the application icon 90b is also moved in a direction that includes an upward direction. Accordingly, application icon 90b can move in a direction that is a composite of multiple directions (e.g., directions substantially parallel and directions substantially perpendicular to the direction of movement of application icon 90c) as a result of application icon 90c being moved toward application icon 90b and/or the placement location of application icon 90b. In some embodiments, in conjunction with moving application icon 90b relative to its placement location in the applications view 9100a, the computer system 101 generates a sound indicative of moving application icon 90b.

In some embodiments, movement input 980g includes movements in more than one direction and/or dimension (e.g., includes components in directions parallel to and components in directions perpendicular to, the cardinal directions of the environment or home user interface 8100), at the same time and/or at different times. For example, in addition to movement in the rightward direction, a portion of the movement input 980g includes movement in a downward direction. In response, application icon 90g is pushed away from application icon 90c in a direction that includes a downward direction, as illustrated in FIG. 9G. Accordingly, a dragged application icon can push more than one icon away in more than one direction and/or dimension at a given time. In some embodiments, the computer system 101 generates sounds indicative of moving the icons that are pushed by the dragged icon.

In some embodiments, in FIG. 9G, the distance between application icons 90c and 90b is less than a threshold amount (e.g., the gap between application icons 90c and 90b, such as a gap between the centers of application icons 90c and 90b, or a gap between the same edges of application icons 90c and 90b) is reduced to less than the threshold amount in response to the movement input 980g). In some embodiments, in accordance with a determination that the distance and/or gap between application icons 90c and 90b is reduced to less than the threshold amount, the computer system 101 stops pushing application icon 90b away from application icon 90c (e.g., irrespective of whether application icon 90c continues to move toward application icon 90b under the influence of movement input 908g).

FIG. 9H is a transition from FIG. 9G. In some embodiments, in accordance with a determination that the distance and/or gap between application icons 90c and 90b is reduced to less than the threshold amount, the computer system 101 stops pushing application icon 90b away from application icon 90c (e.g., away from the placement location of 90b, and/or toward application icon 90d and/or the placement location of application icon 90d). In some embodiments, the computer system 101 starts a timer when the distance and/or gap between application icons 90c and 90b is reduced to less than the threshold amount. In some embodiments, the computer system 101 stops pushing application icon 90b further away from application icon 90c and, optionally, starts the timer, in accordance with a determination that the gap between application icons 90b and 90d is reduced to less than a threshold amount (e.g., as if application icon 90d blocks further movement of application icon 90b). In some embodiments, in accordance with a determination that application icons 90c and 90b remain within less than the threshold amount of distance from one another for more than a threshold amount of time as determined by the timer (e.g., as a result of holding application icon 90c within the less than the threshold amount of distance without release), the computer system 101 pulls application icon 90b toward application icon 90c, as illustrated in FIG. 9H. For example, in FIG. 9H, application icon 90b is moving toward application icon 90c and away from application icon 90d as if the application icon 90c is attracting application icon 90b, thereby continuously assisting the user and providing visual feedback. In some embodiments, the application icon 90b moves underneath application icon 90c (e.g., application icon 90c partially overlays the attracted application icon 90b). In some embodiments, the computer system displays a simulated shadow cast by application icon 90c over application icon 90b and/or plane 287, to indicate a difference in depth between application icon 90c and application icon 90b, and/or between application icon 90c and plane 287.

In some embodiments, in accordance with a determination that a movement input that corresponds to a request to move an application icon meets folder-creation criteria, the computer system 100 initiates a folder creation process and generates an audio output indicative of an operation associated with creating a folder, and/or creates a folder and generates an audio output indicative of an operation associated with creating a folder. In this example, movement input 980g, which corresponds to a request to move application icon 90c, meets folder-creation criteria, and initiates a folder-creation process. For example, after the application icon 90b is moved a threshold amount toward a location of application icon 90c and/or is within less than a threshold distance away from application icon 90c, the computer system 101 generates a folder preview icon 920a, as illustrated in FIG. 9I. Folder preview icon 920a provides an indication that a folder creation process has been initiated, and provides an opportunity to user 7002 to either cancel the folder creation process or to confirm and/or complete the folder creation process.

FIG. 9I is a transition from FIG. 9H. After the application icon 90b is moved a threshold amount toward application icon 90c (and/or is within less than a threshold distance away from application icon 90c and/or application icon 90c remains overlaying application icon 90b for more than a threshold amount of time), the computer system 101 generates and displays folder preview icon 920a, where the folder preview icon 920a indicates initiation of a folder creation process, in accordance with some embodiments. In some embodiments, in conjunction with displaying the folder preview icon 920a, the computer system 101 generates and/or outputs a sound 9900 indicative of initiating a folder-creation process. In this example, the folder creation process is initiated with respect to application icons 90b and 90c. Initially, the computer system 101 pulls in application icon 90b into the folder preview icon 920a. For example, as application icon 90b is attracted by application icon 90c, the computer system 101 displays the folder preview icon 920a at a location that intersects with a location of the application icon 90b and starts reducing the size application icon 90b as if application icon 90b is sucked into the folder preview icon 920a, in accordance with some embodiments. In some embodiments, at this stage, the folder creation process is not completed (e.g., the folder icon with application icons 90b and 90c has not yet been created) and user 7002 can still cancel the folder creation, for example, by continuing the movement input to move the application icon 90c away from the folder preview icon 920a. In FIG. 9I, while user 7002 continues to maintain the air pinch and hold gesture 980f that holds application icon 90c (e.g., partially overlaying the folder preview icon 920a that includes application icon 90b), the folder creation process has not yet been completed and the folder creation process has not yet been cancelled. In some embodiments, the computer system 101 creates a folder icon with application icons 90b and 90c inside the folder, in accordance with a determination that a folder creation confirmation criteria are met (e.g., if air pinch and hold gesture 980f is released while application icon 90c is overlaying the folder preview icon 920a and/or the application icon 90b), as described in further detail with reference to FIG. 9J below. In some embodiments, the computer system 101 generates the folder preview icon 920a at the placement location of application icon 90b. In some embodiments, the computer system 101 generates the folder preview icon 920a in accordance with a determination that the distance between the application icon 90c and the placement location of the application icon 90b is less than a threshold distance. In some embodiments, in accordance with a determination that the distance between the application icon 90c and the placement location of the application icon 90b is less than a threshold distance, the computer system generates the folder preview icon 920a (e.g., an empty icon) at the placement location of application icon 90b and the folder preview icon 920a attracts application icon 90b to return to the placement location of application icon 20b (e.g., toward the application icon 90c) and envelops application icon 90b once application icon 90b has returned to its placement location. In some embodiments, the folder preview icon 920 optionally moves and/or expands toward application icon 90b, before application icon 90b starts to move toward the placement location of application icon 90b and/or while the application icon 90b is moving toward the placement location of application icon 90b, to bring application icon 90b into folder preview icon 920a.

FIG. 9J is a transition from FIG. 9I in response to a release of the pinch and hold gesture 980f while the folder preview icon 920a is displayed (e.g., while the folder preview icon 920a includes both application icon 90c and application icon 90b, or includes application icon 90b). FIG. 9J illustrates the state of applications view 9100a after the folder creation process is completed and folder icon 920, with representations of application icons 90b and 90c inside folder icon 920, is generated. In some embodiments, while the folder preview icon 920a is displayed with application icon 90b inside of it, the computer system 101 detects a release 980j of the air pinch and hold gesture 980f that drops application icon 90c into the folder preview icon 920a. In some embodiments, releasing application icon 90c into the folder preview icon 920a confirms and completes the folder creation process. In some embodiments, in conjunction with completing the folder creation process and/or displaying the folder icon 920, the computer system 101 generates a sound G′ 9902 (e.g., also referred to as sound 9902) indicative of creating a folder. In this example, the computer system 101 generates sound G′ 9902 that is optionally a spatial audio output that has spatial characteristics indicating the location of folder icon 920 in the environment and/or in the home user interface 8100. In some embodiments, the sound 9902 indicative of creating a folder is the same or different from (e.g., in terms of volume, frequency, wave pattern, duration, and/or other audio characteristics) the sound 9900 indicative of initiating the folder-creation process. For example, in response to the detection of release 980j of the air pinch and hold gesture 980f, the computer system 101 drops application icon 90c into the folder preview icon 920a in conjunction with reducing the size of application icon 90c and, optionally, expanding the size of folder preview icon 920a until it reaches a size of a regular application icon and becomes folder icon 920, as illustrated in FIG. 9J. Magnified view 985 in FIG. 9J illustrates a magnified version of folder icon 920, in accordance with some embodiments. As illustrated in magnified view 985, folder icon 920 includes application icons 90c and 90b. In some embodiments, the application icons 90c and 90b inside folder icon 920 are representations that do not respond to user input individually to cause the computer system 101 to perform operations associated with application icons 90c and 90b, respectively. In some embodiments, depending on the object type of the icons inside the folder icon (e.g., for icons that represent controls, or icons representing contacts), the icons optionally can be activated directly from the folder icon to cause performance of corresponding functions. For example, a first control and a second control included within a folder icon of a folder including the first control and the second control are optionally accessible directly from the folder icon by an activation input (e.g., an air pinch gesture detected in conjunction with a gaze directed to the first control or the second control), in some embodiments. In some embodiments, in response to the detection of release 980j of the air pinch and hold gesture 980f, the computer system 101 generates a release sound G′ that is optionally a spatial audio output that has spatial characteristics that corresponds to the location of folder icon 920 in the environment and/or in the home user interface 8100. In some embodiments, the selection sound G generated for selecting application icon 90c is different (e.g., in terms of volume, frequency, wave pattern, duration, and/or other audio characteristics) from the release sound G′ generated for releasing the selected application icon 90c. In some embodiments, the sound G′ indicative of releasing application icon 90c in the folder preview icon 920a is different from a sound indicative of releasing the application icon 90c outside a folder and/or a folder preview icon (e.g., in a location in the applications view 9100a of the home user interface 8100). In some embodiments, in conjunction with generating the folder and displaying folder icon 920, the computer system 101 reflows and/or shifts folder icon 920 and application icons 90d-90k (e.g., corresponding to icons that are located after the sequential position of folder icon 920 or after the sequential position of application icon 90b before it was moved into folder icon 920) by one placement location to fill in a respective placement location vacated as a result of moving two application icons 90b and 90c into one folder icon 920 (e.g., thereby reducing the overall count of icons visible in applications view 9100a). For example, as shown in FIG. 9J, the folder icon 920 is reflowed to the original placement location of application icon 90c, and application icon 90d is reflowed to the original placement location of application icon 90b, and application icons 90e and 90k each shifted by one placement location along a reflow path the goes in a right to left and bottom to top direction. In some embodiments, as application icons and/or folder icon(s) are reflowed, if the destination placement location for an application icon or folder icon is in the same row as its original placement location, the application icon or folder icon shifts within the plane 287 (e.g., as in the case of application icons 90d, 90f-90i, and 90k, and folder icon 920a); and if the destination placement location for an application icon or folder icon is in a different row from its original placement location, the application icon or folder icon shifts to depth(s) that are greater than the depth of the plane 287 and move to its destination placement location along a path behind the plane 287 before settling into the destination placement location within the plane 287 (e.g., as in the case of application icons 90e and 90j).

FIG. 9K illustrates applications view 9100a in the same state as in FIG. 9I before the folder creation process is completed. For example, FIG. 9K illustrates a state of applications view 9100a before application icon 90c is dropped into the folder preview icon 920a (e.g., before the detection of the release 980j of the air pinch and hold gesture 980f). In FIG. 9K, the application icon 90c overlays the folder preview icon 920a that includes the application icon 90b (and/or overlays the application icon 90b in the folder preview icon 920a) and user 7002 continues to hold application icon 90c (e.g., by maintaining the air pinch and hold gesture 980f). In FIG. 9K, user 7002's hand 7022 is about to move in a leftward direction, away from folder preview icon 920a, while holding application icon 90c (e.g., by maintaining the air pinch and hold gesture 980f that holds application icon 90c), as illustrated by the dashed arrow leading from hand 7022.

FIG. 9L is a transition from FIG. 9K in response to detecting a release of the air pinch and hold gesture 980f after application icon 90c is moved away from folder preview icon 920a (e.g., after folder preview icon 920a ceases to be displayed because the distance between application icon 90c and the folder preview icon 920a and/or the distance between application icon 90c and the placement location of application icon 90b, is greater than a threshold distance). In some embodiments, in response to the detection of movement input 980k (e.g., shown in FIG. 9L) by more than a threshold amount of movement (e.g., to cause more than a threshold amount of gap between application icon 90c and the folder preview icon 920a and/or between application icon 90c and the placement location of application icon 90b) while maintaining the air pinch and hold gesture on application icon 90c, the computer system 101 cancels the folder creation process and ceases to display folder preview icon 920a (e.g., in accordance with a determination that the gap between application icon 90c and folder preview icon 920a and/or the placement location of the application icon 90b is increased to more than a threshold amount). In some embodiments, in conjunction with cancelling the folder creation process, the computer system 100 generates sound 9904 indicative of cancelling the folder creation process. In some embodiments, the sound 9904 indicative of cancelling the folder creation process is different from the sound 9900 indicative of initiating the folder creation process (e.g., in terms of volume, frequency, wave pattern, duration, and/or other audio characteristics). In some embodiments, the sound 9904 indicative of cancelling the folder creation process is different from the sound 9902 indicative of creating a folder and/or a sound indicative of placing an application icon into a folder and/or into a folder preview icon (e.g., folder preview icon 920a). In some embodiments, as the application icon 90c is moved away from application icon 90b (e.g., as a result of movement input 980k), in conjunction with removing folder preview icon 920a, the computer system 101 restores original position, size, and/or state of application icon 90b as in FIG. 9E before application icon 90c was dragged toward application icon 90b. In FIG. 9L, the computer system 101 further detects a release 980l of the air pinch and hold gesture 980f that causes the computer system 101 to release the hold on application icon 90c. In response to the detection of release 980l that causes the computer system 101 to release the hold on application icon 90c, the computer system 101 moves application icon 90c back to plane 287 and inserts application icon 90c into a placement location in applications view 9100a corresponding to a location where application icon 90c is released. Accordingly, instead of creating a folder icon 920, the computer system 101 moves application icon 90c to a location that corresponds to or intersects with a placement location in three-dimensional environment where it is dropped. In FIG. 9L, application icon 90c is moved back to plane 287 at the original location of application icon 90c in FIG. 9E, as illustrated in top view 285 in FIG. 9L. In some embodiments, application icon 90c can be dropped elsewhere (e.g., in the manner described in FIGS. 9A-9D), and moving application icon 90c to a different location in application view 9100a causes the computer system 101 to automatically cancel the folder creation process and/or allowing the user to select a new drop-off location for application icon 90c (e.g. moving to another placement location in the same section of the applications view 9100a, a different section in applications view 9100a, or creating another folder with another application icon in the same or different section of applications view 9100a).

FIGS. 9M-9P illustrate moving application icon 90c away from folder preview icon 920a and, instead of dropping application 90c into its original placement location (e.g., the position of application icon 90c in FIG. 9E), user 7002 drags application icon 90c toward the preview of an adjacent section (e.g., toward dimmed application icon 90l on the first section of applications view 9100a). In some embodiments, if a preview of adjacent section is not displayed (e.g., because preview of adjacent section(s) is not enabled in a respective embodiment, and/or an adjacent section is not yet created), the application icon 90c is dragged toward an edge of the currently displayed section to cause navigation to the adjacent section (and, optionally, creation of a new section as the adjacent section if the adjacent section is not yet created).

FIG. 9M illustrates applications view 9100a in the same state as in FIG. 9K before the folder creation process is completed. As in FIG. 9K, FIG. 9M illustrates a state of applications view 9100a before application icon 90c is dropped into the folder preview icon 920a (e.g., before the detection of release 980l of the air pinch and hold gesture 980f in FIG. 9L) and while user 7002 continues to hold application icon 90c over folder preview icon 920a (e.g., as a result of maintaining the air pinch and hold gesture 980f). In FIG. 9M, as in FIG. 9K, user 7002's hand 7022 is about to move in one or more directions that include a leftward direction, away from folder preview icon 920a, while holding application icon 90c, as illustrated by the dashed arrow leading from hand 7022.

FIG. 9N is a transition from FIG. 9M in response to the detection of movement input 980n that drags application icon 90c away from folder preview icon 920a and toward application icon 90a (and/or the placement location of application icon 90a), as illustrated by the reduced gap between application icon 90c and application icon 90a (and/or the reduced distance between application icon 90c and the placement location of application icon 90a). In response to dragging application icon 90c away from folder preview icon 920a (e.g., creating more than a threshold amount of distance between application icon 90c and folder preview icon 920a, and/or between application icon 90c and the placement location of folder preview icon 920a), the computer system 101 cancels the folder creation process and ceases to display folder preview icon 920a (e.g., redisplaying application icon 90b at the placement location of folder preview icon 920a). In some embodiments, in conjunction with cancelling the folder creation process, the computer system 100 generates sound 9904 indicative of cancelling the folder creation process. In some embodiments, the computer system 101 generates the same sound 9904 indicative of cancelling the folder creation process irrespective of the technique used to cancel the folder creation process. In this example, the computer system 101 generates the same sound 9904 when cancelling the folder creation process by dragging application icon 90c away from the folder preview icon 920a and when cancelling the folder creation process by dropping the application icon 90c outside the folder preview icon 920a. In FIG. 9N, instead of releasing the air pinch and hold gesture 980f and dropping application icon 90c at its original placement location (as described with reference to FIG. 9K), user 7002 is about to further drag application icon 90c in the leftward direction past application icon 90a and toward the preview of the first section of applications view 9100a (e.g., toward dimmed application icon 90l on the previous section in applications view 9100), as illustrated by the dashed arrow leading from hand 7022.

FIG. 9O is a transition from FIG. 9N in response to the detection of further movement input 9800 in the one or more directions that include the leftward direction. For example, in FIG. 9O, application icon 90c is moved past application icon 90a (e.g., optionally after initially pushing application icon 90a away and toward application icon 90l and, then, causing application icon 90a to slide underneath application icon 90c, e.g., in the manner as described in relation to FIGS. 9C-9D with respect to application icons 90b and 90c). Further, application icon 90c is dragged towards an edge of the section of applications view 9100a that is currently in focus and toward dimmed application icon 90l. In some embodiments, as the gap between the dragged application icon 90c and dimmed application icon 90l is reduced, application icon 90l is pushed away (e.g., even though application icon 90l is located in a section of applications view 9100a that is not currently in focus, and application icon 90l is shown in a preview of the section containing application icon 90l). In some embodiments, the positioning of application icons (e.g., application icons 90l, 90m, and 90n) in the preview of the adjacent section is slightly different from the positioning of the same application icons in the adjacent section when the adjacent section becomes the section in focus. For example, when the adjacent section including the application icons 90l, 90m, and 90n becomes the section in focus, the relative positions of application icons 90l, 90m, and 90n would be the same as the relative positions of application icons 36d, 36i, and 36m in FIG. 8S (e.g., application icon 90m in the second row would be farther out to the right than application icons 90l and 90n in the first and third rows). Correspondingly, the section containing application icons 90a, 90e, and 90j would no longer be in focus, and a preview containing dimmed versions of application icons 90a, 90e, and 90j would be displayed next to the right edge of the second containing application icons 90l, 90m, and 90n. The relative positions of application icons 90l, 90m, and 90n in the preview would be the same as that of application icons 36n, 360, and 36p as shown in FIG. 8S. As illustrated in FIG. 9O, user 7002 is still holding application icon 90c (e.g., by maintaining the pinch and hold gesture 980f). Top view 285 illustrates that application icon 90c, while being held by user 7002, is lifted off plane 287 toward the viewpoint of user 7002.

FIG. 9P is a transition from FIG. 9O in response to the detection of release 980p of the air pinch gesture 980f. In response to the detection of release 980p of the air pinch and hold gesture 980f, the computer system 101 moves application icon 90c back to plane 287 (e.g., as illustrated in top view 285 in FIG. 9P) at a placement location in application view 9100a corresponding to a location where application icon 90c is released. Accordingly, instead of creating a folder icon, the computer system 101 moves application icon 90c to a different placement location where it is dropped. In FIG. 9P, application icon 90c is moved back to plane 287 at the placement location previously occupied by application icon 90a in FIG. 9M (e.g., before dragging application icon 90c in the leftward direction toward application icon 90a and then application icon 90l). FIG. 9P illustrates a stable state of applications view 9100a after rearrangement of application icons 90a and 90c (e.g., application icon 90a and application icon 90c switched positions).

In some embodiments, the release 980p in FIG. 9P is detected before further movement and dragging of application icon 90c toward application icon 90l in the previous section. In some embodiments, if user 7002 continues to drag application icon 90c toward application icon 90l and moves within a less than a threshold distance away from application icon 90l (and/or the previous section), the computer system 101 automatically (optionally, with animation) switches from displaying the second section in focus to displaying the first section in focus. Accordingly, the computer system 101 disambiguates between rearranging the home user interface, creating a folder, and/or navigating between sections of applications view 9100a while dragging an application icon. In some embodiments, if the air pinch and hold gesture 980f is released while the first section of application view 9100b is in focus, the application icon 90c will be dropped into a position into the first section, causing a new folder to be created in the first section, and/or causing one or more application icons in the first section to reflow in the first section or overflow into the second section.

In FIG. 9Q, the three-dimensional environment includes an applications view 9100b of home user interface 8100 that includes a collection of application icons (e.g., for launching, opening, and/or otherwise causing the computer system 101 to display a respective user interface of a corresponding application). For example, the section of application view 9100b currently in focus and visible via HMD 7100a includes application icons 92c, 92d, 92e, 92f, 92g, 92h, 92i, and 92j (also collectively referred to as application icons 92c-92j). Applications view 9100b in FIG. 9Q is similar to or different from applications view 9100a in FIG. 9A in various embodiments. For example, applications view 9100a and application view 9100b optionally include the same application icons, or different application icons, or some application icons in application views 9100a and 9100b are the same and some application icons in application views 9100a and 9100b are different. Further, in this example, applications view 9100b includes folder icon 92a, folder icon 92b, and folder icon 92k. In some embodiments, folder icons 92a and 92b correspond to user-arranged folders that include respective subsets of application icons selected by a user for inclusion in the respective user-arranged folders (e.g., by dragging and dropping application icons onto other application icons and/or existing folder icons). In some embodiments, the process for dragging and dropping an application icon onto an existing folder icon (e.g., folder icons 92a, 92b in FIG. 9Q, and folder icon 920 in FIG. 9J) is similar to that of dropping an application icon 90c onto another application icon 90b to merge application icon 90c into a folder including application icon 90b (e.g., as described with respect to FIGS. 9E-9J). In some embodiments, a folder icon is initially repelled by a dragged application icon when the dragged icon is moved toward the folder icon, and then when the folder icon is within a threshold distance of the dragged icon, the folder icon stops moving in a direction away from the dragged icon, returns to its placement location, and toward the dragged icon, in the manner described with respect to application icon 90b relative to the dragged application icon 90c in FIGS. 9E-9J. In some embodiments, while the dragged application icon is hovered over the folder icon for at least a threshold amount of time, the folder icon expands to indicate that if a termination of the pinch and hold gesture is detected at this time, the dragged application icon would be absorbed into the folder icon, and the application icon would be added to the folder.

In some embodiments, in response to user 7002's inputs, the computer system 101 has generated folders represented by folder icons 92a and 92b according to user 7002's selection and rearrangement of application icons in applications view 9100b. In contrast, folder icon 92k corresponds to a system-generated folder that includes application icons of applications that operate in compatibility mode with respect to the operating system of computer system 101. In some embodiments, folder icon 92k and its corresponding folder are automatically generated by the computer system 101. In some embodiments, applications that operate in a compatibility mode include compatible applications that are not optimized or designed for XR three-dimensional environment and/or not optimized or designed for the operating system that is loaded on computer system 101. For example, even though respective applications operating in compatibility mode (e.g., also referred to as “compatible” applications) can be opened and interacted with, some of the features provided by a spatial computer system, such as computer system 101, with respect to the three-dimensional experience are unavailable in these applications. In some embodiments, in contrast to “native” applications, “compatible” applications are originally designed and tested for another operating system and/or hardware other than the operating system and/or hardware of the computer system 101, but are operable with acceptable, but less than optimized performance (e.g., do not utilize many of the capabilities of) on the operating system and/or hardware of the computer system 101. In some embodiments, icons of applications that operate in a compatibility mode are automatically added to the system-generated folder corresponding to folder icon 92k upon installation of respective applications on computer system 101. In some embodiments, application icons in the system-generated folder corresponding to folder icon 92k can be removed from the folder corresponding to folder icon 92k and placed on the home user interface 8100, as described in further detail with reference to 9AA-9AF. In some embodiments, applications represented by application icons 92c-92j are “native applications”. Some of the “native” applications are optionally pre-installed on computer system 101. Further, applications view 9100b is optionally displayed in the reconfiguration mode, as shown in FIG. 9Q. For example, similar to applications view 9100a in the reconfiguration mode, preview of adjacent sections in applications view 9100b are visible (e.g., dimmed application icons 92l, 92m, and 920n included in the first section are displayed in the preview of the first section), passthrough portions of the three-dimensional environment visible via HMD 7100a are optionally visually deemphasized, and/or application icons 92c-92j in applications view 9100b oscillate in three dimensions while the reconfiguration mode is active.

FIG. 9Q illustrates magnified version 987 of folder icon 92a and magnified version 989 of folder icon 92b. Folder icon 92a includes representations of application icons that are optionally categorized as utilities applications (e.g., by a user, or automatically by the computer system based on metadata associated with the applications included in the folder corresponding to folder icon 92a). In some embodiments, the label “Utilities” below folder 92a corresponds to a name or label of the folder 92a (e.g., the label is provided by user 7002 or automatically generation or determined by computer system 101). Folder icon 92a includes representations of seven application icons, including application icon 9202 corresponding to a settings application, application icon 9204 corresponding to a clock application, application icon 9206 corresponding to a recording application, application icon 9208 corresponding to an ebooks application, application icon 9210 corresponding to a browser application, application icon 9211 corresponding to a music application, and application icon 9212 corresponding to a flights application. In some embodiments, application icons 9202, 9204, 9206, 9208, 9210, 9111, and 9212 are collectively referred to as application icons 9202-9212. Folder icon 92b includes representations of three application icons, including application icon 9214 corresponding to a first game, application icon 9216 corresponding a second game, and application icon 9218 corresponding to a third game. In some embodiments, application icons 9214, 9216, and 9218 are collectively referred to as application icons 9212-9218. In some embodiments, the label “Games” below folder 92b corresponds to a name or label of the folder 92a (e.g., the label is provided by user 7002 or automatically generation or determined by computer system 101). As illustrated, folder icons 92a and 92b include application icons displayed at a reduced scale (e.g., relative to application icons 92c-92j) and are, optionally, not responsive to selection inputs to open their corresponding applications. In some embodiments, application icons displayed in folder icons have different layouts depending on the number of icons included the folders corresponding to respective folder icons. For example, application icons 9202-9212 in folder icon 92a, application icons in folder icon 92b, and application icons in folder icon 920 (e.g., in FIG. 9J) have different layouts based on the different numbers of icons included in them (e.g., as opposed to merely showing fewer or more icons in a fixed grid or layout). For example, application icons 90b and 90c in folder icon 920 are arranged in a side-by-side layout because folder icon 920 includes two icons (e.g., as opposed to more than two icons). In another example, icons 9212-9218 in folder icon 92b are arranged in a layout that corresponds to a triangle shape because folder icon 92b includes three application icons (e.g., as opposed to fewer or more icons than three icons). In another example, icons 9202-9212 in folder icon 92a are arranged in a layout that corresponds a hex grid (e.g., optionally, because folder icon 92a includes more than a threshold number of icons, such as more than four, five, six, or seven icons).

In FIG. 9R, the computer system 101 detects one or more selection inputs that cause the computer system 101 to select folder icon 92a. For example, user's attention (e.g., based on user 7002's gaze 982r) directed to folder icon 92a causes computer system 101 to put folder icon 92a in focus. Further, the computer system 101 detects an air pinch gesture 980r while folder 92a has input focus, followed by a release of the air pinch gesture 980r within less than a threshold amount of time and with less than a threshold amount of movement (e.g., the hand 7022 remains substantially stationary as a whole during the air pinch gesture), that causes the computer system 101 to expand folder icon 92a to show content of the folder corresponding to folder icon 92a, as illustrated in FIG. 9S.

FIG. 9S is a transition from FIG. 9R in response to the selection of folder icon 92a (e.g., an air pinch gesture that is terminated before meeting a time threshold required for an air pinch and hold gesture). In response to the selection of folder icon 92a, the computer system expands folder icon 92a (optionally, with an animation of the expansion) and displays an expanded version 92a′ of folder icon 92a. In some embodiments, the layout of application icons 9202-9212 in folder icon 92a (e.g., showing scaled down or miniature versions of application icons 9202-9212) is optionally the same as the layout of application icons 9202-9212 in the expanded version 92a′ of folder icon 92a. In some embodiments, application icons 9202-9212 in the expanded version 92a′ of folder icon 92a are displayed at larger scale relative to the scale of application icons 9202-9212 displayed in folder icon 92a. In some embodiments, the application icons 9202-9212 in the expanded version 92a′ of folder icon 92a have the same size and/or appearance as the application icons 9202-9212 if they were displayed outside of a folder in applications view 9100b. In some embodiments, in conjunction with expanding folder icon 92a, the computer system 101 visually deemphasizes other portions of the three-dimensional environment visible via HMD 7100a that are outside the expanded version 92a′ of folder icon 92a. For example, application icons 92c-92j and passthrough portions of three-dimensional environment visible via HMD 7100a outside the expanded version 92a′ of folder icon 92a are blurred, darkened, displayed with increased opaqueness, decreased size and/or moved away from the viewpoint of user 7002. Further, optionally, in conjunction with expanding folder icon 92a, the computer system ceases to display the preview of adjacent sections, including dimmed icons 92l, 92m, and 92n. In some embodiments, in conjunction with expanding folder icon 92a, the computer system 101 moves the expanded version 92a′ of folder icon 92a towards the viewpoint of user 7002, away from the plane 287. In some embodiments, expanded version 92a′ of folder icon 92a is displayed at the same depth occupied by plane 287 and the folder icon 92a, while the applications views 9100b containing the application icons and folder icons are pushed to a greater depth away from the viewpoint of the user. In some embodiments, label 921 that corresponds to the name “Utilities” of folder 92a can be changed in response to user inputs. For example, pinch gesture 980s detected while the attention of the user (e.g., based on gaze input 982s) is directed to label 921 causes the computer system 101 to initiate a process for editing label 921, including activating a text editing mode (e.g., activating a text editing mode optionally includes moving a cursor, highlighting the label, displaying a virtual keyboard and/or other actions for editing label 921). In some embodiments, folder icons can similarly be expanded when applications view 9100b is in the normal mode (e.g., in addition to when applications view 9100b is in the reconfiguration mode). In some embodiments, if a folder includes more than a threshold number of icons that can be shown with sufficient clarity in the folder icon, the computer system displays the threshold number of icons in the folder icon, and displays additional icons in the expanded version of the folder icon along with the icons displayed in the un-expanded version of the folder icon. For example, if the folder corresponding to folder icon 92a included more than seven icons, the folder icon 92a would still show the seven icons as shown in FIG. 9Q when the folder icon 92a is not expanded. However, once folder icon 92a is expanded into the expanded version 92a′ of folder icon 92a, more than seven icons would be displayed in the expanded version 92a of folder icon 92a (e.g., including one or more other icons that were not initially visible in folder icon 92a, as well as the seven icons that were initially visible in folder icon 92a). In some embodiments, the icons in the expanded version 92a′ are scrollable in one or more directions (e.g., up and down directions, left and right directions, and/or radial directions) in response to user's scrolling input (e.g., an air pinch and hold gesture that includes more than a threshold amount of movement within a threshold amount of time, directed to an unoccupied portion of the expanded version 92a′ and/or an application icon within the expanded version 92a′). In some embodiments, the expanded version 92a′ of the folder icon 92a includes a greater portion of a placement grid than that shown in folder icon 92a, and the additional icons are visible on the additional portion of the placement grid along with the icons visible in the portion of the grid visible in folder icon 92a.

In some embodiments, application icons in a folder can be rearranged (and correspondingly causing changes in the folder icon and/or the expanded version of the folder icon) in response to user inputs similar to how application icons in applications view 9100b can be rearranged. In some embodiments, the descriptions regarding how icons may be moved, repositioned, and/or combined into folders, in the same section of a view and/or across multiple sections of the same view, are also applicable to how icons can be moved, repositioned, and/or combined into subfolders in an expanded version of an application folder. FIGS. 9T-9V illustrates moving an application icon from one location to another location within the expanded version 92a′ of folder icon 92a, and, optionally, upon moving the application icon, triggering an automatic reflow of other icons in the expanded version of the folder icon.

In FIG. 9T, the computer system 101 detects one or more selection inputs directed to application icon 9211 in the expanded version 92a′ of folder icon 92a. For example, the computer system 101 detects user's attention (e.g., based on gaze input 982t) directed to application icon 9211 that puts application icon 9211 in focus. Further, while application icon 9211 has input focus, the computer system 101 detects an air pinch and hold gesture 980t that selects and holds application icon 9211 (e.g., until release of pinch gesture 980t is detected). In some embodiments, in response to the air pinch and hold gesture 980t that puts application icon 9211 in focus, the computer system 101 moves application icon 9211 toward the viewpoint of user 7002, resulting in a gap in depth between application icon 9211 and a plane on which expanded version 92a′ of folder icon 92a is displayed and/or located in the three-dimensional environment visible via HMD 7100a. In some embodiments, the computer system 101 expands the size of application icon 9211 or otherwise highlight its appearance relative to its previous appearance to indicate the selected status of application icon 9211. In some embodiments, the computer system displays a simulated shadow cast onto the platter of the expanded version 92a′ of folder icon 92a by the application icon 9211. Further, in FIG. 9T, as illustrated by the dashed arrow leading from hand 7022, the user 7002 is about to drag application icon 9211 in one or more directions that includes an upward direction from the middle row toward the top row in the placement grid of application icons 9202-9212 in the expanded version 92a′ of folder icon 92a.

FIG. 9U is a transition from FIG. 9T in response to the detection of movement input 980u (e.g., while the air pinch and hold gesture 980t is maintained) dragging application icon 9211 from the middle row toward the top row in the placement grid of application icons 9202-9212 in the expanded version 92a′ of folder icon 92a. In FIG. 9U, the application icon 9211 has been dragged (e.g., in response to movement input 980u) at least two thirds of the way to the top row in the placement grid of application icons 9202-9212 or another threshold amount for triggering reflow of application icons in the expanded version 92a′ of folder icon 92a. In some embodiments, in accordance with a determination that application icon 9211 has been dragged at least the threshold amount for triggering reflow of application icons in the expanded version 92a′ of folder icon 92a, the computer system 101 automatically reflows or shifts application icons 9204 and 9212 (e.g., corresponding to icons that are located at and after the sequential placement position of where application icon 9211 is about to be inserted) by one placement location to fill in a respective placement location vacated by application icon 9211 and to move out of the way of application icon 9211 that is about to be inserted in the second placement location in the top row.

FIG. 9V is a transition from FIG. 9U in response to the detection of release 980v of the air pinch and hold gesture 980t that holds application icon 9211 during the movement of application icon 9211. In some embodiments, in accordance with a determination that application icon 9211 has been dragged at least two thirds of the way to the top row in the placement grid of application icons 9202-9212 when release 980v of the air pinch and hold gesture 980t is detected, the computer system 101 inserts application icon 9211 in the second placement location in the top row (e.g., a placement location corresponding to and/or intersecting with a location where application icon 9211 is dropped). Further, in conjunction with inserting application icon 9211 in the second placement location in top row of expanded version 92a′ of the folder icon 92a, the computer system 101 shifts application icons 9204 and 9212 by one placement location to make room for application icon 9211 and to fill in the placement location vacated by application icon 9211 (e.g., corresponding to middle placement location located in the middle row), as illustrated in FIG. 9V. For example, icons 9204 and 9212 are reflowed along a reflow path following a left to right and top to bottom direction along the placement grid. In some embodiments, icon 9204 moves behind the plane containing other application icons in the folder when switching from the top row to the second row of the expanded version 92a′ of folder icon 92a, while application icon 9212 moves within the plane containing the other application icons in the folder because it is moving in the same row (e.g., the second row). In some embodiments, application icons in folders can similarly be rearranged when applications view 9100b is in the normal mode (e.g., in addition to when applications view 9100b is in the reconfiguration mode). In some embodiments, application icons in folders can be deleted in the reconfiguration mode, but not in the normal mode. In some embodiments, deletion of application icons in a folder is not permitted or enabled, and an application icon in a folder can only be deleted when it is moved outside of the folder and when the application view is in the reconfiguration mode. In some embodiment, deletion of application icons inside a folder is enabled when the folder was expanded while the application view is in the reconfiguration mode.

In some embodiments, in addition to rearranging icons in an expanded folder in the three-dimensional environment, a respective icon from the expanded folder can be moved out of the expanded folder onto a respective view of the home user interface as a standalone icon, using a drag and drop input directed to the respective icon (e.g., direct and/or indirect air drag and drop gesture directed to the respective icon). For example, FIGS. 9W-9Z illustrate dragging application icon 9212 out of the expanded version 92a′ of folder icon 92a and placing application icon 9212 onto applications view 9100b of home user interface 8100 as a standalone application icon, in accordance with some embodiments.

In FIG. 9W, the computer system 101 detects one or more selection inputs directed to application icon 9212 in the expanded version 92a′ of folder icon 92a. For example, the computer system 101 detects user's attention (e.g., based on gaze input 982w) directed to application icon 9212 that puts application icon 9212 in focus. Further, while application icon 9212 has input focus, the computer system 101 detects an air pinch and hold gesture 980w that selects and holds application icon 9212 (e.g., until release of air pinch and hold gesture 980w is detected). In some embodiments, in response to the air pinch and hold gesture 980w detected while the application icon 9212 has input focus, the computer system 101 moves application icon 9212 toward the viewpoint of the user 7002, resulting in a gap in depth between application icon 9212 and a plane on which expanded version 92a′ of folder icon 92a is displayed and/or located in the three-dimensional environment visible via HMD 7100a. Optionally, the computer system 101 further enlarges application icon 9212 (e.g., relative to other icons that remain on the plane in three-dimensional environment where the expanded version 92a′ of folder 92a is located). In the example shown in FIGS. 9W-9AA, application icon 9212 serves as an example icon that is dragged out of the folder corresponding to folder icon 92a, however, as a person of ordinary skills can appreciate, another application icon, such as application icon 9211 in FIG. 9S or FIG. 9W, and/or other application icons in the expanded version 92a of folder icon 92a, can be dragged out of the folder and placed onto the applications view 9100a in an analogous manner. Similarly, application icons other than icon 9211, such as icon 9212 or another icon in FIG. 9W, can be dragged and repositioned within the expanded version 92a′ of folder icon 92a in a manner analogous to the manner described with respect to application icon 9211 in FIGS. 9S-9V as well.

Further, in FIG. 9W, as illustrated by the dashed arrow leading from hand 7022, the user 7002 is about to drag application icon 9212 outside of the expanded version 92a′ of folder icon 92a. In some embodiments, while the expanded version 92a′ of folder icon 92a is displayed, the portion of the three-dimensional environment that is visible via HMD 7100a and that is outside of the expanded version 92a′ of folder icon 92a remains blurred or otherwise visually deemphasized (e.g., darkened, and/or receded in depth from the viewpoint), as illustrated in FIG. 9W. In some embodiments, in accordance with a determination that a release of the air pinch and hold gesture 980w is detected while application icon 9212 has input focus and that the user's 7002 hand had remained substantially stationary during the air pinch and hold gesture 980w before the release of the air pinch and hold gesture 980w, the computer system 101 opens the flights application corresponding to application icon 9212. In some embodiments, if more than a threshold amount of movement of the hand is detected before the release of the air pinch and hold gesture, the computer system forgoes opening the flight application corresponding to the application icon 9212. In some embodiments, a corresponding application can be opened from both the applications view of the home user interface and an expanded folder in response to the same selection input directed to an application icon (e.g., an air pinch and release within less than a threshold amount of time and with less than a first threshold amount of movement of hand 7022 during the pinch; and/or an air pinch and hold gesture that is released with less than a second threshold amount of movement of hand 7022, where the first threshold amount of movement is less than, or, optionally, equal to the second threshold amount of movement).

FIG. 9X is a transition from FIG. 9W in response to the detection of movement input 980x dragging application icon 9212 outside of expanded version 92a′ of folder icon 92a. In some embodiments, in accordance with a determination that application icon 9212 has moved past the border of expanded version 92a′ of folder icon 92a (e.g., has moved outside of the expanded version 92a′ of folder icon 92a) or is within less than a threshold distance away from the border of expanded version 92a′ of folder icon 92a, the computer system 101 starts to scale down and/or shrink expanded version 92a′ of folder icon 92a and return folder icon 92a to its unexpanded state at its original placement location in the applications view 9100b. In some embodiments, the computer system 101 displays an animation of expanded version 92a′ of folder icon 92a shrinking back into its original placement location in applications view 9100b (e.g., shrink back to its original size and location before folder icon 92a was expanded), as illustrated in FIG. 9X. FIG. 9X illustrates an intermediary state of applications view 9100b of the home user interface 8100 while the expanded version 92a′ of folder icon 92a is scaling back down to the original size and location of folder icon 92a. In some embodiments, during the animated transition, a representation of the dragged application icon 9212 is no longer included in the expanded version 92a′ as the expanded version 92a′ continues to scale down, as shown in FIG. 9X. In FIG. 9X, application icon 9212 remains under the control of the air pinch and hold gesture 980w and moves in the three-dimensional environment (e.g., relative to the expanded version 92a′ that is scaling down, and relative to the applications view 9100b) based on the movement of the hand 7022 while the air pinch and hold gesture 980w is maintained. In some embodiments, in conjunction with the shrinking the expanded version 92a′ of folder icon 92a, the computer system 101 restores visibility of applications view 9100b to the state it was in before folder icon 92a was expanded. For example, the computer system 101 removes the blurring, dimming, change in opaqueness, and/or other reverses other visual effects that were performed in conjunction with expanding folder icon 92a.

FIG. 9Y is a transition from FIG. 9X after the expanded version 92a′ of folder 92a is scaled back down to folder icon 92a at the original size and displayed at its original location (e.g., at a respective size and location the folder icon 92a was in before it was expanded). In FIG. 9Y, application icon 9212 remains under the control of the air pinch and hold gesture 980w and moves in the three-dimensional environment (e.g., relative to the expanded version 92a′ that is scaling down, and relative to the applications view 9100b) based on the movement of the hand 7022 while the air pinch and hold gesture 980w is maintained. In some embodiments, in accordance with a determination that application icon 9212 is moved out of folder icon 92a (and correspondingly, out of the folder corresponding to folder icon 92a), the application icons 9202-9210 in folder icon 92a (and correspondingly, in the folder represented by folder icon 92a) are automatically shifted and/or reflowed to fill up the placement location vacated by application icon 9212 in the placement grid of application icons displayed in folder icon 92a, as illustrated in magnified view 287a of folder icon 92a in FIG. 9Y. For example, the spatial distribution of application icons in the placement grid in folder icon 92a condense as a result of shifting to fill in the vacated placement location, in accordance with some embodiments.

FIG. 9Z is a transition from FIG. 9Y in response to the detection of a release 980z of the air pinch and hold gesture 980w after the application icon 9212 is moved out of the expanded version 92a′ of folder icon 92a, and the expanded version 92a′ has started and/or completed shrinking down to folder icon 92a. In response to the detection of the release 980z of the air pinch and hold gesture 980w, the computer system 101 inserts application icon 9212 in the placement grid of applications view 9100b at a placement location that corresponds to and/or intersects with a location of application icon 9212 in three-dimensional environment when the release 980z of the air pinch and hold gesture 980w was detected. In some embodiments, in conjunction with dropping application icon 9212 outside a folder, in this example outside folder icon 92a, and placing the application icon 9212 in applications view 9100b, the computer system 101 generates a sound 9906 indicative of dropping an application icon outside a folder icon (e.g., and/or outside a folder preview icon). In some embodiments, the sound 9906 is different from the sound 9902 indicative of dropping an application icon into a folder preview icon and different from a sound 9913 indicative of dropping an application icon into a folder (e.g., as described with reference to FIGS. 9AK-9AL). In some embodiments, the inserted application icon 9212 settles into a respective placement location according to the grid of placement locations in applications view 9100b, where the respective placement location is, optionally, is unoccupied by another application icon prior to the insertion of application icon 9212. In some embodiments, if application icon 9212 is held over a placement location that is currently occupied by another application icon, the application icon may move away from the application icon 9212, move toward application icon 9212, forming a new folder with application icon 9212, in applications view 9100b, in a manner analogous to that described with respect to FIGS. 9A-9V, when the air pinch and hold gesture 980w is terminated (e.g., by the release 980z of the air pinch and hold gesture 980w). In some embodiments, application icons in folders can similarly be rearranged when applications view 9100b is in the normal mode (e.g., in addition to the reconfiguration mode). In some embodiments, application icons in folders can similarly be removed from the folders and placed into placement locations in the applications view of the home user interface as standalone application icons, when applications view 9100b is in the normal mode (e.g., in addition to when applications view 9100b is in the reconfiguration mode).

As described above, both “native” and “compatible” applications are installed and available on computer system 101. In some embodiments, the “compatible” applications are added to a dedicated folder, such as a folder corresponding to folder icon 92k, upon installation of respective compatible applications. In some embodiments, “compatible” applications remain in the folder corresponding to folder icon 92k and cannot be placed on the home user interface 8100 (e.g., in applications view 9100b as standalone application icons) outside folder icon 92k. In some embodiments, “compatible” applications can be placed on home user interface 8100 to be concurrently displayed with “native” applications and/or folders of “native” applications, as described in reference to FIGS. 9AA-9AF.

FIG. 9AA illustrates applications view 9100b in the same state as applications view 9100b in FIG. 9Z (e.g., after application icon 9212 is removed from the folder corresponding to folder icon 92a and placed directly in applications view 9100b of the home user interface 8100 as standalone application icons), in accordance with some embodiments. The computer system 101 detects user's attention (e.g., based on gaze input 982aa) directed to folder icon 92k that corresponds to a folder that includes “compatible” applications. As illustrated in FIG. 9AA, while folder icon 92k, like folder icons 92a and 92b, display application icons at a reduced scale (e.g., relative to application icons displayed directly in applications view 9100b of home user interface 8100), application icons representing “compatible” applications in folder icon 92k have a different appearance (e.g., a different shape, size, and/or color palette) than application icons for “native” applications displayed in folder icons 92a and 92b for user-configured folders. In some embodiments, application icons for “compatible” applications also have a different appearance from application icons for “native” applications that are outside of user-configured folders corresponding to folder icons 92a and 92b and that are directly in applications view 9100b of the home user interface 8100, apart from the mere reduction in icon size due to their inclusion into a folder icon. For example, “native” applications are represented by icons that have a convex shape and “compatible” applications are represented by icons that have a polygon shape, in some embodiments. In another example, “native” applications are represented by icons that are volumetric, rounded, or having a greater thickness, and “compatible” applications are represented by icons that are two-dimensional, flat, or have a reduced thickness. Further, as shown in FIG. 9AA, the computer system 101 detects a selection input while folder icon 92k has input focus (e.g., as a result of gaze input 982aa directed to folder icon 92k). For example, the computer system detects an air pinch gesture 980aa that is released within less than a threshold amount time (e.g., a threshold amount of time required for an air pinch and hold gesture, or another threshold amount of time) and while hand 7022 remains substantially stationary (e.g., moves less than a threshold amount in a unit of time); and in response, the computer system 101 expands folder icon 92k and display expanded version 92k′ of folder icon 92k, as illustrated in FIG. 9AB.

FIG. 9AB is a transition from FIG. 9AA in response to the selection of folder icon 92k for a folder containing “compatible” applications. In response to the selection of folder icon 92k, the computer system expands folder icon 92k and displays an expanded version 92k′ of folder icon 92k. In some embodiments, the folder corresponding to folder icon 92k includes application icons 94a, 94b, 94c, 94d, 94e, 94f, 94g, 94h, 94i, 94j, 94k, and 941 representing respective “compatible” applications (also collectively referred to as application icons 94a-941). Application icons 94a-941 representing “compatible” applications have a different shape from application icons representing “native” applications (e.g., application icons 92c-92j in applications view 9100b of home user interface 8100, application icons 9202-9212 in folder represented by folder icon 92a, and application icons 9214-9218 in folder represented by folder icon 92b, represent “native” applications), in accordance with some embodiments. In some embodiments, the layout of application icons 94a-941 in folder icon 92k (e.g., scaled down or miniature versions of application icons 94a-941 in folder icon 92k) is optionally the same as layout of application icons 94a-941 in the expanded version 92k′ of folder icon 92k, in accordance with some embodiments. In some embodiments, the layout of application icons in folder icon 92k for “compatible” applications is different from the layouts used in folder icons of user-generated or user-configured folders for “native” applications. In some embodiments, application icons 94a-941 in the expanded version 92k′ of folder icon 92k are displayed at larger scale relative to the scale of application icons 94a-941 displayed in folder icon 92k. In some embodiments, in conjunction with expanding folder icon 92k, the computer system 101 visually deemphasizes other portions of the three-dimensional environment that are visible via HMD 7100a and that are outside of the expanded version 92k′ of folder icon 92k (e.g., similar to when folder icon 92a for “native” applications is expanded in FIGS. 9R-9S). In some embodiments, in conjunction with expanding folder icon 92k, the computer system 101 moves the expanded version 92k′ of folder icon 92k towards the viewpoint of the user 7002 and/or away from plane 287 (e.g., similar to when folder icon 92a for “native” applications is expanded). In some embodiments, in conjunction with expanding folder icon 92k, the computer system 101 maintains the expanded version 92k′ of folder icon 92k in the same plane, but pushes other icons in applications view 9100b away from the viewpoint of the user 7002 (e.g., similar to when folder icon 92a for “native” applications is expanded, or alternatively, in contrast to when folder icon 92a for “native” application is expanded). In some embodiments, folder icon 92k can similarly be expanded when applications view 9100b is in the normal mode (e.g., in addition to when applications view 9100b is in the reconfiguration mode). In some embodiments, deletion affordances are displayed in association with application icons 94a-941 in the expanded version 92k′ of folder icon 92k while applications view 9100b is in the reconfiguration mode. For example, respective deletion affordances are displayed at the top left corner of associated application icons 94a-941, such as deletion affordance 94k′ is displayed at the top left corner of associated application icon 94k, in accordance with some embodiments.

Further, in FIG. 9AB, the computer system 101 detects one or more inputs selecting deletion affordance 94k′ associated with application icon 94k. For example, the computer system 101 detects user's attention (e.g., based on gaze input 982ab) directed to deletion affordance 94k′. Optionally, in response to the detection of user's attention (e.g., based on gaze input 982ab) directed to deletion affordance 94k′, the deletion affordance 94k′ lifts away from application icon 94k (and/or away from a respective plane on which the expanded version 92k′ of folder icon 92k is displayed in the three-dimensional environment) toward a viewpoint of user 7002. Further, while deletion affordance 94k′ has input focus (e.g., as a result of gaze input 982ab directed to deletion affordance 94k′), the computer system 101 detects a selection input. For example, the computer system 101 detects an air pinch gesture 980ab that is released within a threshold amount of time and while hand 7022 as a whole remains substantially stationary (e.g., moves less than a threshold amount in a unit of time).

FIG. 9AC is a transition from FIG. 9AB in response to the selection of deletion affordance 94k′. In some embodiments, instead of directly deleting application icon 94k from expanded version 92k′ of folder icon 92k in response to the selection of deletion affordance 94k′, the computer system 101 displays a contextual menu 950, in association with application icon 94k, with different reconfiguration options. For example, the contextual menu 950 includes a selectable option 950a for deleting the application icon 94k; a selectable option 950b for removing application icon 94k from the applications view 9100b of the home user interface (and optionally store it in another location, such as an application library user interface, and/or a folder for deleted applications that is not part of the applications view 9100b but accessible in another user interface); a selectable option 950c for removing application icon 94k from the folder 92k for “compatible” applications; and a selectable option 950d for dismissing the contextual menu 950 and canceling the reconfiguration operation with respect to application icon 94k. In some embodiments, the selectable option 950a, when selected (e.g., by an air pinch gesture that is released within less than a threshold amount of time with less than a threshold amount of movement, detected in conjunction with a gaze input directed to the selectable option 950a; or another type of selection input directed to the selectable option 950a), causes the computer system 101 to delete application icon 94k from the folder for the “compatible” applications, and, optionally, uninstall the corresponding application from the computer system 101. In some embodiments, the selectable option 950b, when selected (e.g., by an air pinch gesture that is released within less than a threshold amount of time with less than a threshold amount of movement, detected in conjunction with a gaze input directed to the selectable option 950b; or another type of selection input directed to the selectable option 950b), causes the computer system 101 to remove application icon 94k from the home user interface 8100, e.g., from the folder for “compatible” applications, from the application views 9100b, and from other places in the home user interface 8100 (e.g., optionally, including from an application library user interface that includes groups of applications according to different categories, if the application library user interface is part of the views or the applications view 9100b of the home menu user interface). In some embodiments, the selectable option 950c, when selected (e.g., by an air pinch gesture that is released within less than a threshold amount of time with less than a threshold amount of movement, detected in conjunction with a gaze input directed to the selectable option 950c; or another type of selection input directed to the selectable option 950c), causes the computer system 101 to move application icon 94k out of the expanded version 92k′ of folder icon 92k for the folder containing “compatible” applications, and add application icon 94k to the applications view 9100b of the home user interface 8100, as illustrated in FIG. 9AD. In some embodiments, the selectable option 950d, when selected (e.g., by an air pinch gesture that is released within less than a threshold amount of time with less than a threshold amount of movement, detected in conjunction with a gaze input directed to the selectable option 950d; or another type of selection input directed to the selectable option 950d), causes the computer system 101 to cancel the reconfiguration process for icon 94k and cease to display contextual menu 950.

Further, in FIG. 9AC, the computer system 101 detects one or more selection inputs selecting the selectable option 950c for moving application icon 94k out of the folder corresponding to folder icon 92k for “compatible” applications. For example, the computer system 101 detects user's attention (e.g., based on gaze input 982ac) directed to selectable option 950c that puts selectable option 950c in focus. Further, while the selectable option 950c has input focus (e.g., as a result of gaze input 982ac directed to selectable option 950c), the computer system 101 detects a selection input. For example, while selectable option 950c has input focus, the computer system 101 detects an air pinch gesture 980ac that is released within a threshold amount of time and while hand 7022 as a whole remains substantially stationary (e.g., moves less than a threshold amount within a unit of time).

FIG. 9AD is a transition from FIG. 9AC in response to the selection of selectable option 950c. In response to the selection of selectable option 950c, the computer system 101 moves application icon 94k out of expanded version 92k′ of folder icon 92k for the folder containing “compatible” applications, and places application icon 94k in an available placement location in applications view 9100b of the home user interface 8100. In some embodiments, the computer system 101 places application icon 94k into the section of applications view 9100b that is currently in focus, as illustrated in FIG. 9AD. In some embodiments, if there is no vacant placement location in the currently displayed section of application view 9100b, the computer system 101 optionally places the application icon 94k at the last placement location in the currently displayed section and creates a new section after the currently displayed section to accommodate the application icon previously occupying the last placement location in the currently displayed section; or alternatively, leaves the currently displayed section unchanged, and creates a new section (e.g., after the last existing section, or right after the currently displayed section) to accommodate the application icon 94k. In some embodiments, the application icons of “compatible” applications are inserted into the same section of applications view 9100 (e.g., a dedicated section for “compatible” applications) once they are moved out of the system-generated folder for “compatible” applications.

FIG. 9AE illustrates application view 9100b after application icon 94k is removed from the folder corresponding to folder icon 92k for “compatible” applications and added to applications view 9100b of home user interface 8100, in accordance with some embodiments. For example, applications view 9100b is in the same state as shown in FIG. 9AD. Further, in FIG. 9AE, the computer system 101 detects one or more inputs selecting deletion affordance 94k′ of application icon 94k. For example, the computer system 101 detects user's attention (e.g., based on gaze input 982ae) directed to deletion affordance 94k′. Optionally, in response to the detection of the user's attention (e.g., based on gaze input 982ae) directed to deletion affordance 94k′, the deletion affordance 94k′ lifts away from application icon 94k (and/or away from a respective plane on which the application icon 94k is displayed in the three-dimensional environment) toward a viewpoint of user 7002. Further, while deletion affordance 94k′ has input focus (e.g., as a result of gaze input 982ae directed to deletion affordance 94k′), the computer system 101 detects a selection input. For example, the computer system 101 detects an air pinch gesture 980ae that is released within a threshold amount of time and while hand 7022 as a whole remains substantially stationary (e.g., moves less than a threshold amount in a unit of time).

FIG. 9AF is a transition from FIG. 9AE in response to the selection of deletion affordance 94k′ while application icon 94k is displayed in applications view 9100b of home user interface 8100. In response to the selection of deletion affordance 94k′, the computer system 101 displays a contextual menu 960, in association with application icon 94k, with various reconfiguration options. In some embodiments, selection options 960a, 960b, and 960d in contextual menu 960 are the same as selectable options 950a, 950b, and 950d in contextual menu 950 while selectable option 960c is different from selectable option 950c. For example, the contextual menu 960 includes selectable option 960a for deleting the application icon 94k (e.g., from the application view 9100b and optionally uninstalls the application corresponding to application icon 94k); selectable option 960b for removing application icon 94k from the home user interface (e.g., from application view 9100b and other portions of the home user interface that may store deleted application icons and “compatible” applications); selectable option 960c for moving application icon 94k back to folder corresponding to folder icon 92k for “compatible” applications; and selectable option 960d for canceling the reconfiguration operation with respect to application icon 94k and dismissing the contextual menu 960. In some embodiments, selectable option 960c, when selected (e.g., by an air pinch gesture that is released within less than a threshold amount of time with less than a threshold amount of movement, detected in conjunction with a gaze input directed to the selectable option 960c; or another type of selection input directed to the selectable option 960c), causes the computer system 101 to remove application icon 94k from applications view 9100b and move application icon 94k back to folder corresponding to folder icon 92k for “compatible” applications.

In some embodiments, in conjunction with deleting or removing a user interface object from the home user interface 8100, the computer system 101 generates a sound indicative of the successful removal of the user interface object, as described below with reference to FIGS. 9AG-9AH. Applications view 9100b of home user interface 8100 in FIG. 9AG is analogous to applications view 9100b of home user interface 8100 in FIG. 9AE (e.g., except that in FIG. 9AE, the user's attention is directed toward a different application icon). In FIG. 9AG, the computer system 101 detects a gaze input 9910a directed towards deletion affordance 97a of application icon 9212. In response to the gaze input 9910a, the computer system 101 puts deletion affordance 97a in focus. While deletion affordance 97a has input focus, the computer system 101 detects a pinch gesture 9910b. In response to selecting deletion affordance 97a (as a result of the pinch gesture 9910b while deletion affordance 99a has input focus), the computer system 101 deletes or removes application icon 9212 from applications view 9100b of home user interface 8100. In some embodiments, in conjunction with removing application icon 9212 from the applications view 9100b, the computer system 101 generates a sound 9908, shown in FIG. 9AH, indicative of the successful removal of a user interface object from a home screen user interface, in this example the successful removal of application icon 9212 from applications view 9100b. As illustrated in FIG. 9AH, the computer system 100 shifts application icon 94k to a position that was previously occupied by application icon 9212 (now removed).

In some embodiments, in response to detecting a user input maintaining a selection (e.g., for more than a threshold amount of time) of a user interface object at a location of the home user interface that corresponds to a folder (e.g., holding a user interface object over a folder), the computer system 101 opens the folder and, optionally, generates a sound indicative of folder opening, as described with reference to FIGS. 9AI-9AJ. In FIG. 9AI, the computer system 101 detects an input selecting application icon 92j. In this example, the input selecting application icon 92j includes a gaze input 9912a that puts application icon 92j in focus and an air pinch gesture 9912b that is detected while application icon 92j has input focus. The dashed arrow leading from user 7002's hand 7022 indicates that user 7002's hand 7022 is about to move application icon 92j, in this example, toward folder 92b.

FIG. 9AJ is a transition from FIG. 9AI in response to detecting movement input 9912c moving application icon 92j to a location in applications view 9100b that corresponds to folder 92b. In this example, while selection of application icon 92j is maintained (e.g., in response to maintaining the air pinch gesture 9912b), the computer system 101 detects movement input 9912c. In response to detecting the movement input 9912c, the computer system 101 moves application icon 92j to the location in applications view 9100b that corresponds to folder 92b.

FIG. 9AK shows a transition from FIG. 9AJ. In some embodiments, in accordance with a determination that application icon 92j is maintained (e.g., for more than a threshold amount of time) at the location in applications view 9100b that corresponds to folder 92b, the computer system 100 opens folder 92b and, optionally, generates a sound 9911 indicative of folder opening. In FIG. 9AK, the user 7002 continues to hold application icon 92j (e.g., by maintaining the air pinch gesture 9912b) at a location corresponding to folder 92b (now in an expanded state). In this example, the home user interface 8100 is in the reconfiguration mode at a time when folder 92b is opened. In some embodiments, the same sound 9911 indicative of opening a folder is generated if the home user interface 8100 is in the normal mode at a time a folder is opened (e.g., in response to selection of the folder by a user input such a pinch gesture or other selection input in the normal mode, rather than in response to dragging an application icon to the folder in the reconfiguration mode).

FIG. 9AL shows a transition from FIG. 9AK. In response to detecting a release of the air pinch gesture 9912b, the computer system 101 drops application icon 92j into folder 92b. In some embodiments, in conjunction with dropping application icon 92j into folder 92b, the computer system 101 generates a sound 9913 indicative of dropping an application icon into a folder. In some embodiments, the sound 9913 indicative of dropping an application icon into a folder is the same sound as the sound 9902 indicative of dropping an application icon into a folder preview icon (e.g., thereby confirming and creating a folder). In some embodiments, the sound 9913 indicative of dropping an application icon into a folder is different from the sound 9906 (e.g., in FIG. 9Z) indicative of dropping an application icon outside a folder and/or outside a folder preview icon. In this example, application icon 92j is dropped into folder 92b that is expanded. In some embodiments, the sound generated for dropping an application icon into a folder, in this example sound 9913, is the same irrespective of whether the application icon is dropped into a folder that is expanded or into a folder that is not expanded.

FIG. 9AM illustrates a transition from FIG. 9H. The user 7002 continues to move application icon 90c in rightward direction toward the right viewport boundary (e.g., instead of holding application icon 90c over application icon 90b for more than a threshold amount of time, as described with reference to FIG. 9I that illustrates an alternate transition from FIG. 9H). FIG. 9AN shows an example transition from FIG. 9AM in response to detecting movement input 9914a by hand 7022 while the air pinch gesture 980f that holds application icon 90c is maintained. Section indicators 9001a and 9100b indicate that there are two sections in applications view 9100a and that the second section (e.g., last section) is the one that is currently visible via the display generation component 7100a in FIG. 9AN.

In some embodiments, in response to the movement input 9914a, the computer system 101 generates a new section of applications view 9100a with available space to place application icon 90c, as illustrated in FIG. 9AO, which illustrates a transition from FIG. 9AN. In some embodiments, the computer system 101 generates a new section of applications view 9100a in accordance with a determination that the movement input 9914a meets criteria for navigating to an adjacent page and in accordance with a determination that the currently displayed section is the last section of applications view 9100a.

Accordingly, in FIG. 9AO, in response to detecting the movement input 9914a, the computer system 101 navigates from the currently displayed section of FIG. 9AN, which includes a group of application icons 90a-90k, to a new section of applications view 9100a, which is created in response to the movement input 9914a. In some embodiments, in conjunction with adding the new section, the computer system 101 adds a new section indicator, in this example a third section indicator 9001c as shown in FIG. 9AO. The third section indicator 9001c is visually emphasized relative to section indicators 9001a and 9001b to indicate that the new section (e.g., the third section) is currently visible in the viewport in FIG. 9AO. In some embodiments, in conjunction with navigating to the new section of applications view 9100a, the computer system 101 generates a sound 9915 indicative of navigation between different sections, in this example, between sections of applications view 9100a. In some embodiments, dimmed application icons 90p, 90q, and 90r correspond to application icons in the previous section of applications view 9100a, thereby providing visual feedback of the existence of a previous section.

In some embodiments, when navigating between sections of application view 9100a, the computer system 101 forgoes generating (e.g., and/or suppresses) sounds indicative of moving application icons in applications view 9100a (e.g., where the movement of application icons is a result of the application icons being pushed by the application icon that is being dragged). For example, in accordance with a determination that the magnitude of the input (e.g., input 9914a of FIG. 9AM) meets section-navigation criteria, the computer system 101 forgoes generating sounds indicative of moving application icons. In the example of FIG. 9AN, the computer system 101 forgoes generating a sound when application icon 90d is pushed by and moved under application icon 90c.

In some embodiments, a sound indicative of creating a new section (e.g., by requesting to navigate beyond a last section of applications view 9100a) is different from the sound indicative of navigating between existing sections of applications view 9100a (e.g., navigating between sections without creating a new section), as described in further detail with reference to FIGS. 9AP-9AQ.

FIG. 9AP shows a transition from FIG. 9B. While the user 7002 continues to hold application icon 90c (e.g., via the air pinch gesture 980b), the computer system 100 detects a movement input 990c requesting to navigate to a previous section of applications view 9100a. In this example, the computer system 101 detects a request to navigate from the currently displayed section in FIG. 9AP, indicated by section indicator 9001b, to the previous section, indicated by section indicator 9001a. FIGS. 9AQ and 9AR show moving application icon 90c towards the left viewport boundary in response to the movement input 990c. Moving application icon 90c first causes displacement of application icon 90b, as illustrated in FIG. 9AQ, and then causes displacement of application icon 90a, as illustrated in FIG. 9AR. In some embodiments, in accordance with a determination that the magnitude of the movement input 990c meets section-navigation criteria, the computer system 101 forgoes generating sounds indicative of moving (e.g., displacing and/or pushing) application icons 90b and 90a. In this example, the computer system 101 forgoes generating a sound when application icon 90b is pushed by application icon 90c and when application icon 90a is pushed by application icon 90c.

FIG. 9AS shows a transition from FIG. 9AR in response to detecting that movement input 990c met section-navigation criteria. In response to detecting that movement input 990c met section-navigation criteria, the computer system 101 navigates from the currently displayed section in FIG. 9AR to a previous section (e.g., the preceding section, here the first section). The navigation is illustrated by visually emphasizing section indicator 9001a relative to section indicator 9001b, whereas before the navigation to the first section, while the second section is displayed as shown in FIG. 9AR, section indicator 9001b is visually emphasized relative to section indicator 9001a. In this example, the first section includes a group of application icons 99a, 99b, 99c, 99d, 99e, 99f, 99g, 99h, 99i, 99j, 99k, 99l. and 99m (e.g., also referred to as a group of application icons 99a-99m). The first section also includes dimmed icons 99n, 990, and 99p that correspond to application icons in the group of application icons in the second section, and provide visual feedback of the existence of the second section.

In some embodiments, the section navigation-criteria includes a requirement that the dragged application icon, in this example application icon 90c, is held near (e.g., within a threshold distance of) a left or right viewport boundary for more than a threshold time. In response to navigating between the currently displayed section, which includes a group of application icons 90a-90k, to the previous section, which includes a group of application icons 99a-99m, the computer system 101 generates a sound 9916 indicative of navigation between sections. In some embodiments, the sound 9916 indicative of navigation between existing sections is different from the sound 9915 indicative of navigation between an existing section and a newly created section.

In some embodiments, section navigation described with reference to FIGS. 9AM-9AO and FIGS. 9AP-9AS is performed in response to movement inputs that drag an application icon toward a left or right viewport boundary. In other examples, section navigation is performed in response to movement inputs that scroll the home user interface 8100 without dragging an application icon. The sounds generated when navigating between sections in response to a request to move an application icon, in this example the sounds 9916 and 9915 that are generated in response to inputs moving application icon 90c, are not generated when navigating between sections in response to scroll inputs or other navigation inputs that do not include a request to move a user interface object. In some embodiments, a sound indicative of navigating between sections in response to movement inputs in a direction toward the right viewport boundary, in this example sound 9915, is different from a sound indicative of navigating between sections in response to movement inputs in a direction toward the left viewport boundary, in this example sound 9916.

In some embodiments, the computer system 101 generates various sounds when performing operations with respect to user interface objects in home user interface 8100. Examples of such sounds include, but are not limited to, sounds indicative of creating a folder, opening a folder, initiating a folder creation process, moving, selecting, and/or dropping user interface objects into a folder or outside a folder, or into a folder preview icon or outside a folder preview icon, and/or other sounds. In some embodiments, such sounds have spatial audio output characteristics that create a perception or sensation that a sound is coming from a respective location in the three-dimensional environment corresponding to a location of a user interface object with respect to which the user input is performed.

Although the examples in FIGS. 9A-9AS are provided with respect to application icons and an applications view, some or all of the features and interactions described with respect to application icons, folder icons, and application views are similarly applicable to other types of icons, folder icons for folders containing other types of icons, and other types of views of the home user interface (e.g., contacts view, environments view, control view, and other types of views corresponding to other object types), in accordance with various embodiments, and analogous descriptions are not repeated herein in the interest of brevity.

FIGS. 10A-10M is a flow diagram of a method 10000 of reconfiguring a home user interface with multiple collections of user interface objects in a three-dimensional environment, in accordance with various embodiments. In some embodiments, method 10000 is performed (10002) at a computer system (e.g., computer system 101 in FIG. 1) that is in communication with one or more display generation components (e.g., touch-screen displays, head-mounted displays, projectors, and/or other types of displays) (e.g., display generation component 120 in FIGS. 1A, 3A, and 4) (e.g., a heads-up display, a display, a touchscreen, a projector, etc.) and one or more input devices (e.g., including one or more sensors and devices for detecting user inputs) (e.g., a camera (e.g., color sensors, infrared sensors, and other depth-sensing cameras) that points downward at a user's hand or a camera that points forward from the user's head). In some embodiments, the computer system is further in communication with one or more output devices other than the one or more display generation component, such as one or more output devices that provide non-visual outputs. In some embodiments, the one or more output devices that provide non-visual outputs include one or more audio output devices, such as one or more speakers, one or more headphones, and/or one or more earbuds. In some embodiments, the one or more output devices that provide non-visual output devices include one or more tactile output generators, such as one or more localized tactile output generators that provide localized tactile outputs at selected locations, and one or more generalized or non-localized tactile outputs throughout multiple components and/or portions of the computer system. In some embodiments, the computer system operates the display generation component, the audio output devices, and the tactile output generators independently of one another when generating outputs; and sometimes, the computer system coordinate the visual outputs, audio outputs and/or tactile outputs to provide feedback to the user regarding the response to the user inputs and/or the state(s) of the computer system. For example, the timing, duration, magnitude, phase, pattern, and/or other characteristics of the outputs are correlated based on the timing, duration, magnitude, phase, pattern, and/or other characteristics of the inputs, the response, and/or the feedback types. In some embodiments, the method 10000 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 800 are, optionally, combined and/or the order of some operations is, optionally, changed.

As described herein, method 10000 provides an improved mechanism for reconfiguring an improved home user interface in a mixed-reality three-dimensional environment. Instead of navigating through various user interfaces and/or menu options, the home user interface includes different collections of user interface objects (optionally, displayed in respective views of the home user interface), where the user interface objects are arranged into the different collections by object type. While a respective collection is visible (optionally, in a reconfiguration mode) in the mixed-reality three-dimensional environment, the computer system detects an input that is directed to a user interface object in the respective collection and corresponds to a request to edit the respective collection of the home user interface (e.g., meets an editing criteria). In response to the same type of user input, the computer system performs different reconfiguration operations depending on a respective object type of the user interface object and/or, in some instances, the same reconfiguration operation irrespective of the object type. Displaying and arranging user interface objects into different collections by object type and using the same type of input to perform different reconfiguration operations depending on the object type, reduces the number of inputs and/or the amount of time needed to reconfigure the home user interface (e.g., the user can use the same type of input to perform reconfiguration operations of the home screen user even when collections of different types of user interface objects are visible) and/or to find a target functionally (e.g., the user does not have to navigate through various menus and/or controls to locate a target functionally).

The computer system displays (10004), via the one or more display generation components, at least a portion of a home menu user interface, in a first view of an environment. For example, the computer system displays applications view 8100a (e.g., in FIG. 8A), environments view 8100b (e.g., in FIG. 8B), and/or contacts view 8100c (e.g., in FIG. 8C). In some embodiments, a home menu user interface includes a home screen user interface, and/or a menu of one or more collections of selectable icons for displaying and/or starting one or more applications, three-dimensional extended reality experiences, and/or communications, optionally in a reconfiguration mode (e.g., an icon reconfiguration mode and/or another mode in which icons in the home menu user interface can be added, deleted, and/or repositioned based on user inputs), and/or in a normal mode (e.g., a mode in which selection of an icon causes the computer system to display a user interface of a corresponding application, start or resume a corresponding three-dimensional extended reality experience, activate a control function or control user interface of a corresponding control; and/or initiate a communication session with a corresponding contact, of the selected icon). In some embodiments, the environment includes a two-dimensional user interface such as a desktop environment with windows, a split-screen display environment, or a full-screen display environment, a two-dimensional user interface and/or a two-dimensional window that is capable of displaying indications of differences in depths (e.g., via simulated shadows, virtual parallax effects, visual obscuring, and/or other visual effects), and/or a three-dimensional environment such as a three-dimensional virtual reality environment, a three-dimensional augmented reality environment, and/or a three-dimensional extended reality environment. In some embodiments, the home menu user interface includes a first plurality of user interface objects of a first object type (e.g., a collection of application icons corresponding to different applications, or an collection of another plurality of objects of a first object type) and a second plurality of user interface objects of a second object type that is different from the first object type (e.g., a collection of representations of users and/or contacts, or a collection of another plurality of objects of a second object type). For example, home user interface 8100 includes applications view 8100a (e.g., in FIG. 8A), environments view 8100b (e.g., in FIG. 8B), and/or contacts view 8100c (e.g., in FIG. 8C). In some embodiments, the home menu user interface optionally includes a third collection of a third plurality of user interface objects (e.g., a collection of icons for launching different experiences, or a collection of another plurality of objects of a third object type), and/or a fourth collection of a fourth plurality of user interface objects (e.g., a collection of controls corresponding to different control functions of the computer system, or other objects of a fourth object type)). In some embodiments, the different experiences that can be launched using the collection of the third plurality of user interface objects include three-dimensional virtual and/or augmented reality environments (e.g., virtual scenery, virtual meeting room, virtual sky, and/or other virtual spatial content that is optionally static or dynamically changing over time) that can be used to replace at least a portion of a view of a physical environment (e.g., used to replace an optical or virtual passthrough or other representations of the physical environment). In some embodiments, the experiences that are started can be provided in conjunction with other applications and/or functions of the computer system, such as providing a background environment for the other applications and functions (e.g., the applications and functions are displayed as objects, user interfaces, and/or windows in the three-dimensional environment of the active experience). Displaying the home menu user interface includes displaying a first portion of a respective plurality of user interface objects. For example, second section of view 8100d of home user interface 100 is displayed in the reconfiguration mode in FIG. 8F or in the normal mode in FIG. 8F. In another example, second section of environments view 8100b of home user interface 100 is displayed in the reconfiguration mode in FIG. 8N or in the normal mode in FIG. 8B. In another example, second section of applications view 8100e of home user interface 100 is displayed in the reconfiguration mode in FIG. 8S or section of applications view 8100a of home user interface 100 in the normal mode in FIG. 8A. In another example, second section of contacts view 8100c of home user interface 100 is displayed in the reconfiguration mode in FIG. 8Y or in the normal mode in FIG. 8C. In some embodiments, the home menu user interface is a multi-arrangement home menu user interface, where a respective arrangement of the home menu user interface includes a corresponding collection of user interface objects of a respective object type (e.g., application icons, contact icons, environment icons, control icons, or icons for another function or purpose). In some embodiments, one respective arrangement of objects from the multi-arrangement home menu user interface is displayed at a time (e.g., by selecting a navigation control for the icon type of the respective arrangement in a navigation menu of the home menu user interface). In some embodiments, the collection of user interface objects in the currently displayed arrangement of objects are arranged into one or more sections (e.g., in a multi-section home menu user interface), with one section having input focus at a given time (e.g., by navigating to the section using navigation gestures and/or page indicators of the currently displayed arrangement of objects).

While displaying the home menu user interface, including displaying the first portion of the respective plurality of user interface objects (e.g., displaying a respective section of a multi-section arrangement of a respective collection of user interface objects for a respective arrangement of a multi-arrangement home menu user interface), the computer system detects (10006) a first user input directed to a first user interface object included in the first portion of the respective plurality of user interface objects, wherein the first user input meets editing criteria (e.g., the first user input causes the reconfiguration mode of the home menu user interface to be activated, and/or at least a portion of the first user input is detected while the home menu user interface is displayed in the reconfiguration mode). In some embodiments, an input that meets the editing criteria includes an input that causes the home menu user interface to enter a reconfiguration mode followed by another input that causes the computer system to perform an editing operation with respect to an object in the reconfiguration mode. In some embodiments, a pinch and hold air gesture that is detected while an attention of a user (e.g., based on a gaze of the user) is directed to a portion of the home menu user interface, such as an unoccupied portion of the home menu user interface (e.g., a gap between adjacent icons in the home menu user interface), or an object in the home menu user interface (e.g., a user interface object of the first object type, the second object type or another object type (e.g., an icon corresponding to an application, an experience, a user identity or contact, or a control)). In some embodiments, when the pinch and hold gesture meets a first time threshold with less than a threshold amount of movement, the computer system displays a selectable option for entering the reconfiguration mode of the home menu user interface, and an input selecting the selectable option causes the computer system to enter the reconfiguration mode. In some embodiments, while the home menu user interface is in the reconfiguration mode, another user input, such as a pinch and drag air gesture, an air pinch gesture, an air tap gesture, or another type of input that is directed to an object or an object control affordance associated with the object, can cause an editing operation to be performed with respect to the object. In some embodiments, an input that meets the editing criteria includes an input that causes the computer system to enter the reconfiguration mode and perform an editing operation with respect to an object in the reconfiguration mode at the same time. In some embodiments, when the pinch and hold gesture meets a second time threshold (e.g., longer than the first time threshold) with less than a threshold amount of movement, the computer system enters the reconfiguration mode (e.g., first ceasing to display the selectable option for entering the reconfiguration mode of the home menu user interface, without requiring an input selecting the selectable option), and, optionally, causes movement of the object in the home menu user interface. In some embodiments, an air gesture can be replaced with another type of gesture in a different operating environment for a corresponding operation that the air gesture triggers in a three-dimensional environment. For example, an air pinch gesture can be replaced with a touch gesture made with a contact on a touch-screen display, where the target location of the touch gesture is determined based on the location of the contact, and the touch gesture can be evaluated against an input threshold such as a duration threshold (e.g., the first time threshold, or the second time threshold) or an intensity threshold (e.g., a light press intensity threshold, or a deep press intensity threshold) based on the duration that the contact is kept with less than a threshold amount of movement, or based on a characteristic intensity (e.g., an average intensity, or a maximum intensity) of the contact. In another example, an air pinch gesture can be replaced with click input made with a mouse or another pointing device, where the target location of the click input is determined based on the location of the cursor or focus selector, and the click can be evaluated against an input threshold such as a duration threshold (e.g., the first time threshold, or the second time threshold) or an intensity threshold (e.g., a light press intensity threshold, or a deep press intensity threshold) based on the duration that the click button is held down. In another example, an air pinch gesture can be replaced with an activation of a hardware affordance (e.g., a digital crown, a dial, a button), where the target location of the activation input is determined based on the object that has input focus, and the activation input can be evaluated against an input threshold such as a duration threshold (e.g., the first time threshold, or the second time threshold) or an intensity threshold (e.g., a light press intensity threshold, or a deep press intensity threshold) based on the amount that the hardware affordance is held down. A movement input can be performed by an air pinch gesture that includes movement of the hand while the hand maintains a pinched posture. In some embodiments, the movement input of the air pinch gesture can be replaced with a movement of a pointer finger. In some embodiments, the movement input of the air pinch gesture can be replaced with a movement of a contact across the touch-screen display or another touch-sensitive surface. In some embodiments, the movement input of the air pinch gesture can be replaced with a movement of a pointing device (optionally, with the click button held down, or released). In some embodiments, the movement input of the air pinch gesture can be replaced with a movement of the hardware affordance, such as rotation of the digital crown by a respective amount.

In response to detecting the first user input that is directed to the first user interface object and that meets the editing criteria (10008): in accordance with a determination that the first user interface object corresponds to a first object type, the computer system performs a first operation of a first operation type (e.g., reconfigures a first state or property of the first user interface object) with respect to the first user interface object (e.g., without performing a second operation of a second operation type with respect to the first user interface object); and in accordance with a determination that the first user interface object corresponds to a second object type different from the first object type, the computer system performs a second operation of a second operation type (e.g., reconfigures a second state or property of the second user interface object), different from the first operation type, with respect to the first user interface object (e.g., without performing the first operation of the first operation type with respect to the first user interface object). For example, in FIG. 8T, a selection input directed to deletion affordance 36g′ (e.g., an air pinch gesture 280t while deletion affordance 36g′ has input focus) causes the computer system 101 to delete application icon 36g representing an application; a selection input directed to offload affordance 30h′ (e.g., an air pinch gesture 2800 while offload affordance 30h′ has input focus) causes the computer system 101 to offloads a virtual or extended-reality environment “Alps” corresponding to the environment icon 30h (e.g., in FIGS. 8O-8P); a selection input directed to control 32a′ for marking contact as “not favorite” (e.g., an air pinch gesture 280y while control 32a′ has input focus) causes the computer system 101 to mark a contact “C1” as “not favorite” and, optionally, to rearrange contacts view 8100c (e.g., in FIGS. 8Y-8Z); and a selection input directed to control 32l′ for marking contact as “favorite” (e.g., an air pinch gesture 280aa while control 32l′ has input focus) causes the computer system 101 to mark a contact “C12” as “favorite” and, optionally, to rearrange contacts view 8100c (e.g., in FIGS. 8AA-8AB).

In some embodiments, the home menu user interface includes (10010) a plurality of different collections of user interface objects (e.g., different collections of user interface objects corresponding to different object types (e.g., application icons, experience icons, widget icons, contact icons, controls, and/or other types of objects) and occupying different spatial portions (e.g., sections, pages, or other types of divisions) of the home menu user interface), including a first collection of user interface objects and a second collection of user interface objects (and, optionally, the third collection of user interface objects, and the fourth collection of user interface objects), wherein the first collection of user interface objects corresponds to the first object type and includes the first plurality of user interface objects of the first object type, and the second collection of user interface objects corresponds to the second object type and includes the second plurality of user interface objects of the second object type. In some embodiments, displaying the respective plurality of user interface objects includes displaying a respective collection of user interface objects (e.g., as the subjects of subsequent reconfiguration operations) from the plurality of different collections of user interface objects (e.g., displaying the collection of application icons, displaying the collection of experience and/or environment icons, displaying the collection of contacts, displaying the collection of controls, or displaying the collection of user interface objects of another object type, optionally, in exclusion of displaying user interface objects of other object type(s) at the same time). For example, collection of application icons 28a-28l in applications view 8100a (e.g., in FIG. 8A); collection of environments icons 30a-30m in environments view 8100b (e.g., in FIG. 8B); and collection of contact icons 32a-32l in contacts view 8100c (e.g., in FIG. 8C). In some embodiments, a respective collection of a multi-collection home menu user interface includes a respective type of objects and cannot be reconfigured or edited to include other types of objects from other collections of the multi-collection home menu user interface. In some embodiments, while one collection of the multi-collection home menu user interfaced is displayed, other collections of the multi-collection home menu user interface are not displayed, or only a hint of the other collection(s) are visible but not editable. For example, one collection of user interface objects is displayed at a time, and another collection can be displayed in response to additional user input, such as selecting a control for displaying a respective collection of the multi-collection home menu user interface or navigate to the adjacent collection of objects in the multi-collection home menu user interface. In some embodiments, performing the first operation of the first operation type with respect to the first user interface object includes performing the first operation in accordance with a determination that the respective collection of user interface object displayed in the home menu user interface is the first collection of user interface objects; and performing the second operation of the first operation type with respect to the first user interface object includes performing the second operation in accordance with a determination that the respective collection of user interface object displayed in the home menu user interface is the second collection of user interface objects. For example, in FIGS. 8T-8U, a selection input directed to deletion affordance 36g′ in applications view 8100e causes the computer system 101 to delete application icon 36g. A selection input directed to offload affordance 30h′ in environments view 8100b causes the computer system 101 to offloads a virtual or extended-reality environment “Alps” (e.g., in FIGS. 8O-8P). A selection input directed to control 32a′ for marking contact as “not favorite” in contacts view 8100c causes the computer system 101 to mark a contact “C1” as “not favorite” and, optionally, to rearrange contacts view 8100c (e.g., in FIGS. 8Y-8Z). A selection input directed to control 32l′ for marking contact as “favorite” in contacts view 8100c causes the computer system 101 to mark a contact “C12” as “favorite” and, optionally, to rearrange contacts view 8100c (e.g., in FIGS. 8AA-8AB).

In some embodiments, the computer system requires that at least a portion of the first user input is detected while the computer system is displaying the home menu user interface in the reconfiguration mode, wherein placement of the first plurality of user interface objects within the first collection (e.g., but not across different collection of user interface objects), and placement of the second plurality of user interface objects within the second collection (e.g., but not across different collection of user interface objects), are configurable by a user (e.g., by dragging the user interface objects within the same second or different sections of the same collection) while the home menu user interface is displayed in the reconfiguration mode. In some embodiments, the computer system displays the home menu user interface in the reconfiguration mode in response to detecting a first portion of the first user input, and performs an operation with respect to the first user interface object in response to a subsequent portion of the first user input. In some embodiments, the computer system already displays the home menu user interface in the reconfiguration mode when the first user input is detected. Arranging or segmenting a home user interface according to object type in views of different types of objects and, in response to the same type of user input directed toward a respective object, performing different reconfiguration operations depending on a respective object type of the respective object, reduces the number of inputs and/or the amount of time needed to reconfigure the home user interface (e.g., the user can use the same type of input to perform reconfiguration operations of the home screen user even when collections of different types of user interface objects are visible).

In some embodiments, performing the first operation with respect to the first user interface object includes (10012), in accordance with a determination that the first user input meets move criteria, wherein the move criteria require that the first user input includes a first movement input in order for the movement criteria to be met by the first user input, relocating the first user interface object (e.g., moving from one placement location to another placement location of the first object type) within the first collection of user interface objects (e.g., relocating the first user interface object without the ability to move the first user interface object into the second collection of user interface objects or other collections of user interface objects, and/or stopping movement of the first user interface object when the movement input attempts to drag the first user interface object toward the second collection of user interface objects); and performing the second operation with respect to the first user interface object includes, in accordance with a determination that the first user input meets the move criteria, relocating the first user interface object (e.g., moving from one placement location to another placement location of the second object type) within the second collection of user interface objects (e.g., relocating the first user interface object without the ability to move the first user interface object into the first collection of user interface objects or other collections of user interface objects, and/or stopping movement of the first user interface object when the movement input attempts to drag the first user interface object toward the first collection of user interface objects). For example, in FIGS. 8AC-8AE, movement input while holding contact icon 32d via pinch gesture 298ac causes the computer system 101 to reposition contact icon 32d in contacts view 8100c. In another example, in FIGS. 8G-8J, movement input 298ac while holding icon 34h via pinch gesture 298 causes the computer system 101 to reposition icon 34h in view 8100d. In some embodiments, the first user input that meets the move criteria includes an air pinch and drag gesture where the pinch gesture is initiated when attention of the user (e.g., based on a gaze of the user) is directed to the first user interface object followed by movement of the hand while maintaining the pinch gesture, or another drag input that is performed with other types of input modalities, such as a contact, an air gesture in location or with a gaze, a pointing device, or a hardware controller) that is directed to the first user interface object (e.g., with a targeting location corresponding to the location of the first user interface object). Repositioning different icons (e.g., contact icons, application icons, and/or environment icons) within respective views of a home user interface in response to the same type of input irrespective of what type of objects are included in a respective view that is in focus (e.g., contacts view, applications view, and/or environments view), reduces the number of inputs and/or the amount of time needed to reconfigure the home user interface (e.g., the user can use the same type of input to reposition user interface objects in a home user interface even when collections of different types of user interface objects are visible).

In some embodiments, the computer system displays (10014) a first control object corresponding to the first user interface object (and optionally, displaying respective instances of the first control object for user interface objects of the first object type) while (e.g., in accordance with a determination that) the first plurality of user interface objects are displayed in the home menu user interface (e.g., when the first collection of user interface objects are displayed, and the second collection of user interface objects are not displayed in the visible portion of the home menu user interface), wherein: performing the first operation with respect to the first user interface object includes, in accordance with a determination that the first user input meets selection criteria with respect to the first control object of the first user interface object, performing a first control function corresponding to the first control object of the first user interface object. For example in some embodiments, the first control object includes a “close” affordance, a “deletion” affordance, an “offload” control, or another type of control object that is activated by a selection input. In some embodiments, the first user input includes an air pinch gesture where the pinch gesture is detected when attention of a user (e.g., based on a gaze of the user) is directed to the first control object of the first user interface object, or another selection input that is performed with other types of input modalities, such as a contact, an air gesture in location or with a gaze, a pointing device, or a hardware controller) that is directed to the first control object of the first user interface object (e.g., with a targeting location corresponding to the location of the first control object). In some embodiments, performing the first control function corresponding to the first control object of the first user interface object includes closing an application corresponding to the first user interface object, or removing an application corresponding to the first user interface object. In some embodiments, the computer system displays a second control object corresponding to the first user interface object (and optionally, displays respective instances of the second control object for user interface objects of the second object type) while (e.g., in accordance with a determination that) the second plurality of user interface objects are displayed in the home menu user interface (e.g., when the second collection of user interface objects are displayed, and the first collection of user interface objects are not displayed in the visible portion of the home menu user interface), wherein: performing the second operation with respect to the first user interface object includes, in accordance with a determination that the first user input meets the selection criteria with respective to the second control object of the first user interface object (e.g., a “favorite” control or an “unfavorite” control, or another type of control object that is activated by a selection input), performing a second control function corresponding to the second control object of the first user interface object (e.g., making a contact corresponding to the first user interface object a favorite contact, or making a contact corresponding to the first user interface object a unfavorite contact). In some embodiments, the first control object is displayed for user interface objects of the first object type and not displayed for user interface objects of the second object type (e.g., application icons are displayed with a “deletion” affordance, but not a “favorite” or “unfavorite control, or an “offload” control), and the second control object is displayed for user interface objects of the second object type and not displayed for user interface objects of the first object type (e.g., contacts icons are displayed with a “favorite” or “unfavorite control, or an “offload” control, but not a “deletion affordance” or “offload” affordance). As another example, experience icons are, optionally, displayed with an “offload” control, but not a “deletion” affordance or a “favorite” or “unfavorite” control. In some embodiments, the first control object is displayed for the user interface objects in the first collection of user interface objects, and not displayed for the user interface objects in the second collection of user interface objects; and the second control object is displayed for user interface objects of the second collection of user interface objects and not displayed for user interface objects of the first collection of user interface objects. In some embodiments, the first collection of user interface objects and the second collection of user interface objects are not concurrently displayed in the home menu user interface and/or are not editable in the same portion of the home menu user interface, and therefore, the first control object and the second control object are not concurrently displayed in the home menu user interface. In some embodiments, the first control object is displayed with the same spatial relationship relative to the first user interface object as the second control object relative to the first user interface object (e.g., the control object is displayed on the upper left corner of the first user interface object, an upper right corner of the first user interface object, below a bottom edge of the first user interface object, or another position relative to the first user interface object, irrespective of the object type of the first user interface object). In some embodiments, the first control object is displayed with a first spatial relationship relative to the first user interface object when the first user interface object is of the first object type, and the second control object displayed with a second spatial relationship relative to the first user interface object when the first user interface object is of the second object type. For example, the same type of selection inputs directed to different controls associated with icons in views 8100a-8100e of home user interface perform different operations. For example, selecting offload affordance 30h displayed in association with virtual environment icon 30h causes the computer system 101 to offload the corresponding virtual environment “Alps”, as described in relation to FIGS. 8N-8O. In another example, selecting deletion affordance 36g′ displayed in association with application icon 36g causes the computer system 101 to delete application icon 36g (and cancel the installation of the corresponding application “App20”), as described in relation to FIGS. 8T-8V. In another example, selecting control 32a′ displayed in association with contact icon 32a causes the computer system 101 to changes the status of corresponding contact C1 from “favorite” to “nor favorite”. In another example, selecting control 32l′ displayed in association with contact icon 32l causes the computer system 101 to changes the status of corresponding contact C12 from “not favorite” to “favorite”. Using the same type of input, directed to respective control objects (e.g., offload affordance, deletion affordance, control for marking a contact as “favorite” and/or “not favorite”) associated with user interface objects, to perform different reconfiguration operations depending on the object type, reduces the number of inputs and/or the amount of time needed to reconfigure the home user interface (e.g., the user can use the same type of input to perform reconfiguration operations of the home user interface even when collections of different types of user interface objects are visible).

In some embodiments, displaying the first control object corresponding to the first user interface object includes (10016): in response to detecting a first portion of the first user input (e.g., a start of the first user input, a beginning portion and/or a middle portion of the first user input, and, optionally not including the termination of the first user input; or the entirety of the first user input, including the beginning, middle, and termination of the first user input): in accordance with a determination that the first portion of the first user input does not meet interaction criteria (e.g., the interaction criteria are different from the selection criteria, and can be met without meeting the selection criteria; or the interaction criteria are met when the selection criteria are met and the first user input is terminated), displaying the first control object with a first spatial relationship to the first user interface object (e.g., including displaying the first user interface object at a first depth relative to the viewpoint from which the environment is viewed, or in a first display layer relative to the display, and displaying the first control object at a second depth relative to the viewpoint or in a second display layer; the first depth is optionally equal to the second depth, and the second display layer is optionally the same as the first display layer), and in accordance with a determination that the first portion of the first user input meets the interaction criteria (e.g., attention is directed to the first user interface object and/or an input element such as a hand, finger, or controller, has moved closer than a threshold distance to the first user interface object), displaying the first control object with a second spatial relationship to the first user interface object, wherein the second spatial relationship is different from the first spatial relationship (e.g., including displaying the first user interface object at the first depth relative to the viewpoint from which the environment is viewed, or in the first display layer relative to the display, and displaying the first control object at a third depth relative to the viewpoint or in a third display layer, where the third depth is different from the second depth, or the third display layer is different from the second display layer). In some embodiments, the third depth is smaller than the second depth, and the first control object is lifted away from the first user interface object, when the interaction criteria are met by the first user input. For example, in FIG. 8N, the offload affordance 30h′ lifts off and moves away from icon 30h resulting in an increased gap in depth between offload affordance 30h′ and icon 30h, as illustrated in side view 283. In another example, in FIG. 8T, deletion affordance 36g′ lifts off and moves away from icon 30g resulting in an increased gap in depth between deletion affordance 36g′ and icon 36g, as illustrated in side view 285. In another example, in FIG. 8Y, the control 32a′ lifts off and moves away from icon 32a resulting in an increased gap in depth between control 32a′ and icon 32a. In some embodiments, a respective instance of the first control object is displayed for multiple or all of the user interface objects of the first object type in the first collection of user interface objects of the first object type, and the instances of the first control object are displayed with respective second depths that are the same as or different (e.g., smaller) than the respective first depths of their corresponding user interface objects of the first object type; and when interaction criteria are met with respect to the first control object for a respective user interface object of the first object type (e.g., when attention of the user, optionally based on a gaze of the user, is directed to the first control object or the first user interface object, and/or when the user's hand is raised to make an air gesture; or when a contact is hovering over the first user interface object or the first control object, or other portions of the first user input that indicates the user's intent to interact with the first user interface object or the first control object), the first control object is lifted further away from the respective user interface object in depth toward the viewpoint of the user, while the respective instances of the first control object for other user interface objects of the first object type maintain their current depths relative to their corresponding user interface objects and the viewpoint. In some embodiments, if the interaction criteria are met with respect to the first control object of another user interface object of the first object type, the first control object of the respective user interface object returns to its original depth, and the first control object of said other user interface object of the first object type is lifted away from said other user interface object toward the viewpoint of the user. In some embodiments, the instances of the first control object are displayed in association with corresponding user interface objects of the first object type, when the home menu user interface enters the reconfiguration mode and the first collection of user interface objects are the currently displayed collection of user interface object in the visible portion of the home menu user interface, and cease to be displayed when the home menu user interface exits the reconfiguration mode and/or when the user navigates to another portion of the home menu user interface that displays the second collection of user interface objects or another collection of user interface objects. In some embodiments, the depths of the user interface objects and the depths of the control objects are measured relative to a viewpoint associated with the environment in which the home menu user interface is displayed. In some embodiments, the depths of the user interface objects and the depths of the control objects are measured relative to a plane and/or surface of the home menu user interface. For example, in some embodiments, the user interface objects of the first object type reside within the plane or surface of the home menu user interface, and the respective control objects are displayed with a first distance in depth from the plane or surface of the home menu user interface; and when the interaction criteria are met with respect to the control object of a respective user interface object of the first object type, the respective user interface object optionally remains in the plane or surface of the home menu user interface or lift up from the plane or surface of the home menu user interface toward the viewpoint while the control object of the respective user interface object lifts up further from the plane or surface of the home menu user interface to create a greater gap in depth between the control object and the respective user interface object. In some embodiments, the relative depths of a user interface object and its control object are indicated based on visual obfuscation of the user interface object by its control object, as the user interface object and the control object are displayed in different display layers. In some embodiments, descriptions related to the visual feedback provided for the first control object are also applicable to the second control object, when the second control object is displayed for the first user interface object (e.g., when the second collection of user interface objects are displayed and the first user interface object is part of the second collection of user interface objects), and are not repeated herein in the interest of brevity. In some embodiments, control objects associated with user interface objects are lifted off the user interface objects (e.g., resulting in an increased gap in depth between the control objects and the user interface objects), when user's attention is directed to the control objects and/or when selected (e.g., in response to air pinch, air long pinch, air tap, air long tap, mouse clicks, and/or other selection inputs). Lifting a control object off of a respective user interface object when selected and/or when user's attention shifts to the control object, provides visual feedback to a user and assists the user when interacting with user interface object in the three-dimensional environment, thereby reducing the number of inputs and/or amount of time needed to interact with user interface object in the three-dimensional environment.

In some embodiments, in response to detecting the first user input, in accordance with the determination that the first user input meets the selection criteria with respect to a respective control object (e.g., the first control object or the second control object, or another control object) of the first user interface object, the computer system outputs (10018), via one or more output devices of the computer system (e.g., tactile output generators, and/or audio output generators), a first non-visual output (e.g., a first audio output corresponding to the first user input, and/or a first tactile output corresponding to the first user input). In some embodiments, the respective control object of the first user interface object includes a “close” affordance, a “deletion” affordance, an “offload” control, a “pin” control, or another type of control object that is activated by a selection input. In some embodiments, the first user input includes an air pinch gesture where the pinch gesture is detected when attention of the user, optionally based on a gaze of the user, is directed to the first object control of the first user interface object, or another selection input that is performed with other types of input modalities, such as a contact, an air gesture in location or with a gaze, a pointing device, or a hardware controller) that is directed to the first control object of the first user interface object (e.g., with a targeting location corresponding to the location of the first control object). In some embodiments, the first non-visual output is outputted at a time that corresponds to the start of the first user input (e.g., upon touch-up of the fingers for the air pinch gesture, upon touch-down of a contact for a tap input, upon down-click of a click input, or upon the start of another type of input). In some embodiments, the first non-visual output is outputted at a time that corresponds to the end of the first user input (e.g., upon depinch of the fingers for the air pinch gesture, upon liftoff of a contact for a tap input, upon up-click of a click input, or upon the termination of another type of input). For example, in FIG. 8O, in conjunction with activating the offload affordance 30h′ and performing the offload operation associated with the offload affordance 30h′, the computer system 101 generates an interaction sound “B” in association with offload affordance 30h′. Outputting a sound when a control object associated with a user interface object is activated, provides audio feedback to a user and assists the user when interacting with user interface object in the three-dimensional environment, thereby reducing the number of inputs and/or amount of time needed to interact with user interface object in the three-dimensional environment.

In some embodiments, outputting, via the one or more output devices of the computer system, the first non-visual output, includes (10020): in accordance with a determination that the first control object is located at a first location in the environment (e.g., a first three-dimensional location in a three-dimensional environment, a first pseudo-three-dimensional location in a pseudo three-dimensional environment, or a first two-dimensional location in a two-dimensional environment), generating a first spatial audio output with a first simulated location that corresponds to the first location in the environment (e.g., a simulated source location on the left side of the three-dimensional environment if the first user interface object is located on the left side of the visible portion of the home menu; or a more precise simulated source location that is close to the location of the first user interface object in the environment); and in accordance with a determination that the first control object is located at a second location, different from the first location, in the environment (e.g., a second three-dimensional location in the three-dimensional environment, a second pseudo-three-dimensional location in the pseudo three-dimensional environment, or a second two-dimensional location in the two-dimensional environment), generating a second spatial audio output with a second simulated location, different from the first simulated location, that corresponds to the second location in the environment (e.g., a simulated source location on the right side of the three-dimensional environment if the first user interface object is located on the right side of the visible portion of the home menu; or a more precise simulated source location that is close to the location of the first user interface object in the environment). For example, in FIG. 8O, the computer system 101 outputs the interaction sounds C, generated in conjunction with selecting or in response to activating the offload affordance 30h′, with a spatial sound effect. The interaction sound C sounds as if coming from a respective location in the three-dimensional environment corresponding to a location of the offload affordance 30h′. Providing spatial audio feedback enhances the operability of the device and makes the user-device interface more efficient (e.g., by helping the user to achieve an intended result and reducing user mistakes when operating/interacting with the device).

In some embodiments, outputting, via the one or more output devices of the computer system, the first non-visual output, includes (10022): in accordance with a determination that the first control object corresponds to a first operation type (e.g., corresponds to “deletion” or “offloading”, or another first operation type), generating a first audio output (e.g., the first spatial audio output, or a first non-spatial audio output) with a first audio output profile (e.g., a first set of one or more frequencies, magnitudes, patterns, duration, and/or other audio characteristics) that corresponds to the first operation type (e.g., a “ding” for the first operation type); and in accordance with a determination that the first control object corresponds to a second operation type (e.g., corresponds to a “favorite” operation, an “unfavorite” operation, a “pin” operation, or another second operation type) different from the first operation type, generating a second audio output (e.g., the second spatial audio output, or a second non-spatial audio output) with a second audio output profile (e.g., a second set of one or more frequencies, magnitudes, patterns, duration, and/or other audio characteristics) that corresponds to the second operation type (e.g., a “ding” for the first operation type), wherein the second audio output file is different from the first audio output profile. For example, the computer system 101 generates different selection sounds (optionally, with spatial audio effects) when deletion affordance 36g′ is selected (in FIG. 8T); when offload affordance 30h′ is selected (in FIG. 8O); when control 32a′ for marking a contact as “not favorite” is selected (in FIG. 8Y); and/or when control 32l′ for marking a s contact as “favorite” is selected (in FIG. 8AA). Providing different audio feedback when interacting with control objects (e.g., deletion affordance, offload affordance, and/or affordance for marking a contact “favorite” and “not favorite”) associated with user interface objects of different type, enhances the operability of the device and makes the user-device interface more efficient (e.g., by helping the user to achieve an intended result and reducing user mistakes when operating/interacting with the device).

In some embodiments, prior to detecting the first user input directed to the first user interface object, the computer system displays (10024) the home menu user interface in a first mode (e.g., a normal mode of operation), wherein selection of the first user interface object causes the computer system to display a first user interface corresponding to the first user interface object (e.g., displays an application window of the application that corresponds to the first user interface object if the first user interface object is an application icon, displays a three-dimensional experience if the first user interface object is an experience icon, displays a communication user interface if the first user interface object is a contact icon, and displays a control user interface or status information for a control if the first user interface object is a control for a control function of the computer system. In some embodiments, while displaying the home menu user interface in the first mode, the computer system detects a second user input that corresponds to a request to display the home menu user interface in a second mode (e.g., a reconfiguration mode of operation that is different from the first mode of operation), wherein one or more configurations of the home menu user interface (e.g., placement locations of user interface objects, font, color pallets, grouping, included user interface objects, favorite icons, pinned icons, and/or other configurations) are adjustable in accordance with user inputs in the second mode, wherein detecting the first user input includes detecting the first user input while the home menu user interface is displayed in the second mode of the home menu user interface. For example, in response to the detection of long pinch gesture 280 while icon 34l has input focus (e.g., in FIG. 8E), the computer system 101 activates the icon reconfiguration mode and displays view 8100d in the reconfiguration mode, as illustrated in FIG. 8F. In another example, in response to the detection of long pinch gesture 280m while gaze input 282m is directed toward view 8100b, the computer system 101 activates the reconfiguration mode and displays environments view 8100b in the reconfiguration mode (e.g., in FIGS. 8M-8N). Displaying control objects, associated with respective user interface objects, while the home user interface is in a reconfiguration mode (optionally, forgoing displaying the control objects when the home user interface is not in the reconfiguration mode) provides visual feedback of the operation state of the computer system enhances the operability of the device and makes the user-device interface more efficient (e.g., by helping the user to achieve an intended result and reducing user mistakes when operating/interacting with the device).

In some embodiments, detecting the second user input that corresponds to a request to display the home menu user interface in the second mode includes (10026) detecting that the second user input is a tap gesture (e.g., an air tap gesture, an air pinch gesture, a long air pinch gesture, or another type of tap or pinch gesture) that meets a first input threshold (e.g., meets a first duration threshold with less than a threshold amount of movement, before terminating the air tap gesture or another type of tap gesture). For example, the termination of the air tap gesture is detected when there is more than a threshold amount of gaze movement, and/or finger lift-off and moving in another direction different from the tapping direction. In some embodiments, a tap gesture includes tapping with a single finger in the air, tapping with one finger onto another finger (e.g., an adjacent finger, another finger of the same hand, or a finger of another hand), and/or tapping on a surface (e.g., a touch-sensitive surface, a physical surface, a virtual surface, such as the virtual surface of a user interface object or the menu user interface, or a virtual affordance). In some embodiments, the air tap gesture is detected in conjunction with the attention of the user (e.g., based on a gaze of the user) and the air tap gesture is directed to a location that corresponds a portion of the home menu user interface based on the attention of the user that is directed to the portion of the home menu user interface (e.g., a user interface object, such as the first user interface object or another user interface object in the respective plurality of user interface objects), and the air tap gesture meets the first input threshold when the attention of the user is maintained on the portion of the home menu user interface with less than a threshold amount of movement for at least a first threshold amount of time. In some embodiments, the tap gesture is directed to a location (e.g., with a finger or input object detected at a location) that corresponds to a portion of the home menu user interface (e.g., a user interface object, such as the first user interface object or another user interface object in the respective plurality of user interface objects) and the tap gesture meets the first input threshold when the tapping finger or input object is maintained at the location that corresponds to the portion of the home menu user interface with less than a threshold amount of movement for at least a first threshold amount of time (e.g., no gaze is needed, the air tap gesture is a gesture performed direct in location of the target). In some embodiments, the second input is a long air pinch gesture detected while a respective user interface object in the home menu user interface has input focus. For example, in FIGS. 8M-8N, in response to the detection of long pinch gesture 280m while gaze input 282m is directed toward view 8100b, the computer system 101 activates the reconfiguration mode and displays environments view 8100b in the reconfiguration mode. Using the same type of input (e.g., a long air pinch gesture) to activate the reconfiguration mode in the home user interface irrespective of what type of collection of user interface objects is visible (e.g., applications view, contacts view, environments, and/or other types of views), reduces the number of inputs and/or the amount of time needed to reconfigure the home user interface.

In some embodiments, while the home menu user interface is displayed in the reconfiguration mode, the computer system detects (10028), via the one or more input devices, one or more user inputs (e.g., one or more user inputs that change one or more aspects of the home menu user interface and/or perform operations enabled in the reconfiguration mode of the home menu user interface) before detecting the first user input. In some embodiments, in response to detecting the one or more user inputs, the computer system performs one or more operations corresponding to the one or more user inputs (e.g., navigates between different collections of user interface objects, and/or changes configurations of the different portions of the home menu user interface, such as repositioning icons, favoriting or unfavoriting icons, pinning icons, removing icons, offloading icons without deleting the corresponding content from the computer system, and/or other operations), while maintaining display, via the one or more display generation components, of the home menu user interface in the reconfiguration mode. For example, in some embodiments, the reconfiguration mode persists between user inputs that configure and/or change one or more aspects of the home menu user interface, such as, an input that selects an “Add” affordance to invoke an icon selection user interface for the object type of the currently displayed collection of user interface objects, followed by an input that selects a new icon to add to the home menu user interface; an input that opens a folder and drags an icon from the folder to a position outside of the folder; an input that browses through different sections of the currently displayed arrangement of the home menu user interface; an input that drags an icon from one position to another position in the currently displayed multi-section arrangement of the home menu user interface, and/or an input that deletes, offloads, downloads, reloads, favorites, unfavorites, and/or performs another operation that is enabled in the reconfiguration mode with respect to an icon. In some embodiments, the one or more inputs include one or more selection inputs (e.g., an air tap gesture or air pinch gesture that is either directly detected on an object or that is detected while attention of the user (e.g., based on a gaze of the user) or other focus selector is directed to the object), one or more navigation inputs (e.g., navigation by a swipe gesture that includes movement of a hand, pointing finger, or pinched fingers, in a navigation direction, or by selection of a navigation control using a selection input), and/or one or more drag inputs (e.g., selection by an air tap or air pinch gesture directed to an object, followed by a movement of the hand that performed the air tap or air pinch gesture while maintaining the tapping or pinched posture of the hand). For example, the reconfiguration mode persists in in view 8100d of home user interface 8100 while icon 34h is relocated, as illustrated in FIGS. 8G-8J. In another example, the reconfiguration mode persists in environments view 8100b when the virtual environment “Alps’ is offloaded (and/or while the virtual environment “Alps” is being offloaded) in response to an input selecting the offload affordance 30h associated with the virtual environment “Alps’ represented by virtual environment icon 30h, as illustrated in in FIGS. 8N-8O. Maintaining the reconfiguration mode between user inputs that configure and/or change one or more aspects of the home user interface, reduces the number of inputs and/or the amount of time needed to reconfigure the home user interface.

In some embodiments, the first user interface object is displayed (10030) in a first placement location in the home menu user interface (e.g., the first user interface object is an application icon in the collection of application icons in the home menu user interface), and performing, in accordance with the determination that the first user interface object corresponds to the first object type, the first operation of the first operation type, includes ceasing to display the first user interface object in the first placement location of the home menu user interface. For example, in accordance with a determination that the first user interface object is of the first object type (e.g., application icons, control icons, or another type of icons), the first user interface object is removed completely from the home menu user interface, or moved to a different placement location in the home menu user interface (e.g., a different placement location in the collection of user interface object that has the same object type as the first user interface object). In some embodiments, in accordance with a determination that the first user interface object is a first application icon that corresponds to a first application, the computer system ceases to display the first application icon at the first placement location (e.g., either remove the first application icon from the home menu user interface or move the first application to a different placement location in the home menu user interface, and optionally causing reordering of the application icons in the home menu user interface). For example, application icons 28a-28l in applications view 8100a can be recorded within sections in applications view 8100a similar to how icon 34h is relocated from one location to another in view 8100d in FIGS. 8G-8J. Providing control over placement and removal of application icons in the home user interface allows a user to configure where and what application icons are displayed, thereby providing more functionality, and making the user-device interface more efficient (e.g., by reducing the number of inputs and/or amount of time needed to locate an application icon and/or open a corresponding application).

In some embodiments, performing, in accordance with the determination that the first user interface object corresponds to the first object type, the first operation of the first operation type, includes (10032) placing the first user interface object in a folder containing one or more user interface objects of the first object type in the home menu user interface. For example, in some embodiments, the first user interface object is added to an existing folder containing zero or more user interface objects, if the first user interface object is dropped onto the existing folder, if the first user interface object is removed from the home screen user interface (e.g., added to a “deleted” or “recently deleted” folder), or if the first user interface object is added to a newly created folder when the first user interface object is dropped onto another user interface object of the first object type. In some embodiments, in accordance with a determination that the first user interface object is a first application icon that corresponds to a first application, the computer system adds the first user interface object into a folder containing one or more other application icons. For example, FIGS. 9G-9J illustrate adding application icons 90b and 90c into folder 920. Allowing a user to place application icons into existing folders or create new folders in the mixed-reality three-dimensional environment, provides more functionality and makes the user-device interface more efficient (e.g., by reducing the number of inputs and/or amount of time needed to locate an application icon and/or open a corresponding application).

In some embodiments, performing, in accordance with the determination that the first user interface object corresponds to the second object type (e.g., the first user interface object is an environment icon displayed among a collection of environment icons), the second operation of the second operation type, includes (10034) removing first content corresponding to the first user interface object from the computer system while maintaining display of the first user interface object in the home menu user interface. In some embodiments, the first user interface object is not removed from the home menu user interface, but the content corresponding to the first user interface object is offloaded from the computer system (e.g., deleted, and/or can be reloaded at a later time upon user request). For example, in some embodiments, in accordance with a determination that the first user interface object is a first environment icon that corresponds to a first three-dimensional environment or experience, the computer system deletes the content of the three-dimensional environment or experience from the computer system, but continues to display the first environment icon in the home menu interface, optionally with an altered appearance to indicate that the content corresponding to the first environment icon needs to be reloaded before the environment can be displayed or used again. For example, FIG. 8P is a transition from FIG. 8O after the computer system 101 offloads the virtual environment “Alps” (e.g., in response to the selection of offload affordance 30h′). FIG. 8P illustrates that while virtual environment icon 30h representing the virtual environment “Alps” remains displayed in environments view 8100b, the appearance of virtual environment icon 30h is changed (relative to FIG. 8O before the environment the virtual environment “Alps” is offloaded) to indicate that the virtual environment “Alps” is offloaded (e.g., but not removed, deleted and/or uninstalled). Providing the ability to offload environments, instead of deleting the environments, enhances the operability of the device and makes the user-device interface more efficient (e.g., by helping the user to achieve an intended result and reducing user mistakes when operating/interacting with the device, such as accidently deleting an environment).

In some embodiments, the first user interface object is displayed (10036) in a first placement location in the home menu user interface (e.g., the first user interface object is an environment icon in the collection of environment icons in the home menu user interface), and performing, in accordance with the determination that the first user interface object corresponds to the second object type, the second operation of the second operation type, does not include ceasing to display the first user interface object in the first placement location of the home menu user interface (e.g., the first user interface object cannot be removed completely from the home menu user interface, or moved to a different placement location in the home menu user interface). For example, in some embodiments, the object of the second object type cannot be moved to a different placement location in the collection of user interface object that is of the second object type. In some embodiments, in accordance with a determination that the first user interface object is a first environment icon that corresponds to a first three-dimensional environment and/or experience, the option for reordering the first environment icon relative to other environment icons is not available (e.g., the environment icons cannot be selectively dragged relative to one another in the reconfiguration mode). For example, positions of virtual environment icons in environments view 8100b cannot be changed (e.g., even while the reconfiguration mode is active) unlike other icons in other views, such as application icons 28a-28l in applications view 8100a (e.g., in FIGS. 8N-8P). Disabling a reorder operation for environment icons in response to user inputs meeting rearrangement criteria, enhances the operability of the device and makes the user-device interface more efficient (e.g., by helping the user to achieve an intended result and reducing user mistakes when operating/interacting with the device, such as accidently deleting an environment).

In some embodiments, displaying the home menu user interface, including the first user interface object, includes (10038): in accordance with the determination that the first user interface object corresponds to the second object type (e.g., the first user interface object is an environment icon displayed among a collection of environment icons), and that content corresponding to the first user interface object (e.g., environment and/or experience data) is not currently available to be displayed at the computer system (e.g., as a result of performing the second operation with respect to the first user interface object, in response to detecting the first user input, or an earlier or later user input, and/or because the environment corresponding to the first user interface object is offloaded), displaying the first user interface object with a first appearance (e.g., dimmed, grayed out, hollowed out, displayed with a download affordance, or another appearance that indicates that downloading is required before the environment and/or experience can be displayed); and in accordance with the determination that the first user interface object corresponds to the second object type (e.g., the first user interface object is an environment icon displayed among a collection of environment icons), and that the content corresponding to the first user interface object (e.g., environment and/or experience data) is available to be displayed at the computer system (e.g., as a result of performing the second operation with respect to the first user interface object, in response to detecting the first user input, or an earlier or later user input, and/or because the environment corresponding to the first user interface object is reloaded or downloaded), displaying the first user interface object with a second appearance different from the first appearance (e.g., with a regular appearance, not dimmed or grayed out, and/or without a download affordance). For example, in FIG. 8P after the computer system 101 offloads the virtual environment “Alps” (e.g., in response to the selection of offload affordance 30h′), virtual environment icon 30h is dimmed or darkened and a cloud icon 35h is displayed next to the “Alps” label to indicate that the virtual environment “Alps” is offloaded (e.g., and/or to indicate that the environment is not currently available to be opened). Displaying a visual indication when an environment icon is offloaded and forgoing displaying such visual indication when the environment is not offloaded, provides visual feedback regarding the state of the environment, thereby improving the operability of the device and making the user-device interface more efficient (e.g., by helping the user to achieve an intended result and reducing user mistakes when operating/interacting with the device).

In some embodiments, while displaying the home menu user interface, including displaying the second plurality of user interface objects of the second object type, wherein the second plurality of user interface objects includes one or more user interface objects that correspond to unavailable (e.g., removed, deleted, or offloaded) environment content (e.g., the environment and/or experience data were deleted, the environment and/or experience is not available to be displayed at the computer system, the environment and/or experience is available to be downloaded or reloaded before it can be displayed at the computer system), and one or more user interface objects that correspond to available environment content (e.g., the environment and/or experience data are downloaded, and the environment and/or experience is available to be displayed at the computer system, without needing to be downloaded again), the computer system detects (10040), via the one or more input devices, a user input that meets selection criteria with respect to a respective user interface object of the second plurality of user interface objects. In some embodiments, the user input is an air tap gesture that is detected at the location of the respective user interface object, an air tap gesture that is detected while attention of the user (e.g., based on the gaze of the user) is directed to the respective user interface object, an air pinch gesture that is detected while attention of the user (e.g., based on a gaze of the user) is directed to the respective user interface object, a tap input by a contact at a location that corresponds to the location of the respective user interface object, a click input that is detected while a focus selector is on the respective user interface object, an activation of a controller when the respective user interface object has input focus, or another type of selection input that targets the respective user interface object. In some embodiments, in response to detecting the user input that meets the selection criteria with respect to the respective user interface object of the second plurality of user interface objects: in accordance with a determination that the respective user interface object corresponds to unavailable environment content, the computer system outputs, via one or more output devices of the computer system, a second non-visual output (e.g., an audio output, and/or a tactile output that provides an alert that the environment content is unavailable); and in accordance with a determination that the respective user interface object corresponds to available environment content, the computer system forgoes outputting, via the one or more output devices of the computer system, the second non-visual output (e.g., outputs no non-visual output, or optionally, outputs a third non-visual output that is different from the second non-visual output, such as a different audio output with a different audio output profile from that of the second non-visual output, and/or a different tactile output with a different tactile output profile from that of the second non-visual output). For example, in FIG. 8K, in response to the selection of virtual environment icon 30h, the computer system 101 generates a selection sound B corresponding to a sound for selecting a virtual environment that is downloaded and loaded. In contrast, a different selection sound B′ is generated when an offloaded environment is selected, as described with reference to FIG. 8Q. In some embodiments, in response to detecting the user input that meets the selection criteria with respect to the respective user interface object of the second plurality of user interface objects, the computer system displays the environment and/or experience content corresponding to the respective user interface object, and optionally generates a different non-visual output. In some embodiments, in response to detecting the user input that meets the selection criteria with respect to the respective user interface object of the second plurality of user interface objects, in accordance with a determination that the respective user interface object corresponds to first environment or experience content, and that the first environment or experience content is available content, the computer system outputs a non-visual output with a first output profile; and in accordance with a determination that the respective user interface object corresponds to a second environment or experience content different from the first environment or experience content, and that the second environment or experience content is available content, the computer system outputs a non-visual output with a second output profile different from the first output profile (e.g., differ in frequency, duration, pattern, and/or type of the non-visual output). Providing different audio feedback when interacting with an environment icon depending on whether the corresponding environment is offloaded or is not offloaded, enhances the operability of the device and makes the user-device interface more efficient (e.g., by helping the user to achieve an intended result and reducing user mistakes when operating/interacting with the device).

In some embodiments, while displaying the home menu user interface, including displaying the second plurality of user interface objects of the second object type, includes (10042): in accordance with a determination that the second plurality of user interface objects include one or more user interface objects that correspond to unavailable environment content (e.g., the environment and/or experience data were deleted, the environment and/or experience is not available to be displayed at the computer system, the environment and/or experience is available to be downloaded or reloaded before it can be displayed at the computer system), displaying first indications (e.g., with badges indicating that they are offloaded environments and/or experiences, without full color of the icons) with the one or more user interface objects that correspond to unavailable environment content; and in accordance with a determination that the second plurality of user interface objects include one or more user interface objects that correspond to available environment content (e.g., the environment and/or experience data are downloaded, and the environment and/or experience is available to be displayed at the computer system, without needing to be downloaded again), displaying the one or more user interface objects that correspond to available environment content, without the first indications (e.g., without the badges, or with full color of the icons). For example, in FIG. 8P after the computer system 101 offloads the virtual environment “Alps” (e.g., in response to the selection of offload affordance 30h′), a cloud icon 35h is displayed next to the “Alps” label to indicate that the virtual environment “Alps” is offloaded. Displaying a visual indication when an environment icon is offloaded and forgoing displaying such visual indication when the environment is not offloaded, provides visual feedback regarding the state of the environment, thereby improving the operability of the device and making the user-device interface more efficient (e.g., by helping the user to achieve an intended result and reducing user mistakes when operating/interacting with the device).

In some embodiments, the home menu user interface includes (10044) a third plurality of user interface objects of a third object type (e.g., a collection of representations of contacts, or another collection of user interface objects of a third object type) that is different from the first object type and the second object type. In some embodiments, in response to detecting the first user input that is directed to the first user interface object and that meets the editing criteria: in accordance with a determination that the first user interface object corresponds to the third object type, the computer system performs a third operation corresponding to a third operation type (e.g., operations corresponding to representations of contacts and communication), different from the first operation type and the second operation type. In some embodiments, the home menu user interface includes the first plurality of user interface objects, the second plurality of user interface objects, and the third plurality of user interface objects in different sections of the home menu user interface, as different collections of user interface objects; and editing operations occur to one of the multiple collections of user interface objects at a time, when that collection of user interface objects are displayed in the home menu user interface, and other collections are not displayed and/or editable. In some embodiments, various features described above with respect to the first object type and/or the second object type, the first plurality of user interface objects and/or the second user interface objects, unless otherwise specified, are also applicable to the third object type and/or the third plurality of user interface objects, and are not repeated herein in the interest of brevity. In some embodiments, the first user interface object that corresponds to the third object type includes a contact icon that corresponds to a first contact or communication target (e.g., email address, phone number, social media handle, account identifier, username, or other identifier for a source or destination of a communication request), and the third operation of the third operation type includes starting a communication, displaying recent communications, displaying options for starting a communication session, and/or viewing recent communications, with regard to the first contact or communication target. For example, in FIG. 8T, a selection input directed toward deletion affordance 36g′ (e.g., an air pinch gesture 280t while deletion affordance 36g′ has input focus) causes the computer system 101 to delete application icon 36g representing an application; a selection input directed toward offload affordance 30h′ (e.g., an air pinch gesture 2800 while offload affordance 30h′ has input focus) causes the computer system 101 to offloads a virtual or extended-reality environment “Alps” corresponding to the environment icon 30h; a selection input directed toward control 32a′ for marking contact as “not favorite” (e.g., an air pinch gesture 280y while control 32a′ has input focus) causes the computer system 101 to mark a contact “C1” as “not favorite” and, optionally, to rearrange contacts view 8100c; and a selection input directed toward control 32l′ for marking contact as “favorite” (e.g., an air pinch gesture 280aa while control 32l′ has input focus) causes the computer system 101 to mark a contact “C12” as “favorite” and, optionally, to rearrange contacts view 8100c. Using the same type of input to perform different reconfiguration operations depending on the object type, reduces the number of inputs and/or the amount of time needed to reconfigure the home user interface.

In some embodiments, the first user interface object is displayed (10046) in a first placement location in the home menu user interface (e.g., the first user interface object is a representation of a contact in the collection of contacts in the home menu user interface), and performing the third operation of the third operation type, in accordance with the determination that the first user interface object corresponds to the third object type includes: in accordance with a determination that the first user interface object is in a first category of objects of the third object type (e.g., are favored contacts, or pinned contacts), ceasing to display the first user interface object in the first placement location of the home menu user interface (e.g., the first user interface object is removed completely from the home menu user interface, or moved to a different placement location in the home menu user interface, such as a different placement location in the collection of user interface object that has the same object type as the first user interface object). In some embodiments, in accordance with a determination that the first user interface object is a representation of a first contact and that the first contact is a favored contact, the computer system ceases to display the representation of the first contact at the first placement location (e.g., either remove the representation of the first contact from the home menu user interface or move the representation of the first contact to a different placement location in the home menu user interface, and optionally causing reordering of the representations of contacts in the home menu user interface). In some embodiments, in accordance with a determination that the first user interface object is in a second category of objects of the third object type (e.g., are recent contacts, and/or not favored or pinned contacts), different from the first category of objects of the third object type, the computer system maintains display of the first user interface object in the first placement location of the home menu user interface (e.g., the first user interface object cannot be removed completely from the home menu user interface, or moved to a different placement location in the home menu user interface). For example, in some embodiments, in accordance with a determination that the first user interface object is a representation of a first contact and the first contact is a recent contact (e.g., had communication with the user within a recent time window, or is a newly added contact), the computer system does not allow removal or reordering of the representation of the first contact (e.g., in the portion of the home menu user interface that displays the recent contacts); and in accordance with a determination that the first user interface object is a representation of a second contact and the second contact is a favored contact or pinned contact, the computer system allows removal of the representation of the second contact from and/or reordering of the representation of the second contact within, the region of the home menu user interface that displays favored and/or pinned contacts (e.g., to the region of the home menu user interface that displays recent contacts and/or all contacts). For example, contact icons in contacts view 8100c that are marked as “favorite” (e.g., contact icons 32b, 32c, 32d, 32e, and 32l corresponding to contacts that are marked as “favorite” in FIG. 8AC) can be reordered or repositioned, as described with reference to FIGS. 8AC-8AE, while contact icons in contacts view 8100c that are marked as “not favorite” (e.g., contact icons 32a, 32f, 32g, 32h, 32i, 32j, and 32k corresponding to contacts that are marked as “not favorite” in FIG. 8AC) remain at their respective locations in contacts view 8100c in response to the same type of input. Disabling a reorder operation for contacts that are displayed according to recency of communication and enabling the reorder operation for contacts that are marked as “favorite,” enhances the operability of the device and makes the user-device interface more efficient (e.g., by helping the user to achieve an intended result and reducing user mistakes when operating/interacting with the device, such as accidently breaking the order of contacts that should be displayed according to recency).

In some embodiments, the computer system displays (10048) a third control object (e.g., a control for make a contact a “favorite” contact) corresponding to a respective user interface object of the third plurality of user interface objects (and optionally, displays respective instances of the third control object for user interface objects of the third object type) while (e.g., in accordance with a determination that) the third plurality of user interface objects are displayed in the home menu user interface. For example, in some embodiments, when the third collection of user interface objects are displayed, and the first collection of user interface object and the second collection of user interface objects are not displayed in the visible portion of the home menu user interface. In some embodiments, while displaying the third control object corresponding to the respective user interface object of the third plurality of user interface objects (and optionally, displaying respective instances of the third control object for user interface objects of the third object type), the computer system detects a third user input that is directed to the third control object (e.g., the “favorite” control for the representation of the first contact that is currently a “recent” contact) and that meets selection criteria. In some embodiments, detecting the third user input includes detecting an air tap gesture or an air pinch gesture while the user's attention is directed to the third control object, where the air tap gesture or air pinch gesture does not meet an input threshold (e.g., the attention of the user, the gaze of the user, and/or pinched posture is not maintained with less than a threshold amount of movement for more than a threshold amount of time). In some embodiments, in response to detecting the third user input, the computer system performs (e.g., in accordance with a determination that the respective user interface object corresponds to the third object type) a third control function corresponding to the third control object of the respective user interface object (e.g., performs an operation of the third operation type), including changing a category of the respective user interface object from the second category of objects of the third object type (e.g., marked as a “recent contact”) to the first category of objects of the third object type (e.g., marked as a “favorite contact”). In some embodiments, changing a category of the respective user interface object between the first category and the second category also causes the computer system to move the respective user interface object between regions corresponding to the first category and the second category, and reflowing other user interface objects of the third object type displayed in one or both of the regions. In some embodiments, changing a category of the respective user interface object between the first category and the second category also causes the computer system to change the control object corresponding to the respective user interface object, to indicate the changes in category and available operation for the respective user interface object. For example, in FIGS. 8AA-8AB, changing the status of contact C12, represented by contacts icon 32l in contacts view 8100c, from “not favorite” to “favorite” also causes contacts icon 32l to move from a portion of contacts view 8100c representing contacts marked as “not favorite” to another portion of contacts view 8100c representing contacts marked as “favorite.” Moving a respective contact icon from a portion of the home user interface representing contacts marked as “not favorite” to another portion representing contacts marked as “favorite,” in conjunction with changing the status of a respective contact from “not favorite” to “favorite,” enhances the operability of the device and makes the user-device interface more efficient (e.g., by reducing the number of inputs and/or amount of time needed to reconfigure a contacts view in the home user interface).

In some embodiments, the computer system displays (10050) a fourth control object (e.g., a control for make a favorite contact an “unfavorite” contact) corresponding to a respective user interface object of the third plurality of user interface objects (and optionally, displays respective instances of the fourth control object for user interface objects of the third object type) while (e.g., in accordance with a determination that) the third plurality of user interface objects are displayed in the home menu user interface (e.g., when the third collection of user interface objects are displayed, and the first collection of user interface object and the second collection of user interface objects are not displayed in the visible portion of the home menu user interface). In some embodiments, while displaying the fourth control object corresponding to the respective user interface object of the third plurality of user interface objects (and optionally, displaying respective instances of the fourth control object for user interface objects of the third object type), the computer system detects a fourth user input that is directed to the fourth control object (e.g., the “unfavorite” control for the representation of the first contact that is currently a “favorite” contact) and that meets selection criteria. In some embodiments, detecting the fourth user input includes detecting an air tap gesture or an air pinch gesture while the user's attention is directed to the fourth control object, where the air tap gesture or air pinch gesture does not meet an input threshold (e.g., the attention of the user, the gaze of the user, and/or the pinched posture is not maintained with less than a threshold amount of movement for more than a threshold amount of time). In some embodiments, in response to detecting the fourth user input, the computer system performs (e.g., in accordance with a determination that the respective user interface object corresponds to the third object type) a fourth control function corresponding to the fourth control object of the respective user interface object (e.g., performs an operation of the third operation type), including changing a category of the respective user interface object from the first category of objects of the third object type (e.g., marked as a “favorite contact”) to the second category of objects of the third object type (e.g., marked as a “recent contact”). In some embodiments, changing a category of the respective user interface object between the first category and the second category also causes the computer system to move the respective user interface object between regions corresponding to the first category and the second category, and to reflow other user interface objects of the third object type displayed in one or both of the regions. In some embodiments, changing a category of the respective user interface object between the first category and the second category also causes the computer system to change the control object corresponding to the respective user interface object, to indicate the changes in category and available operation for the respective user interface object. For example, in FIGS. 8Y-8Z, changing the status of contact C1, represented by contacts icon 32a in contacts view 8100c, from “favorite” to “not favorite” also causes contacts icon 32a to move from a portion of contacts view 8100c representing contacts marked as “favorite” to another portion of contacts view 8100c representing contacts marked as “not favorite”. Moving a respective contact icon from a portion of the home user interface representing contacts marked as “favorite” to another portion representing contacts marked as “not favorite,” in conjunction with changing the status of a respective contact from “favorite” to “not favorite,” enhances the operability of the device and makes the user-device interface more efficient (e.g., by reducing the number of inputs and/or amount of time needed to reconfigure a contacts view in the home user interface).

In some embodiments, while displaying the third plurality of user interface objects corresponding to the third object type, the computer system detects (10052) a respective user input that changes a category of a respective user interface object of the third plurality of user interface object between the first category of objects of the third object type (e.g., marked as a “favorite contact”) to the second category of objects of the third object type (e.g., marked as a “recent contact”). In some embodiments, the respective user input includes an input that selects the “unfavorite” option displayed with a representation of a contact in the “favorite” group of contacts, or an input that selects the “favorite” option displayed with a representation of a contact in the “recent” group of contacts. In some embodiments, in response to detecting the respective user input that changes a category of the respective user interface object of the third plurality of user interface object: in accordance with a determination that the respective user input changes a category of the respective user interface object from the first category of objects of the third object type to the second category of objects of the third object type (e.g., the “unfavorite” option is selected, to change the contact from a “favorite contact” to a “recent contact”), the computer system outputs, via one or more output devices of the computer system, a fourth non-visual output (e.g., an audio output, and/or a tactile output); and in accordance with a determination that the respective user input changes a category of the respective user interface object from the second category of objects of the third object type to the first category of objects of the third object type (e.g., the “favorite” option is selected, to change the contact from a “recent contact” to a “favorite contact”), the computer system outputs, via one or more output devices of the computer system, a fifth non-visual output (e.g., an audio output, and/or a tactile output) different from the fourth non-visual output (e.g., differ in frequency, duration, wave pattern, and other aspects of the non-visual output profile). For example, in FIG. 8Y, the selection sound Y generated when a control for marking a contact as “not favorite” (e.g., control 32a′) is selected is different from the selection sound Y′ generated in FIG. 8AA when a control for marking a contact as “favorite” (e.g., control 32l′) is selected. Providing different audio feedback when interacting with a control object for marking a contact as “favorite” and a control object for marking a contact as “not favorite”, enhances the operability of the device and makes the user-device interface more efficient (e.g., by helping the user to achieve an intended result and reducing user mistakes when operating/interacting with the device).

In some embodiments, the computer system displays (10054) a fifth control object (e.g., a control for removing the representation of contact from “recent” contacts) corresponding to a respective user interface object of the third plurality of user interface objects (and optionally, displays respective instances of the fifth control object for user interface objects of the third object type, such as the objects in the category corresponding to “recent contacts”) while (e.g., in accordance with a determination that) the third plurality of user interface objects are displayed in the home menu user interface (e.g., when the third collection of user interface objects are displayed, and the first collection of user interface object and the second collection of user interface objects are not displayed in the visible portion of the home menu user interface). In some embodiments, while displaying the fifth control object corresponding to the respective user interface object of the third plurality of user interface objects (and optionally, displaying respective instances of the fourth control object for user interface objects of the third object type), the computer system detects a fifth user input that is directed to the fifth control object (e.g., the “delete” control for the representation of the first contact that is currently a “recent” contact) and that meets selection criteria. In some embodiments, the fifth user input includes an input, such as an air tap gesture or air pinch gesture, that is detected in conjunction with an indication of an attention of the user (e.g., based a gaze of the user), and that selects the “deletion” control displayed with a representation of a contact in the “recents” group of contacts. In some embodiments, in response to detecting the fifth user input, the computer system performs (e.g., in accordance with a determination that the respective user interface object corresponds to the third object type) a fifth control function corresponding to the fifth control object of the respective user interface object (e.g., performs an operation of the third operation type), including removing the respective user interface object from the second category of objects of the third object type (e.g., removing the respective user interface object from the group of “recent” contacts) without adding the respective user interface object to the first category of objects of the third object type (e.g., without adding the representation of the first contact to the group of “favorite contacts”). In some embodiments, the respective user interface object is removed from the home menu user interface, until a next time that the state of the respective user interface object changes (e.g., the contact corresponding to the respective user interface object is involved in a new communication event with the computer system), and as a result, the respective user interface object is added back to the second category of objects of the third object type. For example, in FIGS. 8AK-8AL, in response to the selection of control 8210, the computer system 101 removes the selected contact C11 represented by contact icon 32k from contact view 8100c and redisplays the contacts view 8100c of home user interface 8100, as shown in FIG. 8AL. Providing control to a user over whether a contact icon is included in a contacts view of the home user interface, allows a user to configure where and what contact icons are displayed in home user interface, thereby providing more functionality, and making the user-device interface more efficient (e.g., by reducing the number of inputs and/or amount of time needed to locate a contact icon and/or initiate communication with a corresponding contact).

In some embodiments, while displaying the third plurality of user interface objects of the third object type in the home menu user interface, the computer system displays (10056), for a respective user interface object of the third plurality of user interface objects (e.g., for the representation of a respective contact of the collection of representations of contacts), a respective indication (e.g., a “favorite” badge, and/or a “favoriting” control in the selected or unselected state) of whether the respective user interface object of the third plurality of user interface objects is in the first category of objects of the third object type (e.g., a “favorite” contact) or in the second category of objects of the third object type (e.g., an “unfavorite” contact). For example, in some embodiments, the third plurality of user interface objects are a collection of representations of contacts, and the representations of contacts are displayed with respective indications that indicate whether a contact is a “favorite contact” or an “unfavorite contact” (e.g., favorite contacts are displayed with a “favorite” badge or a “favoriting control” in the selected state; and unfavorite contacts are displayed without the “favorite” badge and a “favoriting control” that changes a category of the contact from “unfavorite” to “favorite” when selected by a user input meeting selection criteria). For example, as illustrated in FIGS. 8AG, star indicator 132l displayed in association with contact icon 32l, as a result of marking contact C12 as “favorite,” remains displayed, after exiting the reconfiguration mode. Displaying a visual indication that indicates whether a respective contact is marked as “favorite” and irrespective of whether the reconfiguration mode of the home user interface is active, provides visual feedback regarding the state of the contact, thereby improving the operability of the device and making the user-device interface more efficient (e.g., by helping the user to achieve an intended result and reducing user mistakes when operating/interacting with the device).

In some embodiments, while displaying the third plurality of user interface objects of the third object type in the home menu user interface, the computer system displays (10058) a respective control object for a respective user interface object of the third plurality of user interface objects (e.g., for the representation of a respective contact of the collection of representations of contacts), wherein displaying the respective control includes: in accordance with a determination that the respective user interface object of the third plurality of user interface objects is in the first category of objects of the third object type (e.g., is a “favorite” contact), displaying a first removal control (e.g., a “remove” affordance or “deletion” affordance) for the respective user interface object of the third plurality of user interface objects, wherein the first removal control, when selected, causes the computer system to remove the respective user interface object from the first category of objects of the third object type (e.g., selection of the “remove” affordance causes the computer system to remove the respective user interface object of the third plurality of user interface objects from the first category (e.g., to move the contact from the “favorite” group of contacts, to an “unfavorite” group of contacts or “recent” group of contacts), or to remove the respective user interface object from the home menu user interface (e.g., temporarily until the contact corresponding to the respective user interface object is involved in a new communication with the user of the computer system), or permanently); and in accordance with a determination that the respective user interface object of the third plurality of user interface objects is in the second category of objects of the third object type (e.g., is an “unfavorite” contact), displaying a status-change control (e.g., a “favoriting” control, or a “pinning” control) for the respective user interface object of the third plurality of user interface objects, wherein selection of the status-changing control causes the computer system to remove the respective user interface object from the second category of objects of the third object type (e.g., selection of the “favoriting” affordance causes the computer system to removing the respective user interface object from the “recents” or “unfavorite” group of contacts, and/or to move the respective user interface object to the “Favorites” group of contacts). In some embodiments, when a contact corresponding to a respective user interface object of the third object type has not been actively involved in communication with the user of the computer system for more than a threshold amount of time (e.g., 30 days, 1 week, or some other threshold amount of time), the computer system excludes the respective user interface object from being included in the third plurality of user interface objects, until the contact corresponding to the respective user interface object of the third object type is involved in a new communication with the user of the computer system. In some embodiments, when a contact corresponding to a respective user interface object of the third object type has the first characteristic of contacts (e.g., is a “favorite” or “pinned” contact), the computer system maintains the respective user interface object in the third plurality of user interface objects of the third object type, irrespective of when the contact corresponding to the respective user interface object was last involved in a communication with the user of the computer system. For example, in FIG. 8Y, in contacts view 8100c, the computer system 101 displays controls 32a′-32e′ for marking contacts as “not favorite” and controls 32f′-32l′ for marking contacts as “favorite” and, in FIG. 8S, in applications view 8100e, the computer system 101 displays deletion affordances 36a′-36m′. Proving a control for marking a contact as “favorite” and/or “not favorite,” instead of deletion affordance, enhances the operability of the device and makes the user-device interface more efficient (e.g., by helping the user to achieve an intended result and reducing user mistakes when operating/interacting with the device, such as accidently deleting an environment).

In some embodiments, while displaying the third plurality of user interface objects of the third object type in the home menu user interface, in accordance with a determination that the characteristic of the respective user interface object of the third plurality of user interface objects is in the second category of objects of the third object type (e.g., is an “unfavorite” and/or “recent” contact), the computer system displays (10060) a second removal control (e.g., a “remove” affordance or “deletion” affordance) for the respective user interface object of the third plurality of user interface objects, wherein the second removal control, when selected, causes the computer system to remove the respective user interface object from the third plurality of user interface objects. For example, in some embodiments, selection of the “remove” affordance causes the computer system to remove the respective user interface object from the home menu user interface, such as, to remove the contact from the “unfavorite” or “recent” group of contacts, and/or to remove the respective user interface object from the home menu user interface (e.g., temporarily until the contact corresponding to the respective user interface object is involved in a new communication with the user of the computer system, or permanently). In some embodiments, for a representation of a contact that is not a “favorite” or “pinned” contact, a control for “favoriting” or “pinning” the representation of the contact and a control for removing the representation of the contact from the home menu user interface are both displayed in associated with the representation of the contact. For example, in FIGS. 8AK-8AL, in response to the selection of control 8210, the computer system 101 removes the selected contact C11 represented by contact icon 32k from contact view 8100c and redisplays the contacts view 8100c of home user interface 8100, as shown in FIG. 8AL. Providing an option to remove a contact icon from a view of the home user interface that displays contact icons according to recency of communication with corresponding contacts, provides more functionality and makes the user-device interface more efficient (e.g., by reducing the number of inputs and/or amount of time needed to locate a contact icon and/or initiate communication with a corresponding contact).

In some embodiments, displaying the home menu user interface includes (10062): while displaying the third plurality of user interface objects of the third object type (e.g., representations of contacts, or another example of the third object type), displaying a first add control (e.g., a “+” button, an “Add” button, or another control) concurrently with at least a subset of one or more of the third plurality of user interface objects of the third object type; and while displaying the first search control, detecting, via the one or more input devices, a sequence of one or more inputs corresponding to selection of the first add control (e.g., by a user input that meets the selection criteria with respect to the first add control). In some embodiments, the one or more inputs corresponding to selection of the first add control includes an air pinch gesture where the pinch gesture is detected when attention of the user (e.g., based on a gaze of the user) is directed to the first add control, or another selection input that is performed with other types of input modalities, such as a contact, an air gesture in location or with a gaze, a pointing device, or a hardware controller) that is directed to the first add control (e.g., with a targeting location corresponding to the location of the first add control). In some embodiments, displaying the home menu user interface includes: in response to detecting the selection of the first add control, displaying, via the one or more display generation components, a first adding user interface that enables selection of additional user interface objects of the third object type to add to the third plurality of user interface objects of the third object type. In some embodiments, the first adding user interface includes one or more recommended user interface objects of the third object type, before any search criteria are entered in the first adding user interface. In some embodiments, in response to detecting one or more search criteria entered in a search input region of the first add user interface, the computer system displays a plurality of search results corresponding to different user interface objects of the third object type. In some embodiments, selection of a respective search result or a recommended user interface object displayed in the first add user interface causes the user interface object that corresponds to the respective search result or the recommended user interface object to be added to the home menu user interface, among the third plurality of user interface objects of the third object type. For example, in FIG. 8X, in contacts view 8100b, the computer system 101 displays an affordance 32 for adding a new contact to the contact view 8100c. Providing an option to add a contact icon to a contacts view of the home user interface, provides more functionality and makes the user-device interface more efficient (e.g., by reducing the number of inputs and/or amount of time needed to locate a contact icon and/or initiate communication with a corresponding contact).

In some embodiments, while displaying a first portion of the home menu user interface, the first portion of the home menu user interface includes the first plurality of user interface objects (e.g., without including the second plurality of user interface objects or only includes an indication of the existence of the second plurality of user interface objects), the computer system detects (10064), via the one or more input devices, a sequence of one or more inputs corresponding to a first navigation input directed to the home menu user interface. In some embodiments, the one or more inputs corresponding to a navigation input directed to the home menu user interface includes selection of a navigation control of the home menu user interface (e.g., a navigation control corresponding to the second plurality of user interface objects of the second object type, such as tab menu 8004 in FIGS. 8A-8C) using an air pinch gesture where the air pinch gesture is detected when attention of the user (e.g., based on a gaze of the user) is directed to the navigation control, or another selection input that is performed with other types of input modalities, such as a contact, an air gesture in location or with a gaze, a pointing device, or a hardware controller) that is directed to the navigation control (e.g., with a targeting location corresponding to the location of the navigation control). In some embodiments, in response to detecting the first navigation input directed to the home menu user interface, the computer system ceases to display the first portion of the home menu user interface, and displays a second portion of the home menu user interface, wherein the second portion of the home menu user interface includes the second plurality of user interface objects (e.g., without including the first plurality of user interface objects, or only including an indication of the existence of the first plurality of user interface objects). In some embodiments, while displaying the second portion of the home menu user interface, the second portion of the home menu user interface includes the second plurality of user interface objects (e.g., without including the first and third pluralities of user interface objects, or only including an indication of the existence of the first and third pluralities of user interface objects), the computer system detects a second navigation input directed to the home menu user interface; and in response to detecting the second navigation input directed to the home menu user interface, the computer system ceases to display the second portion of the home menu user interface, and displays the first portion of the home menu user interface (e.g., if a first portion of the navigation element is selected, or if the navigation input is in a first direction), or displays a third portion of the home menu user interface (e.g., if a second portion of the navigation element is selected, or if the navigation input is in a second direction different from the first direction), wherein the third portion of the home menu user interface includes a third plurality of user interface objects (e.g., without including the first and second pluralities of user interface objects, or only including an indication of the existence of the first and second pluralities of user interface objects). For example, tab menu 8004 (shown in FIGS. 8A-8D) has multiple tabs 8004a, 8004b, and 8004c corresponding to different views (e.g., applications view 8100a, environments view 8100b, and contacts view 8100c) of home user interface 8100, and the user can toggle between the different views 810a-8100c using the tabs in tab menu 8004. Navigating between different views of the home user interface (e.g., contacts view, environments view, and/or applications view) using the same tab menu, reduced the number of inputs and/or amount of time needed to find a user interface objects (e.g., a contact icon, an environment icon, and/or an application icon) and/or the number of inputs and/or amount of time needed to reconfigure the home user interface.

In some embodiments, the computer system displays (10066), via the one or more display generation components, a navigation element while the home menu user interface is displayed in a first mode (e.g., a normal mode of operation or a mode of operation other than the reconfiguration mode of operation), wherein detecting the first navigation input directed to the home menu user interface includes detecting a user input directed to the navigation element; and forgoing displaying the navigation element while the home menu user interface is displayed in a reconfiguration mode (e.g., navigation between different sections or collections of user interface objects are disabled when editing of a respective collection of user interface objects). For example, while the tab menu 8004 is visible when home user interface 8100 is in the normal mode, the computer system 101 optionally ceases to display the tab menu 8004, in accordance with a determination that home menu user interface 8100d has transitioned into the reconfiguration mode (as illustrated in FIG. 8F while home user interface 8100d is the reconfiguration mode, compared with FIG. 8E while home user interface 8100d is in the normal mode). Removing the tab menu for navigating between different views of the home user interface while the reconfiguration mode is active, disables the ability to navigate between different views of the home user interface while the reconfiguration mode is active, thereby enhancing the operability of the device and making the user-device interface more efficient (e.g., by helping the user to achieve an intended result and reducing user mistakes when operating/interacting with the device, such as accidently switching to a different view).

In some embodiments, while displaying the first portion of the home menu user interface in the reconfiguration mode, without concurrently displaying the navigation element, the computer system detects (10068), via the one or more input devices, a user input that corresponds to a request to exit the reconfiguration mode of the home menu user interface. In some embodiments, detecting the user input that corresponds to a request to exit the reconfiguration mode of the home menu user interface includes detecting a “done” or “exit” affordance displayed in the home menu user interface in the reconfiguration mode, a selection input directed to an unoccupied portion of the home menu user interface (e.g., an air tap or air pinch gesture detected in conjunction with an indication of the attention of the user (e.g., based on a gaze of the user) that is directed to an unoccupied portion of the home menu user interface), an activation of a power button or digital crown of the computer system, and/or another input that corresponds to a request to terminate a current mode of the computer system and/or restore a previous mode of the computer system. In some embodiments, in response to detecting the user input that corresponds to a request to exit the reconfiguration mode of the home menu user interface, the computer system displays, via the one or more display generation components, the home menu user interface in the first mode (e.g., a normal mode of operation or a mode of operation other than the reconfiguration mode of operation), and displays, via the one or more display generation components, the navigation element with the first portion of the home menu user interface. For example, in FIG. 8Q, in accordance with a determination that the environments view 8100b of home user interface 8100 is no longer in the reconfiguration mode (e.g., in response to the selection of Done button 28028 that causes computer system to deactivate the reconfiguration mode), the computer system 101 redisplays tab menu 8004 for switching between different views of home user interface 8100. Redisplaying the tab menu for navigating between different views of the home user interface in accordance with a determination that reconfiguration mode has been deactivated or exited, enables navigation between different views of the home user interface, thereby enhancing the operability of the device and making the user-device interface more efficient (e.g., by helping the user to achieve an intended result and reducing user mistakes when operating and/or interacting with the device, such as accidently confirming and/or canceling changes made with respect to a corresponding view while in the reconfiguration mode).

In some embodiments, in response to detecting the first user input, in accordance with a determination that the first user input corresponds to a request to move the first user interface object from a first placement location to a second placement location, the computer system displays (10070), via the one or more display generation components, an animated movement of the first user interface object toward a viewpoint of a user before displaying an animated movement of the first user interface object from the first placement location to the second placement location. In some embodiments, in response to detecting the first user input, in accordance with a determination that the first user input does not correspond to a request to move the first user interface object from the first placement location to another placement location, the computer system forgoes displaying, via the one or more display generation components, the animated movement of the first user interface object toward the viewpoint of the user and forgoes displaying an animated movement of the first user interface object from the first placement location to another placement location. For example, in FIG. 8G, in response to the detection of pinch gesture 298 while icon 34h is in focus, the computer system 101 selects icon 34h and optionally moves icon 34h towards the viewpoint of the user 7002 and away from plane 287 (e.g., moving the selected icon 34h closer to the viewpoint of user 7002) resulting in an increased distance in depth between icon 34h and plane 287, as illustrated in top view 285. Further, as illustrated in FIGS. 8H-8I, icon 34h is lifted up away from plane 287 while being dragged within view 8100d of home user interface 8100. Displaying a user interface object at a reduced distance away from the user in accordance with determination that and/or while the user interface object is selected, dragged and/or when user's attention shifts to the user interface, provides visual feedback to a user and assists the user when interacting with user interface object in the three-dimensional environment, thereby reducing the number of inputs and/or amount of time needed to interact with user interface object in the three-dimensional environment.

In some embodiments, aspects/operations of methods 10000, 11000 and 12000 may be interchanged, substituted, and/or added between these methods. For example, the objects and icons that are reconfigured and rearranged in home user interface, in accordance with techniques described with reference to method 10000, are objects and/or icons that can be added to folders created in accordance with techniques described with references to method 11000. In one example, sounds generated in conjunction with performing folder creation operations, in accordance with techniques described with reference to method 12000, are sounds that can be generated in accordance with folder creation techniques described with references to method 11000. For brevity, these details are not repeated here.

FIGS. 11A-11K illustrate a flow diagram of an exemplary method 11000 for creating a folder of user interface objects in a three-dimensional environment, in accordance with some embodiments. In some embodiments, method 11000 is performed at a computer system (e.g., computer system 101 in FIG. 1) that is in communication with one or more display generation components (e.g., display generation component 120 in FIGS. 1A, 3A, and 4) (e.g., a heads-up display, a display, a touchscreen, a projector, etc.) and one or more input devices (e.g., including one or more sensors and devices for detecting user inputs) (e.g., a camera (e.g., color sensors, infrared sensors, and other depth-sensing cameras) that points downward at a user's hand or a camera that points forward from the user's head). In some embodiments, the computer system is further in communication with one or more output devices other than the one or more display generation component, such as one or more output devices that provide non-visual outputs. In some embodiments, the one or more output devices that provide non-visual outputs include one or more audio output devices, such as one or more speakers, one or more headphones, and/or one or more earbuds. In some embodiments, the one or more output devices that provide non-visual output devices include one or more tactile output generators, such as one or more localized tactile output generators that provide localized tactile outputs at selected locations, and one or more generalized or non-localized tactile outputs throughout multiple components and/or portions of the computer system. In some embodiments, the computer system operates the display generation component, the audio output devices, and the tactile output generators independently of one another when generating outputs; and sometimes, the computer system coordinate the visual outputs, audio outputs and/or tactile outputs to provide feedback to the user regarding the response to the user inputs and/or the state(s) of the computer system. For example, the timing, duration, magnitude, phase, pattern, and/or other characteristics of the outputs are correlated based on the timing, duration, magnitude, phase, pattern, and/or other characteristics of the inputs, the response, and/or the feedback types. In some embodiments, the method 11000 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 11000 are, optionally, combined and/or the order of some operations is, optionally, changed.

As described herein, method 11000 provides an improved mechanism for creating a folder of icons (e.g., application icons, contact icons, environment icons, and/or other user interface objects) in a mixed-reality three-dimensional environment. In a home user interface, while a first icon is dragged toward a placement location occupied by a second icon, the computer system initially pushes the second icon away from the first icon. After the second icon is pushed away from the first icon and, in accordance with a determination that the first icon is within less than a threshold distance away from the second icon, the computer system stops pushing the second icon away and initiates a folder creation process that optionally includes displaying a folder preview icon (e.g., with the first icon and/or the second icon) if certain conditions are met. In accordance with a determination that the folder creation process has not been cancelled (e.g., the first and second icon remain within less than the threshold distance away from one another before the expiration of a time period), the computer system pulls the second icon toward the first icon and generates a folder preview icon that, optionally, initially includes at least the second icon and, then, pulls the first icon into the folder preview icon. For example, after the folder preview icon is displayed and in accordance with a determination that the folder creation process has not been cancelled, the first icon appears to be sucked into the folder preview icon together with the second icon. After the folder preview icon is displayed and in accordance with a determination that the folder creation process has been cancelled (e.g., the second icon is moved away from the first icon before the expiration of the time period), the computer system ceases to display the folder preview icon. Pushing an adjacent icon away from a dragged icon and then stop pushing and start pulling the adjacent icon toward the dragged icon after a folder creation process is initiated but before it is completed, provides continued assistance to a user in creating a folder and/or rearranging a home user interface, thereby reducing the number of inputs and/or the amount of time needed to create a folder that includes icons in a home user interface in a mixed-reality environment (e.g., reducing errors and unintended inputs).

The computer system displays (11004), via the one or more display generation components, a first user interface, in a first view of an environment, including displaying a first plurality of user interface objects in a first plurality of placement locations (e.g., placement locations for user interface objects of a first object type) in the first user interface according to a first arrangement of the first plurality of user interface objects (e.g., application icons placed in a first grid according to a first arrangement, representations of users and/or contacts placed in a second grid according to a second arrangement, representations of experiences placed in a third grid according to a third arrangement, controls placed in a fourth grid according to a fourth arrangement, or objects of another object type placed in a respective grid according to another arrangement, in a multi-arrangement home menu user interface). In some embodiments, the first user interface includes a home menu user interface, a first collection of user interface objects in a home menu user interface, or another system user interface that includes user interface objects of a respective object type (e.g., application icons, widgets, representations of users and/or contacts, controls for control functions, or icons for launching environments and/or experiences). In some embodiments, the first user interface is a two-dimensional user interface (e.g., a two-dimensional desktop environment, a two-dimensional window, a split screen display environment, or a full-screen display environment), a pseudo-three-dimensional user interface that is capable of representing different depths of objects within the first user interface (e.g., through multiple display layers with different relative depths, simulated shadows, simulated parallax effects, visual obfuscation of objects along a user's light of sight, and/or other visual effects), or a three-dimensional environment such as a three-dimensional virtual reality environment, a three-dimensional augmented reality environment, and/or a three-dimensional extended reality environment. In some embodiments, a home menu user interface is optionally displayed in a reconfiguration mode (e.g., an icon reconfiguration mode and/or another mode in which icons in the home menu user interface (e.g., a respective collection of multiple collections of icons of different types) can be added, deleted, and/or repositioned based on user inputs), and/or in a normal mode (e.g., a mode in which selection of an icon causes the computer system to display a user interface of a corresponding application, start or resume a corresponding three-dimensional extended reality experience, activate a control function or control user interface of a corresponding control; and/or initiate a communication session with a corresponding contact, of the selected icon). For example, applications view 9100a including application icons 90a-90k is displayed via HMD 7100a in FIG. 9A.

While displaying the first user interface including the first plurality of user interface objects, the computer system detects (11006) a first user input that is directed to a first user interface object of the first plurality of user interface objects, wherein the first user interface object was displayed at a first placement location in the first user interface when a start of the first user input was detected, and wherein the first user input includes first movement and meets drag criteria with respect to the first user interface object. For example, in FIGS. 9G-9H, movement input 980g while the pinch gesture 980f continues to hold application icon 90c. In some embodiments, the first user input is a long pinch and hold air gesture that is directed to the first user interface object (e.g., the pinching fingers are at the location of the first user interface object, or the pinch is detected while attention of the user (e.g., based on a gaze of the user) is directed to the first user interface object), followed by an air drag gesture while maintaining the pinch posture of the hand, where, the long pinch and hold air gesture followed by the air drag gesture triggers the reconfiguration mode, and the air drag gesture is detected while in the reconfiguration mode. In some embodiments, the first user input is an air pinch gesture that is directed to the first user interface object followed by a drag gesture while maintaining the pinch posture of the hand, where the air pinch gesture and the air drag gesture are both detected in the reconfiguration mode. In some embodiments, instead of or in addition to air pinch gestures, another type of air gesture or combination of air gestures are used to meet the drag criteria with respect to the first user interface object. For example, in some embodiments, the drag criteria are met by an air tap gesture or by a long air tap gesture performed with a pointing finger or controller, followed by a movement of the tapping finger or controller. In some embodiments, the targeting location of the air gesture is the location of the air gesture. In some embodiments, the targeting location of the air gesture is the location of attention of the user (e.g., based on a gaze of the user) that is detected at the start of the air gesture and/or during the air gesture. In some embodiments, another type of user input can be used to meet the drag criteria with respect to the first user interface object, e.g., when a different type of environment and/or a different set of input devices are used to interact with the environment. For example, in some embodiments, the drag criteria are met by a touch and hold and drag gesture performed by a contact on a touch-sensitive surface or a touch-screen, where the touch down location of the contact corresponds to the location of the first user interface object. In some embodiments, the drag criteria are met by a click hold and drag input performed by a pointing device, such as a mouse, where the click input is detected while a focus selector of the pointing device, such as a pointer cursor, is on the first user interface object.

In response to detecting the first user input (11008) that meets the drag criteria with respect to the first user interface object, the computer system: moves (11010) the first user interface object relative to the first placement location in the first user interface based on the first movement of the first user input (e.g., based on a direction and/or magnitude of the first user input). For example, in some embodiments, in accordance with a determination that the first movement in in a first input direction (e.g., a direction relative to the user, a touch-sensitive surface, the environment, or the physical environment of the user), the computer system moves the first user interface object in a first interface direction (e.g., a direction relative to the first user interface); and in accordance with a determination that the first movement in in a second input direction (e.g., another direction relative to the user, the touch-sensitive surface, the environment, or the physical environment of the user), the computer system moves the first user interface object in a second interface direction (e.g., another direction relative to the first user interface), wherein the first interface direction corresponds to the first input direction, and the second interface direction corresponds to the second input direction. In some embodiments, the speed and/or magnitude of the movement of the first user interface object relative to the first placement location in the first user interface corresponds to the speed and/or magnitude of the first movement of the first user input. In some embodiments, the movement of the first user interface object is dynamically updated (e.g., displaced, sped up, slowed down, reversed and/or changing directions) based on the changing direction, speed and/or magnitude of the first movement of the first user interface.

In accordance with a determination that the first user interface object is approaching a second user interface object placed in a second placement location, different from the first placement location, in the first user interface, the computer system moves (11012) the second user interface object relative to the second placement location in a first direction away from the first user interface object. For example, in accordance with a determination that the first user interface object is approaching a second user interface object placed in a second placement location, the computer system moves the second user interface objects away from the second placement location, to increase a gap between the first user interface object and the second user interface object, even though the first user interface object is being dragged toward the second placement location (e.g., the amount of movement executed by the second user interface object is optionally more than, less than, or the same as the amount of movement executed by the first user interface object at the same time).

In accordance with a determination that the first user interface object is within a first threshold distance (e.g., a distance that is less than a spacing between adjacent user interface objects in the first user interface) of the second user interface object after the second user interface object is moved relative to the second placement location, away from the first user interface object, the computer system ceases (11014) to move the second user interface object away from the first user interface object and initiates a process for creating a folder that includes the first user interface object and the second user interface object. For example, in some embodiments, the first user interface object can be dragged closer to the second user interface object, even though the second user interface object is moving in a direction away from the first user interface object (e.g., the second user interface object is tethered to the second placement location and slows down when moved farther away from the second placement location; and/or the second user interface object slows down, or further movement of the second user interface object is blocked or limited, as the second user interface object approaches a third placement location occupied by a third user interface objects); and in accordance with a determination that the first user interface object is within a first threshold distance (e.g., a distance that is less than a spacing between adjacent user interface objects in the first user interface) of the second user interface object, the computer system ceases to move the second user interface object away from the first user interface object and initiates a process for creating a folder that includes the first user interface object and the second user interface object. In some embodiments, the computer system shows that the first user interface object and the second user interface object moving toward each other (e.g., both objects are moving at the same time, or either object is moving while the other object is stationary) and merging into a preview of a folder, in accordance with a determination that the first user interface object is within a first threshold distance of the second user interface object after the second user interface object is moved relative to the second placement location, away from the first user interface object. For example, FIGS. 9F-9J illustrates a scenario in which the computer system 101 initiates a folder creation process with respect to a dragged icon 90c and another icon, icon 90b, toward which the dragged icon is being moved.

In some embodiments, in response to detecting the first user input that meets the drag criteria with respect to the first user interface object, in accordance with the determination that the first user interface object is within the first threshold distance of the second user interface object after the second user interface object is moved relative to the second placement location, away from the first user interface object, the computer system displays (11016) an indication (e.g., a selectable option for creating a folder, and/or a visual indication showing a preview of a folder) regarding creation of the folder that includes the first user interface object and the second user interface object (e.g., a folder to be placed at the second placement location, or another placement location for folders). For example, folder preview icon 920a in FIG. 9I provides an indication that a folder creation process has been initiated, and provides an opportunity to user 7002 to either cancel the folder creation process or to confirm and/or complete the folder creation process. Displaying a folder preview icon in accordance with a determination that a folder creation process is initiated (e.g., with respect to a dragged icon and an icon toward which the dragged icon is moved) provides visual feedback to a user and assists the user when rearranging the home user interface and/or creating a folder.

In some embodiments, in response to detecting the first user input that meets the drag criteria with respect to the first user interface object, in accordance with a determination that the first user interface object has moved past the second placement location after approaching the second placement location based on the first movement, the computer system moves (11018) the second user interface object relative to the second placement location in a second direction that is different from the first direction (e.g., the first direction is a direction that is away from the first user interface object). In some embodiments, in accordance with a determination that the first user interface object has moved past the second placement location after approaching the second placement location based on the first movement, the computer system moves the second user interface objects away from the second placement location to a third placement location. For example, in some embodiments, if the first user interface object is moved to a placement location that is ordered before the second placement location, the second user interface object is reflowed to a third placement location that is ordered after the second placement location, which involves a movement of the second user interface object in a second direction different from the first direction. In some embodiments, the second direction and the third direction are opposite directions, because the relative positions of the first user interface object and the second user interface object have switched (e.g., the first user interface is no longer approaching the second user interface object and has moved past the second user interface object). For example, in FIG. 9J, in conjunction with generating the folder and displaying folder icon 920, the computer system reflows or shifts application icons 90d-90k by one placement location to fill in a respective placement location vacated as a result of replacing two application icons 90b and 90c with one folder icon 920. Automatically move icons out of the way of an icon that is being dragged, in accordance with a determination that respective criteria are met, reduces the number of inputs and/or the amount of time needed to arrange and/or reconfigure a home user interface in a three-dimensional environment.

In some embodiments, in response to detecting the first user input that meets the drag criteria with respect to the first user interface object, in accordance with a determination that confirmation criteria are met by the first user input while the first user interface object is within the first threshold distance of the second user interface object, the computer system creates (11020) the folder including the first user interface object and the second user interface object at the second placement location. In some embodiments, the first user interface object comes within the first threshold distance of the second user interface object, as a result of the second user interface object moving toward the first user interface object after having moved relative to the second placement location away from the first user interface object. In some embodiments, confirmation criteria are met when the first user input is terminated while the first user interface object is within the first threshold distance of the second user interface object, the second user interface object has stopped moving away from the first user interface object, and the process for creating a folder is initiated. In some embodiments, the confirmation criteria are met when the first user input is terminated (e.g., the pinch posture of the hand that performs the air pinch and drag gesture is released), and/or the first user input is held substantially stationary for at least a threshold amount of time (e.g., the air drag gesture is stopped, and/or has less than a threshold amount of movement in a threshold time window for at least a threshold amount of time), when the distance between the first user interface object and the second user interface object is less than the first threshold distance, and/or when the preview of the folder is displayed. For example, as described and illustrated with reference to FIGS. 9G-9J, the computer system 101 creates a folder icon 920 with application icons 90b and 90c inside the folder, in accordance with a determination that a folder creation confirmation criteria are met (e.g., if pinch gesture 980f is released while application icon 90c is overlaying the folder preview icon 920a and/or the application icon 90b). After the folder creation process has been initiated (e.g., while displaying a folder preview icon) but before it is completed, providing a user with an ability to either confirm or cancel the folder creation process, enhances the operability of the device and makes the user-device interface more efficient (e.g., by helping the user to achieve an intended result and reducing user mistakes while creating a folder and/or rearranging the home user interface).

In some embodiments, in response to detecting the first user input that meets the drag criteria with respect to the first user interface object, in accordance with a determination that confirmation criteria are not met by the first user input while the first user interface object is within the first threshold distance of the second user interface object, the computer system forgoes (11022) creating the folder at the second placement location (and, optionally, forgoes creating a folder corresponding to the first user input). In some embodiments, the first user interface object is within the first threshold distance of the second user interface object as a result of the first user interface object moving away from the second user interface object after the second user interface object having stopped moving away from the first user interface object. In some embodiments, the confirmation criteria are not met when the first user input is not terminated while the first user interface object is within the first threshold distance of the second user interface object, and the first user input moves the first user interface farther away from the second placement location such that the distance between the first user interface object and the second user interface object is greater than a threshold distance, such as the first threshold distance or a greater distance than the first threshold distance. In some embodiments, after the first user interface object is moved away from the second placement location without the first user input meeting the confirmation criteria, the computer system restores the second user interface object into the second placement location, and ceases to display the indication regarding the creation of the folder (e.g., a preview of the folder including the first user interface object and the second user interface object, or another form of a preview of the folder). For example, in FIGS. 9K-9L, in response to the detection of movement input 980k while maintaining a hold of application icon 90c (e.g., via pinch gesture 980f), the computer system 101 cancels the folder creation process and ceases to display folder preview icon 920a (e.g., in accordance with a termination that the gap between application icon 90c and folder preview icon 920a and/or the application icon 90b is increased to more than a threshold amount). After the folder creation process has been initiated (e.g., while displaying a folder preview icon) but before it is completed, providing a user with an ability to either confirm or cancel the folder creation process, enhances the operability of the device and makes the user-device interface more efficient (e.g., by helping the user to achieve an intended result and reducing user mistakes while creating a folder and/or rearranging the home user interface).

In some embodiments, in response to detecting the first user input that meets the drag criteria with respect to the first user interface object, in accordance with the determination that the first user interface object is within the first threshold distance (e.g., a distance that is less than a spacing between adjacent user interface objects in the first user interface) of the second user interface object after the second user interface object is moved relative to the second placement location, away from the first user interface object, the computer system moves (11024) the second user interface toward the first user interface object (e.g., toward the second placement location, as the first user interface object is moving toward the second placement location). For example, in FIGS. 9G-9H, the dragged application icon 90c initially pushes away application icon 90b toward which application icon 90c is dragged, and, in accordance with a determination that the distance and/or gap between application icons 90c and 90b is reduced to less than the threshold amount, the computer system 101 stops pushing application icon 90b away from application icon 90c and starts pulling application icon 90b toward application icon 90c, as illustrated in FIG. 9H. While a first icon is dragged toward a placement location occupied by a second icon, the computer system initially pushes the second icon away from the first icon. After the second icon is pushed away from the first icon and, in accordance with a determination that the first icon is within less than a threshold distance away from the second icon, the computer system stops pushing the second icon away and starts pulling the second icon toward the first icon, thereby providing visual indication to the user that the folder creation process has been initiated. Proving visual feedback to the user that the folder creation process is initiated, reduces the number of inputs and/or amount of time needed to create a folder or rearrange the home user interface (e.g., by helping the user to achieve an intended result and reducing user mistakes while creating a folder and/or rearranging the home user interface).

In some embodiments, moving the second user interface object relative to the second placement location in the first direction away from the first user interface object includes (11026) moving the second user interface object with displacements in two or more dimensions (e.g., left and right, as well as up and down environment directions or interface directions) of the environment that result in an increased distance between the first user interface object and the second user interface object in the environment (e.g., in the pseudo three-dimensional environment (e.g., two orthogonal dimensions and a third dimension indicated by different display layers), or in the three-dimensional environment). In some embodiments, the movement of the first user interface object is in two dimensions (e.g., in a plane or a surface parallel to a plane or surface the first user interface), while the movement of the second user interface object is in three-dimensions (e.g., can be lifted away or pushed past the plane or surface of the first user interface, as well as moving within or parallel to the plane or surface of the first user interface). For example, while application icon 90c is dragged toward application icon 90b, the computer system 101 moves application icon 90b in one or more directions that include a rightward direction and, optionally, a downward and/or upward direction, away from the dragged application icon 90c and/or toward application icon 90d. While a first icon is dragged toward a placement location occupied by a second icon, the computer system initially pushes the second icon away from the first icon in one or more directions and/or dimensions. Pushing the second icon away from a dragged icon, provides visual feedback to a user and assists the user when rearranging the home user interface and/or creating a folder, thereby enhancing the operability of the device and making the user-device interface more efficient (e.g., by helping the user to achieve an intended result and reducing user mistakes while creating a folder and/or rearranging the home user interface).

In some embodiments, in response to detecting the first user input that meets the drag criteria with respect to the first user interface object (11028): in accordance with a determination that the first user interface object is approaching a third user interface object placed in a third placement location, different from the first placement location and the second placement location, in the first user interface, the computer system moves the third user interface object relative to the third placement location in a second direction away from the first user interface object. In some embodiments, moving the third user interface object relative to the third placement location in the second direction away from the first user interface object includes moving the third user interface objects away from the third placement location, to increase a gap between the first user interface object and the third user interface object, even though the first user interface object is being dragged toward the third placement location (e.g., the amount of movement executed by the third user interface object is optionally more than, less than, or the same as the amount of movement executed by the first user interface object at the same time). In some embodiments, in accordance with a determination that the first user interface object is within the first threshold distance (e.g., a distance that is less than a spacing between adjacent user interface objects in the first user interface) of the third user interface object after the third user interface object is moved relative to the third placement location, away from the first user interface object, the computer system ceases to move the third user interface object away from the first user interface object (e.g., shows the first user interface object and the third user interface object moving toward each other (e.g., both objects are moving at the same time, or either object is moving while the other object is stationary) and merging into a preview of a folder) and initiates a process for creating a folder that includes the first user interface object and the third user interface object. In some embodiments, the first user interface object is within the first threshold distance of the third user interface object because the first user interface object can be dragged closer to the third user interface object, even though the third user interface object is moving in a direction away from the first user interface object (e.g., the third user interface object is tethered to the third placement location and slows down when moved farther away from the third placement location). In some embodiments, the computer system shows that the first user interface object and the third user interface object moving toward each other (e.g., both objects are moving at the same time, or either object is moving while the other object is stationary) and merging into a preview of a folder, in accordance with a determination that the first user interface object is within the first threshold distance of the third user interface object after the third user interface object is moved relative to the third placement location, away from the first user interface object. In some embodiments, descriptions regarding the process for creating a folder including a dragged object (e.g., the first user interface object) and another object (e.g., the second user interface object, or another user interface object of the same object type as the dragged object), unless stated clearly otherwise, are also applicable to the process for creating a folder including the first user interface object and the third user interface object, and are not repeated herein in the interest of brevity. In some embodiments, the behaviors of the first user interface object, the second user interface object, and/or corresponding visual feedback, as described above with respect to the first user interface object and the second user interface object are also applicable to the third user interface object, and are not repeated here in the interest of brevity. In some embodiments, multiple user interface objects may be moving relative to the first user interface (e.g., relative to the first user interface object, and/or relative to their respective placement locations) at a given moment, based on the movement direction of the first user interface object and based on the relative distances between the first user interface object and the respective user interface objects among the multiple user interface objects (e.g., some may be moving toward their placement locations after having moved away from their placement locations, and some are moving away from their placement locations, some may be moving to increase their distances away from the first user interface object, and/or some may be moving to decrease their distances from the first user interface object). In some embodiments, the movements of the multiple user interface objects are transient, and the user interface objects are restored to their respective placement locations, unless a folder is actually created in accordance with a determination that the confirmation criteria are met with respect to folder creation for the first user interface object and one of the multiple user interface objects. For example, in FIGS. 9G-9H, movement input 980g that drags application icon 90c includes movement in more than one direction and/or dimension and, in response, application icons 90b and 90g are pushes pushed away from application icon 90c in accordance with the movement input 980g. While a first icon is dragged in the home user interface, the computer system initially pushes one or more other icons away from the first icon. Pushing one or more other icons away from a dragged icon, provides visual feedback to a user and assists the user when rearranging the home user interface and/or creating a folder, thereby enhancing the operability of the device and making the user-device interface more efficient (e.g., by helping the user to achieve an intended result and reducing user mistakes while creating a folder and/or rearranging the home user interface).

In some embodiments, in response to detecting the first user input (11030): in accordance with a determination that the first user interface object has moved less than a first threshold amount of movement relative to the first placement location (e.g., the first threshold amount of movement is a movement by at least two thirds of the way to a next row in the grid of the first user interface, or a movement by another threshold amount for triggering reflow) based on (e.g., in accordance with) the first movement of the first user input, the computer system forgoes moving another user interface object in the first user interface into the first placement location (e.g., keeps the first placement location temporarily unoccupied, reflow of user interface objects is not triggered, and icons that are located after the sequential position of the first user interface object remain in their original placement locations); and in accordance with a determination that the first user interface object has moved more than the first threshold amount of movement relative to the first placement location based on (e.g., in accordance with) the first movement of the first user input, the computer system moves another user interface object in the first user interface into the first placement location (e.g., fills the first placement location temporarily, reflow of user interface objects is triggered, and icons that are located after the sequential position of the first user interface object are shifted from their original placement locations to adjacent placement locations toward the first placement location along the reflow path). For example, in FIG. 9T, in accordance with a determination that application icon 9211 has been dragged (e.g., in response to movement input 980u) at least the threshold amount for triggering reflow of application icons in the expanded version 92a′ of folder 92a, the computer system 101 automatically reflows or shifts application icons 9204 and 9212 to make room for application icon 9211. Automatically reflowing or shifting icons in the home user interface to make room for a dragged icon, in accordance with a determination that the icon has been dragged by more than a threshold amount, reduces the number of inputs and/or amount of time needed to rearrange the home user interface.

In some embodiments, in response to detecting, via the one or more input devices, an initial portion of the first user input that is directed to the first user interface object (e.g., the initial portion of the first user input is detected before the start of the first movement and/or before the first user input meets the drag criteria with respect to the first user interface object), in accordance with a determination that the initial portion of the first user input meets interaction criteria with respect to the first user interface object, the computer system displays (11032) a first animated movement of the first user interface object relative to the first placement location (e.g., the first animated movement shows the first user interface object lift away from the first placement location toward a viewpoint of the user, where the first animated movement does not correspond to the first movement and/or does not require that the first user input includes a movement or that the first user input meets the drag criteria). For example, in FIG. 9F, application icon 90c is moved towards the viewpoint of the user 7002 and away from plane 287 in response to the detection of one or more selection inputs (e.g., pinch gesture 980f detected while application icon 90c has input focus as a result of gaze input 928f). In some embodiments, the first user input is a long pinch and hold air gesture that is directed to the first user interface object followed by an air drag gesture while maintaining the pinch posture of the hand, and/or the first user input is an air pinch gesture that is directed to the first user interface object followed by a drag gesture while maintaining the pinch posture of the hand; and the initial portion of the first user input includes the long pinch and hold air gesture or the air pinch gesture before the air drag gesture is started or before a sufficient portion of the air drag gesture is completed. In some embodiments, instead of or in addition to air pinch gestures, another type of air gesture or combination of air gestures are used to meet the drag criteria with respect to the first user interface object. For example, in some embodiments, the drag criteria are met by an air tap gesture or by a long air tap gesture performed with a pointing finger or controller, followed by a movement of the tapping finger or controller; and the initial portion of the first user input includes the air tap gesture or the long air tap gesture. In some embodiments, the drag criteria are met by a touch hold and drag gesture performed by a contact on a touch-sensitive surface or a touch-screen, where the touch down location of the contact corresponds to the location of the first user interface object; and the initial portion of the first user input includes the touch and hold portion of the input. In some embodiments, the drag criteria are met by a click hold and drag input performed by a pointing device, such as a mouse, where the click input is detected while a focus selector of the pointing device, such as a pointer cursor, is on the first user interface object; and the initial portion of the first user input includes the click and hold portion of the input. Displaying an icon at a reduced distance away from the user (e.g., relative to other icons in the home user interface), in accordance with determination that and/or while the user interface object is selected, dragged and/or when user's attention shifts to the user interface, provides visual feedback to a user and assists the user when interacting with user interface object in the three-dimensional environment, thereby reducing the number of inputs and/or amount of time needed to interact with user interface object in the three-dimensional environment.

In some embodiments, in response to detecting, via the one or more input devices, a termination of the first user input (e.g., the final portion of the first user input that is detected after the second user interface object has stopped moving away from the first user interface object), in accordance with a determination that the first user interface object is within the first threshold distance of the second user interface object (e.g., when the termination of the first user input is detected, and optionally, while the indication regarding the creation of a folder including the first user interface object and the second user interface object is still displayed), the computer system displays (11034) the folder at the second placement location in the first user interface. In some embodiments, the folder includes both the first user interface object and the second user interface object. For example, in FIGS. 9I-9J, while the folder preview icon 920a is displayed with application icon 90b inside of it, the computer system 101 detects a release 980j of pinch gesture 980f that drops application icon 90c into the folder preview icon 920a, thereby causes the computer system 101 to generate folder icon 920 with application icons 90b and 90c inside of it. In some embodiments, the first user input is a long pinch and hold air gesture that is directed to the first user interface object followed by an air drag gesture while maintaining the pinch posture of the hand, and/or the first user input is an air pinch gesture that is directed to the first user interface object followed by a drag gesture while maintaining the pinch posture of the hand; and the termination of the first user input includes release of the pinch posture (e.g., the pinched fingers are moved apart from each other). In some embodiments, instead of or in addition to air pinch gestures, another type of air gesture or combination of air gestures are used to meet the drag criteria with respect to the first user interface object. For example, in some embodiments, the drag criteria are met by an air tap gesture or by a long air tap gesture performed with a pointing finger or controller, followed by a movement of the tapping finger or controller; and the termination of the first user input includes an air flick or another air tap of the finger that performed the air tap gesture or the long air tap gesture. In some embodiments, an air flick gesture is performed with a finger, two or more fingers of a hand, or another input object, when the movement of the finger(s) or input object has an acceleration that is greater than a threshold acceleration (e.g., a sudden increase in movement speed that is initiated from a substantially stationary state or a uniform movement state). In some embodiments, the finger(s) or input object executing the accelerated flick movement were operationally holding a pinched posture prior to the flick movement and the flick movement terminates a pinch and hold gesture or a pinch and drag gesture performed with the finger(s) or input object. In some embodiments, the flick gesture is detected when the movement of the finger(s) or input object exceeds a threshold speed (e.g., as a result of an abrupt increase in acceleration of the movement). In some embodiments, the drag criteria are met by a touch hold and drag gesture performed by a contact on a touch-sensitive surface or a touch-screen, where the touch down location of the contact corresponds to the location of the first user interface object; and the termination of the first user input includes the lift off of the contact from the touch-sensitive surface or touch-screen. In some embodiments, the drag criteria are met by a click hold and drag input performed by a pointing device, such as a mouse, where the click input is detected while a focus selector of the pointing device, such as a pointer cursor, is on the first user interface object; and the termination of the first user input includes the release of the hold input (e.g., lift-off of the finger that pressed and held the mouse button). Dropping an icon that is being held (e.g., via a pinch and hold air gesture) into a folder preview icon in order to generate the folder, provides the user with efficient means to either create the folder or cancel the folder creation process, thereby enhancing the operability of the device and making the user-device interface more efficient (e.g., by helping the user to achieve an intended result and reducing user mistakes while creating a folder and/or rearranging the home user interface).

In some embodiments, prior to detecting the termination of the first user input, in accordance with a determination that the first user interface object is within the first threshold distance from the second user interface object, the computer system displays (11036), via the one or more display generation components, a preview of the folder (e.g., a platter containing the first user interface object and the second user interface object, or the representations of the first user interface object and the second user interface object) and displays, via the one or more display generation components, a second animated movement of the second user interface object into the preview of the folder. In some embodiments, the second animated movement of the second user interface object is displayed multiple times, while the distance between the first user interface object and the second user interface object remains within the first threshold distance, and before the termination of the first user input is detected and the folder is actually created at the second placement location. In some embodiments, the second animated movement of the second user interface object is displayed one time, and the preview of the folder remains displayed while the distance between the first user interface object and the second user interface object remains within the first threshold distance, until the termination of the first user input is detected and/or until the folder is actually created at the second placement location. In some embodiments, if the first user input moves the first user interface object away from the second placement location, the computer ceases to display the preview of the folder and ceases to display the second animated movement of the second user interface object. For example, in FIGS. 9H-9I, as application icon 90b is attracted by application icon 90c (e.g., after initially being pushes away by application icon 90c), the computer system 101 displays the folder preview icon 920a at a location that intersects with a location of the application icon 90b and starts reducing the size application icon 90b as if application icon 90b is sucked into the folder preview icon 920a (e.g., folder icon 90b appears inside folder preview icon 920a). After folder creation process with respect to a first icon and a second icon has been initiated, including displaying a folder preview icon, and in accordance with a determination that the folder creation process has not been cancelled (e.g., the first and second icons remain within less than the threshold distance away from one another before the expiration of a time period), the computer system pulls the second icon into the folder preview icon (e.g., the folder preview icon appears to swallow the second icon), thereby continuously providing visual feedback that the folder creation process has been initiated and has not yet been cancelled. Proving visual feedback to the user that the folder creation process has not been cancelled, reduces the number of inputs and/or amount of time needed to create a folder or rearrange the home user interface (e.g., by helping the user to achieve an intended result and reducing user mistakes while creating a folder and/or rearranging the home user interface).

In some embodiments, detecting the first user input that meets the drag criteria includes (11038) detecting, via the one or more input devices, an initial portion of the first user input that is directed to the first user interface object, followed by detecting the first movement; and detecting the initial portion of the first user input includes detecting, via the one or more input devices, an air pinch gesture that is started (e.g., with two fingers of the same hand touching up on each other) while attention of the user (e.g., based on gaze) is directed to the first user interface object (e.g., the attention of the user is on the first user interface object or is within a reactive region associated with the first user interface object, and the attention of the user is substantially stable with less than a threshold amount of movement relative to the first user interface object for at least a threshold amount of time), and the air pinch gesture is maintained for at least a first threshold amount of time with less than a threshold amount of movement before the first movement is started (e.g., hand that performs the air pinch gesture keeps the pinch posture substantially stationary while the attention of the user (e.g., based on a gaze of the user) is maintained on the first user interface object). In some embodiments, the computer system displays an indication that first user interface object is selected to be dragged by the first user input, if more than a threshold of movement of the hand is detected while the pinch posture of the hand is maintained. In some embodiments, in response to detecting the initial portion of the first user input that is directed to the first user interface object (e.g., the initial portion of the first user input is detected before the start of the first movement and/or before the first user input meets the drag criteria with respect to the first user interface object), in accordance with a determination that the initial portion of the first user input meets interaction criteria with respect to the first user interface object, the computer system displays a first animated movement of the first user interface object relative to the first placement location (e.g., the first animated movement shows the first user interface object lift away from the first placement location toward a viewpoint of the user, where the first animated movement does not correspond to the first movement and/or does not require that the first user input includes a movement or that the first user input meets the drag criteria). For example, in FIGS. 9F-9J, the input that causes the computer system 101 to drag application icon 90c to create a folder icon 920 with application icons 90b and 90c inside of it, starts with an air pinch gesture 980b, and a hold of the air pinch gesture 980b (e.g., maintaining the air pinch gesture 980b for more than a threshold amount) detected while application icon 90c has input focus as a result of gaze input 982b. Using user's gaze to move input focus to a respective icon and using a long air pinch gesture to select and drag an icon in the home user interface, provides an ergonomic and efficient way for a user to interact with objects in the three-dimensional environment, including reducing the number of inputs and/or amount of time needed to create a folder or rearrange the home user interface.

In some embodiments, in response to detecting, via the one or more input devices, a termination of the first user input that meets the drag criteria with respect to the first user interface object: in accordance with a determination that the first user interface object is approaching a first unoccupied placement location and is within a second threshold distance (e.g., same as the first threshold distance, greater than the first threshold distance, or shorter than the first threshold distance) of the first unoccupied placement location at the termination of the first user input, the computer system places (11040) the first user interface object in the first unoccupied placement location in the first user interface (and optionally, restores the second user interface object back to the second placement location, and/or reflows user interface objects in the first user interface to fill the first placement location vacated by the first user interface object). For example, in FIGS. 9K-9L and FIGS. 9M-9P, instead of dropping application icon 90c into the folder preview icon 920a, user 7002 drags application icon 90c away from the folder preview icon 920a and drops application icon 90c elsewhere in applications view 9100a, thereby causing the computer system to move application icon 90c to a different location in application view 9100a instead of generating folder icon 920. Dropping an icon that is being held (e.g., via a pinch and hold air gesture) into a folder preview icon in order to generate the folder and dragging the icon away from the folder preview icon to cancel the folder creation, provides the user with efficient means to either create the folder or rearrange icons on the home user interface, thereby enhancing the operability of the device and making the user-device interface more efficient (e.g., by helping the user to achieve an intended result and reducing user mistakes while creating a folder and/or rearranging the home user interface).

In some embodiments, in response to detecting the first user input that meets the drag criteria with respect to the first user interface object, in accordance with a determination that the first user interface object is approaching a fourth user interface object placed in a fourth placement location, different from the first placement location and the second placement location, in the first user interface, the computer system moves (11042) the fourth user interface object relative to the fourth placement location in a third direction away from the first user interface object (e.g., moves the fourth user interface objects away from the fourth placement location, to increase a gap between the first user interface object and the fourth user interface object, even though the first user interface object is being dragged toward the fourth placement location (e.g., the amount of movement executed by the fourth user interface object is optionally more than, less than, or the same as the amount of movement executed by the first user interface object at the same time)). For example, in FIGS. 9B-9E, the application icon 90c is dragged toward application icon 90b that moves out of the way of the dragged application icon 90c, by appearing to slide underneath application icon 90c and moving into the placement location in applications view 9100a vacated by application icon 90c. Dropping an icon that is being held (e.g., via a pinch and hold air gesture) into a folder preview icon in order to generate the folder and dragging the icon away from the folder preview icon (e.g., optionally causing other icons to be pushed away) to cancel the folder creation, provides the user with efficient means to either create the folder or rearrange icons on the home user interface, thereby enhancing the operability of the device and making the user-device interface more efficient (e.g., by helping the user to achieve an intended result and reducing user mistakes while creating a folder and/or rearranging the home user interface).

In some embodiments, in response to detecting the first user input that meets the drag criteria with respect to the first user interface object, in accordance with a determination that the first user interface object is within the first threshold distance (e.g., a distance that is less than a spacing between adjacent user interface objects in the first user interface) of the fourth user interface object after the fourth user interface object is moved relative to the fourth placement location, away from the first user interface object, the computer system moves (11044) the fourth user interface object toward the fourth placement location in the first user interface. In some embodiments, the first user interface object is within the first threshold distance because the first user interface object can be dragged closer to the fourth user interface object, even though the fourth user interface object is moving in a direction away from the first user interface object (e.g., the fourth user interface object is tethered to the fourth placement location and slows down when moved farther away from the fourth placement location). In some embodiments, moving the fourth user interface object toward the fourth placement location includes moving the fourth user interface object toward the first user interface object (e.g., showing the first user interface object and the third user interface object moving toward each other (e.g., both objects are moving at the same time, or either object is moving while the other object is stationary). For example, in FIG. 9G, the computer system 101 initially pushes application icon 90b away from its placement location as a result of dragging application icon 90c toward application icon 90b, and after dragging application icon 90c away from application icon 90b (e.g., in an opposite direction), in FIG. 9L or FIG. 9N, the computer system 101 moves application icon 90b back to its original location (e.g., before it was pushed). While a first icon is dragged in the home user interface toward a second icon to rearrange the home user interface and/or create a folder, the computer system dislodges the second icon out of its respective placement location. In accordance with a determination that the first icon is dragged in another direction away from the second icon (e.g., thereby optionally cancelling a folder creatin process with respect to the first and second icons), the computer system restores position of the second icon into its placement location. Restoring the position of the second icon (e.g., after canceling the folder creation process and/or removing the folder preview icon), provides visual feedback to the user that the computer system responds to user's inputs and assists the user when rearranging the home user interface and/or creating a folder, thereby enhancing the operability of the device and making the user-device interface more efficient (e.g., by helping the user to achieve an intended result and reducing user mistakes while creating a folder and/or rearranging the home user interface).

In some embodiments, the first placement location is (11046) in a first portion of the first user interface and the second placement location in a second portion of the first user interface that is different from the first portion of the first user interface, and wherein the first portion of the first user interface and the second portion of the first user interface are portions of a first page of the first user interface (e.g., the first portion and the second portion are concurrently visible, in the same grid, and/or have the same level of visibility at a given time). For example, in FIGS. 9G-9J, the applications 90c and 90b are on the same section of applications view 9100a of home user interface 8100 before being moved into folder icon 920. While a first icon is dragged in the home user interface toward a second icon on the same section in the home user interface to rearrange the home user interface and/or create a folder, the computer system dislodges the second icon out of its respective placement location. In accordance with a determination that the first icon is dragged in another direction away from the second icon (e.g., thereby optionally cancelling a folder creatin process with respect to the first and second icons), the computer system restores position of the second icon into its placement location. Restoring the position of the second icon (e.g., after canceling the folder creation process and/or removing the folder preview icon), provides visual feedback to the user that the computer system responds to user's inputs and assists the user when rearranging the home user interface and/or creating a folder, thereby enhancing the operability of the device and making the user-device interface more efficient (e.g., by helping the user to achieve an intended result and reducing user mistakes while creating a folder and/or rearranging the home user interface).

In some embodiments, the fourth placement location is (11048) in a third portion of the first user interface, and wherein the third portion of the first user interface is in a second page of the first user interface different from the first page of the first user interface (e.g., the first portion and the third portion are not concurrently visible, are not in the same grid, and/or do not have the same level of visibility at a given time). In some embodiments, a portion of the second page is concurrently displayed with the first page of the first user interface, and when the first user interface object is dragged into the region of the second page that is concurrently visible with the first page, the computer system navigates from the first page of the first user interface to the second page of the first user interface, where the fourth placement location including the fourth user interface object are in the currently displayed page of the first user interface, and the first user interface can interact with the placement location and/or user interface objects (e.g., be inserted into a placement location, and/or causing user interface objects in the second page to move relative to their respective placement locations) in the second page of the first user interface. For example, when the application icon 90c is dragged away folder preview icon 920 with application icon 90c displayed inside of it, thereby causing the computer system 101 to cancel the folder creation process, application icon 90c is dragged toward dimmed application 90l visible in the preview of the previous section of applications view 9100a. While a first icon is dragged in the home user interface toward a second icon on the same section in the home user interface to rearrange the home user interface and/or create a folder, the computer system dislodges the second icon out of its respective placement location. In accordance with a determination that the first icon is dragged in another direction away from the second icon (e.g., thereby optionally cancelling a folder creatin process with respect to the first and second icons) to a third icon on a different section of the home user interface, the computer system restores position of the second icon into its placement location. Restoring the position of the second icon (e.g., after canceling the folder creation process and/or removing the folder preview icon), provides visual feedback to the user that the computer system responds to user's inputs and assists the user when rearranging the home user interface and/or creating a folder, thereby enhancing the operability of the device and making the user-device interface more efficient (e.g., by helping the user to achieve an intended result and reducing user mistakes while creating a folder and/or rearranging the home user interface).

In some embodiments, the first plurality of user interface objects in the first plurality of placement locations in the first user interface includes (11050) one or more folders and one or more individual user interface objects (e.g., the individual user interface objects include individual icons corresponding to different applications, contacts, environments, experiences, and/or control functions, and respectively occupying a single placement location by itself), wherein a respective folder (e.g., a new folder that includes the first user interface object and the second user interface object, or an existing folder) of the one or more folders is configured to include two or more individual user interface objects (e.g., when the folder is not empty, or includes a single individual user interface object) and occupies a single placement location in the first user interface In some embodiments, while displaying the first user interface including the one or more folders and the one or more individual user interface objects, the computer system detects, via the one or more input devices, a second user input that corresponds to a request to expand a first folder of the one or more folder (e.g., an air tap gesture or air pinch gesture that is detected while attention of the user (e.g., based on gaze) is directed to the first folder). In some embodiments, other types of input that meet selection criteria can replace the air tap gesture or air pinch gesture that is detected in conjunction with a gaze input directed to a target of the air gesture. For example, in some embodiments, the second user input is an air tap gesture that is performed at the location of the first folder without requiring a gaze input. In some embodiments, the second user input is a tap gesture performed by a contact on a touch-sensitive surface or touch-screen, where the location of the contact corresponds to the location of the first folder. In some embodiments, the second user input is a click input performed by a pointing device, such as a mouse, while a focus selector of the pointing device, such as a pointer cursor, is located on the first folder. In some embodiments, the second user input is an activation of a controller, such as a button or digital crown mouse, while the first folder has input focus. In some embodiments, in response to detecting the second user input that corresponds to a request to expand the first folder of the one or more folders, the computer system displays, via the one or more display generation components, an expanded representation of the first folder in the first user interface, including displaying a second plurality of user interface objects within the expanded representation of the first folder (and optionally, reducing visual prominence of the user interface objects outside of the first folder). For example, the expanded version 92a′ of folder 92a is displayed in FIG. 9S. In some embodiments, reducing the visual prominence of the user interface objects outside of the first folder includes blurring, darkening, making more translucent, and/or reducing sizes and color saturation of, the user interface objects outside of the first folder when the first folder is expanded to show the content of the first folder (e.g., the user interface objects that are included in the first folder). For example, in FIG. 9S, visual prominence of application icons 92c-92j and passthrough portions of three-dimensional environment visible via HMD 7100a outside the expanded version 92a′ of folder 92a, is reduced. In conjunction with expanding a folder when selected, the computer system reduces visual prominence of portions of the three-dimensional environment outside the expanded folder. Reducing visual prominence of portions of the three-dimensional environment outside an expanded folder enhances the operability of the device and makes the user-device interface more efficient (e.g., by helping the user to achieve an intended result and reducing user mistakes while interacting with a folder).

In some embodiments, while displaying the first user interface, including displaying the second plurality of user interface objects within the expanded version of the first folder in the first user interface, the computer system detects (11052), via the one or more input devices, a third user input that is directed to a respective user interface object of the second plurality of user interface objects within the expanded version of the first folder, wherein the third user input includes second movement and meets the drag criteria with respect to the respective user interface object of the second plurality of user interface objects (e.g., the third user input includes an air pinch and hold gesture that meets a first duration threshold, where attention of the user (e.g., based on a gaze of the user) is directed to the respective user interface object at the start of the air pinch and hold gesture, followed by an air drag gesture while the hand moves while maintaining the pinch posture of the air pinch and hold gesture). In some embodiments, descriptions regarding the first user input that includes the first movement and that meets the drag criteria with respect to the first user interface object are also applicable to the interaction between the third user input and the respective user interface object (e.g., when the respective user interface object is an individual user interface object, and/or when the respective user interface object is a folder), and the same description is not repeated herein in the interest of brevity. Similarly, descriptions regarding the third user input and the respective user interface object are also applicable to the first user input and the first user interface object, when the first user interface object and the second user interface object are individual user interface objects within an expanded version of an existing folder (e.g., the new folder including the first user interface object and the second user interface object, if created, would be a new folder within the existing folder). In some embodiments, in response to detecting the third user input that includes the second movement and that meets drag criteria with respect to the respective user interface object of the second plurality of user interface objects: the computer system moves the respective user interface object of the second plurality of user interface object based on (e.g., in accordance with) the second movement of the third user input; in accordance with a determination that the respective user interface of the second plurality of user interface objects is within of the expanded version of the first folder, the computer system displays, via the one or more display generation components, user interface objects of the first plurality of user interface objects that are located outside of the expanded version of the first folder (e.g., including the one or more individual user interface objects and zero or more folders of the one or more folders other than the first folder) in the first user interface, with a first set of visual properties that corresponds to a reduced visual prominence as compared to the second plurality of user interface objects; and in accordance with a determination that the respective user interface of the second plurality of user interface objects is outside of the expanded version of the first folder, the computer system displays, via the one or more display generation components, the user interface objects of the first plurality of user interface objects that are located outside of the expanded version of the first folder (e.g., including the one or more individual user interface objects and zero or more folders of the one or more folders other than the first folder) in the first user interface, with a second set of visual properties that corresponds to a comparable visual prominence as compared to the second plurality of user interface objects. For example, in some embodiments, when a folder is in an expanded state with its constituent user interface objects displayed with a regular size of the constituent user interface objects, the computer allows the user to drag one of the constituent user interface object to a different placement location (e.g., an occupied placement location or an unoccupied placement location) within the expanded representation of the folder, in a manner similar to that described earlier when the first user interface object is dragged in the first user interface. In some embodiments, when the user input drags one of the constituent user interface object within the expanded representation of the folder, the content outside of the expanded representation of the folder is displayed with reduced visual prominence (e.g., blurred, darkened, and/or make more translucent) relative to the content within the expanded representation of the folder. In contrast, when the user input drags one of the constituent user interface object outside of the expanded representation of the folder, the visual prominence of the content outside of the expanded representation of the folder is increased (e.g., to a regular level), and optionally, the content within the folder is reduced in visual prominence. For example, in FIGS. 9U-9V, while application icon 9211 is moved within the bounds of expanded version 92a′ of folder 92a, portions of the three-dimensional environment visible via HMD 7100a that are outside the expanded version 92a′ of folder 92a remain visually deemphasized, and, in accordance with a determination that application icon 9212 outside the bounds of expanded version 92a′ of folder 92a (e.g., in response to the detection of movement input 980x), the computer system restores visual prominence of the portions of the three-dimensional environment that are outside the expanded version 92a′ of folder 92a. Maintaining reduced visual prominence of portions of the three-dimensional environment that are outside an expanded folder while an icon is moved with the bounds of the expanded folder, and restoring visual prominence of portions of the three-dimensional environment that are outside an expanded folder while the icon is moved out of the bounds of the expanded folder, assists the user when rearranging the folder and provides visual feedback to the user that the computer system is responding to the requests for reconfiguring contents in the folder, thereby enhancing the operability of the device and making the user-device interface more efficient (e.g., by helping the user to achieve an intended result and reducing user mistakes while creating reconfiguring contents in a folder).

In some embodiments, while the user interface objects of the first plurality of user interface objects that are located outside of the expanded version of the first folder (e.g., including the one or more individual user interface objects and zero or more folders of the one or more folders other than the first folder) are displayed with a respective set of visual properties, the computer system detects (11054), via the one or more input devices, a termination of the third user input. In some embodiments, the third user input is a long pinch and hold air gesture that is directed to the respective user interface object followed by an air drag gesture while maintaining the pinch posture of the hand, and/or the third user input is an air pinch gesture that is directed to the respective user interface object followed by a drag gesture while maintaining the pinch posture of the hand; and the termination of the third user input includes release of the pinch posture (e.g., the pinched fingers are moved apart from each other). In some embodiments, instead of or in addition to air pinch gestures, another type of air gesture or combination of air gestures are used to meet the drag criteria with respect to the respective user interface object. For example, in some embodiments, the drag criteria are met by an air tap gesture or by a long air tap gesture performed with a pointing finger or controller, followed by a movement of the tapping finger or controller; and the termination of the third user input includes an air flick or another air tap of the finger that performed the air tap gesture or the long air tap gesture. In some embodiments, the drag criteria are met by a touch hold and drag gesture performed by a contact on a touch-sensitive surface or a touch-screen, where the touch down location of the contact corresponds to the location of the respective user interface object; and the termination of the third user input includes the lift off of the contact from the touch-sensitive surface or touch-screen. In some embodiments, the drag criteria are met by a click hold and drag input performed by a pointing device, such as a mouse, where the click input is detected while a focus selector of the pointing device, such as a pointer cursor, is on the respective user interface object; and the termination of the first user input includes the release of the hold input (e.g., lift-off of the finger that pressed and held the mouse button). In some embodiments, in response to detecting the termination of the third user input: in accordance with a determination that the user interface objects of the first plurality of user interface objects that are located outside of the expanded version of the first folder (e.g., including the one or more individual user interface objects and zero or more folders of the one or more folders other than the first folder) are displayed with the first set of visual properties that corresponds to a reduced visual prominence as compared to the second plurality of user interface objects (e.g., because the respective user interface object is still within the expanded representation of the first folder), the computer system places the respective user interface object (e.g., in a placement location that corresponds to the location of the respective user interface object at the termination of the third user input) within the expanded representation of the first folder; and in accordance with a determination that the user interface objects of the first plurality of user interface objects that are located outside of the expanded version of the first folder (e.g., including the one or more individual user interface objects and zero or more folders of the one or more folders other than the first folder) are displayed with the second set of visual properties that corresponds to a comparable visual prominence as compared to the second plurality of user interface objects (e.g., because the respective user interface object is moved outside of the expanded representation of the first folder), the computer system places the respective user interface object (e.g., in a placement location that corresponds to the location of the respective user interface object at the termination of the third user input) outside the expanded representation of the first folder. For example, in FIGS. 9U-9V and FIGS. 9W-9Z, while dragging application icon 9211 from expanded version 92a′ of folder 92a, if application icon 9211 is dropped while portions of the three-dimensional environment outside the bounds of expanded version 92a′ of folder 92a remain visually deemphasized, the computer system 101 inserts application icon 9211 back into expanded version 92a′ of folder 92a, and, if application icon 9211 is dropped while portions of the three-dimensional environment outside the bounds of expanded version 92a′ of folder 92a are displayed with restored visual prominence, the computer system 101 inserts application icon 9211 in applications view 9100b outside folder 92a. Disambiguating between removing an icon from an expanded folder (optionally, inserting the removed icon in the home user interface) and repositioning the icon within the expanded folder based on whether visual prominence of the portions of three-dimensional environment outside the folder is reduced or not, respectively, provides visual feedback to the user that the computer system is responding to the requests for reconfiguring contents in the folder, thereby enhancing the operability of the device and making the user-device interface more efficient (e.g., by helping the user to achieve an intended result and reducing user mistakes while creating reconfiguring contents in a folder).

In some embodiments, the second plurality of user interface objects included in the first folder corresponds to a first total object count, and wherein displaying the second plurality of user interface objects within the expanded representation of the first folder includes (11056): in accordance with a determination that the first total object count is less than (and, optionally, equal to) a first threshold object count, displaying, via the one or more display generation components, the second plurality of user interface object within the expanded representation of the first folder according to a first set of layout properties (e.g., according to a first grid shape, a first grid size, with label, without label, with a first icon size, with a first grid density, and/or other first spatial arrangement); and in accordance with a determination that the first total object count is greater than (and, optionally, equal to) the first threshold object count, displaying, via the one or more display generation components, the second plurality of user interface object within the expanded representation of the first folder according to a second set of layout properties (e.g., according to a second grid shape, a second grid size, with label, without label, with a second icon size, with a second grid density, and/or other second spatial arrangement) that is different from the first set of layout properties. In some embodiments, the first set of layout properties and the second set of layout properties respective includes different grid shapes, such as square grid, rectangular grid, triangular grid, and/or hex grid. For example, icons 90b and 90c in folder 920 are arranged in a side-by-side layout (e.g., in FIG. 9J); icons 9212-9218 in folder 92b are arranged in a layout that corresponds to a triangle shape (e.g., in FIG. 9Q); and icons 9202-9212 in folder icon 92a are arranged in a layout that corresponds a hex grid (e.g., in FIG. 9Q). For example, icons 90b and 90c in folder 920 are arranged in a side-by-side layout (e.g., in FIG. 9J); icons 9212-9218 in folder 92b are arranged in a layout that corresponds to a triangle shape (e.g., in FIG. 9Q); and icons 9202-9212 in folder icon 92a are arranged in a layout that corresponds a hex grid (e.g., in FIG. 9Q). Displaying icons in folders different layouts based on the number of icons in the folder, provide additional visual feedback to the user about the contents in the folder, thereby enhancing the operability of the device and making the user-device interface more efficient (e.g., by helping the user to achieve an intended result and reducing user mistakes while creating a folder and/or rearranging the home user interface).

In some embodiments, the first plurality of user interface objects includes (11058) a first category of one or more user interface objects (e.g., “native” applications that are originally designed and tested for the operating system and/or hardware of the computer system) and a second category of one or more user interface objects (e.g., “compatible” applications that are originally designed and tested for another operating system and/or hardware other than the operating system and/or hardware of the computer system, but are operable with acceptable, but less than optimized performance (e.g., do not utilize many of the capabilities of) on the operating system and/or hardware of the computer system). In some embodiments, displaying the first plurality of user interface objects includes: displaying, via the one or more display generation components, the one or more user interface objects from the first category of one or more user interface objects with a first set of appearance properties (e.g., a first shape, size, and/or color palette); and displaying, via the one or more display generation components, the one or more user interface objects from the second category of one or more user interface objects with a second set of appearance properties (e.g., a second shape, size, and/or color palette) different from the first set of appearance properties. For example, application icons 94a-941 representing “compatible” applications have different appearance (e.g., a different shape, size, and/or color palette) than application icons 92c-92j representing “native” applications (e.g., optionally, regardless of whether the respective icons for “native” and “compatible” applications are displayed inside folders or on the home screen user interface 8100 (e.g., outside folders), as described with reference to FIGS. 9AB and 9AF. Displaying icons representing a first category of applications with different appearance from icons representing a second category of applications, provides visual feedback to the user with respect to the category of applications represented by respective icons, thereby reducing the number of inputs and/or time needed to locate and/or open a target application.

In some embodiments, the one or more user interface objects of the first category of one or more user interface objects correspond to (11060) one or more native applications of the computer system, and the one or more user interface objects of the second category of one or more user interface objects correspond to non-native applications that are compatible with the computer system. For example, application icons 94a-941 representing “compatible” applications have different appearance (e.g., a different shape, size, and/or color palette) than application icons 92c-92j representing “native” applications (e.g., optionally, regardless of whether the respective icons for “native” and “compatible” applications are displayed inside folders or on the home screen user interface 8100 (e.g., outside folders), as described with reference to FIGS. 9AB and 9AF. In some embodiments, native applications of the computer system include applications that are pre-installed on the computer system, and/or applications that include features that utilize the capabilities of the computer system, such as the capabilities related to the three-dimensional nature of the environment, and/or behaviors of the operating system that distinguish the operating system of the computer system from other operating systems that are not installed on the computer system. In some embodiments, some native applications are installed on the computer system by a user, apart from the native applications that are pre-installed onto the computer system by a manufacturer of the computer system. In some embodiments, non-native applications are applications that are not pre-installed on the computer system and are installed on the computer system by a user. In some embodiments, non-native applications include applications that are designed to function on one or more other operating systems that are not installed on the computer system, but are capable of functioning on the computer system in a manner that does not utilize the full capabilities of the computer system, such as the capabilities related to the three-dimensional nature of the environment and/or behaviors of the operating system that distinguish the operating system of the computer system from the other operating systems that are not installed on the computer system. Displaying icons representing “compatible” applications with different appearance from icons representing “native” applications, provides visual feedback to the user with respect to with respect to compatibility of application with the operating system, thereby reducing the number of inputs and/or time needed to locate and/or open a target application.

In some embodiments, displaying the one or more user interface objects of the second category of one or more user interface objects (e.g., at a time while no user interface object is being dragged (e.g., moving or held stationary based on a user input that meets the drag criteria) in the first user interface) includes (11062): in accordance with a determination that a respective user interface object of the second category of one or more user interface objects is outside of a designated folder for the second category of one or more user interface objects, displaying, via the one or more display generation components, the respective user interface object of the second category of one or more user interface objects with a third set of appearance properties (e.g., a third shape, size, color palette, and/or material); and in accordance with a determination that the respective user interface object of the second category of one or more user interface objects is within of the designated folder for the second category of one or more user interface objects, displaying, via the one or more display generation components, the respective user interface object of the second category of one or more user interface objects with a fourth set of appearance properties (e.g., a fourth shape, size, color palette, and/or material) different from the third set of appearance properties, when an expanded representation of the designated folder is displayed in the first user interface. In some embodiments, when the icons for the second category of applications (e.g., the non-native applications and/or user-installed applications) are outside of a designated folder (e.g., the folder for holding non-native applications and/or user-installed applications when the non-native applications and/or user-installed applications are deleted or removed from display in the first user interface), the computer system displays the application icons for those applications with a first appearance (e.g., in a circular glass icon, and/or with an outline that mimics the appearance of the icons for native applications and/or pre-installed applications); and when the icons for the second category of applications are inside of the designated folder, the computer system displays the icons for those applications with a second appearance (e.g., a rounded square icon, and/or without the outline that mimics the appearance of the icons for native applications and/or pre-installed applications). For example, in FIGS. 9AB and 9AD, when application icon 94k, representing a “compatible” application, is displayed inside folder 92k, for “compatible” applications, application icon 94k is displayed with first appearance (e.g., a square or polygonal icon), and when application icon 94k is displayed outside folder 92k, on the home user interface 8100, application icons 94k has a second appearance (e.g., a circular glass icon). Displaying icons of a respective application category with different appearance depending on whether the icons are displayed in a folder or outside the folder, reduces the amount of time needed to distinguish between the icons corresponding to applications of the respective application category from other icons in the home screen user interface, thereby enhancing the operability of the device and making the user-device interface more efficient (e.g., by helping the user to achieve an intended result and reducing user mistakes while creating a folder and/or rearranging the home user interface).

In some embodiments, while displaying the expanded representation of the first folder in the first user interface, including displaying the second plurality of user interface objects within the expanded representation of the first folder, the computer system detects (11064), via the one or more input devices, attention of the user (e.g., based on gaze of the user, and/or other indications of the target location of the attention of the user) directed to a first portion of the expanded representation of the first folder, wherein the first portion of the expanded representation of the first folder corresponds to a title of the first folder; and while detecting the attention of the user directed to the first portion of the expanded representation of the first folder, detecting, via the one or more input devices, a first air gesture that meets first criteria (e.g., detecting an air pinch gesture, or detecting an air tap gesture). In some embodiments, in response to detecting the first air gesture while detecting the attention of the user directed to the first portion of the expanded representation of the first folder, the computer system displays, via the one or more user display generation components, an editing user interface for editing the title of the first folder (e.g., displays a virtual keyboard, displays the title in a textual input field with a cursor, displays selectable options for changing the font, size, and/or color of the title text, and/or displays other options for editing the title of the first folder). In some embodiments, the computer system detects, via the one or more input devices, one or more editing inputs directed to the editing user interface for editing the title of the first folder (e.g., one or more typing inputs directed to a physical or virtual keyboard), and updates the title of the first folder based on the one or more editing inputs. For example, in FIG. 9S, an air pinch gesture 980s detected while gaze input 982s is directed toward label 921 of expanded version 92a′ of folder 92a causes the computer system 101 to initiate a process for editing label 921, including activating a text editing mode (e.g., activating a text editing mode optionally includes moving a cursor, highlighting the label, displaying a virtual keyboard and/or other actions for editing label 921). Using user's gaze to move input focus to a folder title and using air pinch gesture to active an editing operation with respect to the folder title, provides an ergonomic and efficient way for a user to change a folder's title in the three-dimensional environment (e.g., by reducing the number of inputs and/or amount of time needed to change a folder's title).

In some embodiments, in response to detecting the first user input that meets the drag criteria with respect to the first user interface object, in accordance with a determination that confirmation criteria are met by the first user input while the first user interface object is within the first threshold distance of the second user interface object, the computer system displays (11066), via the one or more display generation components, a third animated movement of a preview of the folder toward the first user interface object, before displaying the folder including the first user interface object and the second user interface object at the second placement location. In some embodiments, the first user interface object is within the first threshold distance of the second user interface object as a result of the second user interface object moving toward the first user interface object after having moved relative to the second placement location away from the first user interface object. In some embodiments, the confirmation criteria are met when the first user input is terminated while the first user interface object is within the first threshold distance of the second user interface object, the second user interface object has stopped moving away from the first user interface object, and the process for creating a folder is initiated. In some embodiments, the confirmation criteria are met when the first user input is terminated (e.g., the pinch posture of the hand that performs the air pinch and drag gesture is released), and/or the first user input is held substantially stationary for at least a threshold amount of time (e.g., the air drag gesture is stopped, and/or has less than a threshold amount of movement in a threshold time window for at least a threshold amount of time), when the distance between the first user interface object and the second user interface object is less than the first threshold distance, and/or when the preview of the folder is displayed. For example, in accordance with a determination that application icon 90c and 90b remain within less than threshold distance from one another for more than a threshold amount of time, the computer system 101 generates folder preview icon 920a that initially appears to swallow application icon 90b (e.g., by moving folder preview icon 920a toward application icon 90b or by moving application icon 90b into folder preview icon 920a). Further, after folder preview icon 920a appears to have swallowed application icon 90b, folder preview icon 920a appears to further swallow application icon 90a (e.g., by expanding folder preview icon 920a to include application icon 90c and/or by moving folder preview icon 920a toward application icon 90c). After folder creation process with respect to a first icon and a second icon has been initiated, including displaying a folder preview icon, and in accordance with a determination that the folder creation process has not been cancelled (e.g., the first and second icons remain within less than the threshold distance away from one another before the expiration of a time period), the computer system pulls the second icon into the folder preview icon (e.g., the folder preview icon appears to swallow the second icon), thereby continuously providing visual feedback that the folder creation process has been initiated and has not yet been cancelled. Proving visual feedback to the user that the folder creation process has not been cancelled, reduces the number of inputs and/or amount of time needed to create a folder or rearrange the home user interface (e.g., by helping the user to achieve an intended result and reducing user mistakes while creating a folder and/or rearranging the home user interface).

In some embodiments, detecting the first user input that is directed to the first user interface object and that meets the drag criteria includes (11068) detecting an initial portion of the first user input (e.g., an air pinch and hold gesture detected in conjunction with a gaze directed to the first user interface object) and detecting, via the one or more input devices, a termination of the first user input (e.g., the release of the pinch posture, after the air drag gesture performed by the pinching hand). In some embodiments, in response to detecting the initial portion of the first user input (e.g., the portion of the first input that selects and picks up the first user interface object), the computer system outputs, via one or more output devices of the computer system (e.g., via one or more speakers, one or more headphones, one or more earbuds, and/or one or more tactile output generators), a first non-visual output having a first output profile (e.g., a first sound having a first wave pattern, frequency, phase, and/or accompanying tactile output); and in response to detecting the termination of the first user input (e.g., the portion of the first input that drops off the first user interface object), the computer system outputs, via the one or more output devices of the computer system, a second non-visual output having a second output profile (e.g., a second sound having a second wave pattern, frequency, phase, and/or accompanying tactile output) that is different from the first output profile (e.g., the first non-visual output differs from the second non-visual output in terms of frequencies, amplitudes, wave patterns, and other audio and/or tactile output properties). In some embodiments, the timing of the non-visual outputs is synchronized with the time that the criteria for picking up the first user interface object are met and the time that the criteria for dropping off the first user interface object are met. In some embodiments, the timing of the non-visual outputs is synchronized with the time that the first user interface object is dislodged from the first placement location and the time that the first user interface object settles into a new placement location (e.g., inside a folder, or outside of a folder). For example, in FIG. 9F, the selection sound G generated for selecting application icon 90c is different from the release sound G′ generated for releasing the selected application icon 90c (e.g., in FIG. 9J). Providing different audio feedback when an icon is grabbed from when the icon is released, provides audio feedback to the user that the computer system is responding to user's inputs, thereby enhancing the operability of the device and making the user-device interface more efficient (e.g., by helping the user to achieve an intended result and reducing user mistakes when operating/interacting with the device).

In some embodiments, in response to detecting the first user input, the computer system: generates (11070), via the one or more output devices of the computer system, a third non-visual output (e.g., an audio output or a tactile output) based on movement of the second user interface object relative to the second placement location (e.g., an audio output that is played when the second user interface object is dislodged from the second placement location), as a result of a movement of the first user interface object toward the second user interface object. For example, in FIG. 9G, in accordance with a determination that adjacent application icon 90b is dislodged from its placement location as a result of being pushed by the dragged application icon 90c, the computer system 101 generates and outputs a distinctive sound to indicate that application icon 90b is dislodged. Providing audio feedback when an icon moves as a result of another icon being dragged and/or repositioned in the home user interface, provides audio feedback that icons other than the icon that is being dragged are automatically rearranged by the computer system, thereby enhancing the operability of the device and making the user-device interface more efficient (e.g., by helping the user to achieve an intended result and reducing user mistakes when operating/interacting with the device).

In some embodiments, generating the third non-visual output based on the movement of the second user interface object relative to the second placement location includes (11072): in accordance with a determination that the second placement location is located in a first region of the first user interface (e.g., the first region having a first spatial relationship to the viewpoint of the user), generating the third non-visual output with a first set of spatial characteristics that corresponds to the first region of the first user interface (e.g., the third non-visual output has a simulated source location in the first region of the first user interface); and in accordance with a determination that the second placement location is located in a second region of the first user interface different from the first region of the first user interface (e.g., the second region having a second spatial relationship to the viewpoint of the user, different from the first spatial relationship to the viewpoint of the user), generating the third non-visual output with a second set of spatial characteristics that corresponds to the second region of the first user interface (e.g., the third non-visual output has a simulated source location in the second region of the first user interface), the second set of spatial characteristics differ from the first set of spatial characteristics. In some embodiments, as the first user interface object is dragged to different regions of the first user interface, causing user interface objects located in different placement locations to dislodge and move relative to their respective placement locations, the computer system generates spatial audio feedback with spatial characteristics indicating the region(s) from which the user interface objects are being dislodged by the movement of the first user interface objects. For example, in FIGS. 9M-90 while application icon 90c is selected, the computer system 101 generates and outputs a selection sound, and when application icon 90c is subsequently dragged in applications view 9100a (e.g., toward dimmed application icon 90l), the computer system generates a movement sounds that has a spatial audio effect in that the movement sounds seems to move along or according to the movement of the dragged application icon 90c. Spatializing audio feedback simulates a more realistic listening experience in which audio seems to come from sources of sound in a particular frame of reference, such as the physical environment surrounding the user, and/or the three-dimensional environment surrounding the viewpoint of the user. For example, the third non-visual feedback is provided as spatial audio from a simulated location corresponding to the relative location of the second placement location from the user in the three-dimensional environment. In an example, when spatial audio is enabled, the audio that is output from the audio output device (e.g., earbuds or HMD) sounds as though the respective audio for respective objects (e.g., real-world objects, and/or virtual objects) are coming from different simulated spatial locations (which may change over time) in a frame of reference, such as a physical environment and/or the three-dimensional environment. The positioning (e.g., simulated spatial locations) of the real-world objects and virtual objects is independent of movement of audio output device (e.g., earbuds or HMD) relative to the frame of reference. As an example, the simulated spatial locations of the one or more real-world objects and/or virtual objects in the three-dimensional environment, when fixed, are fixed relative to the frame of reference, and, when moving, move relative to the frame of reference. For example, where the frame of reference is a physical environment, the one or more real-world objects have respective simulated spatial locations in the physical environment. Where the frame of reference is a three-dimensional extended reality environment, the one or more virtual objects have respective simulated spatial locations in the three-dimensional extended reality environment. As the audio output device, such as the earbuds or HMD, moves about the three-dimensional environment, due to movement of the user, the audio output from the audio output device is automatically adjusted so that the audio continues to sound as though it is coming from the one or more real-world objects or virtual objects at their respective spatial locations in the three-dimensional environment. As the one or more objects move through a sequence of spatial locations about the three-dimensional environment, the audio output from the audio output device, such as the earbuds or HMD, is adjusted so that the audio continues to sound as though it is coming from the objects at the sequence of spatial locations in the three-dimensional environment. Such adjustment for moving sound sources also takes into account any movement of the audio output device relative to the three-dimensional environment. For example, if the audio output device moves relative to the physical environment along an analogous path as a moving object in the three-dimensional environment so as to maintain a constant spatial relationship with the object in the three-dimensional environment, the audio would be output so that the sound does not appear to move relative to the audio output device. Providing spatial feedback enhances the operability of the device and makes the user-device interface more efficient (e.g., by helping the user to achieve an intended result and reducing user mistakes when operating/interacting with the device), which, additionally, reduces power usage and improves battery life of the device by enabling the user to use the device more quickly and efficiently.

In some embodiments, aspects/operations of methods 10000, 11000, and 12000 may be interchanged, substituted, and/or added between these methods. For brevity, these details are not repeated here.

FIG. 12 illustrates a flow diagram of an exemplary method 12000 for generating sounds associated with folder creation operations and other operations performed with respect user interface objects in a three-dimensional environment, in accordance with various embodiments. In some embodiments, method 12000 is performed at a computer system (e.g., computer system 101 in FIG. 1) that is in communication with one or more display generation components (e.g., display generation component 120 in FIGS. 1A, 3A, and 4, or HMD 7100a in FIGS. 7, 8A-8AL, and 9A-9AS) (e.g., a heads-up display, a display, a touchscreen, a projector, etc.), one or more audio output devices (e.g., electronic component 1-112), and one or more input devices (e.g., including one or more sensors and devices for detecting user inputs, such as one or more sensors in sensor assembly 1-356, and/or FIG. 1I). The one or more input devices optionally include a camera (e.g., color sensors, infrared sensors, and other depth-sensing cameras) that points downward at a user's hand or a camera that points forward from the user's head). In some embodiments, the computer system is further in communication with one or more output devices other than the one or more display generation component, such as one or more output devices that provide non-visual outputs. In some embodiments, the one or more output devices that provide non-visual outputs include one or more audio output devices, such as one or more speakers, one or more headphones, and/or one or more earbuds. In some embodiments, the one or more output devices that provide non-visual output devices include one or more tactile output generators, such as one or more localized tactile output generators that provide localized tactile outputs at selected locations, and one or more generalized or non-localized tactile outputs throughout multiple components and/or portions of the computer system. In some embodiments, the computer system operates the display generation component, the audio output devices, and the tactile output generators independently of one another when generating outputs; and sometimes, the computer system coordinates the visual outputs, audio outputs and/or tactile outputs to provide feedback to the user regarding the response to the user inputs and/or the state(s) of the computer system. For example, the timing, duration, magnitude, phase, pattern, and/or other characteristics of the outputs are correlated based on the timing, duration, magnitude, phase, pattern, and/or other characteristics of the inputs, the response, and/or the feedback types. In some embodiments, the method 12000 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 12000 are, optionally, combined and/or the order of some operations is, optionally, changed.

The devices, methods, and/or computer-readable storage mediums described below enhance the operability of the device and makes the user-device interface more efficient (e.g., by helping the user to provide proper inputs and reducing user mistakes when operating/interacting with the device) which, additionally, reduces power usage and/or improves battery life of the device by enabling the user to use the device more quickly and efficiently. As described herein, the method 12000 generates various audio outputs indicative of operations associated with creating a folder, including creating a folder, initiating a process for creating a folder, cancelling a folder creation process, dropping a user interface object into a folder and/or outside a folder, and other audio outputs indicative of operations associated with moving a user interface object through different sections (and/or groups of objects) of a home screen user interface. Providing improved audio feedback (such as by generating audio output indicative of an operation associated with creating a folder, including audio output indicative of initiating a process for creating a folder, audio output indicative of creating a folder, audio output indicative of cancelling a folder creation process, dropping a user interface object into a folder and/or outside a folder, and/or by generating audio output indicative of other operations performed with respect to a user interface object, including operations associated with moving a user interface object through different sections (and/or groups of objects) of a home screen user interface) enhances the operability of the device by reducing accidental and mistaken inputs, reducing energy usage by the device. Generating various audio outputs indicative of operations associated with creating a folder and/or indicative of operations performed with respect to user interface objects in a home user interface provides audio feedback to a user about a state of the computer system and whether and how is the computer system responding to user inputs, thereby reducing accidental and mistaken inputs and, optionally, prompting the user to adjust their inputs which reduces energy usage, and improves battery life for battery powered devices.

While displaying, via the one or more display generation components, a user interface (e.g., a view of a home user interface, such as applications views 9100a and 9100b of home user interface 8100 in FIGS. 9A-9AS) in a reconfiguration mode, including displaying a first plurality of user interface objects (e.g., a collection of application icons, contact icons, environment icons, and/or other icons of a same type), the computer system detects (12002), via the one or more input devices, a user input (e.g., a touch input, a mouse input, and/or an air gesture) that corresponds to a request to move an object (e.g., the user input drags a first user interface object toward a second user interface object of the plurality of user interface objects displayed in the user interface). In some embodiments, the plurality of user interface objects are displayed in an environment (e.g., a two-dimensional user interface or a three-dimensional environment such as a three-dimensional virtual reality environment, a three-dimensional augmented reality environment, and/or a three-dimensional extended reality environment). In response to detecting (12003) the user input that corresponds to the request to move the object, the computer system moves (12004) the object. For example, as described with reference to FIGS. 9F-9J, in response to the detection of movement input 980g, the computer system 101 moves application icon 90c toward a location of application icon 90b in applications view 9100a. In response to detecting (12003) the user input that corresponds to the request to move the object, in accordance with a determination that the user input meets folder-creation criteria, the computer system generates (12006), via the one or more audio output devices, an audio output indicative of an operation associated with creating a folder. In one example, as described with reference to FIG. 9I, in conjunction with initiating a folder creation process (e.g., by displaying the folder preview icon 920a), the computer system 101 generates and/or outputs a sound 9900 indicative of initiating the folder-creation process. In another example, as described with reference to FIG. 9J, in conjunction with creating a folder and/or displaying the folder icon 920, the computer system 101 generates a sound 9902 indicative of creating a folder. In some embodiments, the user input drags a first user interface object toward a location of a second user interface object of the plurality of user interface objects displayed in the user interface. In some embodiments, the folder-creation criteria are met in accordance with a determination that the user input causes the computer system to maintain less than a threshold distance between the first user interface object (e.g., dislodged from a corresponding location in the user interface) and the placement location of the second user interface object for more than a threshold of time. In some embodiments, in accordance with a determination that the folder-creation criteria are met, a folder creation process with respect to the first user interface object and the second user interface object is initiated. In some embodiments, the folder-creation criteria are not met in accordance with a determination that, in response to the user input, the computer system does not maintain the threshold distance between the first user interface object and the placement location of the second user interface object for more than the threshold of time.

In some embodiments, in accordance with a determination that the first input does not meet the folder-creation criteria, the computer system forgoes performing the operation associated with creating the folder and forgoes generating the audio output indicative of the operation associated with creating the folder.

In some embodiments, when a reconfiguration mode of a user interface is active, positions and/or availability of icons displayed in the user interface can be adjusted in response to user inputs, as described in further detail in relation to FIGS. 8A-8L, 10A-10M and method 10000. In some embodiments, the plurality of user interface objects are visible in a view of a three-dimensional environment and are arranged in a preset arrangement, as described in further detail in relation to FIG. 8A. In some embodiments, the user input that corresponds to the request for performing an operation associated with creating a folder and the folder-creation criteria are described in further detail in relation to FIGS. 9A-9AF, 11A-11K and method 11000. For example, the user input selects the first user interface object (e.g., via an air pinch, a pinch and hold, an air tap, or other selection input directed toward the first user interface object) and moves the first user interface object (e.g., via a drag input or movement input while maintaining selection of the first user interface object such as maintaining an air pinch gesture, maintaining a button press state, and/or maintaining a touch down state) from a first placement location of the first user interface object to a second placement location of the second user interface object.

In some embodiments, various audio outputs are described as being generated “in conjunction” with performing an operation. It should be understood that generating an audio output in conjunction with performing an operation (e.g., different from the generation of the audio output) includes generating the audio output after performing the operation, before performing the operation, in response to performing the operation, or in response to an event that cause the computer system to perform the operation, substantially simultaneously with performing the operation, or concurrently with performing the operation.

In some embodiments, in response to detecting the user input that corresponds to the request to move the object, and in accordance with the determination that the user input meets the folder-creation criteria, the computer system displays a visual prompt indicating initiation of a folder creation process without creating a folder (e.g., or more generally, performing an operation associated with creating a folder, optionally in conjunction with generating the audio output indicative of the operation associated with creating a folder, wherein performing the operation associated with creating a folder includes the displaying of the visual prompt). In some embodiments, the audio output is generated in conjunction with displaying the visual prompt indicating initiation of the folder creation process. In some embodiments, in response to detecting the user input that corresponds to the request to move the object, in accordance with the determination that the user input does not meet the folder-creation criteria, the computer system moves the object without displaying a visual prompt indicating the initiation of a folder creation process. In some embodiments, the visual prompt indicating initiation of the folder creation process is a folder preview icon (e.g., folder preview icon 920a in FIG. 9I); a selection option displayed in a prompt dialog or in a menu; and/or other visual indication that provides visual feedback to a user that a folder creation process has been initiated, and/or that provides an opportunity to a user to either cancel the folder creation process or to confirm and/or complete the folder creation process. In some embodiments, the folder preview icon includes the second user interface object toward which the first user interface object was being dragged. For example, as described with reference to FIG. 9I, in response to movement input 980g (e.g., in FIG. 9G) that corresponds to a request to move application icon 90c and in accordance with a determination that the movement input 980g meets the folder-creation criteria, the computer system 100 displays folder preview icon 920a that indicates initiation of a folder creation process and outputs a sound 9900 indicative of initiating the folder-creation process.

In some embodiments, in response to detecting the user input that corresponds to the request to move the object, and in accordance with the determination that the user input meets the folder-creation criteria, the computer system creates a respective folder (e.g., or more generally, performing an operation associated with creating a folder, optionally in conjunction with generating the audio output indicative of the operation associated with creating a folder, wherein performing the operation associated with creating a folder includes the creating of the respective folder). The audio output is generated in conjunction with creating the respective folder. For example, as described with reference to FIG. 9J, in conjunction with creating a folder and/or displaying the folder icon 920, the computer system 101 generates a sound 9902 indicative of creating a folder. In some embodiments, in response to detecting the user input that corresponds to the request to move the object, in accordance with the determination that the user input does not meet the folder-creation criteria, the computer system moves the object without creating the respective folder (e.g., without displaying a folder icon). In some embodiments, the audio output is a spatial audio output, such that a perception or sensation is created that a sound is coming from a respective location in a three-dimensional environment corresponding to a location of the respective folder.

In some embodiments, the user input that corresponds to the request to move the object includes a first portion and a second portion. In some embodiments, in response to detecting the first portion of the user input that meets first criteria, the computer system displays a visual prompt indicating initiation of a folder creation process and generates, via the one or more audio output devices, in conjunction with displaying the visual prompt, a first audio output indicative of the initiation of the folder creation process. In some embodiments, the first portion of the user input selects the first user interface object (e.g., via an air pinch, a pinch and hold, an air tap, or other selection input directed toward the first user interface object) and moves the first user interface object (e.g., via a drag input while maintaining selection of the first user interface object) from a first location of the first user interface object to a second location of the second user interface object. In some embodiments, the first criteria are met in accordance with a determination that less than a threshold distance is maintained between the first user interface object and the second user interface object for at least a threshold amount of time, or that the first user interface object is maintained substantially stationary within less than the threshold distance from the second user interface object for at least the threshold amount of time. In some embodiments, in response to detecting the second portion of the user input that meets second criteria, the computer system creates a folder, including displaying a folder icon, and generates, via the one or more audio output devices, in conjunction with creating the folder, a second audio output indicative of the folder creation, wherein the second audio output is different from the first audio output. For example, as described with reference to FIGS. 9I-9J, the sound 9900 indicative of initiating the folder-creation process and the sound 9902 indicative of creating a folder are different sounds (e.g., in terms of volume, frequency, wave pattern, duration, and/or other audio characteristics). In some embodiments, the second criteria are met in accordance with a determination that the first user interface object is released at a location in the first user interface object that corresponds to a folder preview icon (e.g., a temporary folder created to indicate initiation of the folder creation process). For example, the computer system completes the folder creation process in response to detecting the second portion of the user input that includes dropping the first user interface object into the folder preview icon. In some embodiments, the computer completes the folder creation process in response to detecting that less than a threshold distance is maintained between the first user interface object and the folder preview icon for at least a threshold amount of time (e.g., 0.5, 1, 1.5, 2.0, 2.5, 3.0 seconds and/or other threshold amount of time) and/or in response to detecting that the first user interface object is maintained substantially stationary within the threshold distance from the folder preview icon for at least the threshold amount of time. In some embodiments, the second criteria are not met in accordance with a determination that the first user interface object is released at a location in the user interface that is different from the location that corresponds to the folder preview icon. In some embodiments, the second criteria are not met in accordance with a determination that, after the folder preview icon is displayed, the first user interface object is moved more than a threshold distance away from the location that corresponds to the folder preview icon. In some such scenarios, the computer system cancels the folder creation process and ceases display of the folder preview. In some embodiments, the first audio output is generated with a first audio output profile (e.g., a first set of one or more frequencies, magnitudes, patterns, duration, and/or other audio characteristics) that correspond to or are indicative of the initiation of the folder creation process, and the first audio output is same or different from second audio output that is generated with a second audio output profile (e.g., a second set of one or more frequencies, magnitudes, patterns, duration, and/or other audio characteristics) and that is indicative of the folder creation. In some embodiments, the first audio output and/or the second audio output are optionally generated with spatial audio effects. In some embodiments, the first audio output indicative of the initiation of the folder creation process is a spatial audio output, such that a perception or sensation is created that a sound is coming from a respective location in a three-dimensional environment corresponding to a location of the folder preview icon. In some embodiments, the second audio output indicative of the folder creation is a spatial audio output, such that a perception or sensation is created that a sound is coming from a respective location in a three-dimensional environment corresponding to the created folder.

In some embodiments, the object is a first user interface object of the plurality of user interface objects. In some embodiments, the user input is directed toward the first user interface object, and a start of the user input is detected while the first user interface object is displayed at a first location in the user interface and a second user interface object is displayed at a second location in the user interface. In some embodiments, the user input includes movement. In some embodiments, in response to detecting the movement, the computer system moves the first user interface object away from the first location toward the second location of the second user interface object. For example, as described with reference to FIGS. 9F-9J, the movement input 980g includes dragging or moving application icon 90c toward a location of application icon 90b in applications view 9100a.

In some embodiments, the computer system detects, via the one or more input devices, a second user input directed toward a third user interface object of the plurality of user interface objects (e.g., the third user interface object is the object that is moved in response the user input, the third user interface object is the first user interface object that is moved towards the second user interface object in response to the user input, the third user interface object is the second user interface object toward which the first user interface object is moved in response to the user input, and/or other user interface object in the user interface). In some embodiments, the second input corresponds to a request to move the third user interface object from a first respective location to a second respective location in the user interface. In some embodiments, the second user input directed toward the third user interface object corresponds to the user input that corresponds to the request to move the object (e.g., the user input in response to which the audio output indicative of the operation associated with creating a folder is generated). In some embodiments, the computer system detects, via the one or more input devices, a termination of the second user input (e.g., a lift off input, a release of a pinch, a touch-up input, and/or a mouse button release), wherein the termination of the second user input is detected while the third user interface object is at the second respective location. In some embodiments, in response to detecting the termination of the second user input, the computer system releases the third user interface object, including, in accordance with a determination that the second respective location corresponds to a folder (e.g., a folder that is permanently created or a temporary folder created to indicate that a folder creation process has been initiated) that is displayed in the user interface, generating, via the one or more audio output devices, a third audio output (e.g., in conjunction with releasing the third user interface object in the folder); and, in accordance with a determination that the second respective location does not correspond to a folder, generating, via the one or more audio output devices, a fourth audio output (e.g., in conjunction with releasing the third user interface object in the user interface at a location that does not corresponds to a folder), wherein the fourth audio output is different from the third audio output. In some embodiments, the computer system generates one sound to indicate that an object is dropped into a folder and a different sound to indicate that the object is dropped outside the folder. In one example, as described with reference to FIG. 9Z, the sound 9906 indicative of dropping an application icon outside a folder icon and/or a folder preview icon is different from the sound 9902 indicative of dropping an application icon into a folder preview icon (e.g., as described with reference to FIG. 9J) and/or a sound 9913 indicative of dropping an application icon into a folder (e.g., as described with reference to FIGS. 9AK-9AL). In some embodiments, methods for expanding a folder and operations performed with respect to an expanded folder are described in further detail in relation to FIGS. 9Q-9Z and method 11000 of FIGS. 11A-11K.

In some embodiments, in response to detecting the termination of the second user input and in accordance with the determination that the second respective location corresponds to the folder, the computer system releases the third user interface object in the folder, including: in accordance with a determination that the folder is in an expanded state at a time the termination of the second user input is detected, generating, via the one or more audio output devices, in conjunction with releasing the third user interface object in the folder in the expanded state, the third audio output; and, in accordance with a determination that the folder is not in the expanded state at the time the termination of the second user input is detected, generating, via the one or more audio output devices, in conjunction with releasing the third user interface object in the folder in the expanded state, the third audio output. In some embodiments, the audio output generated to indicate that an object is dropped into a folder is the same irrespective of whether the object is dropped into a folder in an expanded state or non-expanded state. For example, as described with reference to FIG. 9AL, the sound 9913 generated for dropping application icon 92j into folder 92b, which is in an expanded state, is optionally the same sound that would be generated if application icon 92j were dropped into folder 92b while folder 92b is not expanded.

In some embodiments, in response to detecting the user input that corresponds to the request to move the object, the computer system moves the object to a location that corresponds to a folder displayed in the user interface, including, in accordance with a determination that the object is maintained at the location that corresponds to the folder for at least a threshold amount of time, opening the folder (e.g., springing open the folder and, optionally, revealing previously undisplayed content of the folder) and generating, via the one or more audio output devices, an audio output indicative of folder opening. For example, as described with reference to FIG. 9AK, in conjunction with opening folder 92b, the computer system 101 generates sound 9911 indicative of folder opening. In some embodiments, in accordance with a determination that the object is not maintained at the location that corresponds to the folder for at least the threshold amount of time, the computer system does not open the folder (e.g., maintains display of the second folder in a non-expanded state), and the computer system forgoes generating and/or outputting the audio output indicative of folder opening. In some embodiments, a same audio output indicative of folder opening is generated while the user interface is in the reconfiguration mode as while the user interface is in the normal mode (e.g., non-reconfiguration mode).

In some embodiments, after generating the audio output indicative of the operation associated with creating a folder and before a folder has been created based on the request to move the object, the computer system detects, via the one or more input devices, a portion of the user input that corresponds to a request to cancel the folder creation process. In some embodiments, in response to detecting the portion of the user input that corresponds to the request to cancel the folder creation process, in conjunction with canceling the folder creation process, the computer system generates, via the one or more audio output devices, an audio output indicative of cancellation of the folder creation process. For example, as described with reference to FIGS. 9K-9L, in conjunction with cancelling the folder creation process, the computer system 100 generates sound 9904 indicative of cancelling the folder creation process. In some embodiments, initiation of the folder creation process includes displaying a temporary folder (e.g., a folder preview icon) and the portion of the user input that corresponds to the request to cancel the folder creation process includes moving the object away from the temporary folder. In some embodiments, in accordance with a determination that the object is moved more than the threshold distance away from the temporary folder, the computer system cancels the folder creation process, including the temporary folder. In some embodiments, canceling the folder creation process includes ceasing to display the temporary folder. In some embodiments, the audio output indicative of cancellation of a folder creation process is different from an audio output indicative of completion of a folder creation process.

In some embodiments, the audio output indicative of the operation associated with creating a folder corresponds to an audio output indicative of initiation of a folder creation process. In some embodiments, the audio output indicative of cancellation of a folder creation process is different from the audio output indicative of initiation of a folder creation process. For example, as described with reference to FIGS. 9K-9L, the sound 9904 indicative of cancelling the folder creation process is different from the sound 9900 (e.g., in FIG. 9I) indicative of initiating the folder creation process. In some embodiments, the audio output indicative of initiation of a folder creation process has a first audio output profile (e.g., a first sound having a first wave pattern, frequency, phase, and/or accompanying tactile output) and the audio output indicative of cancellation of a folder creation process has a second audio output profile (e.g., a second sound having a second wave pattern, frequency, phase, and/or accompanying tactile output) different from the first audio output profile.

In some embodiments, the audio output indicative of cancellation of a folder creation process is different from an audio output that is generated in response to detecting that the object is placed in a folder (e.g., where the object is moved to and dropped into a folder, and/or where the object is released while the object is at a location that corresponds to a folder, such as folder in an expanded state, a folder in a non-expanded state, and/or a temporary folder). For example, as described with reference to FIGS. 9K-9L, the sound 9904 indicative of cancelling the folder creation process is different from the sound 9902 (e.g., in FIG. 9J) indicative of creating a folder and/or a sound 9913 indicative of placing an application icon into a folder (e.g., in FIG. 9AL) and/or into a folder preview icon, such as folder preview icon 920a.

In some embodiments, the first plurality of user interface objects is displayed, via the one or more display generation components, in an environment (e.g., a two-dimensional user interface or a three-dimensional environment such as a three-dimensional virtual reality environment, a three-dimensional augmented reality environment, and/or a three-dimensional extended reality environment). In some embodiments, a respective audio output generated in response to performing an operation with respect to a folder has a simulated location that corresponds to a location of the folder in the environment. For example, as described with reference to FIG. 9J, the sound G′ 9902 indicative of creating a folder (e.g., by dropping application icon 90c into folder preview icon 920a) has spatial characteristics that corresponds to the location of folder icon 920 in the three-dimensional environment and/or in the home user interface 8100.

In some embodiments, a respective audio output is generated in conjunction with moving the object, and the respective audio output has a simulated location that corresponds to a location of the object that is being moved in response to detecting the user input. For example, as described with reference to FIG. 9C, the sound indicative of moving application icon 90b has spatial audio characteristics indicating a position or a region in the three-dimensional environment from which the application icon 90b is dislodged. In some embodiments, the computer system generates a movement sound that has a spatial audio effect in that the movement sound seems to move along with or according to the movement of the object. For example, the respective audio output that is generated in conjunction with moving the object is provided as spatial audio from a simulated location corresponding to the location of the object, where the simulated location changes as the object is moving in the environment. Further details about the characteristics of spatial audio are provided in relation to method 11000 (e.g., method step 11072).

In some embodiments, while moving the object in the user interface in response to detecting the user input, the computer system generates, via the one or more audio output devices, audio outputs different from the audio output indicative of the operation associated with creating a folder. In some embodiments, the audio outputs that are generated correspond to ambient sounds (e.g., ambient sounds A and A′ that are described in further detail with reference to FIGS. 8E-8F), where the ambient sounds are different from sounds that are generated by the computer system in response to the detection of user inputs (e.g., inputs interacting with the user interface and/or interacting with objects in the user interface). In some embodiments, as the object is dragged to different regions of the user interface, causing user interface objects located in different placement locations to dislodge and move relative to their respective placement locations, the computer system generates spatial audio feedback with spatial characteristics indicating the region(s) from which the user interface objects are being dislodged by the movement of the object. For example, as described with reference to FIG. 9C, in conjunction with dislodging or moving application icon 90b relative to its placement location in the applications view 9100a, the computer system 101 generates a sound indicative of moving an application icon, in this example application icon 90b.

In some embodiments, the plurality of objects are arranged into a plurality of groups of objects (e.g., a multi-section or multi-page home screen user interface, where a respective section or page includes a respective group of the plurality of groups of objects), and a subset of the plurality of objects, including the object, are displayed in a first group that is active (e.g., currently displayed or has user input focus). In some embodiments, in response to detecting the user input that corresponds to the request to move the object, the computer system moves the object in a direction of a second group of the plurality of groups and, in conjunction with navigating from the first group to the second group, the computer system generates, via the one or more audio output devices, an audio output indicative of navigation between groups. For example, as described with reference to FIG. 9AS, in conjunction with navigating from the currently displayed section, which includes a group of application icons 90a-90k, to the previous section, which includes a group of application icons 99a-99k, the computer system 101 generates a sound 9916 indicative of navigation between sections of applications view 9100a of home screen user interface 8100. In some embodiments, navigating from the first group to the second group includes ceasing display of a first subset of the plurality of objects in the first group and displaying a second subset of the plurality of objects in the second group. In some embodiments, the plurality of groups of objects are scrolled or navigated through in response to detecting a movement of the object from the first group in a direction of the second group and maintaining a hold of the object outside an arrangement of the first subset of the plurality of objects in the first group for at least a threshold amount of time. For example, the plurality of groups of objects (e.g., of a multi-page or multi-section home screen) are automatically scrolled in response to dragging an icon towards an edge (e.g., left or right edge) of a viewport and maintaining the icon at the edge or at less than a threshold distance from the edge for at least a threshold amount of time. For example, if an application icon is moved from a location in a first group of objects (e.g., currently displayed or has user input focus) in a direction of a second group of objects (e.g., not currently displayed or not yet displayed, or does not have user input focus or does not yet have input focus) and the application icon is held for more than a threshold amount of time outside an arrangement of application icons included in the first group towards the second group, an arrangement of application icons in the second group automatically and, optionally, gradually slide over or move in place of the arrangement of application icons in the first group, and the arrangement of application icons in the first group gradually slide off (or cease to be displayed in) a viewport of a three-dimensional environment.

In some embodiments, the computer system detects, via the one or more input devices, a navigation input (e.g., a swipe input, a gaze input, a tap input, and/or other input such an air pinch and drag input, an air swipe input or a digital crown rotation input). In some embodiments, in response to detecting the navigation input, the computer system displays, via the one or more display generation components, navigation from a third group to a fourth group of the plurality of groups (e.g., moving the fourth group of the plurality of groups into a region that has user input focus and/or ceasing to display the third group and displaying the fourth group at a location that was previously occupied by the third group) without moving an object and without generating, via the one or more audio output devices, the audio output indicative of navigation between groups. In some embodiments, while the audio output indicative of navigation between groups is generated (and, optionally, outputted) in conjunction with navigating from the first group to the second group in response to the user input that corresponds to the request to move the object, the audio output indicative of navigation between groups is not generated in conjunction with navigating from the first group to the second group in response to a scroll input or other navigation input (e.g., that does not include movement of an object). For example, as described with reference to FIGS. 9AM-9AS, the sounds 9916 and 9915 indicative of navigation between sections in response to inputs moving application icon 90c are not generated when navigating between sections in response to scroll inputs or other navigation inputs that do not include a request to move a user interface object.

In some embodiments, audio outputs indicative of objects being moved are not generated while moving objects and navigating from the first group to the second group (or, optionally, while navigating from one group to a different group). For example, as described with reference to FIG. 9AO, when navigating between sections of application view 9100a, the computer system 101 forgoes generating (e.g., suppresses) sounds indicative of moving application icons in applications view 9100a (e.g., where the movement of application icons is a result of the application icons being pushed by the application icon that is being dragged). For example, the computer system 101 forgoes generating a sound when application icon 90d is pushed and moved underneath application icon 90c.

In some embodiments, in accordance with a determination that the object is moved in a first direction, the audio output indicative of navigation between sections has a first audio output profile (e.g., a first sound having a first wave pattern, frequency, phase, and/or accompanying tactile output). In some embodiments, in accordance with a determination that the object is moved in a second direction different from (e.g., opposite of) the first direction, the audio output indicative of navigation between sections has a second audio output profile (e.g., a second sound having a first wave pattern, frequency, phase, and/or accompanying tactile output) different from the first audio profile. For example, as described with reference to FIGS. 9AM-9AS, a sound indicative of navigating between sections in response to movement inputs in a direction of the right viewport boundary (e.g., sound 9915) is different from a sound indicative of navigating between sections in response to movement inputs in a direction of the left viewport boundary (e.g., sound 9916).

In some embodiments, the user input that corresponds to the request to move the object is a request to move the object in the respective direction. In some embodiments, in response to detecting the input corresponding to the request to move the object in the respective direction, (e.g., further away from the first section, further away from a preceding section that precedes the second section in the sequence, or moving the object towards an end of the user interface) the computer system generates a new group of the plurality of groups, where the new group has space to place the object in the group; and in conjunction with generating the new group, the computer system generates, via the one or more audio output devices, an audio output indicative of group generation, where the audio output indicative of group generation is different from the audio output indicative of navigation between groups. In some embodiments, the new group is generated in accordance with a determination that the object is moved within a threshold distance from an edge of a viewport (e.g., where the edge of the viewport corresponds to a last edge of the user interface), or that the object is maintained at less than the threshold distance from the edge for at least a threshold amount of time. For example, as described with reference to FIG. 9AS, the sound 9916 indicative of navigation between existing sections is different from the sound 9915 indicative of navigation between an existing section and a newly created section of applications view 9100a.

In some embodiments, the computer system detects a user input (e.g., a touch input, a mouse input, and/or an air gesture) directed toward a respective user interface object of the plurality of user interface objects. In some embodiments, the user input corresponds to a request to remove the respective user interface object from the user interface. In some embodiments, in response to detecting the user input, the computer system removes the respective user interface object from the user interface (e.g., ceasing to display the respective user interface object, optionally, while maintaining display of one or more objects in the group), and in conjunction with removing the respective user interface object from the user interface, the computer system generates, via the one or more audio output devices, an audio output indicative of removal of the respective user interface object from the user interface. For example, as described with reference to FIGS. 9AG-9AH, in conjunction with removing application icon 9212 from the applications view 9100b, the computer system 101 generates a sound 9908 indicative of the successful removal of a user interface object from a home screen user interface, in this example the successful removal of application icon 9212.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

As described above, one aspect of the present technology is the gathering and use of data available from various sources to improve XR experiences of users. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to improve an XR experience of a user. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of XR experiences, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an XR experience can generated by inferring preferences based on non-personal information data or a bare minimum amount of personal information, such as the content being requested by the device associated with a user, other non-personal information available to the service, or publicly available information.

1. A method, comprising:
at a computer system that is in communication with one or more display generation components and one or more input devices:
displaying, via the one or more display generation components, a first user interface, in a first view of an environment, including displaying a first plurality of user interface objects in a first plurality of placement locations in the first user interface according to a first arrangement of the first plurality of user interface objects;
while displaying the first user interface including the first plurality of user interface objects, detecting a first user input that is directed to a first user interface object of the first plurality of user interface objects, wherein the first user interface object was displayed at a first placement location in the first user interface when a start of the first user input was detected, and wherein the first user input includes first movement and meets drag criteria with respect to the first user interface object; and
in response to detecting the first user input that meets the drag criteria with respect to the first user interface object:
moving the first user interface object relative to the first placement location in the first user interface based on the first movement of the first user input;
in accordance with a determination that the first user interface object is approaching a second user interface object placed in a second placement location, different from the first placement location, in the first user interface, moving the second user interface object relative to the second placement location in a first direction away from the first user interface object; and
in accordance with a determination that the first user interface object is within a first threshold distance of the second user interface object after the second user interface object is moved relative to the second placement location, away from the first user interface object, ceasing to move the second user interface object away from the first user interface object and initiating a process for creating a folder that includes the first user interface object and the second user interface object.

2. The method of claim 1, including:
in response to detecting the first user input that meets the drag criteria with respect to the first user interface object, in accordance with the determination that the first user interface object is within the first threshold distance of the second user interface object after the second user interface object is moved relative to the second placement location, away from the first user interface object, displaying an indication regarding creation of the folder that includes the first user interface object and the second user interface object.

3. The method of claim 1, including:
in response to detecting the first user input that meets the drag criteria with respect to the first user interface object, in accordance with a determination that the first user interface object has moved past the second placement location after approaching the second placement location based on the first movement, moving the second user interface object relative to the second placement location in a second direction that is different from the first direction.

4. The method of claim 1, including:
in response to detecting the first user input that meets the drag criteria with respect to the first user interface object, in accordance with a determination that confirmation criteria are met by the first user input while the first user interface object is within the first threshold distance of the second user interface object, creating the folder including the first user interface object and the second user interface object at the second placement location.

5. The method of claim 1, including:
in response to detecting the first user input that meets the drag criteria with respect to the first user interface object, in accordance with a determination that confirmation criteria are not met by the first user input while the first user interface object is within the first threshold distance of the second user interface object, forgoing creating the folder at the second placement location.

6. The method of claim 1, including:
in response to detecting the first user input that meets the drag criteria with respect to the first user interface object, in accordance with the determination that the first user interface object is within the first threshold distance of the second user interface object after the second user interface object is moved relative to the second placement location, away from the first user interface object, moving the second user interface object toward the first user interface object.

7. The method of claim 1, wherein moving the second user interface object relative to the second placement location in the first direction away from the first user interface object includes moving the second user interface object with displacements in two or more dimensions of the environment that result in an increased distance between the first user interface object and the second user interface object in the environment.

8. The method of claim 1, including:
in response to detecting the first user input that meets the drag criteria with respect to the first user interface object:
in accordance with a determination that the first user interface object is approaching a third user interface object placed in a third placement location, different from the first placement location and the second placement location, in the first user interface, moving the third user interface object relative to the third placement location in a second direction away from the first user interface object; and
in accordance with a determination that the first user interface object is within the first threshold distance of the third user interface object after the third user interface object is moved relative to the third placement location, away from the first user interface object, ceasing to move the third user interface object away from the first user interface object and initiating a process for creating a folder that includes the first user interface object and the third user interface object.

9. The method of claim 1, including:
in response to detecting the first user input:
in accordance with a determination that the first user interface object has moved less than a first threshold amount of movement relative to the first placement location based on the first movement of the first user input, forgoing moving another user interface object in the first user interface into the first placement location; and
in accordance with a determination that the first user interface object has moved more than the first threshold amount of movement relative to the first placement location based on the first movement of the first user input, moving another user interface object in the first user interface into the first placement location.

10. The method of any of claim 1, including:
in response to detecting, via the one or more input devices, an initial portion of the first user input that is directed to the first user interface object, in accordance with a determination that the initial portion of the first user input meets interaction criteria with respect to the first user interface object, displaying a first animated movement of the first user interface object relative to the first placement location.

11. The method of claim 1, including:
in response to detecting, via the one or more input devices, a termination of the first user input, in accordance with a determination that the first user interface object is within the first threshold distance of the second user interface object, displaying the folder at the second placement location in the first user interface.

12. The method of claim 11, including:
prior to detecting the termination of the first user input, in accordance with a determination that the first user interface object is within the first threshold distance from the second user interface object, displaying, via the one or more display generation components, a preview of the folder and displaying, via the one or more display generation components, a second animated movement of the second user interface object into the preview of the folder.

13. The method of claim 1, wherein:
detecting the first user input that meets the drag criteria includes detecting, via the one or more input devices, an initial portion of the first user input that is directed to the first user interface object, followed by detecting the first movement; and
detecting the initial portion of the first user input includes detecting, via the one or more input devices, an air pinch gesture that is started while attention of a user is directed to the first user interface object, and the air pinch gesture is maintained for at least a first threshold amount of time with less than a threshold amount of movement before the first movement is started.

14. The method of claim 1, including:
in response to detecting, via the one or more input devices, a termination of the first user input that meets the drag criteria with respect to the first user interface object:
in accordance with a determination that the first user interface object is approaching a first unoccupied placement location and is within a second threshold distance of the first unoccupied placement location at the termination of the first user input, placing the first user interface object in the first unoccupied placement location in the first user interface.

15. The method of claim 1, including:
in response to detecting the first user input that meets the drag criteria with respect to the first user interface object, in accordance with a determination that the first user interface object is approaching a fourth user interface object placed in a fourth placement location, different from the first placement location and the second placement location, in the first user interface, moving the fourth user interface object relative to the fourth placement location in a third direction away from the first user interface object.

16. The method of claim 15, including:
in response to detecting the first user input that meets the drag criteria with respect to the first user interface object, in accordance with a determination that the first user interface object is within the first threshold distance of the fourth user interface object after the fourth user interface object is moved relative to the fourth placement location, away from the first user interface object, moving the fourth user interface object toward the fourth placement location in the first user interface.

17. The method of claim 15, wherein the first placement location is in a first portion of the first user interface and the second placement location in a second portion of the first user interface that is different from the first portion of the first user interface, and wherein the first portion of the first user interface and the second portion of the first user interface are portions of a first page of the first user interface.

18. The method of claim 17, wherein the fourth placement location is in a third portion of the first user interface, and wherein the third portion of the first user interface is in a second page of the first user interface different from the first page of the first user interface.

19. The method of claim 1, wherein:
the first plurality of user interface objects in the first plurality of placement locations in the first user interface includes one or more folders and one or more individual user interface objects, wherein a respective folder of the one or more folders is configured to include two or more individual user interface objects and occupies a single placement location in the first user interface, and
the method includes:
while displaying the first user interface including the one or more folders and the one or more individual user interface objects, detecting, via the one or more input devices, a second user input that corresponds to a request to expand a first folder of the one or more folders; and
in response to detecting the second user input that corresponds to a request to expand the first folder of the one or more folders, displaying, via the one or more display generation components, an expanded representation of the first folder in the first user interface, including displaying a second plurality of user interface objects within the expanded representation of the first folder.

20. The method of claim 19, including:
while displaying the first user interface, including displaying the second plurality of user interface objects within the expanded representation of the first folder in the first user interface, detecting, via the one or more input devices, a third user input that is directed to a respective user interface object of the second plurality of user interface objects within the expanded representation of the first folder, wherein the third user input includes second movement and meets the drag criteria with respect to the respective user interface object of the second plurality of user interface objects; and
in response to detecting the third user input that includes the second movement and that meets drag criteria with respect to the respective user interface object of the second plurality of user interface objects:
moving the respective user interface object of the second plurality of user interface objects based on the second movement of the third user input;
in accordance with a determination that the respective user interface object of the second plurality of user interface objects is within of the expanded representation of the first folder, displaying, via the one or more display generation components, user interface objects of the first plurality of user interface objects that are located outside of the expanded representation of the first folder in the first user interface, with a first set of visual properties that corresponds to a reduced visual prominence as compared to the second plurality of user interface objects; and
in accordance with a determination that the respective user interface object of the second plurality of user interface objects is outside of the expanded representation of the first folder, displaying, via the one or more display generation components, the user interface objects of the first plurality of user interface objects that are located outside of the expanded representation of the first folder in the first user interface, with a second set of visual properties that corresponds to a comparable visual prominence as compared to the second plurality of user interface objects.

21. The method of claim 20, including:
while the user interface objects of the first plurality of user interface objects that are located outside of the expanded representation of the first folder are displayed with a respective set of visual properties, detecting, via the one or more input devices, a termination of the third user input; and
in response to detecting the termination of the third user input:
in accordance with a determination that the user interface objects of the first plurality of user interface objects that are located outside of the expanded representation of the first folder are displayed with the first set of visual properties that corresponds to a reduced visual prominence as compared to the second plurality of user interface objects, placing the respective user interface object within the expanded representation of the first folder; and
in accordance with a determination that the user interface objects of the first plurality of user interface objects that are located outside of the expanded representation of the first folder are displayed with the second set of visual properties that corresponds to a comparable visual prominence as compared to the second plurality of user interface objects, placing the respective user interface object outside the expanded representation of the first folder.

22. The method of claim 19, wherein the second plurality of user interface objects included in the first folder corresponds to a first total object count, and wherein displaying the second plurality of user interface objects within the expanded representation of the first folder includes:
in accordance with a determination that the first total object count is less than a first threshold object count, displaying, via the one or more display generation components, the second plurality of user interface objects within the expanded representation of the first folder according to a first set of layout properties; and
in accordance with a determination that the first total object count is greater than the first threshold object count, displaying, via the one or more display generation components, the second plurality of user interface objects within the expanded representation of the first folder according to a second set of layout properties that is different from the first set of layout properties.

23. The method of claim 1, wherein:
the first plurality of user interface objects includes a first category of one or more user interface objects and a second category of one or more user interface objects; and
displaying the first plurality of user interface objects includes:
displaying, via the one or more display generation components, the one or more user interface objects from the first category of one or more user interface objects with a first set of appearance properties; and
displaying, via the one or more display generation components, the one or more user interface objects from the second category of one or more user interface objects with a second set of appearance properties different from the first set of appearance properties.

24. The method of claim 23, wherein the one or more user interface objects of the first category of one or more user interface objects correspond to one or more native applications of the computer system, and the one or more user interface objects of the second category of one or more user interface objects correspond to non-native applications that are compatible with the computer system.

25. The method of claim 23, wherein displaying the one or more user interface objects of the second category of one or more user interface objects includes:
in accordance with a determination that a respective user interface object of the second category of one or more user interface objects is outside of a designated folder for the second category of one or more user interface objects, displaying, via the one or more display generation components, the respective user interface object of the second category of one or more user interface objects with a third set of appearance properties; and
in accordance with a determination that the respective user interface object of the second category of one or more user interface objects is within of the designated folder for the second category of one or more user interface objects, displaying, via the one or more display generation components, the respective user interface object of the second category of one or more user interface objects with a fourth set of appearance properties different from the third set of appearance properties, when an expanded representation of the designated folder is displayed in the first user interface.

26. The method of claim 19, including:
while displaying the expanded representation of the first folder in the first user interface, including displaying the second plurality of user interface objects within the expanded representation of the first folder, detecting, via the one or more input devices, attention of a user directed to a first portion of the expanded representation of the first folder, wherein the first portion of the expanded representation of the first folder corresponds to a title of the first folder;
while detecting the attention of the user directed to the first portion of the expanded representation of the first folder, detecting, via the one or more input devices, a first air gesture that meets first criteria; and
in response to detecting the first air gesture while detecting the attention of the user directed to the first portion of the expanded representation of the first folder, displaying, via the one or more display generation components, an editing user interface for editing the title of the first folder.

27. The method of claim 1, including:
in response to detecting the first user input that meets the drag criteria with respect to the first user interface object, in accordance with a determination that confirmation criteria are met by the first user input while the first user interface object is within the first threshold distance of the second user interface object, displaying, via the one or more display generation components, a third animated movement of a preview of the folder toward the first user interface object, before displaying the folder including the first user interface object and the second user interface object at the second placement location.

28. The method of claim 1, wherein detecting the first user input that is directed to the first user interface object and that meets the drag criteria includes detecting an initial portion of the first user input and detecting, via the one or more input devices, a termination of the first user input, and
the method includes:
in response to detecting the initial portion of the first user input, outputting, via one or more output devices of the computer system, a first non-visual output having a first output profile; and
in response to detecting the termination of the first user input, outputting, via the one or more output devices of the computer system, a second non-visual output having a second output profile that is different from the first output profile.

29. The method of claim 1, including:
in response to detecting the first user input:
generating, via one or more output devices of the computer system, a third non-visual output based on movement of the second user interface object relative to the second placement location, as a result of a movement of the first user interface object toward the second user interface object.

30. The method of claim 29, wherein generating the third non-visual output based on the movement of the second user interface object relative to the second placement location includes:
in accordance with a determination that the second placement location is located in a first region of the first user interface, generating the third non-visual output with a first set of spatial characteristics that corresponds to the first region of the first user interface; and
in accordance with a determination that the second placement location is located in a second region of the first user interface different from the first region of the first user interface, generating the third non-visual output with a second set of spatial characteristics that corresponds to the second region of the first user interface, the second set of spatial characteristics differs from the first set of spatial characteristics.

31. A computer system that is in communication with one or more display generation components and one or more input devices, the computer system comprising:
one or more processors; and
memory storing one or more programs configured to be executed by the one or more processors, the one or more programs including instructions for:
displaying, via the one or more display generation components, a first user interface, in a first view of an environment, including displaying a first plurality of user interface objects in a first plurality of placement locations in the first user interface according to a first arrangement of the first plurality of user interface objects;
while displaying the first user interface including the first plurality of user interface objects, detecting a first user input that is directed to a first user interface object of the first plurality of user interface objects, wherein the first user interface object was displayed at a first placement location in the first user interface when a start of the first user input was detected, and wherein the first user input includes first movement and meets drag criteria with respect to the first user interface object; and
in response to detecting the first user input that meets the drag criteria with respect to the first user interface object:
moving the first user interface object relative to the first placement location in the first user interface based on the first movement of the first user input;
in accordance with a determination that the first user interface object is approaching a second user interface object placed in a second placement location, different from the first placement location, in the first user interface, moving the second user interface object relative to the second placement location in a first direction away from the first user interface object; and
in accordance with a determination that the first user interface object is within a first threshold distance of the second user interface object after the second user interface object is moved relative to the second placement location, away from the first user interface object, ceasing to move the second user interface object away from the first user interface object and initiating a process for creating a folder that includes the first user interface object and the second user interface object.

32. A computer-readable storage medium storing one or more programs configured to be executed by one or more processors of a computer system that is in communication with one or more display generation components and one or more input devices, the one or more programs including instructions for:
displaying, via the one or more display generation components, a first user interface, in a first view of an environment, including displaying a first plurality of user interface objects in a first plurality of placement locations in the first user interface according to a first arrangement of the first plurality of user interface objects;
while displaying the first user interface including the first plurality of user interface objects, detecting a first user input that is directed to a first user interface object of the first plurality of user interface objects, wherein the first user interface object was displayed at a first placement location in the first user interface when a start of the first user input was detected, and wherein the first user input includes first movement and meets drag criteria with respect to the first user interface object; and
in response to detecting the first user input that meets the drag criteria with respect to the first user interface object:
moving the first user interface object relative to the first placement location in the first user interface based on the first movement of the first user input;
in accordance with a determination that the first user interface object is approaching a second user interface object placed in a second placement location, different from the first placement location, in the first user interface, moving the second user interface object relative to the second placement location in a first direction away from the first user interface object; and
in accordance with a determination that the first user interface object is within a first threshold distance of the second user interface object after the second user interface object is moved relative to the second placement location, away from the first user interface object, ceasing to move the second user interface object away from the first user interface object and initiating a process for creating a folder that includes the first user interface object and the second user interface object.

33-54. (canceled)
